(19) United States
(12) Patent Application Publication
(10) Pub. No.: US 2021/0387350 A1
(43) Pub. Date: Dec. 16, 2021

(54) ROBOTIC KITCHEN HUB SYSTEMS AND METHODS FOR MINIMANIPULATION LIBRARY ADJUSTMENTS AND CALIBRATIONS OF MULTI-FUNCTIONAL ROBOTIC PLATFORMS FOR COMMERCIAL AND RESIDENTIAL ENVIORNMENTS WITH ARTIFICIAL INTELLIGENCE AND MACHINE LEARNING

(71) Applicant: Mark Oleynik, Monaco (MC)

(72) Inventor: Mark Oleynik, Monaco (MC)

(21) Appl. No.: 17/120,221

(22) Filed: Dec. 13, 2020

Related U.S. Application Data
(63) Continuation-in-part of application No. 16/900,842, filed on Jun. 12, 2020.

(51) Int. Cl. B25J 11/00; B25J 19/00; B25J 9/16; B25J 9/08; A47J 36/32

(52) U.S. Cl. CPC B25J 11/0045; B25J 19/007; A47J 36/321; B25J 9/08; B25J 9/1682; B25J 9/1692

(57) ABSTRACT

The present disclosure is directed to methods, computer program products, and computer systems of a robotic kitchen hub for minimanipulation library adjustments and calibrations of multi-functional robotic platforms for commercial and residential environments with artificial intelligence and machine learning. The multi-functional robotic platform includes a robotic kitchen for calibration with either a joint state trajectory or in a coordinate system like a cartesian coordinate for mass installation of robotic kitchens. Calibration verifications and minimanipulation library adaptation and adjustment of any serial model or different models provide scalability in the mass manufacturing of a robotic kitchen system. A robotic kitchen with multi-mode provides a robot mode, a collaboration mode and a user mode which a particular food dish can be prepared by the robot, a collaboration on sharing tasks between the robot and a user, or the robot serves as an aid for the user to prepare a food dish.

### CROSS REFERENCE TO RELATED APPLICATIONS

This application is a continuation-in-part of co-pending U.S. patent application Ser. No. 16/900,842 entitled “Systems and Methods for Minimanipulation Library Adjustments and Calibrations of Multi-Functional Robotic Platforms with Supported Subsystem Interactions,” filed 12 Jun. 2020.

This application claims priority to U.S. Provisional Application Ser. No. 63/121,907 entitled “Systems and Methods for Minimanipulation Library Adjustments and Calibrations of Multi-Functional Robotic Platforms with Supported Subsystem Interactions,” filed 5 Dec. 2020, U.S. Provisional Application Ser. No. 63/093,100 entitled “Systems and Methods for Minimanipulation Library Adjustments and Calibrations of Multi-Functional Robotic Platforms with Supported Subsystem Interactions,” filed 16 Oct. 2020, U.S. Provisional Application Ser. No. 63/088,443 entitled “Systems and Methods for Minimanipulation Library Adjustments and Calibrations of Multi-Functional Robotic Platforms with Supported Subsystem Interactions,” filed 6 Oct. 2020, U.S. Non-Provisional application Ser. No. 16/900,842 entitled “Systems and Methods for Minimanipulation Library Adjustments and Calibrations of Multi-Functional Robotic Platforms with Supported Subsystem Interactions,” filed on 12 Jun. 2020, U.S. Provisional Application Ser. No. 63/088,443 entitled “Systems and Methods for Minimanipulation Library Adjustments and Calibrations of Multi-Functional Robotic Platforms with Supported Subsystem Interactions,” filed 6 Jun. 2020, U.S. Provisional Application Ser. No. 63/026,328 entitled “Ingredient Storing Smart Container for Human and Robotic Operation Environment,” filed 18 May 2020, U.S. Provisional Application Ser. No. 62/984,321 entitled “Systems and Methods for Operation Automated and Robotic, Instrumental Environments Including Living and Warehouse Facilities,” filed 3 Mar. 2020, U.S. Provisional Application Ser. No. 62/970,725 entitled “Systems and Methods for Operation Automated and Robotic, Instrumental Environments Including Living and Warehouse Facilities,” filed 6 Feb. 2020, the disclosures of which are incorporated herein by reference in their entireties.

This application is also related to U.S. Provisional Application Ser. No. 62/929,973 entitled “Method and System of Robotic Kitchen and IOT Environments,” filed 4 Nov. 2019, and U.S. Provisional Application Ser. No. 62/860,293 entitled “Systems and Methods for Operation Automated and Robotic Environments in Living and Warehouse Facilities,” filed 12 Jun. 2019

### BACKGROUND

### Technical Field

The present disclosure relates generally to the interdisciplinary fields of robotics and artificial intelligence (AI), more particularly to computerized robotic systems employing electronic libraries of minimanipulations with transformed robotic instructions for replicating movements, processes, and techniques with real-time electronic adjustments.

### Background Art

Research and development in robotics have been undertaken for decades, but the progress has been mostly in the heavy industrial applications like automobile manufacturing automation or military applications. Simple robotics systems have been designed for the consumer markets, but they have not seen a wide application in the home-consumer robotics space, thus far. With advances in technology, combined with a population with higher incomes, the market may be ripe to create opportunities for technological advances to improve people's lives. Robotics has continued to improve automation technology with enhanced artificial intelligence and emulation of human skills and tasks in many forms in operating a robotic apparatus or a humanoid.

The notion of robots replacing humans in certain areas and executing tasks that humans would typically perform is an ideology in continuous evolution since robots were first developed in the 1970s. Manufacturing sectors have long used robots in teach-playback mode, where the robot is taught, via pendant or offline fixed-trajectory generation and download, which motions to copy continuously and without alteration or deviation. Companies have taken the pre-programmed trajectory-execution of computer-taught trajectories and robot motion-playback into such application domains as mixing drinks, welding or painting cars, and others. However, all of these conventional applications use a 1:1 computer-to-robot or tech-playback principle that is intended to have only the robot faithfully execute the motion-commands, which is usually following a taught/pre-computed trajectory without deviation.

As the research and development in the robotic industry has accelerated in recent years, both in consumer robotics, commercial robotics and industrial robotics, companies are working to design robotic products that can be scaled and widely deployed in their respective regions and worldwide. Due in part to the mechanical compositions of a robotic product, mass manufacturing and installation of robotic products present challenges to ensure that the finished robotic product operates to meet with the technical specification, which can arise from issues such as part variations, manufacturing errors, installation differences, and others.

Accordingly, it is desirable to have a robotic system with a fully or semi-automatic calibration operating framework and minimanipulation library adjustment for mass manufacturing kitchen modules, multiple modes of operations, and subsystems operating and interacting in a robotic kitchen.

### SUMMARY OF THE DISCLOSURE

Embodiments of the present disclosure are directed to methods, computer program products, and computer systems of a multi-functional robotic platform including a robotic kitchen for calibration with either a joint state trajectory or in a coordinate system like a cartesian coordinate for mass installation of robotic kitchens, multi-mode (also referred to as multiple modes, e.g., bimodal, trimodel, multimodal, etc.) operations of the robotic kitchen to provide different ways to prepare food dishes, and subsystems tailored to operate and interact with the various elements of a robotic kitchen, such as the robotic effectors, other subsystems, and containers, ingredients.

In a first aspect of the present disclosure, a system and a method comprises a reliable operation inside a robotic kitchen in an instrumented environment is the capability to rely on absolute positioning of the instrumented environment. As to resolve a common problem in robotics in which each robotic system manufactured undergoes calibration verifications and minimanipulation library adaptation and adjustment of any serial model or different models automatic adaptation. The disclosure is directed to the scalability in the mass manufacturing of a robotic kitchen system, as well as methods as to how each manufactured robotic kitchen system meets the operational requirements. Standardized procedures are adopted which are aimed to automate the calibration process. Accurate and repeatable assembly process is the first step in assuring that each manufactured robotic system is as close as possible to the assumed (or predetermined) geometry or geometric parameters. Lifetime product natural deformation could be also the reason to process time to time automatic calibration and minimanipulation library adaptation and adjustment. The different product models need to have also adapted and validated library of minimanipulation which support various functional operations. Automated calibration procedures assure that operations created inside a master (or model) kitchen environment works in each robotic kitchen system and the solution is easily scalable for mass production. The physical geometry is adapted for robotic operations, any displacement in the robotic system is being compensated using various techniques as described in the present disclosure. In another embodiment, the present disclosure is directed to a robotic system compatibility operable in a plurality of different modes. User mode, robot mode and collaborative mode. Document specifying the way of mitigation for the risk in collaborative mode, using different sensors to keep environment safe for human collaborative operation. For example, the present disclosure describes a robotic kitchen system and a method that operates with any functional robotic platform having minimanipulation operations libraries of a master robotic kitchen module with an automatic calibration system for initializing the initial state of another robotic kitchen during an installation.

In a second aspect of the present disclosure, a robotic system and a method that comprise a plurality of modes of operations of a robotic kitchen, including but not limited to, a robot operating mode, a collaborative operating mode between a robot apparatus and a user, and a user operating mode which the robotic kitchen facilitating to the requirements by the user.

In a third aspect of the present disclosure, a robotic kitchen includes subsystems that are designed to operate and interact with a robot (e.g., one or more robotic arms coupled to one or more end effectors), or interact with other subsystems, kitchen tools, kitchen devices, or containers.

Broadly stated, a system for mass production of a robotic kitchen module, comprises a kitchen module frame for housing a robotic apparatus in an instrumented environment, the robotic apparatus having one or more robotic arms and one or more effectors, the one or more robotic arms including a share joint, the kitchen module having a set of robotic operatable parameters for calibration verifications to an initial state for operation by the robotic apparatus; and one or more calibration actuators coupled to a respective one of the one or more robotic arms, each calibration actuator corresponding to an axis on x-y-z axes, each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations.

Advantageously, the robotic systems and methods of the present disclosure provide greater functions and capabilities that work on multi-functional robotic platforms with calibration techniques with a joint state embodiment or a cartesian embodiment with multiple modes of operating the robotic kitchen.

The structures and methods of the present disclosure are disclosed in detail in the description below. This summary does not purport to define the disclosure. The disclosure is defined by the claims. These and other embodiments, features, aspects, and advantages of the disclosure will become better understood with regard to the following description, appended claims, and accompanying drawings.

### BRIEF DESCRIPTION OF THE DRAWINGS

The disclosure will be described with respect to specific embodiments thereof, and reference will be made to the drawings, in which:

FIG. 1A is a system diagram illustrating a top sectional view in an intersection of a robotic kitchen in a robot operating mode in accordance with the present disclosure; FIG. 1B is a system diagram illustrating a front view in the intersection of a robotic kitchen in a robot operating mode in accordance with the present disclosure; and FIG. 1C is a system diagram illustrating a front view of a robotic kitchen in a robot operating mode, with safeguard actuated to a down position to create a physical barrier between a robot apparatus in operation and human user, in accordance with the present disclosure; and FIGS. 1D, 1E, IF, 1G are flow diagrams illustrating a software system of the robotic kitchen with several subsystems, including a kitchen core, a chief executor, a creator software, shared components, and a user interface in accordance with the present disclosure.

FIGS. 2A-1 to 2A-4 collectively represent one complete flow diagram illustrating a process for different modes of operations, including a robot mode, a collaborative mode and a user mode, in a robotic kitchen in accordance with the present disclosure.

FIG. 2B is a flow diagram illustrating robotic task-execution via one or more minimanipulation library data sets to execute recipes from an electronic library database in a collaborative mode with a safety function and as to how a remote robotic system would utilize the minimanipulation (MM) library(ies) to carry out a remote replication of a particular task (cooking, painting, etc.) in accordance with the present disclosure.

FIG. 2C is a block diagram illustrating a data-centric view of the robotic system with a database for collaborative mode use safety workspace analysis sensory data in accordance with the present disclosure.

FIG. 2D depicts a dual-arm torso humanoid robot system as a set of manipulation function phases associated with any manipulation activity, regardless of the task to be accomplished, for MM library manipulation-phase combinations and transitions for task-specific action-sequences in accordance with the present disclosure.

FIG. 2E depicts a flow diagram illustrating the process of minimanipulation Library(ies) generation, for both generic and task-specific motion-primitives as part of the studio-data generation, collection and analysis process in accordance with the present disclosure.

FIG. 2F depicts a block diagram illustrating an automated minimanipulation parameter-set building engine for a minimanipulation task-motion primitive associated with a particular task in accordance with the present disclosure.

FIG. 2G is a block diagram illustrating examples of various minimanipulation data formats in the composition, linking and conversion of minimanipulation robotic behavior data in accordance with the present disclosure.

FIG. 2H depicts a logical diagram of main action blocks in the software-module/action layer within the macro-manipulation and micro-manipulation subsystems and the associated minimanipulation libraries dedicated to each in accordance with the present disclosure.

FIG. 2I depicts a block diagram illustrating the macro-manipulation and micro-manipulation physical subsystems and their associated sensors, actuators and controllers with their interconnections to their respective high-level and subsystem planners and controllers as well as world and interaction perception and modelling systems for minimanipulation planning and execution process in accordance with the present disclosure.

FIG. 2J depicts a block diagram illustrating one embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems in accordance with the present disclosure.

FIG. 2K depicts the process by which minimanipulation command-stack sequences are generated for any robotic system, in this case deconstructed to generate two such command sequences for a single robotic system that has been physically and logically split into a macro- and micro-manipulation subsystem in accordance with the present disclosure.

FIG. 2L depicts a block diagram illustrating another embodiment of the physical layer structured as a macro-manipulation/micro-manipulation in accordance with the present disclosure.

FIG. 2M depicts a block diagram illustrating another embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems in accordance with the present disclosure.

FIG. 2N depicts one of a myriad number of possible decision trees that may be used to decide on a macro-/micro-logical and physical breakdown of a system for the purpose of high fidelity control in accordance with the present disclosure.

FIG. 2O is a block diagram illustrating an example of a macro manipulation (also referred to as macro minimanipulation) of a stir process with todo parameters divided into (or composed of) multiple micro manipulations in accordance with the present disclosure.

FIG. 2P is a flow diagram illustrating the process of a macro/micro manager in allocating one or more macro manipulations and one or more micro manipulations in accordance with the present disclosure.

FIG. 3A is a system diagram illustrating a top view in the intersection of a robotic kitchen in a user operating mode in accordance with the present disclosure. In this illustration, the robot is hidden in the storage, the safeguard is actuated in the upper position, and human user is operating inside the cooking zone; FIG. 3B is a system diagram illustrating a front view in of a robotic kitchen in a user operating mode in accordance with the present disclosure. In this illustration, the robot is hidden in the storage, the safeguard is actuated in an upper position, and the human user is operating inside the cooking zone; and FIG. 3C is a system diagram illustrating a front view of the robotic kitchen in a user operating mode in accordance with the present disclosure. In this illustration, the robot is hidden in the storage, the safeguard is actuated in the upper position, and the human user is operating inside the cooking zone; FIG. 3D is a system diagram illustrating robot storage automatic doors closed and robot inside storage zone in accordance with the present disclosure; FIG. 3E is a system diagram illustrating robot storage automatic doors opened and robot inside the cooking zone; and FIG. 3F is a system diagram illustrating robot storage automatic doors with sensors, actuators guides, and safety components.

FIG. 4A is a system diagram illustrating a top view in the intersection of a robotic kitchen in a collaborative operating mode in accordance with the present disclosure. Safeguard is actuated to the upper position allowing the user to operate inside the cooking zone. Example robots are operating alongside human users. Camera and safety sensor system are monitoring the user position to plan robot actions and keep the user safe; FIG. 4B is a system diagram illustrating the front view of a robotic kitchen in a collaborative operating mode in accordance with the present disclosure. Safeguard is actuated to the upper position allowing the user to operate inside the cooking zone. Example robots are located inside cooking zone, safety sensors are visible; and FIG. 4C is a system diagram illustrating the front view of a robotic kitchen in a collaborative operating mode in accordance with the present disclosure. Safeguard is actuated to the upper position allowing the user to operate inside the cooking zone. Example robots are operating alongside human users. Camera and safety sensor system are monitoring the user position to plan robot actions and keep the user safe.

FIG. 5 is a system diagram illustrating a robotic kitchen system in a collaborative mode in accordance with the present disclosure.

FIG. 6 is a system diagram illustrating collaborative robot cooking station with conveyor belt system. Robots are performing cooking operations and passing dishes on the conveyor belts to human users.

FIG. 7A is a system diagram illustrating stationary collaborative robot cooking station in accordance with the present disclosure. A user is not harmed by the robot, as the robot is not able to physically reach the user. Zoning sensors are also placed in roboti kitchen the system. Robot is portioning the meals for human users in the common area, the user picks the dish, and then robot portions another one. Common area external zoning sensors for user detection are visible, the system understands when the user entered the common area; and FIG. 7B is a system diagram illustrating a stationary collaborative robot cooking station in accordance with the present disclosure. A user is not harmed by the robot, as the robot is not able to physically reach the user. Zoning sensors are also placed in roboti kitchen the system. Robot is portioning the meals for human users in the common area, the user picks the dish, and then robot portions another one. Common area internal zoning sensors for robot detection are visible, the system understands when the robot entered the common operation area.

FIG. 8 is a system diagram illustrating a robotic kitchen low level control system architecture in accordance with the present disclosure.

FIG. 9 is a system diagram illustrating an example of a robots system using different types of actuators in accordance with the present disclosure.

FIG. 10 is a system diagram illustrating a robotic hand with a plurality of sensors and a plurality of actuators for handling reliable recipe execution (e.g., sensors: RFID tag reader, UV light, LED light, tactile sensors, pressure sensors, barcode scanner) in accordance with the present disclosure.

FIG. 11A is a system diagram illustrating automatic tendon adjustment process for robotic hands in accordance with the present disclosure. If an object gets displaced after cooking operation i.e. stirring, the hand is commanding finger joints position to readjust itself to fix the object position back to the starting one. A system is using sensors and cameras to determine the displacement of the object and fixed position accuracy; and FIG. 11B is a system diagram illustrating a robot system with cameras attached to the carriage body. The System is able to monitor the surrounding environment. Grasp validation procedure available on the drawing. Camera ability to adjust its position and orientation with different angular configurations making the vision system more versatile. A vision system field of view is visible on the drawing.

FIG. 12 is a system diagram illustrating the reliable and repeatable assembly process of the frame in accordance with the present disclosure. Single parts of the frame illustrated on the diagram have the ability to interface one to another in only one way, to high precision machined inserts. The same way of interfacing is applied between the frame and subsystems.

FIG. 13 is a system diagram illustrating example assembly procedure for the robotic kitchen frame explained in accordance with the present disclosure. Profiles come in pre-assembled kits for ease of transport, which in one embodiment, is assembled only in one way, as to minimize the risk of inaccuracy and mistakes.

FIG. 14 is a system diagram illustrating a bottom view of the frame and subsystem interfacing one to another. High precision interfaces are visible on the drawing, High accuracy and repeatability inside the system is ensured inside the assembled system.

FIG. 15A is a system diagram illustrating an isometric view of the etalon model in accordance with the present disclosure.

FIG. 15B is a system diagram illustrating an side view of the etalon model in accordance with the present disclosure.

FIG. 15C is a system diagram illustrating an isometric view of the etalon model in accordance with the present disclosure.

FIG. 15D is a system diagram illustrating an isometric view of the etalon model in accordance with the present disclosure.

FIG. 16A is a system diagram illustrating automatic robot error tracking procedure, with the Y, Z positions and the X1, Y1 and Z1 positions illustrated in FIG. 16C, in accordance with the present disclosure; and FIG. 16B is a system diagram illustrating automatic robot error tracking procedure in accordance with the present disclosure.

FIG. 17 is a system diagram illustrating automatic adjustment procedure of robot model n in joint state execution library mode in accordance with the present disclosure.

FIG. 18 is a calibration flow chart indicating sequence of operation during calibration in accordance with the present disclosure.

FIG. 19 is a system diagram illustrating a tool storage mechanism for robotic kitchen in an exploded view in accordance with the present disclosure.

FIG. 20 is a system diagram illustrating vertical movement of the tool storage inside the kitchen environment in accordance with the present disclosure.

FIG. 21 is a system diagram illustrating vertical movement of the tool storage inside the kitchen environment in accordance with the present disclosure.

FIG. 22 is a system diagram illustrating tool storing drawers with its linear actuation, position feedback, position locking functionality for defined grasp position in accordance with the present disclosure.

FIG. 23A is a pictorial diagram illustrating a front view of quadruple direction hook interface in accordance with the present disclosure; and FIG. 23B is a system diagram illustrating isometric view of quadruple direction hook interface in accordance with the present disclosure.

FIG. 24 is a system diagram illustrating a tool storage system in a user mode in accordance with the present disclosure.

FIG. 25A is a visual diagram illustrating an exploded view of an inventory tracking device hook with multiple sensors, actuators, indicators, and communication modules in accordance with the present disclosure; and FIG. 25B is a visual diagram illustrating an exploded view of an inventory tracking device with multiple sensors, actuators, indicators, and communication modules in accordance with the present disclosure.

FIG. 26A is a visual diagram illustrating an inventory tracking device actuated hook initial position and orientation in accordance with the present disclosure; FIG. 26B is a visual diagram illustrating an inventory tracking device actuated hook position and orientation change executed by actuator system inside in accordance with the present disclosure; and FIG. 26C is a visual diagram illustrating an inventory tracking device actuated hook position and orientation change executed by actuator system inside in accordance with the present disclosure.

FIG. 27 is a system diagram illustrating one embodiment of an inventory tracking device architecture in accordance with the present disclosure.

FIG. 28 is a system diagram illustrating inventory tracking device example communication architecture in accordance with the present disclosure.

FIG. 29 is a system diagram illustrating one embodiment of an inventory tracking device for product installation in accordance with the present disclosure.

FIG. 30 is a system diagram illustrating one embodiment of an inventory tracking device for object training in accordance with the present disclosure.

FIG. 31 is a system diagram illustrating one embodiment of an inventory tracking device for object detection in accordance with the present disclosure.

FIG. 32 is a system diagram illustrating one example of an inventory tracking device on the sequence behaviour for product installation in accordance with the present disclosure.

FIG. 33 is a system diagram illustrating one example of an inventory tracking device on sequence behaviour for object training and detection in accordance with the present disclosure.

FIG. 34 is a system diagram illustrating one embodiment of a smart rail system in accordance with the present disclosure.

FIG. 35 is a system diagram illustrating one example on the functionality of a smart rail system in accordance with the present disclosure.

FIG. 36 is a system diagram illustrating one embodiment of a smart rail device example communication system in accordance with the present disclosure.

FIG. 37 is a system diagram illustrating an exploded view of a smart refrigerator with a different type of sensors, actuators and indicators integrated inside as part of a robotic kitchen in accordance with the present disclosure.

FIG. 38 is a system diagram illustrating an exploded view of a smart refrigerator tray with functionality provided by different types of sensors, actuators and indicators for use with the smart refrigerator in the robotic kitchen in accordance with the present disclosure.

FIG. 39 is a system diagram illustrating a user grasping of a container from container tray, with a light-emitting diode (LED) light projected on the position of the container in accordance with the present disclosure.

FIG. 40 is a visual diagram illustrating a refrigerator system with an integrated container tray and a set of containers in a robotic kitchen in accordance with the present disclosure.

FIG. 41 is a visual diagram illustrating one or more containers placed on the tray with electromagnet auto positioning functionality in accordance with the present disclosure.

FIG. 42 is a visual diagram illustrating the operational compatibility representation with robot and a human hand. Containers placed inside the refrigerator system can be operated freely by anthropomorphic hands in accordance with the present disclosure.

FIG. 43 is a system diagram illustrating the operational compatibility with a gripper type (for example, parallel and electromagnetic) in accordance with the present disclosure.

FIG. 44 is a system diagram illustrating a robotic system gripper with an electromagnet grasping and operating one or more container sin accordance with the present disclosure.

FIG. 45 is a visual diagram illustrating the back of a container with the lid in a closed position in accordance with the present disclosure.

FIG. 46 is a visual diagram of a coupler for robot gripper, with terminals for power and data exchange, in accordance with the present disclosure.

FIG. 47 is a system diagram illustrating the bottom view of the container in accordance with the present disclosure.

FIG. 48 is a system diagram illustrating an exploded view of the container with the functional components in accordance with the present disclosure.

FIG. 49 is a system diagram illustrating an automatic charging station inside the tray for containers, with physical contacts and wireless charging modules, in accordance with the present disclosure.

FIG. 50A is a system diagram illustrating a robot actuating to push to open a container lid mechanism, with a visible closed position, in accordance with the present disclosure.

FIG. 50B is a system diagram illustrating a robot actuating the push to open a container lid mechanism, with a visible open position, in accordance with the present disclosure.

FIG. 51 is pictorial diagram illustrating an exploded view of a robot end effector compatibility with a lid handle operation in accordance with the present disclosure.

FIG. 52 is a system diagram illustrating the different sizes of containers inside the robotic kitchen system refrigerator in accordance with the present disclosure.

FIG. 53 is a block diagram illustrating overall architecture of the refrigerator system in accordance with the present disclosure.

FIG. 54 is a system diagram illustrating a generic storage space with inventory tracking, position allocation and automatic sterilization functionality, with an automatic hand sterilization procedure, in accordance with the present disclosure.

FIG. 55 is a system diagram illustrating a robotic kitchen environment sterilization equipment, with an automatic hand sterilization procedure in accordance with the present disclosure.

FIG. 56 is a visual diagram illustrating a robotic kitchen in which one or more robotic kitchen equipment are placed inside and under refrigerator storage in accordance with the present disclosure.

FIG. 57 is a visual diagram illustrating a human user operating a graphical user interface (“GUI”) screen in accordance with the present disclosure.

FIG. 58 is a visual diagram illustrating a robotic kitchen in which one or more robotic kitchen equipment are placed inside and under refrigerator storage in accordance with the present disclosure.

FIG. 59 is a visual diagram illustrating a human user operating a graphical user interface (“GUI”) screen in accordance with the present disclosure.

FIG. 60 is a visual diagram illustrating a system with an automated safeguard opened position (of a robotic kitchen) in accordance with the present disclosure.

FIG. 61 is a block diagram illustrating a smart ventilation system inside of a robotics system environment in accordance with the present disclosure.

FIG. 62A is a block diagram illustrating a top view of a fire safety system along with the indications of nozzles and fire detect tube in accordance with the present disclosure; and FIG. 62B is a block diagram illustrating a dimeric view of a fire safety system along with the indications of nozzles and fire detect tube in accordance with the present disclosure.

FIG. 63 system diagram illustrating mobile robot manipulator interacting with the kitchen in accordance with the present disclosure.

FIG. 64A is a flow diagram illustrating the repositioning a robotic apparatus by using actuators for compensating the difference of an environment in accordance with the present disclosure; FIG. 64B is a flow diagram illustrating the recalculation each robotic apparatus joint state for trajectory execution with x-y-z and rotational axes for compensating the difference of an environment in accordance with the present disclosure; and FIG. 64C is flow diagram illustrating cartesian trajectory planning for environment adjustment in accordance with the present disclosure.

FIG. 65 is a flow diagram illustrating the process of placement for reconfiguration with a joint state in accordance with the present disclosure.

FIGS. 66A-H are table diagrams illustrating one embodiment of a manipulations system for a robotic kitchen in accordance with the present disclosure.

FIGS. 67A-B are tables (intended as one table) illustrating one example of a stir manipulation to action primitive in accordance with the present disclosure.

FIG. 68 is a block diagram illustrating a robotic kitchen manufacturing environment with an etalon unit production phase, an additional unit production phase, and all units life duration adjustment phase in accordance with the present disclosure.

FIG. 69 is a block diagram illustrating an example of a parameterized minimanipulation in accordance with the present disclosure.

FIG. 70 is a block diagram illustrating an example of a cloud inventory central database structure in executing a sequential operation of minimanipulations with a plurality of data fields (or parameters) on the horizontal rows, and a plurality of dates and times on the vertical columns in accordance with the present disclosure.

FIG. 71 is a block diagram illustrating a first embodiment of a robotic kitchen artificial intelligence (“AI”) engine (“AI Engine”, “AI Brain”, or “Moley Brain) in accordance with the present disclosure.

FIG. 72 is a block diagram illustrating the robotic artificial intelligence engine module with one or more processors, one or more graphics processing units (GPU), a network, and an optional field-programmable gate arrays (FPGA) in accordance with the present disclosure.

FIG. 73 is a block diagram depicting the process of calibration whereby deviations of the position and orientation of the physical world system are compared to the reference positions and orientations from the virtual world etalon model, allowing a set of parameter deviations to be computed in accordance with the present disclosure.

FIG. 74 is a block diagram depicting a situational decision-tree to be used to determine when to apply one of three parameter adaptation and compensation techniques in the calibration process in accordance with the present disclosure.

FIG. 75 is a block diagram depicting a schematic fashion a plurality of reference points and associated state configuration vector locations, not limited to two dimensions, but rather in multi-dimensional space, where the robotic kitchen could be commanded to carry out a (re-)calibration procedure to ensure proper performance within the entire workspace as well as within specific portions of the workspace in accordance with the present disclosure.

FIG. 76 is a block diagram depicting the process of a flowchart by which one or more of the calibration processes can be carried out in accordance with the present disclosure. The process utilizes a set of calibration-point and -vector datasets from the etalon model, which are compared to real-world positions, allowing for the computation of parameter adaptation datasets to compensate for the misalignment between the robot system in the physical world and that in the ideal virtual world, and how such compensation data cab ne used to modify one or more databases in accordance with the present disclosure.

FIG. 77 is a block diagram depicting a flowchart by which one or more of the pre-command sequence step execution deviation compensation processes can be carried out in accordance with the present disclosure.

FIG. 78 is a block diagram depicting the structure and execution flow of Action-Primitive (AP) Mini-manipulation Library (MML) commands in accordance with the present disclosure.

FIG. 79 is a block diagram depicting how the starting- and ending configurations for any given macro- or micro-AP can be defined not only for each specific subsystem within a robotic kitchen but also contain state variables not limited solely to physical position/orientation, but also other more generic system descriptors in accordance with the present disclosure.

FIG. 80 is a block diagram illustrating a flowchart of how a specific cooking step made up of multiple sequential macro-Aps, themselves each described by a multitude of micro-Aps would be executed by a cooking sequence controller executing a particular cooking step within a particular recipe in accordance with the present disclosure.

FIG. 81 is a block diagram depicting a decision-tree flow for a given AP adaptation. The notion revolves around the potential need to adapt a given AP based on deviations in the sensed configuration of the robotic system in accordance with the present disclosure.

FIG. 82 is a block diagram depicting a comparison of a standard robotic control process, to that of a MML-driven process with minimal adaptation in accordance with the present disclosure.

FIG. 83 is a block diagram depicting the MML Parameter Adaptation elements, which have parameters that can be developed through a variety of methods, including through simulation, teach/playback, manual encoding or even by watching and codifying the process of a master in the field (chef in the case of a kitchen) in accordance with the present disclosure.

FIG. 84 is a block diagram depicting the actual process steps that form part of an MML Adaptation and AP-execution.

FIG. 85 is a block diagram illustrating a multi-stage parameterized process file with the notion of using pre-defined execution steps at the micro- and macro-levels within separate mini-manipulations, by transitioning through pre-defined robot-configurations for each of these steps, thereby avoiding any robot reconfiguration and replanning during the entire process-step execution, as all mini-manipulations consist of pre-computed and -verified starting- and ending robot configurations as part of a their pre-validated execution sequence in accordance with the present disclosure.

FIG. 86 is a pictorial diagram illustrating a perspective view of a robotic arm platform with a robotic arm with one or more actuators and a rotary module in accordance with the present disclosure.

FIG. 87 is a pictorial diagram illustrating a robotic arm platform with a robotic arm with one or more actuators and a rotary module in accordance with the present disclosure.

FIG. 88 is a pictorial diagram illustrating a perspective view of a robotic arm platform with a robotic arm with one or more actuators and a rotary module in accordance with the present disclosure.

FIG. 89 is a pictorial diagram illustrating a first embodiment of a robotic arm magnetic gripper platform with the robotic arm, a magnetic gripper, the one or more actuators and the rotary module in accordance with the present disclosure.

FIG. 90 is a pictorial diagram illustrating a perspective view of the first embodiment of robotic arm magnetic gripper platform with the robotic arm, the magnetic gripper, the one or more actuators and the rotary module in accordance with the present disclosure.

FIG. 91 is a pictorial diagram illustrating a second embodiment of the robotic arm magnetic gripper platform with the robotic arm, the magnetic gripper, the one or more actuators and the rotary module in accordance with the present disclosure.

FIG. 92 is a pictorial diagram illustrating a perspective view of the second embodiment of the robotic arm magnetic gripper platform with the robotic arm, the magnetic gripper, the one or more actuators and the rotary module in accordance with the present disclosure.

FIG. 93 is a pictorial diagram illustrating a perspective view of a dual robotic arm platform with a pair (or a plurality) of the robotic arms and a pair (or a plurality) of the magnetic grippers, and a plurality of actuators and the rotary modules in accordance with the present disclosure.

FIG. 94 is a pictorial diagram illustrating a perspective view of the third embodiment of a robotic arm magnetic gripper platform with the robotic arm, the magnetic gripper, the one or more actuators and the rotary module, force and torque sensor for robotic arm, and an integrated camera for the robot in accordance with the present disclosure.

FIG. 95 is a perspective view of a frying basket for use with the round, spheric, rectangular, square or other robotic module assembly in accordance with the present disclosure.

FIG. 96 is a perspective view of a wok body for use with the round, spheric, rectangular, square or other robotic module assembly in accordance with the present disclosure.

FIG. 97A is a pictorial diagram illustrating an isometric view of a round (or a spheric) robotic module assembly with a single robotic arm and a single end effector in accordance with the present disclosure.

FIG. 97B is a pictorial diagram illustrating a top view of a round robotic module assembly with a single robotic arm and a single end effector in accordance with the present disclosure.

FIG. 98A is a pictorial diagram illustrating an isometric view of a round robotic module assembly with two robotic arms and two end effectors in accordance with the present disclosure.

FIG. 98B is a pictorial diagram illustrating a top view of a round robotic module assembly with two robotic arms and two end effectors in accordance with the present disclosure.

FIG. 99A is a pictorial diagram illustrating an isometric front view of a round (or a spheric) robotic module assembly with two robotic arms and two end effectors which the robot is a moveable portion in accordance with the present disclosure.

FIG. 99B is a pictorial diagram illustrating an isometric back view of a round robotic module assembly with two robotic arms and two end effectors which the robot is a moveable portion in accordance with the present disclosure.

FIG. 100A is a pictorial diagram illustrating an isometric front view of a rectangular robotic module assembly with two robotic arms and two end effectors which the robot is a moveable portion in accordance with the present disclosure.

FIG. 100B is a pictorial diagram illustrating an isometric back view of a rectangular robotic module assembly with two robotic arms and two end effectors which the robot is a moveable portion in accordance with the present disclosure.

FIG. 101 is a pictorial diagram illustrating an isometric front right view of a rectangular (or a square) robotic module assembly with one or more robotic arms and one or more end effectors with a conveyor belt located in the back side of the rectangular robotic module assembly in accordance with the present disclosure.

FIG. 102 is a pictorial diagram illustrating an isometric front left view of a rectangular (or a square) robotic module assembly with one or more robotic arms and one or more end effectors with a conveyor belt located in the back side of the rectangular robotic module assembly in accordance with the present disclosure.

FIG. 103 is a pictorial diagram illustrating an isometric back right view of a rectangular (or a square) robotic module assembly with one or more robotic arms and one or more end effectors with the conveyor belt located in the back side of the rectangular robotic module assembly in accordance with the present disclosure.

FIG. 104 is a pictorial diagram illustrating an isometric back left view of a rectangular (or a square) robotic module assembly with one or more robotic arms and one or more end effectors with the conveyor belt located in the back side of the rectangular robotic module assembly in accordance with the present disclosure.

FIG. 105 is a block diagram illustrating a first embodiment of a front view of commercial robotic kitchen with a plurality of robotic module assemblies in accordance with the present disclosure.

FIG. 106 is a block diagram illustrating the first embodiment of an isometric front right view of a commercial robotic kitchen with a plurality of robotic module assemblies with respect to FIG. 105 in accordance with the present disclosure.

FIG. 107 is a block diagram illustrating the first embodiment of an isometric front left view of a commercial robotic kitchen with a plurality of robotic module assemblies with respect to FIG. 105 in accordance with the present disclosure.

FIG. 108 is a block diagram illustrating the first embodiment of an isometric back right view of a commercial robotic kitchen with a plurality of robotic module assemblies with respect to FIG. 105 in accordance with the present disclosure.

FIG. 109 is a block diagram illustrating a second embodiment of a front view of commercial robotic kitchen with a plurality of robotic module assemblies with an end robotic module assembly with a front side conveyor belt and a back side conveyor belt in accordance with the present disclosure.

FIG. 110 is a block diagram illustrating the second embodiment of an isometric front right view of commercial robotic kitchen with a plurality of robotic module assemblies with an end robotic module assembly with a front side conveyor belt and a back side conveyor belt with respect to FIG. 109 in accordance with the present disclosure.

FIG. 111 is a block diagram illustrating the second embodiment of an isometric front left view of commercial robotic kitchen with a plurality of robotic module assemblies with an end robotic module assembly with a front side conveyor belt and a back side conveyor belt with respect to FIG. 109 in accordance with the present disclosure.

FIG. 112 is a block diagram illustrating the second embodiment of an isometric back view of commercial robotic kitchen with a plurality of robotic module assemblies with an end robotic module assembly with a front side conveyor belt and a back side conveyor belt with respect to FIG. 109 in accordance with the present disclosure.

FIGS. 113A-D are block diagrams illustrating the various layouts of a commercial robotic kitchen including a front view, a top view, and a sectional view in accordance with the present disclosure.

FIG. 114 is a flow chart illustrating a first embodiment of the process of steps in operating a commercial robotic kitchen with a plurality of robotic module assemblies in accordance with the present disclosure.

FIG. 115 is a flow chart illustrating a second embodiment of the process of steps in operating a commercial robotic kitchen with a plurality of robotic module assemblies with a master robotic module assembly or a slave robotic module assembly preparing a plurality of orders for the same dish in a larger portion at the same time in accordance with the present disclosure.

FIG. 116 is a block diagram illustrating one embodiment of a commercial robotic kitchen with a plurality of cooking stations line suitable for restaurants, hotels, hospitals, offices, academic institutions and work places in accordance with the present disclosure.

FIG. 117 is a block diagram illustrating one embodiment of a commercial robotic kitchen with an open kitchen suitable for restaurants, hotels, hospitals, offices, academic institutions and work places in accordance with the present disclosure.

FIG. 118 is a block diagram illustrating a robo cuisines hub with a plurality of robot module assemblies (or robot chefs), a plurality of transport robots that transport the food dishes prepared by the robo chefs and move the food dishes to the autonomous vehicles (or robotaxi) for deliveries of the food dishes to the customers in accordance with the present disclosure.

FIG. 119 is a block diagram illustrating an isometric view of the robo cuisines hub with a plurality of robot chefs and a plurality of transport robots with respect to FIG. 118 in accordance with the present disclosure.

FIG. 120 is a block diagram illustrating a top view of the robo cuisines hub with a plurality of robot chefs and a plurality of transport robots with respect to FIG. 118 in accordance with the present disclosure.

FIG. 121 is a block diagram illustrating a back view of the robo cuisines hub with a plurality of robot chefs and a plurality of transport robots with respect to FIG. 118 in accordance with the present disclosure.

FIG. 122 is a block diagram illustrating an isometric front view of a robotic kitchen module assembly with a scrapping tool component in accordance with the present disclosure.

FIG. 123 is a block diagram illustrating an isometric back view of a robotic kitchen module assembly with a scrapping tool component with respect to FIG. 122 in accordance with the present disclosure.

FIG. 124 is a block diagram illustrating the side view of a robotic kitchen module assembly with the scrapping tool component with respect to FIG. 122 in accordance with the present disclosure.

FIGS. 125, 126, 127, 128 are pictorial diagrams illustrating a touch screen operation finger including a conductive material (metal: aluminum) fingertip, finger rubber part, finger metal part, a screen, and capacitive buttons in accordance with the present disclosure.

FIG. 129 is a block diagram illustrating a first embodiment of a mobile robotic kitchen on a food truck in accordance with the present disclosure.

FIG. 130 is a block diagram illustrating a second embodiment of a pop-up restaurant or a food catering service in accordance with the present disclosure.

FIG. 131 is a block diagram illustrating one example of a robotic kitchen module assembly with a motorized (or automatic) dosing device and a manual dosing device that can be tailored for the robotic kitchen which the one or more robotic hands coupled to one of more robotic end effectors can operate a dosing device manually, or the computer processor in the robotic kitchen can send an instruction signal to a dosing device to dispense the amount of dosing automatically in accordance with the present disclosure.

FIG. 132 depicts the functionalities and process-steps of pre-filled ingredient containers with one or more program ingredient dispenser controls for use in the standardized robotic kitchen.

FIG. 133 is a block diagram illustrating a robotic nursing care module with a three-dimensional vision system in accordance with the present disclosure.

FIG. 134 is a block diagram illustrating a robotic nursing care module with standardized cabinets in accordance with the present disclosure.

FIG. 135 is a block diagram illustrating a robotic nursing care module with one or more standardized storages, a standardized screen, and a standardized wardrobe in accordance with the present disclosure.

FIG. 136 is a block diagram illustrating a robotic nursing care module with a telescopic body with a pair of robotic arms and a pair of robotic hands in accordance with the present disclosure.

FIG. 137 is a block diagram illustrating a first example of executing a robotic nursing care module with various movements to aid an elderly person in accordance with the present disclosure.

FIG. 138 is a block diagram illustrating a second example of executing a robotic nursing care module with loading and unloading a wheel chair in accordance with the present disclosure.

FIG. 139 is a block diagram illustrating one embodiment of an isometric view in calibrating and operating a chemical embodiment with the robot with one or more robot arms coupled to one or more robotic end effectors in accordance with the present disclosure.

FIG. 140 is a block diagram illustrating one embodiment of a front view in calibrating and operating a chemical embodiment with the robot with one or more robot arms coupled to one or more robotic end effectors in accordance with the present disclosure.

FIG. 141 is a block diagram illustrating one embodiment of a bottom angled view in calibrating and operating a chemical embodiment with the robot with one or more robot arms coupled to one or more robotic end effectors in accordance with the present disclosure.

FIG. 142 is a block diagram illustrating one embodiment of a top angled view in calibrating and operating a chemical embodiment with the robot with one or more robot arms coupled to one or more robotic end effectors in accordance with the present disclosure.

FIG. 143 is a block diagram illustrating a telerobotic for a hospital environment with operating one or more robot arms coupled to one or more robotic end effectors for distance (or remote) automation in accordance with the present disclosure.

FIG. 144 is a block diagram illustrating a telerobotic for a manufacturing environment with operating one or more robot arms coupled to one or more robotic end effectors for distance (or remote) automation in accordance with the present disclosure.

FIG. 145 illustrates one embodiment of object interactions in an unstructured environment in accordance with the present disclosure.

FIG. 146 illustrates a graph for indicating linear dependency of the total waiting time on the number of constraints in accordance with the present disclosure.

FIG. 147 illustrates information flow and generation of incomplete APAs, according to an exemplary environment in accordance with the present disclosure.

FIG. 148 is a block diagram illustrating write-in and read-out scheme for a database of pre-planned solutions in accordance with the present disclosure.

FIG. 149 is a flow chart illustrating one embodiment of a process for executing an interaction in accordance with the present disclosure.

FIG. 150 is an architecture diagram illustrating one embodiment on one or more portions of a robot in accordance with the present disclosure.

FIG. 151 illustrates an architecture of a general-purpose vision subsystem in accordance with the present disclosure.

FIG. 152 illustrates an architecture for identifying objects using the general-purpose vision subsystem in accordance with the present disclosure.

FIG. 153 illustrates a sequence diagram of a process for identifying objects in an environment or workspace in accordance with the present disclosure.

FIGS. 154A-154E illustrate an example of a wall locking mechanism in accordance with the present disclosure.

FIG. 155 is a block diagram illustrating one example of a robot kitchen prepare multiple recipes at the same time with the execution of the minimanipulations with a first robot (robot 1), a smart appliance, and an operator graphical user interface (GUI) in accordance with the present disclosure.

FIG. 156A is a block diagram illustrating an isometric front view of a robotic café (or café barista) for a robot to serve a variety of drinks to customers in accordance with the present disclosure; and FIG. 156B is a block diagram illustrating an isometric back view of a robotic café for a robot to serve a variety of drinks to customers in accordance with the present disclosure.

FIG. 157A is a block diagram illustrating an isometric front view of a robotic bar (barista alcohol) for a robot to serve a variety of drinks to customers in accordance with the present disclosure; and FIG. 157B is a block diagram illustrating an isometric back view of a robotic café for a robot to serve a variety of drinks to customers in accordance with the present disclosure.

FIG. 158 is a block diagram illustrating a mobile, multi-use robot module for fitting with a cooking station, a coffee station, or a drink station in accordance with the present disclosure.

FIG. 159 is a block diagram illustrating an example of a computer device on which computer-executable instructions to perform the robotic methodologies discussed herein may be installed and executed in accordance with the present disclosure.

### DETAILED DESCRIPTION

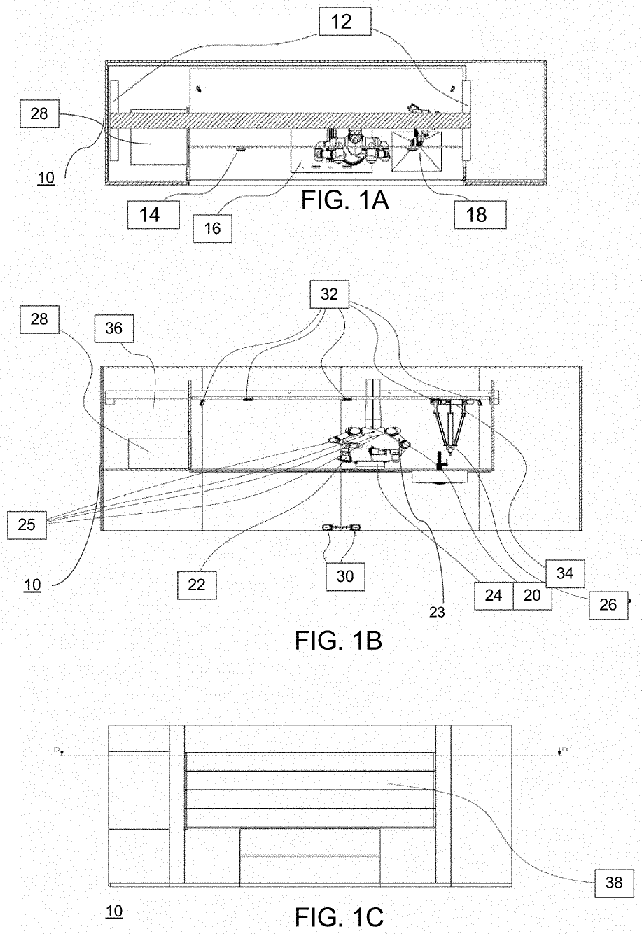

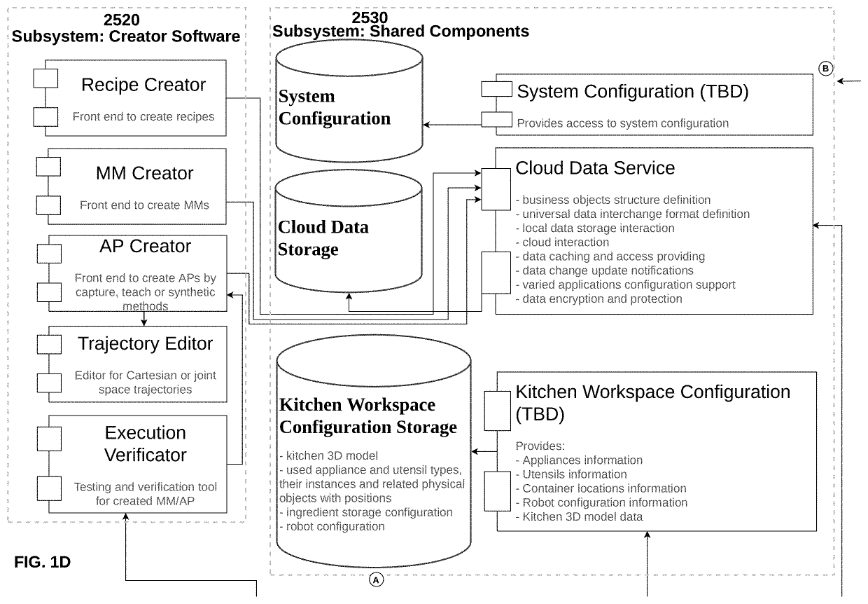

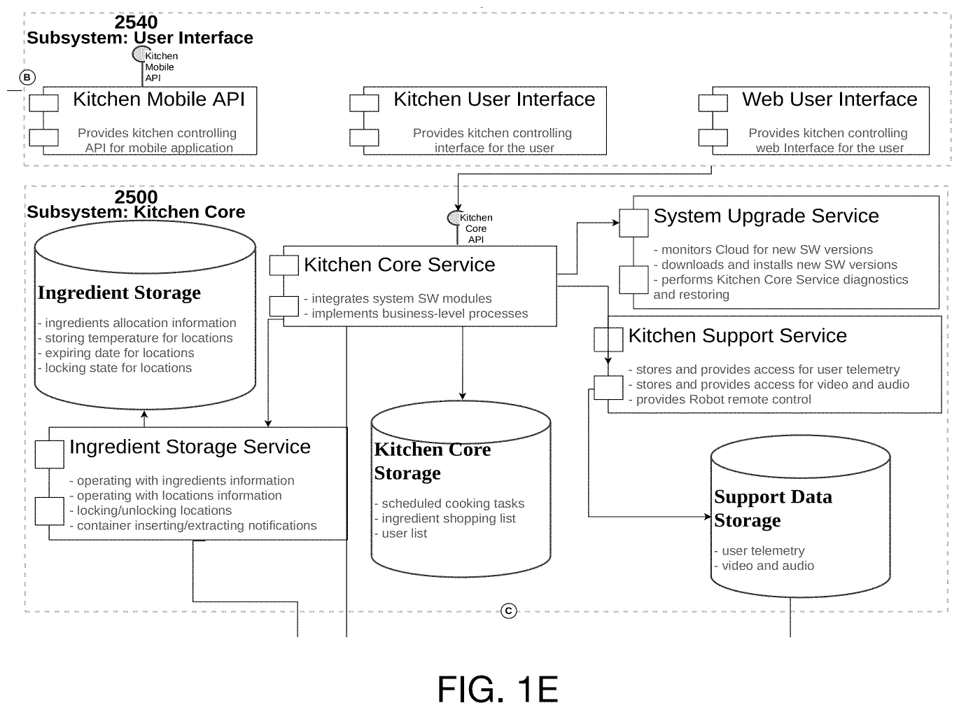

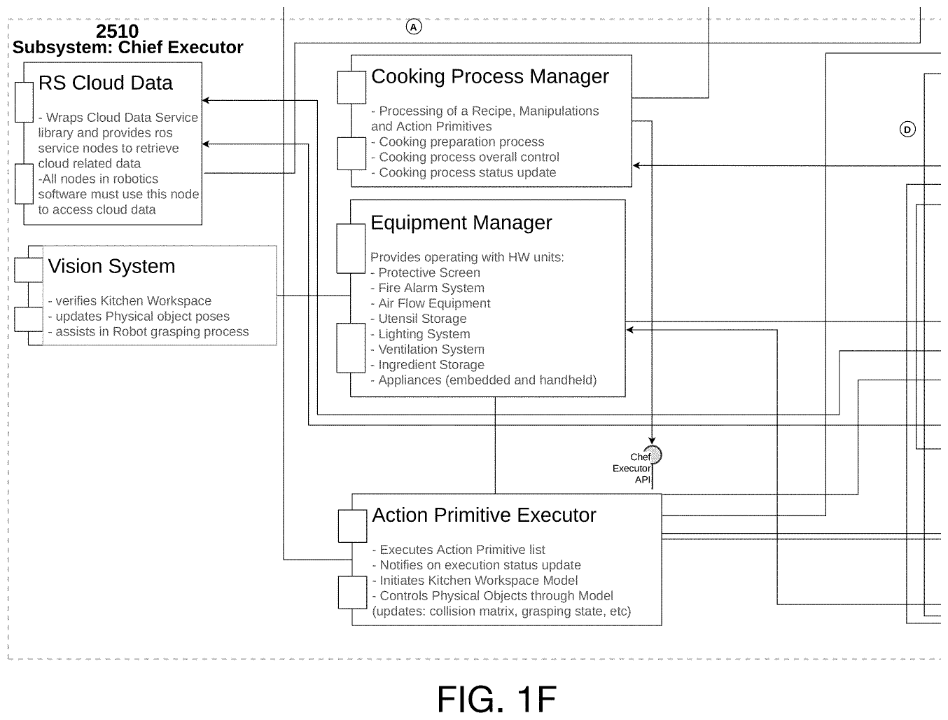

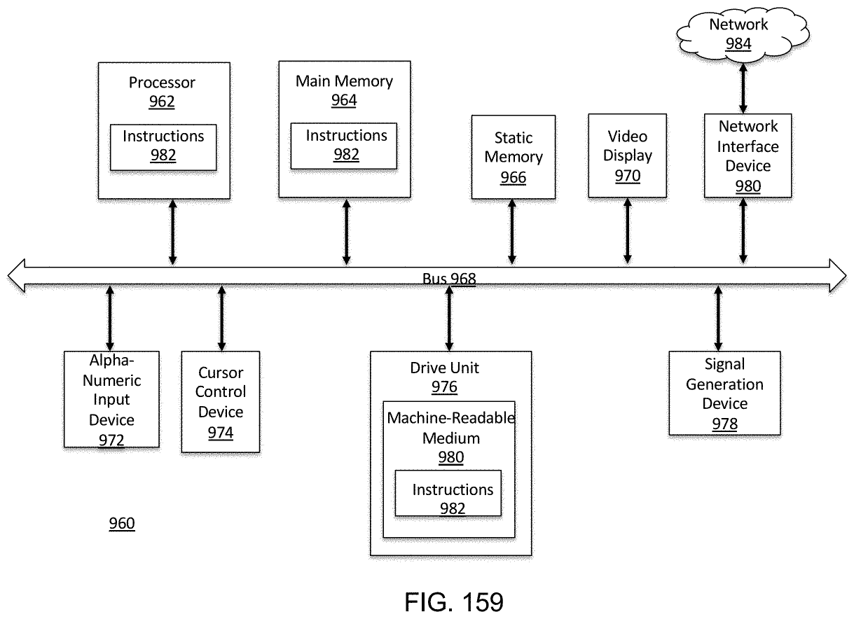

A description of structural embodiments and methods of the present disclosure is provided with reference to FIGS. 1-159. It is to be understood that there is no intention to limit the invention to the specifically disclosed embodiments but that the invention may be practiced using other features, elements, methods, and embodiments. Like elements in various embodiments are commonly referred to with like reference numerals.

The following definitions apply to the elements and steps described herein. These terms may likewise be expanded upon.

Accuracy—refers to how closely a robot can reach a commanded position. Accuracy is determined by the difference between the absolute positions of the robot compared to the commanded position. Accuracy can be improved, adjusted, or calibrated with external sensing, such as sensors on a robotic hand or a real-time three-dimensional model using multiple (multi-mode) sensors.

Action Primitive (AP)—refers to the smallest functional operation executable by the robot. An action primitive starts and ends with a Default Posture. In one embodiment, action primitive refers to an indivisible robotic action, such as moving the robotic apparatus from location X1 to location X2, or sensing the distance from an object (for food preparation) without necessarily obtaining a functional outcome. In another embodiment, the term refers to an indivisible robotic action in a sequence of one or more such units for accomplishing a minimanipulation. These are two aspects of the same definition. (smallest functional subblock—lower level minimanpualtion.

Adaptation—a process referred to reconfiguring a robotic system through a transformation process from a given starting configuration or pose into a modified or different configuration or pose.

Alignment—the process of reconfiguring a robotic system by way of a transformation process from a current configuration to a more desirable configuration or pose for the purpose of a streamlined command execution of a macro manipulation or micro minimanipulation AP, command step or sequence.

Best-Match—closest configuration between an as-sensed and possible ideal or simulated or experimentally-defined possible configuration candidates for a robotic system in free-space or while handling/grasping an object or interacting with the environment, by way of one or more methods for establishing deviation metrics based on a variety of linear or multi-dimensional deviation-computation metrics applied to one or more types of sensory data types.

Boundary Configuration—a joint or cartesian robot configuration at the start (first) or end (last) step of one or more commanded motion sequences.

Calibration—a process by which a real-world system undergoes one or more measurement steps to determine the deviation of the real-world system configuration in cartesian and/or joint-space from that of an etalon model. The deviation can then be used in one of multiple ways to ensure the system will perform as intended and predicted in the ideal world through transformations to ensure alignment between the real and ideal worlds as part of an adaptation process. Calibration can be performed at any time during the life-cycle of the system and at one or more points within the workspace of the system.

Cartesian plan—refers to a process which calculates a joint trajectory from an existing cartesian trajectory.

Cartesian trajectory—refers to a sequence of timed samples (each sample comprises of an xyz position and an 3-axis orientation expressed as a quaternion or euler angles) in the kitchen space, defined for a specific frame (object or hand frame) and related to another reference frame (kitchen or object frame).

Collaborative mode—refers to one of the multiple modes of the robotic kitchen (other modes include a robot mode and a user mode) where the robot executes a food preparation recipe in conjunction with a human user, where the execution of a food preparation recipe may divide up the tasks between the robot and the human user.

Compensation—a process by which an adaptation of a system results in a more suitable configuration of a physical entity or parameter values describing the same, in order to enact commanded changes to a parameter or system, based on sensed robot-configuration values or changes to the environment which the robot operates within and interacts with, for the purposes of a more effective execution of one or more command sequences that make up a particular process.

Configuration—synonymous with posture, which refers to a specific set of cartesian endpoint positions achievable through one or more joint space linear or angular values for one or more robot joints.

Dedicated—refers to hardware elements such as processors, sensors, actuators and buses, that are solely used by a particular element or subsystem. In particular, each subsystem within the macro- and micro-manipulation systems, contain elements that utilize their own processors and sensor and actuators that re solely responsible for the movements of the hardware element (shoulder, arm-joint, wrist, finger, etc.) they are associated with.

Default Posture—refers to a predefined robot posture, associated with a specific held object or empty hand for each arm.

Deviation—Displacement as defined by a multi-dimensional space between an as-measured actual and desired robot configuration in cartesian and/or joint-space.

Emulation Abstraction—description of a set of steps or actions in a fashion that allows for repeatable execution of these steps or actions by another entity, including but not limited to, a computer-controlled robotic system.

Encoding—a process by which a human or an automated process creates a sequence of machine-readable, interpretable and executable command steps as part of a computer-controlled execution process to be carried out at a later time.

Etalon Model—standard or reference Model.

Executor—a module within a given controller system responsible for the successful execution of one or more commands within one or more stand-alone or interconnected execution sequences.

Joint State—refers to a configuration for a set of robot joints, expressed as a set of values, one for each joint.

Joint Trajectory (aka Joint Space Trajectory or JST)—refers to a timed sequence of joint states.

Kitchen Module (or Kitchen Volume)—a standardized full-kitchen module with standardized sets of kitchen equipment, standardized sets of kitchen tools, standardized sets of kitchen handles, and standardized sets of kitchen containers, with predefined space and dimensions for storing, accessing, and operating each kitchen element in the standardized full-kitchen module. One objective of a kitchen module is to predefine as much of the kitchen equipment, tools, handles, containers, etc. as possible, so as to provide a relatively fixed kitchen platform for the movements of robotic arms and hands. Both a chef in the chef kitchen studio and a person at home with a robotic kitchen (or a person at a restaurant) uses the standardized kitchen module, so as to maximize the predictability of the kitchen hardware, while minimizing the risks of differentiations, variations, and deviations between the chef kitchen studio and a home robotic kitchen. Different embodiments of the kitchen module are possible, including a standalone kitchen module and an integrated kitchen module. The integrated kitchen module is fitted into a conventional kitchen area of a typical house. The kitchen module operates in at least two modes, a robotic mode and a normal (manual) mode.

Library—synonymous with computer-accessible digital-data database or repository, located on a local computer, a network computer, a mobile device, or a cloud computer.

Machine Learning—refers to the technology wherein a software component or program improves its performance based on experience and feedback. One kind of machine learning often used in robotics is reinforcement learning, where desirable actions are rewarded and undesirable ones are penalized. Another kind is case-based learning, where previous solutions, e.g. sequences of actions by a human teacher or by the robot itself are remembered, together with any constraints or reasons for the solutions, and then are applied or reused in new settings. There are also additional kinds of machine learning, such as inductive and transductive methods.

Minimanipulation (MM)—generally, MM refers to one or more behaviors or task-executions in any number or combinations and at various levels of descriptive abstraction, by a robotic apparatus that executes commanded motion-sequences under sensor-driven computer-control, acting through one or more hardware-based elements and guided by one or more software-controllers at multiple levels, to achieve a required task-execution performance level to arrive at an outcome approaching an optimal level within an acceptable execution fidelity threshold. The acceptable fidelity threshold is task-dependent and therefore defined for each task (also referred to as “domain-specific application”). In the absence of a task-specific threshold, a typical threshold would be 0.001 (0.1%) of optimal performance.
In one embodiment from a robotic technology perspective, the term MM refers to a well-defined pre-programmed sequence of actuator actions and collection of sensory feedback in a robot's task-execution behavior, as defined by performance and execution parameters (variables, constants, controller-type and -behaviors, etc.), used in one or more low-to-high level control-loops to achieve desired motion/interaction behavior for one or more actuators ranging from individual actuations to a sequence of serial and/or parallel multi-actuator coordinated motions (position and velocity)/interactions (force and torque) to achieve a specific task with desirable performance metrics. MMs can be combined in various ways by combining lower-level MM behaviors in serial and/or parallel to achieve ever-higher and higher-level more-and-more complex application-specific task behaviors with an ever higher level of (task-descriptive) abstraction.
In another embodiment from a software/mathematical perspective, the term MM refers to a combination (or a sequence) of one or more steps that accomplish a basic functional outcome within a threshold value of the optimal outcome (examples of threshold value as within 0.1, 0.01, 0.001, or 0.0001 of the optimal value with 0.001 as the preferred default). Each step can be an action primitive, corresponding to a sensing operation or an actuator movement, or another (smaller) MM, similar to a computer program comprised of basic coding steps and other computer programs that may stand alone or serve as sub-routines. For instance, a MM can be grasping an egg, comprised of the motor actions required to sense the location and orientation of the egg, then reaching out a robotic arm, moving the robotic fingers into the right configuration, and applying the correct delicate amount of force for grasping: all primitive actions. Another MM can be breaking-an-egg-with-a-knife, including the grasping MM with one robotic hand, followed by grasping-a-knife MM with the other hand, followed by the primitive action of striking the egg with the knife using a predetermined force at a predetermined location.
In a further embodiment, manipulation refers to a high level robotic operation in which the robot manipulates an object using the bare hands or some utensil. A Manipulation comprises of (is composed by) Action Primitives.
High-Level Application-specific Task Behaviors—refers to behaviors that can be described in natural human-understandable language and are readily recognizable by a human as clear and necessary steps in accomplishing or achieving a high-level goal. It is understood that many other lower-level behaviors and actions/movements need to take place by a multitude of individually actuated and controlled degrees of freedom, some in serial and parallel or even cyclical fashion, in order to successfully achieve a higher-level task-specific goal. Higher-level behaviors are thus made up of multiple levels of low-level MMs in order to achieve more complex, task-specific behaviors. As an example, the command of playing on a harp the first note of the 1^{st} bar of a particular sheet of music, presumes the note is known (i.e., g-flat), but now lower-level MMs have to take place involving actions by a multitude of joints to curl a particular finger, move the whole hand or shape the palm so as to bring the finger into contact with the correct string, and then proceed with the proper speed and movement to achieve the correct sound by plucking/strumming the cord. All these individual MMs of the finger and/or hand/palm in isolation can all be considered MMs at various low levels, as they are unaware of the overall goal (extracting a particular note from a specific instrument). While the task-specific action of playing a particular note on a given instrument so as to achieve the necessary sound, is clearly a higher-level application-specific task, as it is aware of the overall goal and need to interplay between behaviors/motions and is in control of all the lower-level MMs required for a successful completion. One could even go as far as defining playing a particular musical note as a lower-level MM to the overall higher-level applications-specific task behavior or command, spelling out the playing of an entire piano-concerto, where playing individual notes could each be deemed as low-level MM behaviors structured by the sheet music as the composer intended.
Low-Level Minimanipulation Behaviors—refers to movements that are elementary and required as basic building blocks for achieving a higher-level task-specific motion/movement or behavior. The low-level behavioral blocks or elements can be combined in one or more serial or parallel fashion to achieve a more complex medium or a higher-level behavior. As an example, curling a single finger at each finger joint is a low-level behavior, as it can be combined with curling each of the other fingers on the same hand in a certain sequence and triggered to start/stop based on contact/force-thresholds to achieve the higher-level behavior of grasping, whether this be a tool or a utensil. Hence, the higher-level task-specific behavior of grasping is made up of a serial/parallel combination of sensory-data driven low-level behaviors by each of the five fingers on a hand. All behaviors can thus be broken down into rudimentary lower levels of motions/movements, which when combined in certain fashion achieve a higher-level task behavior. The breakdown or boundary between low-level and high-level behaviors can be somewhat arbitrary, but one way to think of it is that movements or actions or behaviors that humans tend to carry out without much conscious thinking (such as curling ones fingers around a tool/utensil until contact is made and enough contact-force is achieved) as part of a more human-language task-action (such as “grab the tool”), can and should be considered low-level. In terms of a machine-language execution language, all actuator-specific commands, which are devoid of higher-level task awareness, are certainly considered low-level behaviors.

Minimanipulation library adaptation—refers to a particular minimanipulation library is adapted (or modified) to custom fit a specific kitchen module due to the differences (or deviations from the reference parameters of a master kitchen) identified between a master kitchen module and the particular kitchen module.

Minimanipulation library transformation—refers to transforming a cartesian coordinate environment to a different operating environment tailored to a specific type of robot. Repositioning the actuators to compensate for a greater flexibility for the robotic arms and effectors to reach a particular location

Macro/Micro minimanipulations—refers to a combination of macro mininmanipulations and micro minimanipulations for executing a complete or a portion of the food preparation recipe. The term macro minimanipulations and micro minimanipulations can have a different types of relationship between macro minimanipulations and micro minimanipulations. For example, in one embodiment, macro/micro minimanipulations refers to one macro minimanipulation comprises one or more micro minimanipulations. To phrase it another way, each micro minimanipulation serves as a subset of a macro minimanipulation. In another embodiment, a macro-micro minimanipulation subsystem refers to a separation at the logical and physical level that is to bound the computational load on planners and controllers, particularly for the required inverse kinematic computation, to a level that allows the system to operate in real-time. The term “macro minimanipulation” is also referred to as macro manipulation, or macro-manipulation. The term “micro minimanipulation” is also referred to as micro manipulation, or micro-minimanipulation.

Motion Plan—refers to a process which calculates a joint trajectory from a start joint state and an end joint state.

Motion Primitives—refers to motion actions that define different levels/domains of detailed action steps, e.g. a high-level motion primitive would be to grab a cup, and a low-level motion primitive would be to rotate a wrist by five degrees.

Open-Loop—to be understood as used in the system control literature, where a computer-controlled system is acted upon by a set of actuators that are commanded along a time-stamped pre-computed/-defined trajectory described by position-/velocity-/torque-/force-parameters that are not subjected to any modification based on any system feedback from sensors, whether internal or external, during the time-period the system operates in the open-loop fashion. It is to be understood that all actuators are nevertheless operating in a localized closed-loop fashion in that each actuator will be caused to follow the pre-computed time-stamped trajectory described by position-/velocity-/torque-/force-parameters for each actuation unit, without the parameters being modified from their pre-computed values by any external sensory data not local to the respective actuator, required to measure and track the respective parameter (such as joint-position, -velocity, -torque, -force, etc.).

Parameter Adjustment—refers to the process of changing the values of parameters based on inputs. For instance changes in the parameters of instructions to the robotic device can be based on the properties (e.g. size, shape, orientation) of, but not limited to, the ingredients, position/orientation of kitchen tools, equipment, appliances, speed, and time duration of a minimanipulation.

Pose—synonymous or similar with Configuration.

Pose Configuration—a set of parameters that describe a set of specific configurations for a particular command execution step that can be used to compare the real world configurations to, in order to perform a best-match process to define which such set of parameters comes closest to describing the as-sensed real-world robot system configuration.

Pre planned JST (aka Cached JST)—refers to a pre-planned JST, saved inside a cache and retrieved when required for execution.

Ready-Pose/-Configuration—configuration of a robotic system in which it is disengaged and not interacting with the environment, capable of being commanded to reposition itself without requiring any collision-free interference checking by any trajectory planning or execution module.

Recipe—refers to a sequence of manipulations.

Reconfiguration—refers to an operation which can move the robot from the current joint state to a unique pre-defined joint state, used typically when the object to manipulate was moved from it's expected pre-defined placement.

Resequencer—a process by which a sequence of events or commands can be reordered or replaced by way of adding or moving events or commands in an execution queue, so as to adapt to perceived changes in the environment.

Robotic Apparatus—refers one or more robotic arms and one or more robotic end effectors. The robotic apparatus may include a set of robotic sensors, such as cameras, range sensors, and force sensors (haptic sensors) that transmit their information to the processor or set of processors that control the effectors.

Robot mode—refers to one of the multiple modes of the robotic kitchen where the robot completely or primarily executes a food preparation recipe.

Sense-Interpret-Replan-Act-Resense Loop—standard computer-controlled loop carried out at each time-step defined by a high-frequency controller involving the use of all system sensors to measure the state of the entire system, which data is then used to interpret (identify, model, map) the world state, leading to a replanning of the next commanded execution step, before the controller is allowed to enact the command step. At the next time-step the system again re-enters the same loop by re-sensing the entire system and surrounding world and environment. The loop has been the standard for robotic systems operating (moving, grasping, handling objects and interacting with the world) in a dynamic and non-deterministic environment.

Sense-ID/Model/Map Sequence—Basic starting sequence needed to understand the state of the physical world, involving the collection of all available sensory data (robot and surrounding world and workspace), and the interpretation of the data, involving the identification of known (and unknown) elements within the workspace/world, modeling them and identifying (model-/pattern matching to known elements) them as best possible, and final step of mapping them as to their location and orientation in multi-dimensional space.

Stack-up Time—time defined as an ever-increasing additive time delay due to unforeseen events within a robot controller execution sequence, increasing the deterministic execution time-window from a known and fixed number to that of a larger undesirable non-zero number larger than zero.

Transformation Parameter/Vector/Matrix—Numerical value or multiple values arranged in a multi-dimensional vector or matrix, used to effect a change in an alternate set of numbers, such as positions, velocities, trajectories or configurations of a robotic system.

User mode—refers to one of the multiple modes of the robotic kitchen where the robot may serve to aid or facilitate a human in food preparation recipe.

Vertex—a point or configuration in cartesian or joint space uniquely described by one or more numerical values in stand-alone or vector-format as defined within one or more standard coordinate frames.

For additional information on replication by a robotic apparatus and or a robotic assistant executing one or more minimanipulations from one or more minimanipulation libraries, see U.S. non-provisional patent application Ser. No. 14/627,900, now U.S. Pat. No. 9,815,191, entitled “Methods and Systems for Food Preparation in Robotic Cooking Kitchen,” and U.S. nonprovisional patent application Ser. No. 14/829,579, now U.S. Pat. No. 10,518,409, entitled “Robotic Manipulation Methods and Systems for Executing a Domain-Specific Application in an Instrumented Environment with Electronic Manipulation Libraries,” filed on 18 Aug. 2015, the disclosures of which are incorporated herein by reference in their entireties.

For additional information on containers in a domain-specific application in an instrumented environment, see pending U.S. non-provisional patent application Ser. No. 15/382,369, entitled, “Robotic Manipulation Methods and Systems for Executing a Domain-Specific Application in an Instrumented Environment with Containers and Electronic Manipulation Libraries,” filed on 16 Dec. 2016, the disclosure of which is incorporated herein by reference in its entirety.

For additional information for operating a robotic system and executing robotic interactions, see the pending U.S. non-provisional patent application Ser. No. 16/045,613, entitled “Systems and Methods for Operating a Robotic System and Executing Robotic Interactions,” filed on 25 Jul. 2018, the disclosure of which is incorporated herein by reference in its entirety.

For additional information on a deep learning based objection detection system of images, see the pending U.S. non-provisional patent application Ser. No. 16/870,899, entitled “Systems and Methods for Automated Training of Deep-Learning-Based Object Detection,” filed on 9 May 2020, the disclosure of which is incorporated herein by reference in its entirety.

FIG. 1A is a visual diagram depicting robotic system operating in a robot mode with an axis system, robot carriage 20 34, which comprise of one or more robotic arms 23 coupled with or more end effectors 22. In one embodiment, the robot 10 is operating with an instrumented environment of a robotic kitchen. The axis 12 can be actuated using various different types of linear and rotary actuators, e.g. pneumatic actuators, hydraulic actuators, electric actuators etc. A robot system comprises of a multiple axis (e.g., x-y-z axes, x-y-z and rotational, multiple rotational and linear axes, the entire robot can rotate around one axis system, etc.) system allowing a carriage 20 carrying one or more arms 23 to reach to any point within the workspace (or an instrumented environment of the robotic kitchen), such as to adjust for any orientation as required to execute a robotic operation. In one embodiment, the robotic system 10 comprises a centralized control system for controlling and interacting with each of the subsystems in the robotic kitchen system. Each subsystem serves to provide one or more cooking functions involved during the execution of a food recipe by the robot system alongside others subsystems on the figure there is a sink and a tap 18, hob 16, oven 28 and worktop area which is constantly monitored by vision system 32.

FIG. 1B is a visual diagram depicting a different kind of robotic system that can be used inside the system 26, and robots can work in collaboration with each other like shown on figure. Different sensor and camera 32 environment monitoring system works inside the system. Safety sensors to scan environment around the robot are visible on the figure. Robot 20 using its end-effector 22 to hold a cooking tool 24 is visible on the figure.

FIG. 1C is a visual diagram depicting In a robot mode (or “a robotic mode), prior to execution of the recipe, the robot system begin execution of safety operations sequence, one of them is safeguard (or “a protective screen”) 38 actuating and interlocking to provide a protection shield from humans. After the protective screen is closed and interlocked, then the centralized control system in the robotic kitchen would permit the robot to operate. While the safeguard is being actuated to a down position, required safeguard position for robot mode, one or more safety sensors 30 is monitoring the instrumented environment (or “a confined workspace) around robotic kitchen 10 to ensure that safeguard actuation would be cause potential hazards, preventing harming a human, e.g. children, or an animal. The robotic kitchen 10 includes a vision system 32 that provides vision and feedback capabilities to support and complement robot execution. The robot 20 operates with kitchen tools, kitchen appliances, kitchen equipment and kitchen smart appliances.

FIGS. 1D, 1E, IF, 1G are flow diagrams, which form one large diagram, illustrating a software system of the robotic kitchen with several subsystems, including a kitchen core 2500, a chief executor 2510, a creator software 2520, shared components 2530, and a user interface 2540. The subsystem of kitchen core 2500 is designed to implement the main business-level processes and to integrate all other modules into the system. The kitchen core 2500 is responsible for controlling and updating the status of the whole system, scheduling cooking tasks, controlling active cooking task, working with ingredients, ingredient storage, managing recipes and user accounts. The subsystem comprises of (1) kitchen core service: integrates system software modules, implements business level processes; (2) system upgrade service: checks for new system version, performing system updates and subsystem diagnostics; and (3) ingredient storage service: managing ingredients and ingredients storage. The kitchen core subsystem 2500 processes requests from user interface subsystem, such as cooking and cleaning requests, and then depending on the request saves some data modifications done by user such as adding or removing ingredients or requests execution from a chief executor subsystem 2510 by Cooking Process Manager.

The subsystem of the chief executor 2510 performs recipe execution, storing and updating kitchen environment status and managing all hardware kitchen components. The chief executor subsystem 2510 comprises of:
cooking process manager: processes recipe and controls cooking process
action primitive executor: executes and controls robot manipulations, updates robot state and execution status
kitchen world model: stores and updates kitchen environment status such as object locations and states, provides environment status to other modules
planner coordinator: performs Cartesian and motion planning
cartesian planner: performs planning in Cartesian space
motion planner: performs planning in joint space
jst cache: saves and loads planned manipulation joint state trajectories
trajectory executor: performs joint state trajectory execution
robot controllers: implements robot drivers
robot sensors: collecting all available data from all sensors and providing it to other modules
PLC Board: performs communication between high-level software components and low-level hardware controllers
equipment manager: executes appliance commands, stores and updates appliance statuses
vision system: updates kitchen object positions and orientations, verifies robot manipulations execution
rs cloud data: provides interface between chief executor subsystem and shared components subsystem, converting data structures
system calibration service: identifies and calculates calibration variables for given physical model, checks, validates and corrects kitchen virtual world model based on provided calibration data

The chief executor subsystem 2510 receives execution requests from Kitchen Core subsystem such as a recipe, requests execution data from Shared Components subsystem such as Action Primitive and its associated robotics data and performs trajectories execution, which are can be planned or requested by cache module from cloud data service. Before the execution subsystem is capable of checking the environment and perform calibration if needed, which can modify executable joint state trajectory or request re-plan of Cartesian trajectory.

The subsystem of shared components 2520 includes mainly storage components used in other software subsystems or components. The shared components subsystem 2520 includes (1) system configuration: stores configurations for kitchen core subsystem; (2) cloud data service: stores all business data such as recipes, manipulations etc.; and (3) kitchen workspace configuration storage: stores kitchen 3D model and robot configurations.

Since the shared components subsystem stores all the data, which can be used by creator subsystem to get recipes, Minimanipulations, Action Primitives, trajectories and associated data for editing or saving, by Chief Executor subsystem 2510 to get executable robotics data such as trajectories inside Action Primitives and robot configuration associated data to set up virtual world and robot model and by kitchen core subsystem to get recipes associated data.

The subsystem of a creator software 2530 provides applications for creation and editing both business and robotics data. The subsystem comprises of:
recipe creator: application for creating and editing high-level recipes with functionality of precise definition of each recipe step including timings, ingredient amounts and videos
mm creator: application for creating and editing minimanipulations with functionality of creating manipulation trees and creating and editing manipulation parameters
ap creator: application for creating action primitives, action primitive sub blocks using synthetic, teach and capture methods of creation
trajectory editor: application for editing cartesian and joint state trajectories with functionality of shifting joints, translating and rotating points in trajectories and modifying trajectory speed
execution verification: application for automated testing and verification of correct execution of created Minimanipulation/AP based on available sensors data and pre-selected verification control points

Creation process starts from chief, who creates recipes, which are then used as an input for creation Action Primitives with given manipulation parameters, from which are then created cartesian and joint state trajectories. This data is saved in cloud data service in Shared Components subsystem 2520 and later used for execution by Action Primitive Executor in Chief Executor subsystem. After data is created, it should be tested and verified by Execution Verificator to ensure that this data can be executed reliably.

The subsystem of a user interface 2540 implements user interface for interaction with the whole system of a robotic platform. The user interface subsystem 2540 comprises from:
kitchen user interface: provides graphical interface for controlling the whole system which comes together with the kitchen
kitchen mobile API: provides control of the whole system for mobile applications
web user interface: provides control of the whole system using web applications
   It is used as an entry point for user to the whole system, from which starts recipe selection, ingredient management and recipe cooking, which is then communicates with Kitchen Core subsystem to process all user requests.

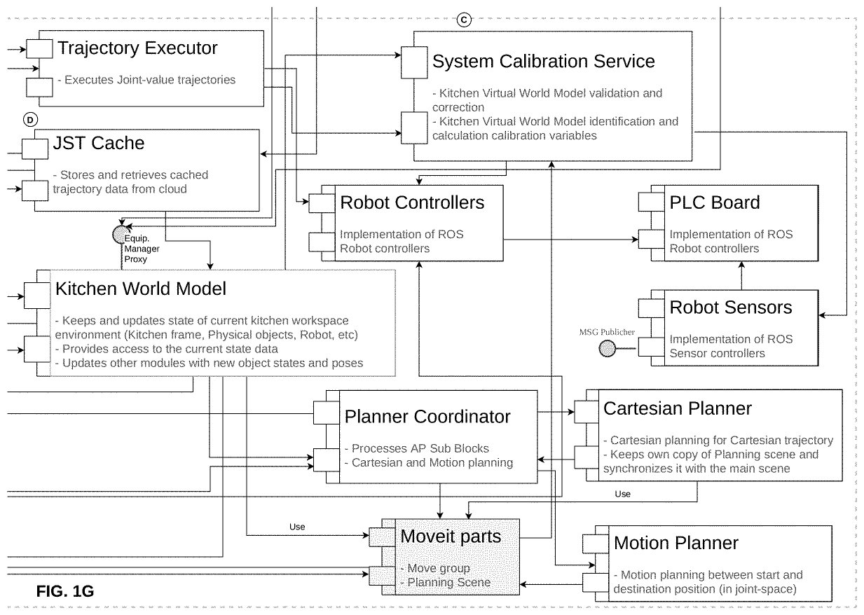

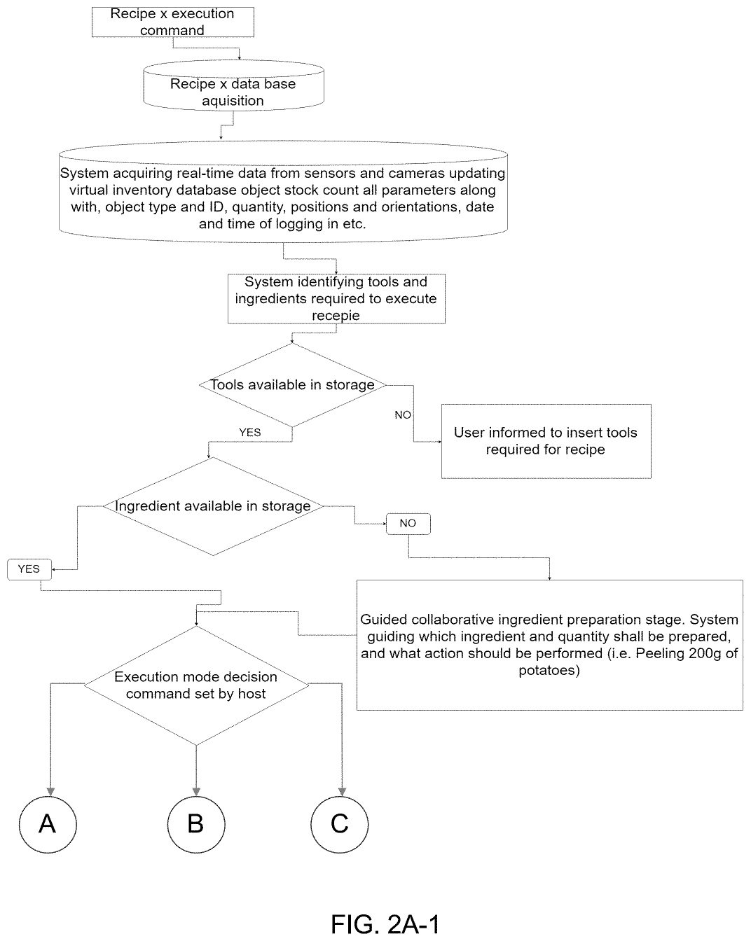

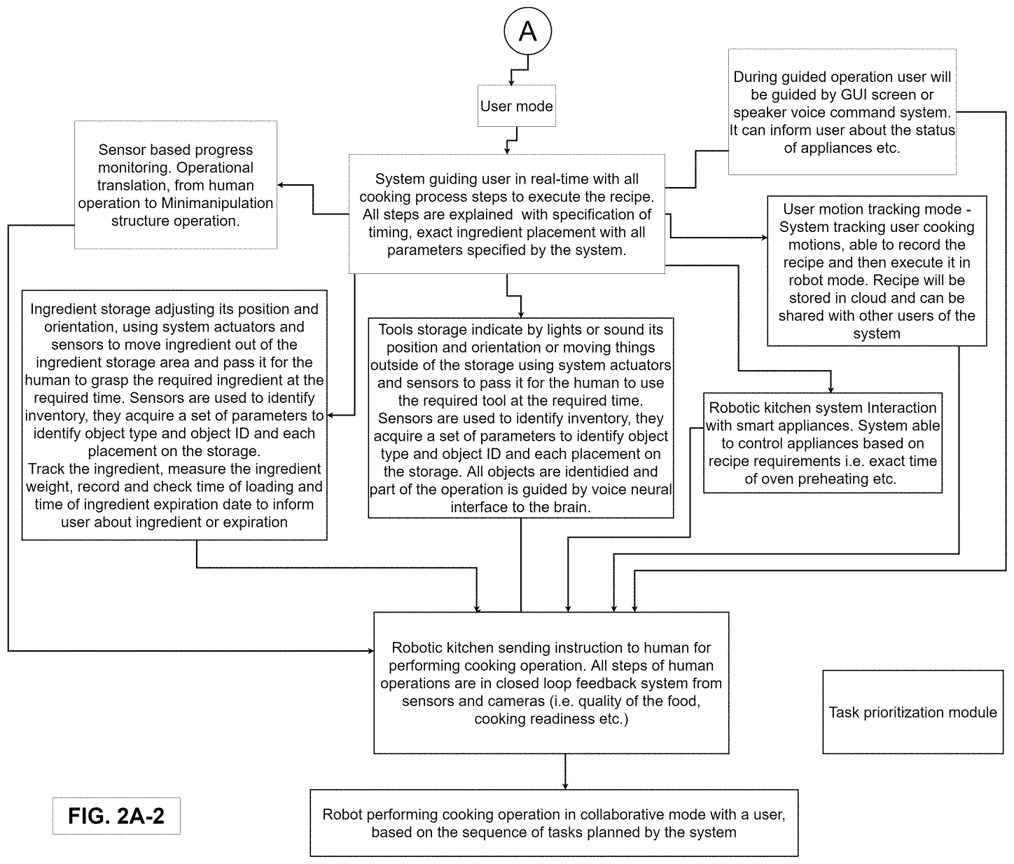

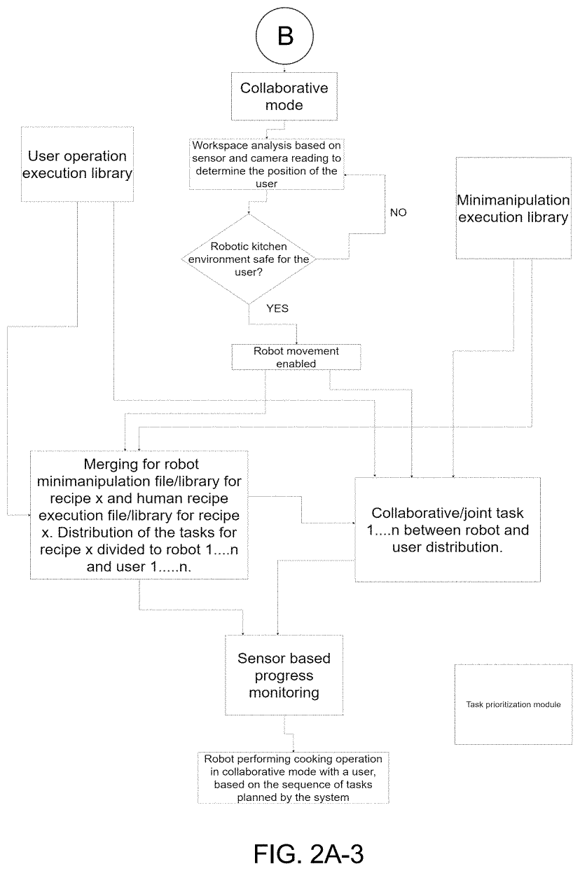

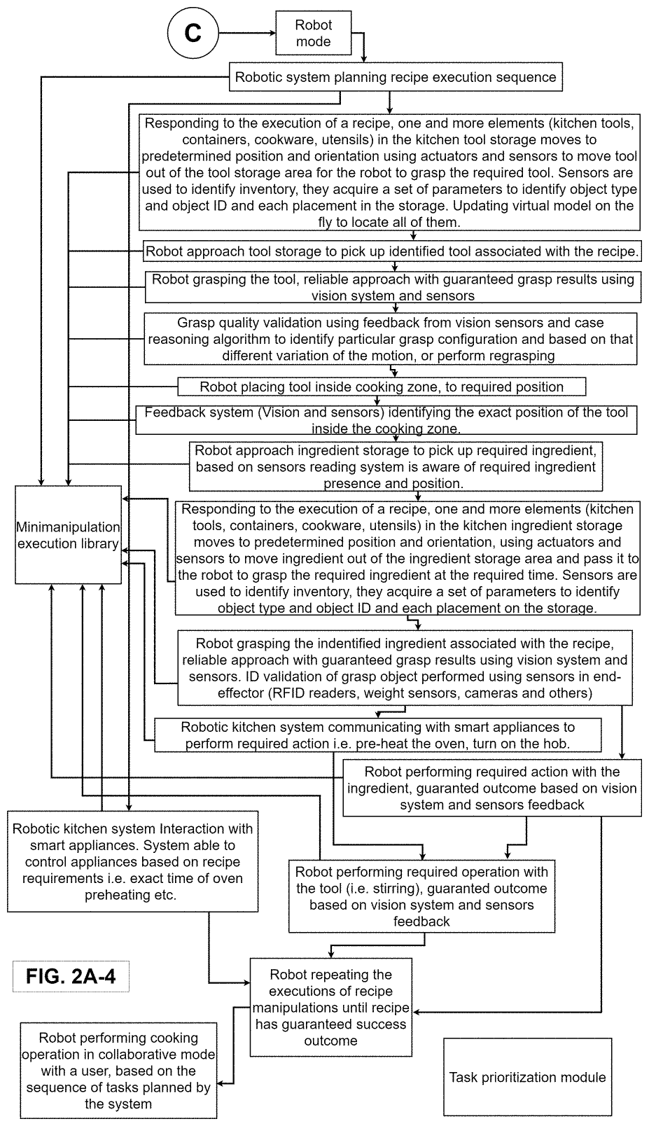

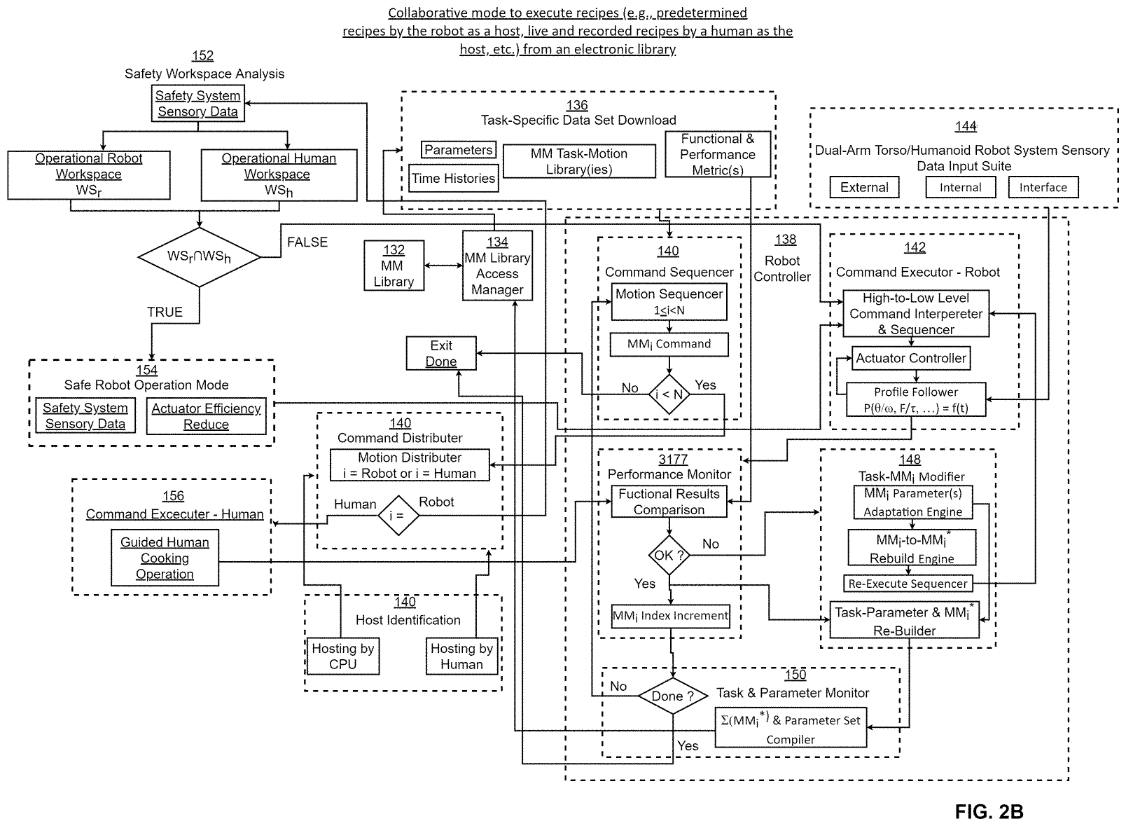

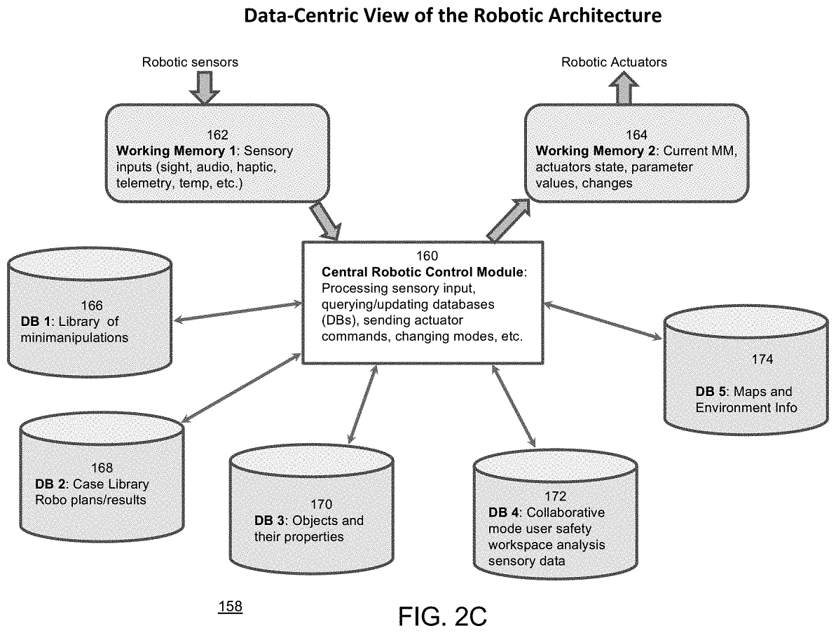

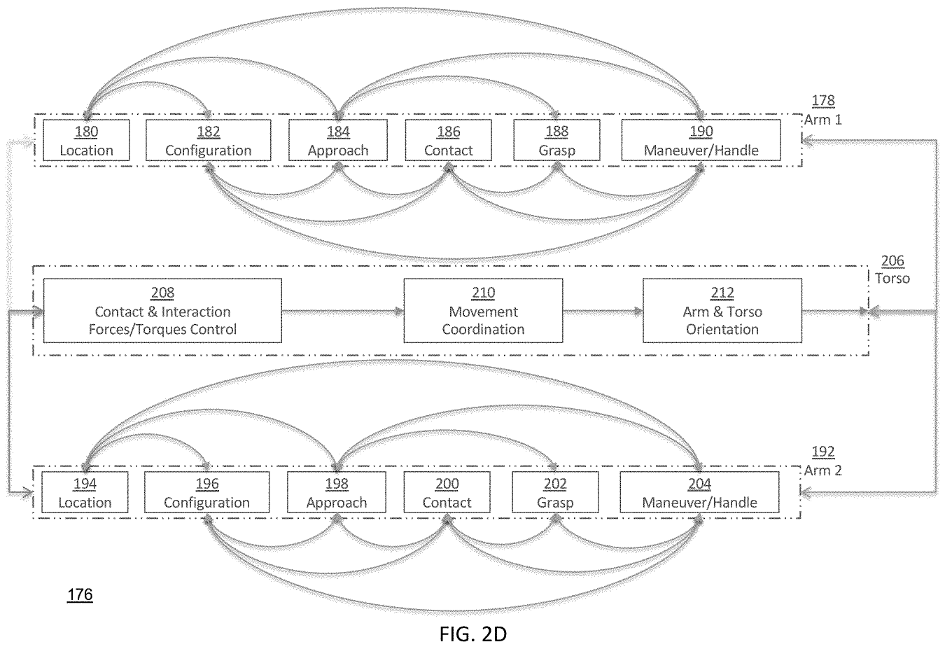

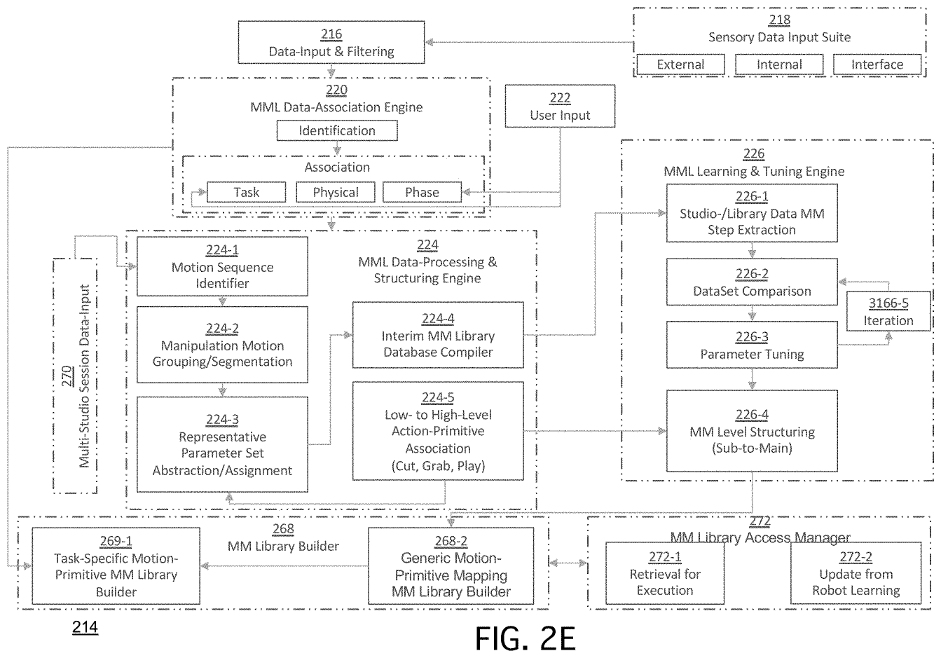

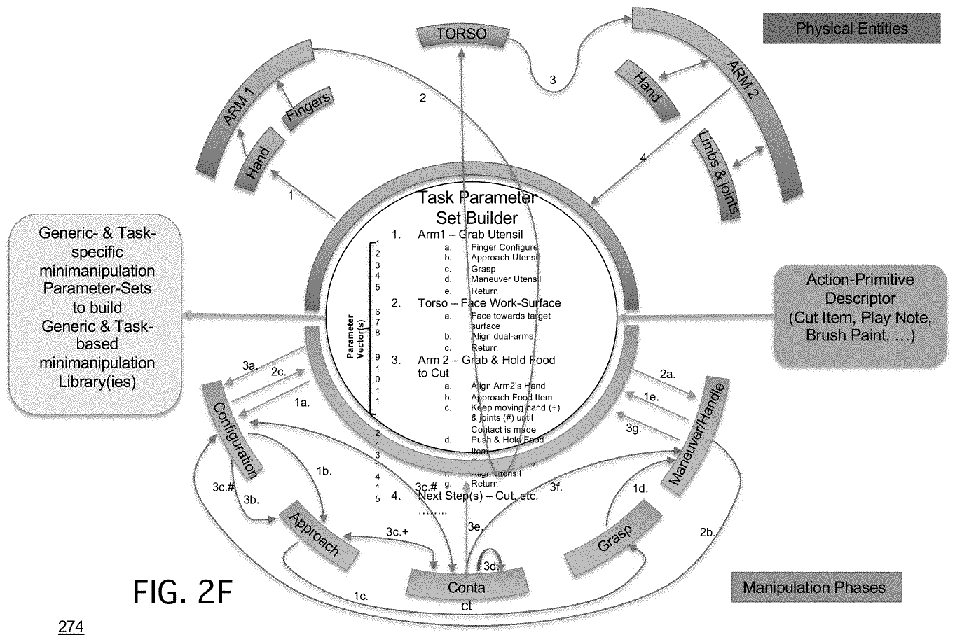

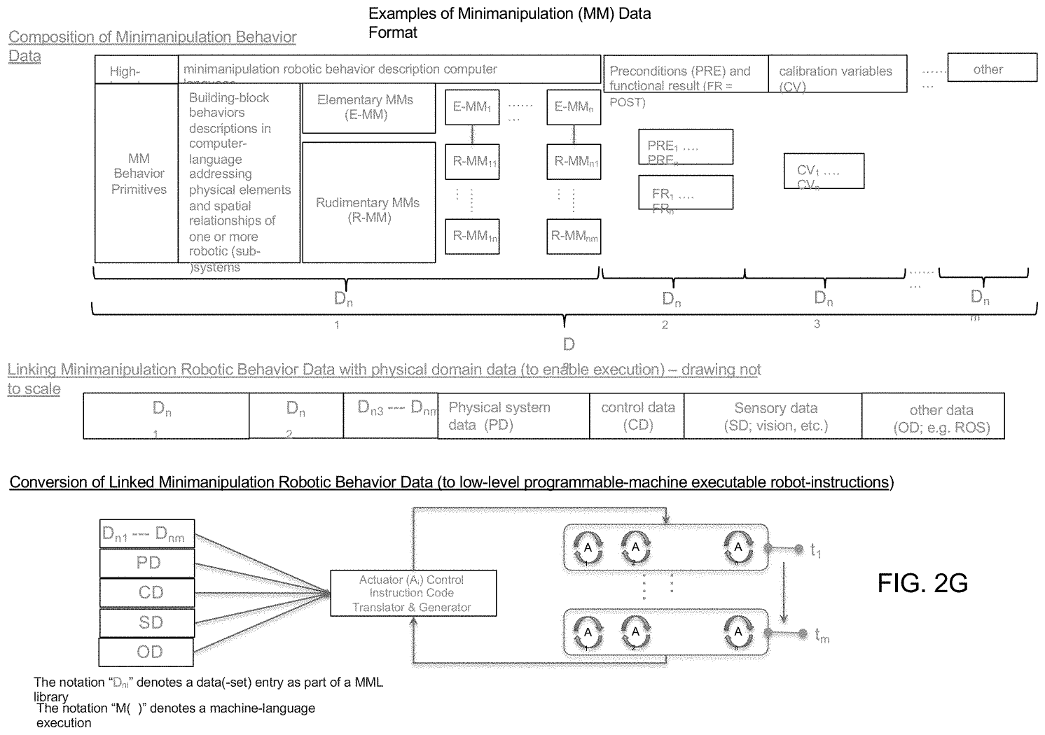

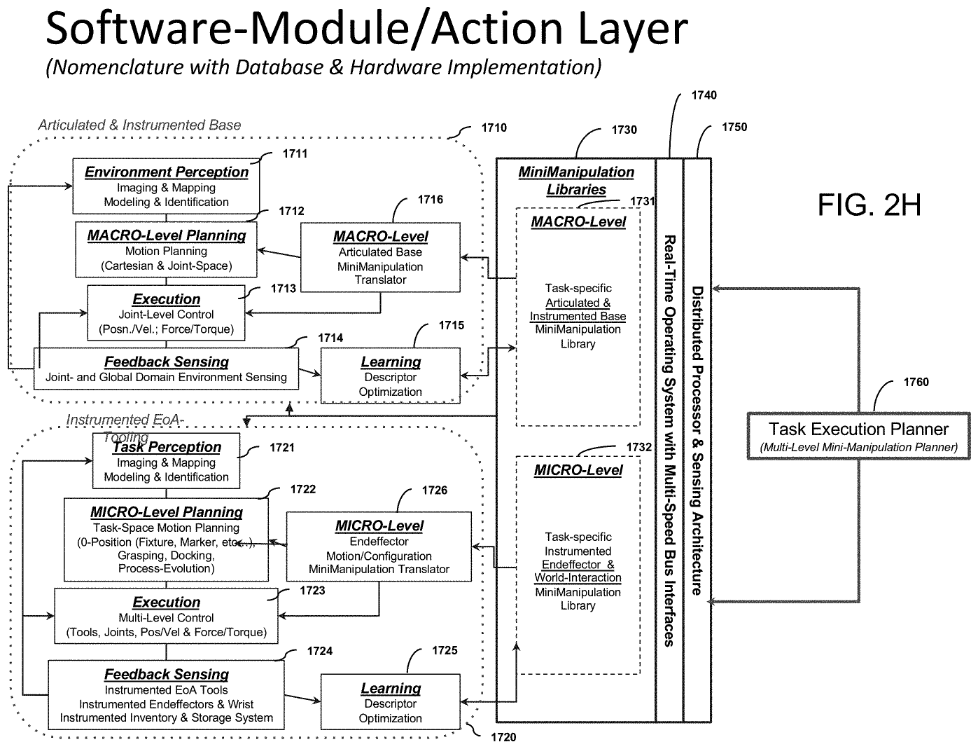

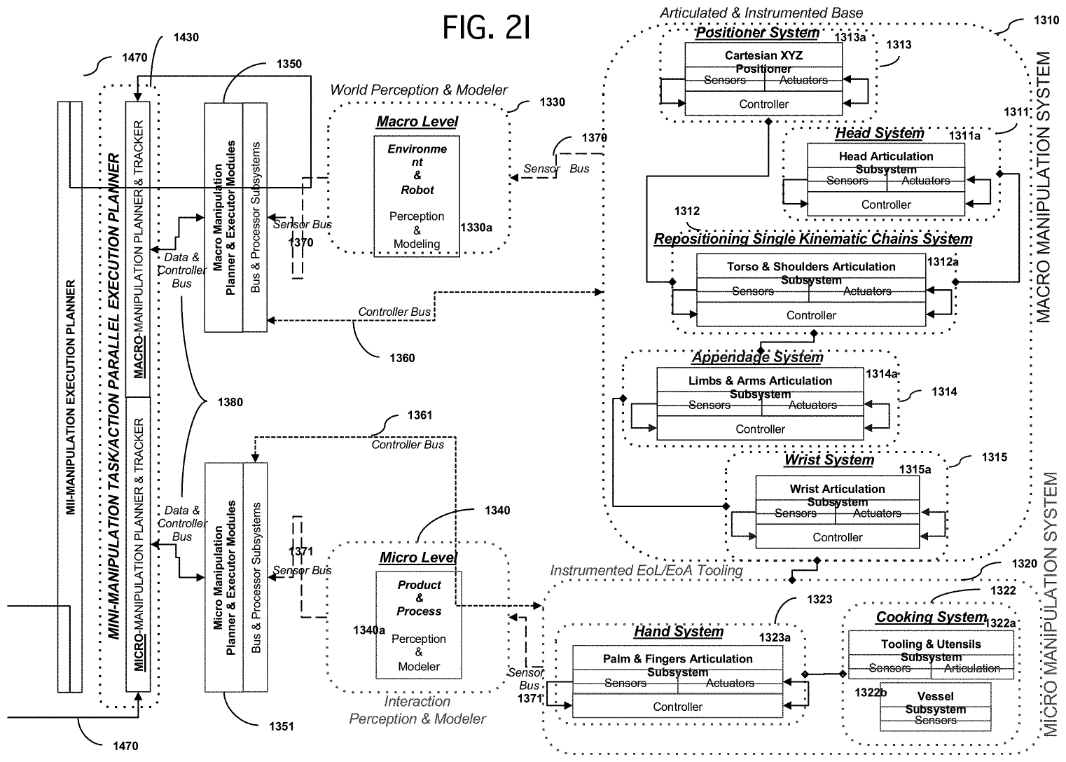

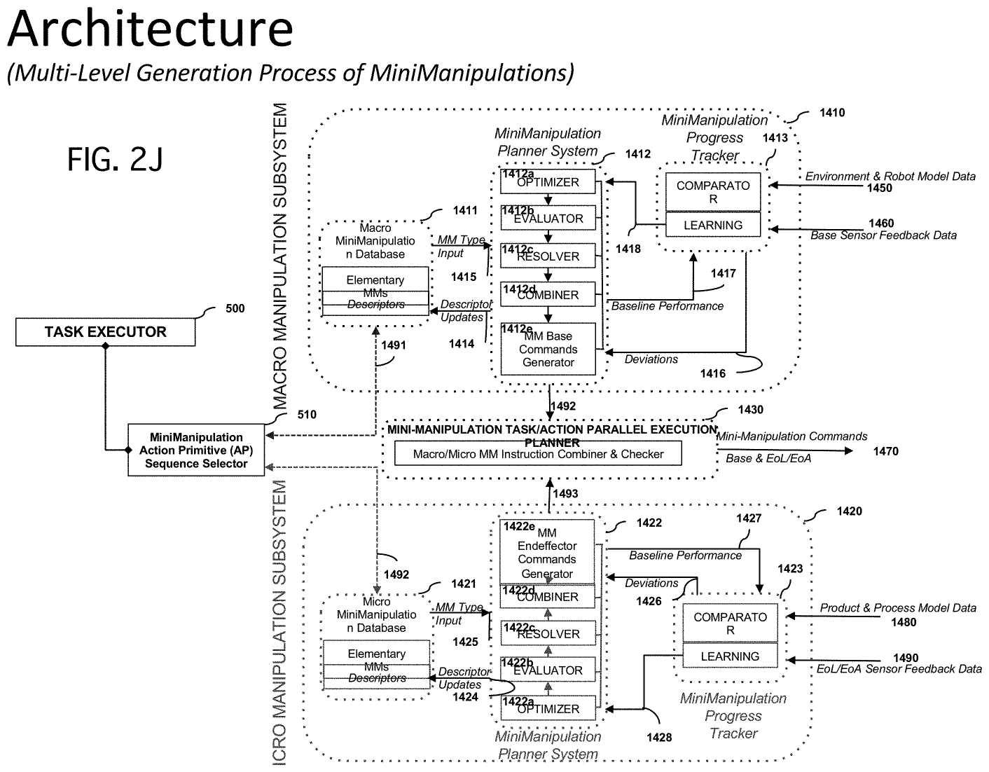

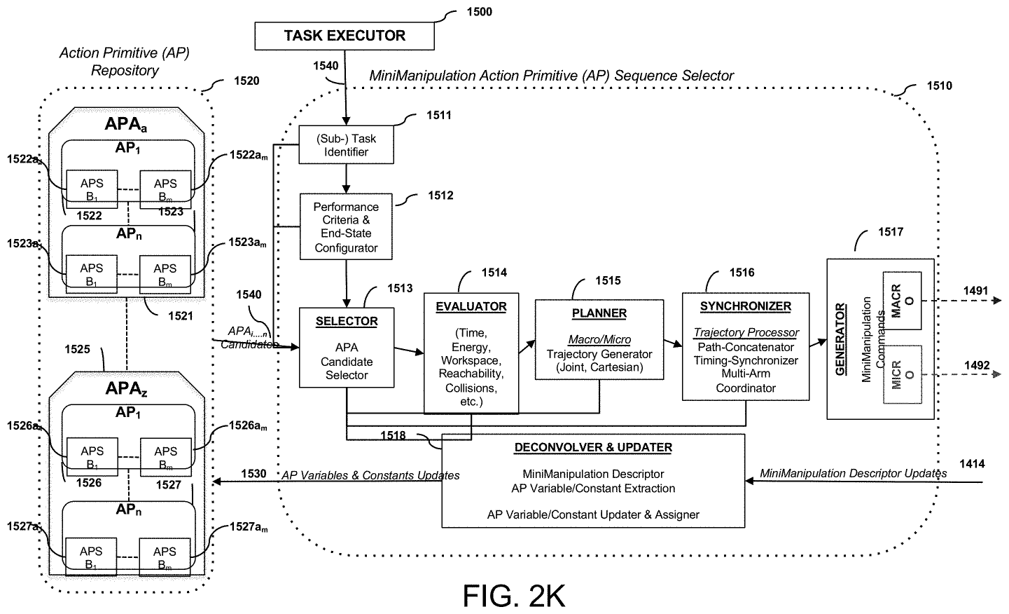

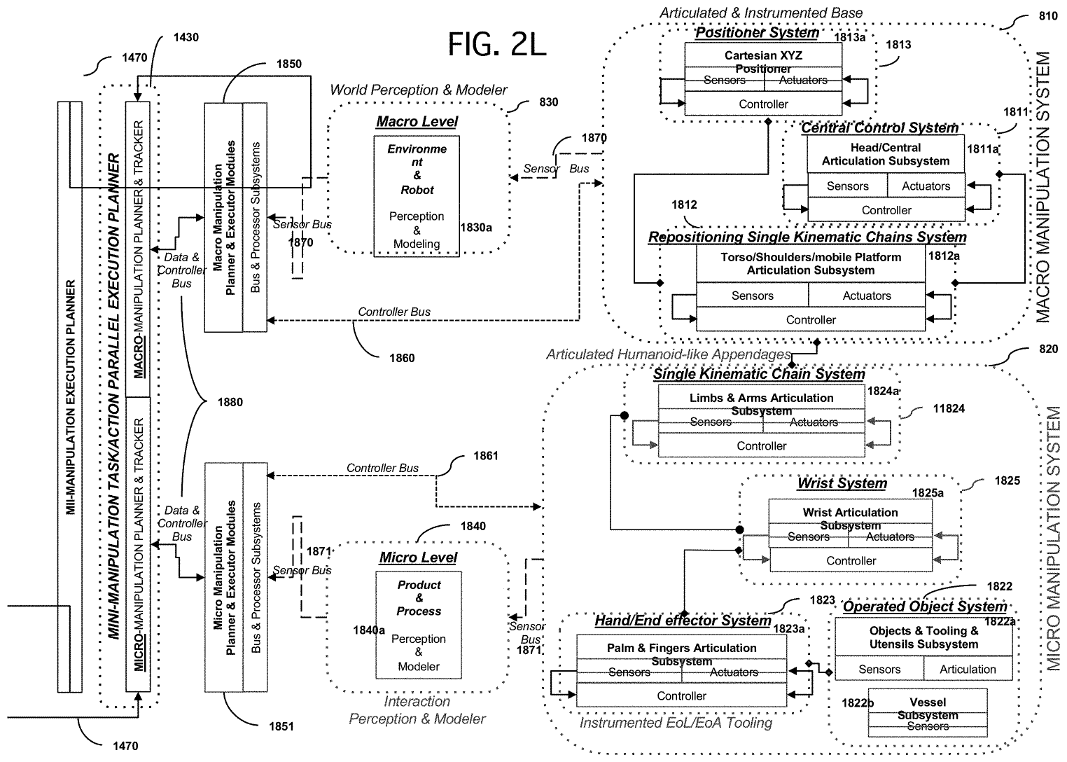

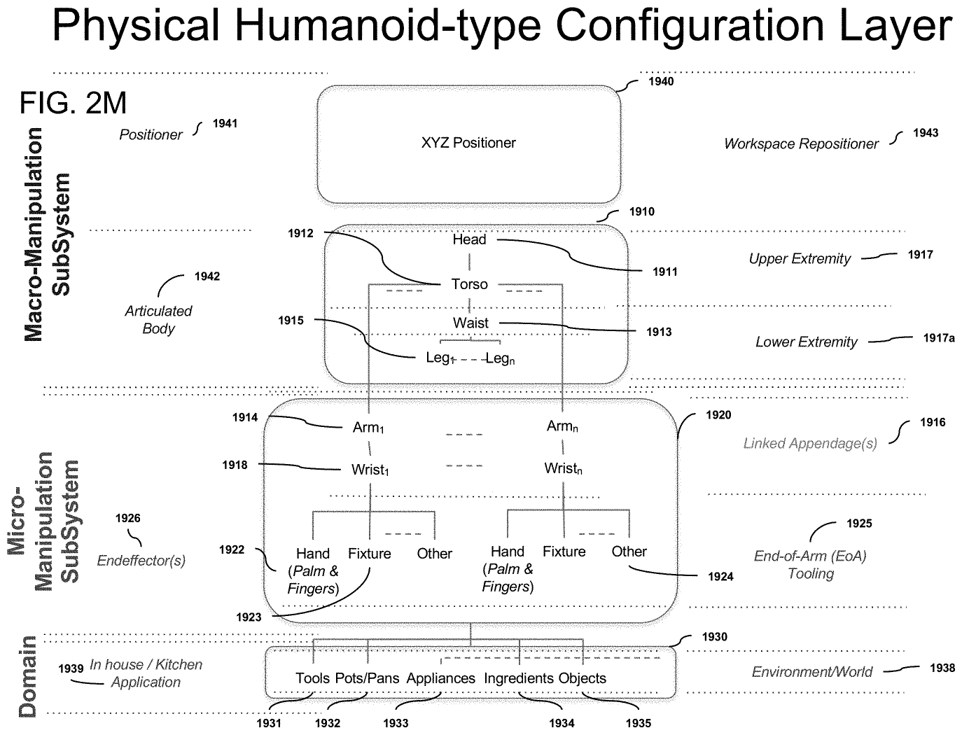

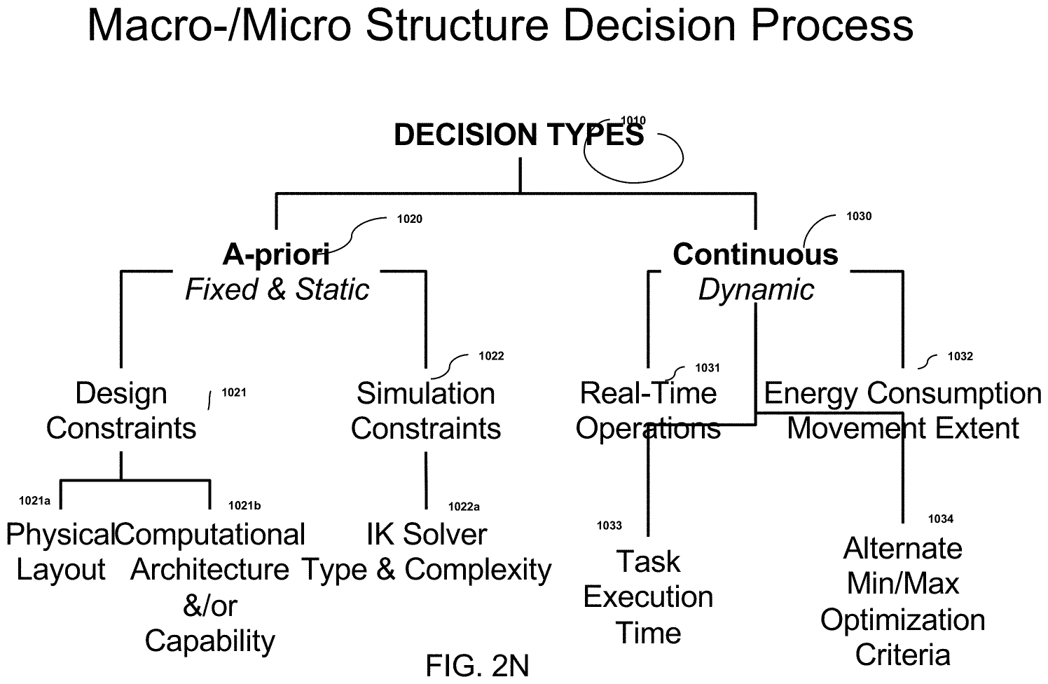

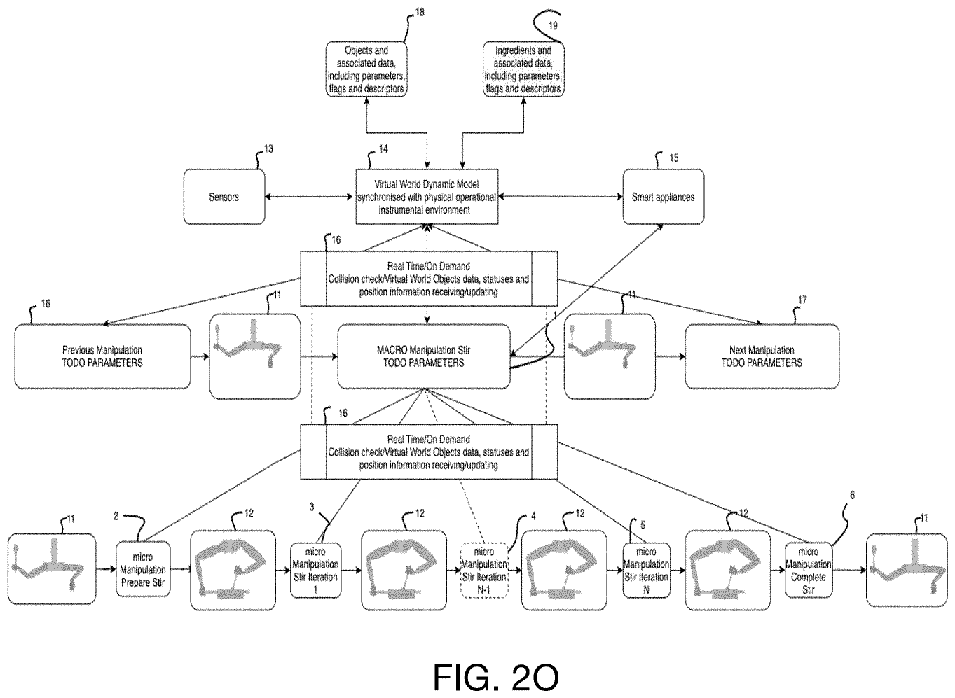

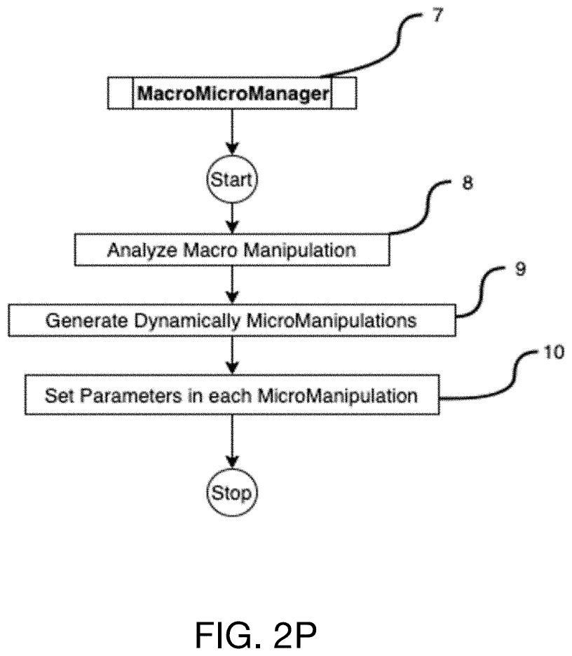

FIGS. 2A-1 to 2A-4 collectively represent one complete flow diagram illustrating a process for different modes of operations, including a robot mode, a collaborative mode and a user mode, in a robotic kitchen FIG. 2A-1 is a system diagram illustrating initial robotic kitchen operation sequences while entering different robot modes. The system is triggered when user starts the operation when user commands the execution 1000. The system acquires data about execution recipe, understands all parameters, tools, equipment required to execute the recipe 1001. The system gathers the information about current state of the kitchen, it is able to compare with the requirements 1002. Tools, ingredients required to complete the recipe needs to be inside the kitchen before start of the execution 1004. In case certain objects are not present in the system, user is guided to feed the system with the required objects 1005. The decision of the execution mode 1006 is done by the user based on his preferences, recipe can be executed in user, collaborative and robot state.

FIG. 2A-2 is a system diagram is illustrating user operating mode. After choosing user execution mode, system start real-time guidance process 1007. System is guiding the user with GUI screen or voice commands 1012 until completion of the recipe with every single step of the recipe creation process, with exact timing. This functionality is the key to perfectly prepared dish 1007. Tool storage system is interacting with the user throughout recipe execution process. The system understand positions of the tools and can pass the exact tool to the user on the exact required time 1008. This functionality makes cooking process much easier. Ingredient storage system is interacting with the user throughout recipe execution process. The system understands positions of the exact ingredient and can pass the ingredient tool to the user on the exact required time 1009. Ingredient storage system also has ability to understand many parameters of the ingredients such as, expiry date visual appearance, type, ID, amount, weight etc. Robotic kitchen has centralized control over smart appliances, user is able to interact with all appliances in kitchen, using one centralized kitchen robotic system interface. This functionality is also crucial in recipe execution process. System can for instance preheat the oven, set it to ideal temperature in the exact time along many other things, based on the recipe requirements 1010. User has ability to record his cooking execution process to create a execution library recipe from it. After recording the recipe, it can be saved, and used by the robot, human or in collaborative mode 1011. All cooking steps are have guaranteed results, robotic kitchen system has many sensors, to understand if the recipe was successful or not. This closed loop feedback system is making sure all cooking steps along the process are successful, in case they are not, system is guiding user again to execute successful operation. Quality of ingredients, readiness of the food etc. are all validated in real-time by many sensors inside the system 1013. User is guided with all recipe execution steps with feedback on each step until full recipe is finished 1014. All operations in user mode are coming together to form user operation execution library 1030. Task execution sequence is planned based on data from task prioritization module 1038.

FIG. 2A-4 is a system diagram is illustrating robot execution mode inside robotic kitchen. Robotic kitchen is planning execution sequence 1015. Based on the execution sequence it can plan exact time when tools or ingredients and tools needs to be passed to use them for recipe execution 1016. Ingredient and tool storage systems are passing the ingredients to the robot in such a manner it is easy for the robot to grasp it with its end-effector 1017. Sensory data feedback inside the system guarantees successful outcome of all operations. Making sure that grasping operations are successful and the equipment desired position is also up to the requirements 1018. As mentioned in user operating mode description, robot has ability to interface to smart cooking appliances, in this case, the system controls the cooking process with all its parameters fully autonomous 1019. All operations in the recipes are coming together to minimanupulation execution library 1020. Task execution sequence is planned based on data from task prioritization module 1038.

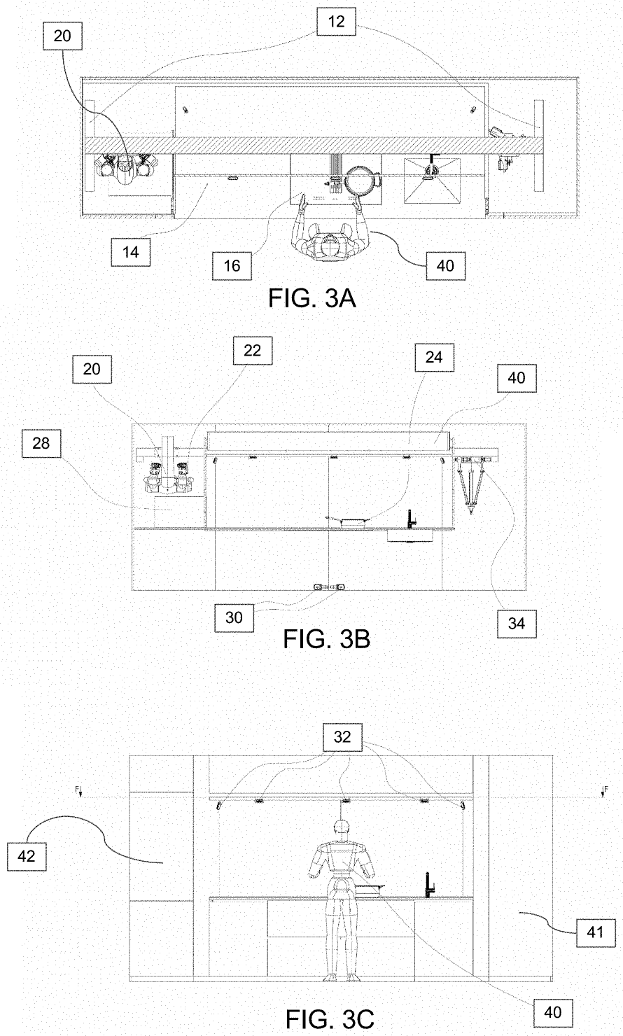

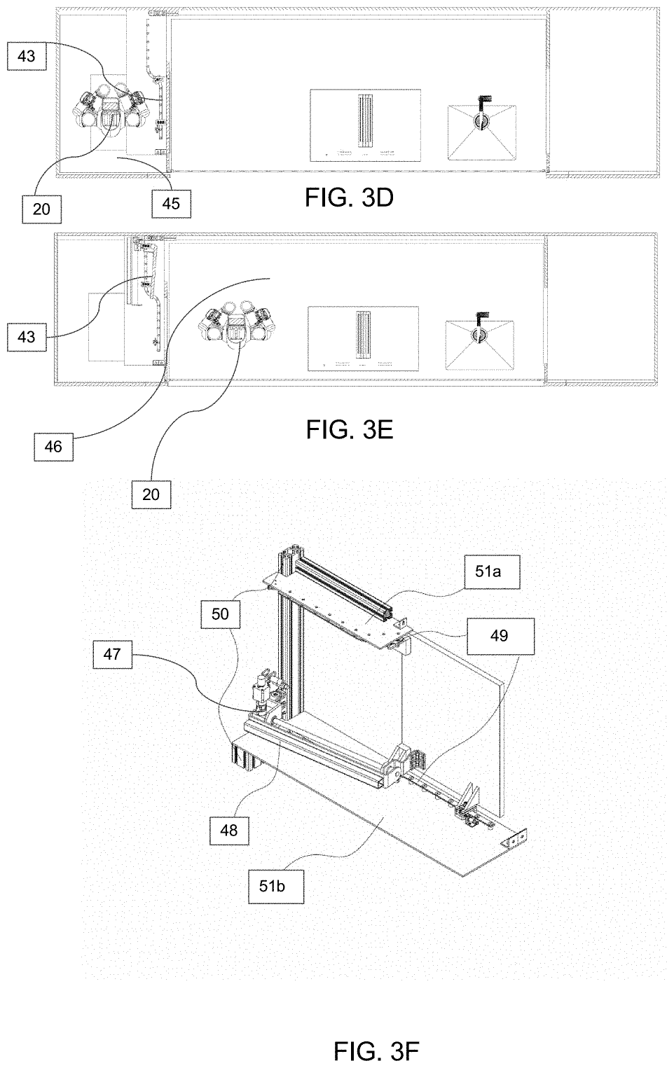

FIG. 2A-3 is a system diagram is illustrating collaborative mode execution mode inside robotic kitchen. Robotic kitchen has been designed for human and user compatibility, all subsystems and equipment inside is for both scenarios usage. Collaborative mode execution architecture is based on the current host situation. The host assignment depends on the recipe mode. In case the recipe is preprogrammed and replayed by the system, robotic kitchen is the host and it is distributing the tasks to human and to itself, in case of dynamic recipe creation by the user, user is the host, and robot follows given tasks. The most crucial factor in collaborative mode is user safety. The first step before each robot execution is analysis of sensory real-time data and risk mitigation 1035. Only when environment is safe for the user, each motion command can be enabled 1036. Recipe execution sequencer 1037 is created from merging both user 1030 and robot 1020 execution libraries, also depending on the host situation. It is distributing the tasks based on task prioritization module. Sensory data 1035 is constantly monitoring the safety for the user inside the operational environment. It is also monitoring outcome of cooking operation and makes sure it is on track. User and robot can also share single task in collaboration, for instance both chop the tomatoes.

FIG. 2B is a flow diagram illustrating robotic task-execution via one or more minimanipulation library data sets to execute recipes from an electronic library database in a collaborative mode with a safety function and as to how a remote robotic system would utilize the minimanipulation (MM) library(ies) to carry out a remote replication of a particular task (cooking, painting, etc.), which can be carried out by an expert in a studio-setting, where the expert's actions were recorded, analyzed and translated into machine-executable sets of hierarchically-structured minimanipulation datasets (commands, parameters, metrics, time-histories, etc.) which when downloaded and properly parsed, allow for a robotic system (in this case a dual-arm torso/humanoid system) to faithfully replicate the actions of the expert with sufficient fidelity to achieve substantially the same end-result as that of the expert in the studio-setting.

At a high level, this is achieved by downloading the task-descriptive libraries containing the complete set of minimanipulation datasets required by the robotic system, and providing them to a robot controller for execution. The robot controller generates the required command and motion sequences that the execution module interprets and carries out, while receiving feedback from the entire system to allow it to follow profiles established for joint and limb positions and velocities as well as (internal and external) forces and torques. A parallel performance monitoring process uses task-descriptive functional and performance metrics to track and process the robot's actions to ensure the required task-fidelity. A minimanipulation learning-and-adaptation process is allowed to take any minimanipulation parameter-set and modify it should a particular functional result not be satisfactory, to allow the robot to successfully complete each task or motion-primitive. Updated parameter data is then used to rebuild the modified minimanipulation parameter set for re-execution as well as for updating/rebuilding a particular minimanipulation routine, which is provided back to the original library routines as a modified/re-tuned library for future use by other robotic systems. The system monitors all minimanipulation steps until the final result is achieved and once completed, exits the robotic execution loop to await further commands or human input.

In specific detail the process outlined above, can be detailed as the sequences described below. The MM library, containing both the generic and task-specific MM-libraries, is accessed via the MM library access manager, which ensures all the required task-specific data sets required for the execution and verification of interim/end-result for a particular task are available. The data set includes at least, but is not limited to, all necessary kinematic/dynamic and control parameters, time-histories of pertinent variables, functional and performance metrics and values for performance validation and all the MM motion libraries relevant to the particular task at hand.

All task-specific datasets are fed to the robot controller. A command sequencer creates the proper sequential/parallel motion sequences with an assigned index-value ‘I’, for a total of ‘i=N’ steps, feeding each sequential/parallel motion command (and data) sequence to the command executor. The command executo takes each motion-sequence and in turn parses it into a set of high-to-low command signals to actuation and sensing systems, allowing the controllers for each of these systems to ensure motion-profiles with required position/velocity and force/torque profiles are correctly executed as a function of time. Sensory feedback data from the (robotic) dual-arm torso/humanoid system is used by the profile-following function to ensure actual values track desired/commanded values as close as possible.

A separate and parallel performance monitoring process measures the functional performance results at all times during the execution of each of the individual minimanipulation actions, and compares these to the performance metrics associated with each minimanipulation action and provided in the task-specific minimanipulation data set. Should the functional result be within acceptable tolerance limits to the required metric value(s), the robotic execution is allowed to continue, by way of incrementing the minimanipulation index value to ‘i++’, and feeding the value and returning control back to the command-sequencer process, allowing the entire process to continue in a repeating loop. Should however the performance metrics differ, resulting in a discrepancy of the functional result value(s), a separate task-modifier process is enacted.

The minimanipulation task-modifier process is used to allow for the modification of parameters describing any one task-specific minimanipulation, thereby ensuring that a modification of the task-execution steps will arrive at an acceptable performance and functional result. This is achieved by taking the parameter-set from the ‘offending’ minimanipulation action-step and using one or more of multiple techniques for parameter-optimization common in the field of machine-learning, to rebuild a specific minimanipulation step or sequence MMᵢ into a revised minimanipulation step or sequence MMᵢ*. The revised step or sequence MMᵢ* is then used to rebuild a new command-0sequence that is passed back to the command executor for re-execution. The revised minimanipulation step or sequence MMᵢ* is then fed to a re-build function that re-assembles the final version of the minimanipulation dataset, that led to the successful achievement of the required functional result, so it may be passed to the task- and parameter monitoring process.

The task- and parameter monitoring process is responsible for checking for both the successful completion of each minimanipulation step or sequence, as well as the final/proper minimanipulation dataset considered responsible for achieving the required performance-levels and functional result. As long as the task execution is not completed, control is passed back to the command sequencer. Once the entire sequences have been successfully executed, implying ‘i=N’, the process exits (and presumably awaits further commands or user input. For each sequence-counter value ‘I’, the monitoring task also forwards the sum of all rebuilt minimanipulation parameter sets Σ(MMᵢ*) back to the MM library access manager to allow it to update the task-specific library(ies) in the remote MM library. The remote library then updates its own internal task-specific minimanipulation representation [setting Σ(MM_{i,new})=Σ(MMᵢ*)], thereby making an optimized minimanipulation library available for all future robotic system usage.

The host identification 160 is responsible for identification the host in collaborative execution mode. Hosting can be done by human, in this case recipe is no preprogrammed, or can be done by CPU, in this case recipe library is preprogrammed. Host is identified by the user. This impacts further execution, because all commands will be distributed by the host.

Next stage is the Command distributor 161. The block is responsible for assigning minimanipulation to the execution party, human or the robotic system

In case of distributing the task to human user, sequence goes to command executor—human 156. In this scenario, user is performing cooking operation with robotic kitchen guidance and performance monitor 146 feedback.

In case of distributing the command to the robot program jumps into safety workspace analysis block. This block main function is to analyse the operational workspace and assess if it is safe for the robot to perform motion commands. The system is analysing if the next motion planned for the robot is intersecting in any matter with human operational workspace. In case it is not, robot is jumping straight to Command executor—robot 142, in case two workspaces are intersecting, robot is jumping into safe robot operational mode 154, in which case actuators efficiency are reduced, and safety sensory data is analyzed ever more carefully.

FIG. 2C is a block diagram illustrating a data-centric view of the robotic architecture 158 (or robotic system), with a central robotic control module contained in the central box, in order to focus on the data repositories. The central robotic control module 160 contains working memory needed by all the processes. In particular the Central Robotic Control establishes the mode of operation of the Robot, for instance whether it is observing and learning new minimanipulations, from an external teacher, or executing a task or in yet a different processing mode.

A working memory 1 162 contains all the sensor readings for a period of time until the present: a few seconds to a few hours—depending on how much physical memory, typical would be about 60 seconds. The sensor readings come from the on-board or off-board robotic sensors and may include video from cameras, ladar, sonar, force and pressure sensors (haptic), audio, and/or any other sensors. Sensor readings are implicitly or explicitly time-tagged or sequence-tagged (the latter means the order in which the sensor readings were received).

A working memory 2 164 contains all of the actuator commands generated by the Central Robotic Control and either passed to the actuators, or queued to be passed to same at a given point in time or based on a triggering event (e.g. the robot completing the previous motion). These include all the necessary parameter values (e.g. how far to move, how much force to apply, etc.).

A first database (database 1) 166 contains the library of all minimanipulations (MM) known to the robot, including for each MM, a triple <PRE, ACT, POST>, where is a set of items in the world state that must be true before the actions can take place, and result in a set of changes to the world state denoted as. In a preferred embodiment, the MMs are index by purpose, by sensors and actuators they involved, and by any other factor that facilitates access and application. In a preferred embodiment each POST result is associated with a probability of obtaining the desired result if the MM is executed. The Central Robotic Control both accesses the MM library to retrieve and execute MM's and updates it, e.g. in learning mode to add new MMs.

A second database (database 2) 168 contains the case library, each case being a sequence of minimanipulations to perform a give task, such as preparing a given dish, or fetching an item from a different room. Each case contains variables (e.g. what to fetch, how far to travel, etc.) and outcomes (e.g. whether the particular case obtained the desired result and how close to optimal—how fast, with or without side-effects etc.). The Central Robotic Control both accesses the Case Library to determine if has a known sequence of actions for a current task, and updates the Case Library with outcome information upon executing the task. If in learning mode, the Central Robotic Control adds new cases to the case library, or alternately deletes cases found to be ineffective.

A third database (database 3) 170 contains the object store, essentially what the robot knows about external objects in the world, listing the objects, their types and their properties. For instance, an knife is of type “tool” and “utensil” it is typically in a drawer or countertop, it has a certain size range, it can tolerate any gripping force, etc. An egg is of type “food”, it has a certain size range, it is typically found in the refrigerator, it can tolerate only a certain amount of force in gripping without breaking, etc. The object information is queried while forming new robotic action plans, to determine properties of objects, to recognize objects, and so on. The object store can also be updated when new objects introduce and it can update its information about existing objects and their parameters or parameter ranges.

A fourth database (database 4) contains information about the user interaction with the robot system. Data about safe operational space while the user is present in certain operational cooking zone, how robot has to behave around user in certain listed scenarios velocity data, acceleration data, maximum safe operational space volume data, tools that are allowed to operate by the robot in collaborative mode, potential hazardous situations that robot has to avoid or mitigate while operating in collaborative mode, operational restrictions is collaborative mode, collaborative mode environmental parameters, smart appliances data, safety sensory data (environment scanners, zoning sensors, vision system along more sensors). Essentially, all information about the environment and operations that are potential hazard for the user are cross checked with the sensory data from the system, hazard mitigation libraries. Robotic systems can make operational parameters decisions based on this data. For instance, limit the velocities while the user is in a certain position in the kitchen regarding the robot. Prevent from using certain tools or perform certain hazardous operations while the user is in a certain position in the kitchen (using a knife, moving a pot with hot water along other potential hazardous situations in the kitchen environment. It is storing libraries for interaction with the user, for instance it can ask the user to perform certain tasks, move out of the environment for certain time if required by a safety mitigation library etc.

A fifth database (database 4) 174 contains information about the environment in which the robot is operating, including the location of the robot, the extent of the environment (e.g. the rooms in a house), their physical layout, and the locations and quantities of specific objects within that environment. Database 4 is queried whenever the robot needs to update object parameters (e.g. locations, orientations), or needs to navigate within the environment. It is updated frequently, as objects are moved, consumed, or new objects brought in from the outside (e.g. when the human returns form the store or supermarket).

FIG. 2D depicts a dual-arm torso humanoid robot system 176 as a set of manipulation function phases associated with any manipulation activity, regardless of the task to be accomplished, for MM library manipulation-phase combinations and transitions for task-specific action-sequences 176.

Hence in order to build an ever more complex and higher level set of minimanipulation (MM) motion-primitive routines form a set of generic sub-routines, a high-level minimanipulation (MM) can be thought of as a transition between various phases of any manipulation, thereby allowing for a simple concatenation of minimanipulation (MM) sub-routines to develop a higher-level minimanipulation routine (motion-primitive). Note that each phase of a manipulation (approach, grasp, maneuver, etc.) is itself its own low-level minimanipulation described by a set of parameters involved in controlling motions and forces/torques (internal, external as well as interface variables) involving one or more of the physical domain entities [finger(s), palm, wrist, limbs, joints (elbow, shoulder, etc.), torso, etc.].

Arm 1 180 of a dual-arm system, can be thought of as using external and internal sensors, to achieve a particular location 180 of the end effector, with a given configuration 182 prior to approaching a particular target (tool, utensil, surface, etc.), using interface-sensors to guide the system during the approach-phase 184, and during any grasping-phase 188 (if required); a subsequent handling-/maneuvering-phase 190 allows for the end effector to wield an instrument in it grasp (to stir, draw, etc.). The same description applies to an Arm 2 192, which could perform similar actions and sequences.

Note that should a minimanipulation (MM) sub-routine action fail (such as needing to re-grasp), all the minimanipulation sequencer has to do is to jump back backwards to a prior phase and repeat the same actions (possibly with a modified set of parameters to ensure success, if needed). More complex sets of actions, such playing a sequence of piano-keys with different fingers, involves a repetitive jumping-loops between the Approach 184, 186 and the Contact 186, 200 phases, allowing for different keys to be struck in different intervals and with different effect (soft/hard, short/long, etc.); moving to different octaves on the piano key-scale would simply require a phase-backwards to the configuration-phase 182 to reposition the arm, or possibly even the entire torso 3140 through translation and/or rotation to achieve a different arm and torso orientation 208.

Arm 2 192 could perform similar activities in parallel and independent of Arm 178, or in conjunction and coordination with Arm 178 and Torso 206, guided by the movement-coordination phase (such as during the motions of arms and torso of a conductor wielding a baton), and/or the contact and interaction control phase 208, such as during the actions of dual-arm kneading of dough on a table.

Minimanipulations (MM) ranging from the lowest-level sub-routine to the more higher level motion-primitives or more complex minimanipulation (MM) motions and abstraction sequences, can be generated from a set of different motions associated with a particular phase which in turn have a clear and well-defined parameter-set (to measure, control and optimize through learning). Smaller parameter-sets allow for easier debugging and sub-routines that be guaranteed to work, allowing for a higher-level MM routines to be based completely on well-defined and successful lower-level MM sub-routines.

Notice that coupling a minimanipulation (sub-) routine to a not only a set of parameters required to be monitored and controlled during a particular phase of a task-motion, but also associated further with a particular physical (set of) units, allows for a very powerful set of representations to allow for intuitive minimanipulation (MM) motion-primitives to be generated and compiled into a set of generic and task-specific minimanipulation (MM) motion/action libraries.

FIG. 2E depicts a flow diagram illustrating the process 214 of minimanipulation Library(ies) generation, for both generic and task-specific motion-primitives as part of the studio-data generation, collection and analysis process. This figure depicts how sensory-data is processed through a set of software engines to create a set of minimanipulation libraries containing datasets with parameter-values, time-histories, command-sequences, performance-measures and—metrics, etc. to ensure low- and higher-level minimanipulation motion primitives result in a successful completion of low-to-complex remote robotic task-executions.

In a more detailed view, it is shown how sensory data is filtered and input into a sequence of processing engines to arrive at a set of generic and task-specific minimanipulation motion primitive libraries. The processing of the sensory data 218 involves its filtering-step 216 and grouping it through an association engine 220, where the data is associated with the physical system elements as well as manipulation-phases, potentially even allowing for user input 222, after which they are processed through two MM software engines.

The MM data-processing and structuring engine 224 creates an interim library of motion-primitives based on identification of motion-sequences 224-1, segmented groupings of manipulation steps 224-2 and then an abstraction-step 224-3 of the same into a dataset of parameter-values for each minimanipulation step, where motion-primitives are associated with a set of pre-defined low- to high-level action-primitives 224-5 and stored in an interim library 224-4. As an example, process 224-1 might identify a motion-sequence through a dataset that indicates object-grasping and repetitive back-and-forth motion related to a studio-chef grabbing a knife and proceeding to cut a food item into slices. The motion-sequence is then broken down in 224-2 into associated actions of several physical elements (fingers and limbs/joints) with a set of transitions between multiple manipulation phases for one or more arm(s) and torso (such as controlling the fingers to grasp the knife, orienting it properly, translating arms and hands to line up the knife for the cut, controlling contact and associated forces during cutting along a cut-plane, re-setting the knife to the beginning of the cut along a free-space trajectory and then repeating the contact/force-control/trajectory-following process of cutting the food-item indexed for achieving a different slice width/angle). The parameters associated with each portion of the manipulation-phase are then extracted and assigned numerical values in 224-3, and associated with a particular action-primitive offered by 224-5 with mnemonic descriptors such as ‘grab’, ‘align utensil’, ‘cut’, ‘index-over’, etc.

The interim library data 224-4 is fed into a learning-and-tuning engine 226, where data from other multiple studio-sessions 270 is used to extract similar minimanipulation actions and their outcomes 226-1 and comparing their data sets 226-2, allowing for parameter-tuning 226-3 within each minimanipulation group using one or more of standard machine-learning/-parameter-tuning techniques in an iterative fashion. A further level-structuring process 226-4 decides on breaking the minimanipulation motion-primitives into generic low-level sub-routines and higher-level minimanipulations made up of a sequence (serial and parallel combinations) of sub-routine action-primitives.

A following library builder 268 then organizes all generic minimanipulation routines into a set of generic multi-level minimanipulation action-primitives with all associated data (commands, parameter-sets and expected/required performance metrics) as part of a single generic minimanipulation library 268-2. A separate and distinct library is then also built as a task-specific library 268-1 that allows for assigning any sequence of generic minimanipulation action-primitives to a specific task (cooking, painting, etc.), allowing for the inclusion of task-specific datasets which only pertain to the task (such as kitchen data and parameters, instrument-specific parameters, etc.) which are required to replicate the studio-performance by a remote robotic system.

A separate MM library access manager 272 is responsible for checking-out proper libraries and their associated datasets (parameters, time-histories, performance metrics, etc.) 272-1 to pass onto a remote robotic replication system, as well as checking back in updated minimanipulation motion primitives (parameters, performance metrics, etc.) 272-2 based on learned and optimized minimanipulation executions by one or more same/different remote robotic systems. This ensures the library continually grows and is optimized by a growing number of remote robotic execution platforms.

FIG. 2F depicts a block diagram illustrating an automated minimanipulation parameter-set building engine 274 for a minimanipulation task-motion primitive associated with a particular task. It provides a graphical representation of how the process of building (a) (sub-) routine for a particular minimanipulation of a particular task is accomplished based on using the physical system groupings and different manipulation-phases, where a higher-level minimanipulation routine can be built up using multiple low-level minimanipulation primitives (essentially sub-routines comprised of small and simple motions and closed-loop controlled actions) such as grasp, grasp the tool, etc. This process results in a sequence (basically task- and time-indexed matrices) of parameter values stored in multi-dimensional vectors (arrays) that are applied in a stepwise fashion based on sequences of simple maneuvers and steps/actions. In essence this figure depicts an example for the generation of a sequence of minimanipulation actions and their associated parameters, reflective of the actions encapsulated in the MM Library Processing & Structuring Engine 214 from FIG. 2E.

The example depicted in FIG. 2F shows a portion of how a software engine proceeds to analyze sensory-data to extract multiple steps from a particular studio data set. In this case it is the process of grabbing a utensil (a knife for instance) and proceeding to a cutting-station to grab or hold a particular food-item (such as a loaf of bread) and aligning the knife to proceed with cutting (slices). The system focuses on Arm 1 in Step 1., which involves the grabbing of a utensil (knife), by configuring the hand for grabbing (1.a.), approaching the utensil in a holder or on a surface (1.b.), performing a pre-determined set of grasping-motions (including contact-detection and—force control not shown but incorporated in the GRASP minimanipulation step 1.c.) to acquire the utensil and then move the hand in free-space to properly align the hand/wrist for cutting operations. The system thereby is able to populate the parameter-vectors (1 thru 5) for later robotic control. The system returns to the next step that involves the torso in Step 2., which comprises a sequence of lower-level minimanipulations to face the work (cutting) surface (2.a.), align the dual-arm system (2.b.) and return for the next step (2.c.). In the next Step 3., the Arm2 (the one not holding the utensil/knife), is commanded to align its hand (3.a.) for a larger-object grasp, approach the food item (3.b.; involves possibly moving all limbs and joints and wrist; 3.c.), and then move until contact is made (3.c.) and then push to hold the item with sufficient force (3.d.), prior to aligning the utensil (3.f.) to allow for cutting operations after a return (3.g.) and proceeding to the next step(s) (4. and so on).

The above example illustrates the process of building a minimanipulation routine based on simple sub-routine motions (themselves also minimanipulations) using both a physical entity mapping and a manipulation-phase approach which the computer can readily distinguish and parameterize using external/internal/interface sensory feedback data from the studio-recording process. This minimanipulation library building-process for process-parameters generates ‘parameter-vectors’ which fully describe a (set of) successful minimanipulation action(s), as the parameter vectors include sensory-data, time-histories for key variables as well as performance data and metrics, allowing a remote robotic replication system to faithfully execute the required task(s). The process is also generic in that it is agnostic to the task at hand (cooking, painting, etc.), as it simply builds minimanipulation actions based on a set of generic motion- and action-primitives. Simple user input and other pre-determined action-primitive descriptors can be added at any level to more generically describe a particular motion-sequence and to allow it to be made generic for future use, or task-specific for a particular application. Having minimanipulation datasets comprised of parameter vectors, also allows for continuous optimization through learning, where adaptions to parameters are possible to improve the fidelity of a particular minimanipulation based on field-data generated during robotic replication operations involving the application (and evaluation) of minimanipulation routines in one or more generic and/or task-specific libraries.

FIG. 2G is a block diagram illustrating examples of various minimanipulation data formats in the composition, linking and conversion of minimanipulation robotic behavior data. In composition, high-level MM behavior descriptions in a dedicated/abstraction computer programming language are based on the use of elementary MM primitives which themselves may be described by even more rudimentary MM in order to allow for building behaviors from ever-more complex behaviors.

An example of a very rudimentary behavior might be ‘finger-curl’, with a motion primitive related to ‘grasp’ that has all 5 fingers curl around an object, with a high-level behavior termed ‘fetch utensil’ that would involve arm movements to the respective location and then grasping the utensil with all five fingers. Each of the elementary behaviors (incl. the more rudimentary ones as well) have a correlated functional result and associated calibration variables describing and controlling each.

Linking allows for behavioral data to be linked with the physical world data, which includes data related to the physical system (robot parameters and environmental geometry, etc.), the controller (type and gains/parameters) used to effect movements, as well as the sensory-data (vision, dynamic/static measures, etc.) needed for monitoring and control, as well as other software-loop execution-related processes (communications, error-handling, etc.).

Conversion takes all linked MM data, from one or more databases, and by way of a software engine, termed the Actuator Control Instruction Code Translator & Generator, thereby creating machine-executable (low-level) instruction code for each actuator (A₁ thru Aₙ) controller (which themselves run a high-bandwidth control loop in position/velocity and/or force/torque) for each time-period (t₁ thru tₘ), allowing for the robot system to execute commanded instruction in a continuous set of nested loops.

FIG. 2H depicts a logical diagram of main action blocks in the software-module/action layer within the macro-manipulation and micro-manipulation subsystems and the associated minimanipulation libraries dedicated to each. The architecture of the software-module/action layer provides a framework that allows the inclusion of: (1) refined End effector sensing (for refined and more accurate real-world interface sensing); (2) introduction of the macro- (overall sensing by and from the articulated base) and micro- (local task-specific sensing between the end effectors and the task-/cooking-specific elements) tiers to allow continuous minimanipulation libraries to be used and updated (via learning) based on a physical split between coarse and fine manipulation (and thus positioning, force/torque control, product-handling and process monitoring); (3) distributed multi-processor architecture at the macro- and micro-levels; (4) introduction of the “0-Position” concept for handling any environment elements (tools, appliances, pans, etc.); (5) use of aids such as fixturing-elements and markers (structured targets, template-matching, virtual markers, RFID/IR/NFC markers, etc.) to increase speed and fidelity of docking/handling and improve minimanipulations; and (6) electronic inventorying system for tools and pots/pans as well as Utensil/Container/Ingredient storage and access.

The macro-/micro-distinctions provide differentiations on the types of minimanipulation libraries and their relative descriptors and improved and higher-fidelity learning results based on more localized and higher-accuracy sensory elements contained within the end effectors, rather than relying on sensors that are typically part of (and mounted on) the articulated base (for larger FoV, but thereby also lower resolution and fidelity when it comes to monitoring finer movements at the “product-interface” (where the cooking tasks mostly take place when it comes to decision-making).

The overall structure in FIG. 2H illustrates (a) using sensing elements to image/map the surroundings and then (b) create motion-plans based on primitives stored in minimanipulation libraries which are (c) translated into actionable (machine-executable) joint-/actuator-level commands (of position/velocity and/or force/torque), with (d) a feedback loop of sensors used to monitor and proceed in the assigned task, while (e) also learning from its execution-state to improve existing minimanipulation descriptors and thus the associated libraries. The elaboration on having macro- and micro-level actions based on macro- and micro-level sensory systems, at the articulated base and end effectors, respectively. The sensory systems then perform identical functions, but create and optimize descriptors and minimanipulations in separate minimanipulation databases, which are all merged into a single database that the respective systems draw from.

The macro-/micro-level split also allows: (1) presence and integration of sensing systems at the macro (base) and micro (end effector) levels (not to speak of the varied sensory elements one could list, such as cameras, lasers, haptics, any EM-spectrum based elements, etc.); (2) application of varied learning techniques at the macro- and micro levels to apply to different minimanipulation libraries suitable to different levels of manipulation (such as coarser movements and posturing of the articulated base using macro-minimanipulation databases, and finer and higher-fidelity configurations and interaction forces/torques of the respective end effectors using micro-minimanipulation databases), and each thus with descriptors and sensors better suited to execute/monitor/optimize said descriptors and their respective databases; (3) need and application of distributed and embedded processors and sensory architecture, as well as the real-time operating system and multi-speed buses and storage elements; (4) use of the “0-Position” method, whether aided by markers or fixtures, to aid in acquiring and handling (reliably and accurately) any needed tool or appliance/pot/pan or other elements; and (5) interfacing of an instrumented inventory system (for tools, ingredients, etc.) and a smart Utensil/Container/Ingredient storage system.

A multi-level robotic operational system, in this case one of a two-level macro- and micro-manipulation subsystem, comprising of a macro-level articulated and instrumented large workspace coarse-motion articulated and instrumented base 1710, connected to a micro-level fine-motion high-fidelity environment interaction instrumented EoA-tooling subsystem 1720, allows for position and velocity motion planners to provide task-specific motion commands through minimanipulation libraries 1730 at both the macro- and micro-levels (1731 and 1732, respectively). The ability to share feedback data and send and receive motion commands is only possible through the use of a distributed processor and sensing architecture 1750, implemented via a (distributed) real-time operating system interacting over multiple varied-speed bus interfaces 1740, taking in high-level task-execution commands from a high-level planner 1760, which are in turn broken down into separate yet coordinated trajectories for both the macro and micro manipulation subsystems.

The macro-manipulation subsystem instantiated by an instrumented articulated and controller-actuated articulated instrumented base 1710 requires a multi-element linked set of operational blocks 1711 thru 1716 to function properly. Said operational blocks rely on a separate and distinct set of processing and communication bus hardware responsible for the macro-level sensing and control tasks at the macro-level. In a typical macro-level subsystem said operational blocks require the presence of a macro-level command translator 1716, that takes in minimanipulation commands from a library 730 and its macro-level minimanipulation sublibrary 1731, and generates a set of properly sequenced machine-readable commands to a macro-level planning module 1712, where the motions required for each of the instrumented and actuated elements are calculated in at least the joint- and Cartesian-space. Said motion commands are sequentially fed to an execution block 1713, which controls all instrumented articulated and actuated joints in at least joint- or Cartesian space to ensure the movements track the commanded trajectories in position/velocity and/or torque/force. A feedback sensing block 1714 provides feedback data from all sensors to the execution block 1713 as well as an environment perception block/module 1711 for further processing. Feedback is not only provided to allow tracking the internal state of variables, but also sensory data from sensor measuring the surrounding environment and geometries. Feedback data from said module 1714 is used by the execution module 1713 to ensure actual values track their commanded setpoints, as well as an environment perception module 1711 to image and map, model and identify the state of each articulated element, the overall configuration of the robot as well as the state of the surrounding environment the robot is operating in. Additionally, said feedback data is also provided to a learning module 1715 responsible for tracking the overall performance of the system and comparing it to known required performance metrics, allowing one or more learning methods to develop a continuously updated set of descriptors that define all minimanipulations contained within their respective minimanipulation library 730, in this case the macro-level minimanipulation sublibrary 1731.

In the case of the micro-manipulation system instantiated by an instrumented articulated and controller-actuated articulated instrumented EoA-tooling subsystem 1720, the logical operational blocks described above are similar except that operations are targeted and executed only for those elements that form part of the micro-manipulation subsystem 620. Said instrumented articulated and controller-actuated articulated instrumented EoA-tooling subsystem 1720, requires a multi-element linked set of operational blocks 1721 thru 1726 to function properly. Said operational blocks rely on a separate and distinct set of processing and communication bus hardware responsible for the micro-level sensing and control tasks at the micro-level. In a typical micro-level subsystem said operational blocks require the presence of a micro-level command translator 1726, that takes in minimanipulation commands from a library 1730 and its micro-level minimanipulation sublibrary 1732, and generates a set of properly sequenced machine-readable commands to a micro-level planning module 1722, where the motions required for each of the instrumented and actuated elements are calculated in at least the joint- and Cartesian-space. Said motion commands are sequentially fed to an execution block 1723, which controls all instrumented articulated and actuated joints in at least joint- or Cartesian space to ensure the movements track the commanded trajectories in position/velocity and/or torque/force. A feedback-sensing block 1724 provides feedback data from all sensors to the execution block 1723 as well as a task perception block/module 1721 for further processing. Feedback is not only provided to allow tracking the internal state of variables, but also sensory data from sensors measuring the immediate EoA configuration/geometry as well as the measured process and product variables such as contact force, friction, interaction product state, etc. Feedback data from said module 1724 is used by the execution module 1723 to ensure actual values track their commanded setpoints, as well as a task perception module 1721 to image and map, model and identify the state of each articulated element, the overall configuration of the EoA-tooling as well as the type and state of the environment interaction variables the robot is operating in, as well as the particular variables of interest of the element/product being interacted with (as an example a paintbrush bristle width during painting or a the consistency and of egg whites being beaten or the cooking-state of a fried egg). Additionally, said feedback data is also provided to a learning module 1725 responsible for tracking the overall performance of the system and comparing it to known required performance metrics for each task and its associated minimanipulation commands, allowing one or more learning methods to develop a continuously updated set of descriptors that define all minimanipulations contained within their respective minimanipulation library 730, in this case the micro-level minimanipulation sublibrary 1732.

FIG. 2I depicts a block diagram illustrating the macro-manipulation and micro-manipulation physical subsystems and their associated sensors, actuators and controllers with their interconnections to their respective high-level and subsystem planners and controllers as well as world and interaction perception and modelling systems for minimanipulation planning and execution process. The hardware systems innate within each the macro- and micro-manipulation subsystems are reflected at both the macro-manipulation subsystem level through the instrumented articulated and controller-actuated articulated base 1310, and the micro-manipulation level through the instrumented articulated and controller-actuated end-of-arm (EoA) tooling 1320 subsystems. Both are connected to their perception and modelling systems 1330 and 1340, respectively.

In the case of the macro-manipulation subsystem 1310, a connection is made to the world perception and modelling subsystem 1330 through a dedicated sensor bus 1370, with the sensors associated with said subsystem responsible for sensing, modelling and identifying the world around the entire robot system and the latter itself, within said world. The raw and processed macro-manipulation subsystem sensor data is then forwarded over the same sensor bus 1370 to the macro-manipulation planning and execution module 1350, where a set of separate processors are responsible for executing task-commands received from the task minimanipulation parallel task execution planner 1430, which in turn receives its task commands from the high-level minimanipulation planner 1470 over a data and controller bus 1380, and controlling the macro-manipulation subsystem 1310 to complete said tasks based on the feedback it receives from the world perception and modelling module 1330, by sending commands over a dedicated controller bus 1360. Commands received through this controller bus 1360, are executed by each of the respective hardware modules within the articulated and instrumented base subsystem 1310, including the positioner system 1313, the repositioning single kinematic chain system 1312, to which are attached the head system 1311 as well as the appendage system 1314 and the thereto attached wrist system 1315.

The positioner system 1313 reacts to repositioning movement commands to its Cartesian XYZ positioner 1313a, where an integral and dedicated processor-based controller executes said commands by controlling actuators in a high-speed closed loop based on feedback data from its integral sensors, allowing for the repositioning of the entire robotic system to the required workspace location. The repositioning single kinematic chain system 1312 attached to the positioner system 1313, with the appendage system 1314 attached to the repositioning single kinematic chain system 1312 and the wrist system 1315 attached to the ends of the arms articulation system 1314a, uses the same architecture described above, where each of their articulation subsystems 1312a, 1314a and 1315a, receive separate commands to their respective dedicated processor-based controllers to command their respective actuators and ensure proper command-following through monitoring built-in integral sensors to ensure tracking fidelity. The head system 1311 receives movement commands to the head articulation subsystem 311a, where an integral and dedicated processor-based controller executes said commands by controlling actuators in a high-speed closed loop based on feedback data from its integral sensors.

The architecture is similar for the micro-manipulation subsystem. The micro-manipulation subsystem 1320, communicates with the product and process modelling subsystem 1340 through a dedicated sensor bus 1371, with the sensors associated with said subsystem responsible for sensing, modelling and identifying the immediate vicinity at the EoA, including the process of interaction and the state and progression of any product being handled or manipulated. The raw and processed micro-manipulation subsystem sensor data is then forwarded over its own sensor bus 1371 to the micro-manipulation planning and execution module 351, where a set of separate processors are responsible for executing task-commands received from the minimanipulation parallel task execution planner 1430, which in turn receives its task commands from the high-level minimanipulation planner 1470 over a data and controller bus 1380, and controlling the micro-manipulation subsystem 11320 to complete said tasks based on the feedback it receives from the product and process perception and modelling module 340, by sending commands over a dedicated controller bus 1361. Commands received through this controller bus 1361, are executed by each of the respective hardware modules within the instrumented EoA tooling subsystem 1320, including the hand system 1323 and the cooking-system 1322. The hand system 1323 receives movement commands to its palm and fingers articulation subsystem 1323a with its respective dedicated processor-based controllers commanding their respective actuators to ensure proper command-following through monitoring built-in integral sensors to ensure tracking fidelity. The cooking system 1322, which encompasses specialized tooling and utensils 1322a (which may be completely passive and devoid of any sensors or actuators or contain simply sensing elements without any actuation elements), is responsible for executing commands addressed to it, through a similar dedicated processor-based controller executing a high-speed control-loop based on sensor-feedback, by sending motion commands to its integral actuators. Furthermore, a vessel subsystem 1322b representing containers and processing pots/pans, which may be instrumented through built-in dedicated sensors for various purposes, can also be controlled over a common bus spanning between the hand system 1323 and the cooking system 1322.

FIG. 2J depicts a block diagram illustrating one embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems.

A high-level task executor 1500 provides a task description to the minimanipulation sequence selector 1510, that selects candidate action-primitives (elemental motions and controls) separately to the separate macro- and micro-manipulation subsystems 1410 and 1420 respectively, where said components are processed to yield a separate stack of commands to the minimanipulation parallel task execution planner 1430 that combines and checks them for proper functionality and synchronicity through simulation, and then forwards them to each of the respective macro- and micro-manipulation planner and executor modules 1350 and 1351, respectively.

In the case of the macro-manipulation subsystem, input data used to generate the respective minimanipulation command stack sequence, includes raw and processed sensor feedback data 460 from the instrumented base, environment perception and modelling data 1450 from the world perception modeller 1330. The incoming minimanipulation component candidates 1491 are provided to the macro minimanipulation database 1411 with its respective integral descriptors, which organizes them by type and sequence 1415, before they are processed further by its dedicated minimanipulation planner 1412; additional input to said database 1411 occurs by way of minimanipulation candidate descriptor updates 1414 provided by a separate learning process described later. Said macro manipulation subsystem planner 1412 also receives input from the minimanipulation progress tracker 1413, which is responsible to provide progress information on task execution variables and status, as well as observed deviations, to said planning system 1412. The progress tracker 1413 carries out its tracking process by comparing inputs comprising of the required baseline performance 1417 for each task-execution element with sensory feedback data 1460 (raw & processed) from the instrumented base as well as environment perception and modelling data 1450 in a comparator, which generates deviation data 1416 and process improvement data 1418 comprising of performance increases through descriptor variable and constant modifications developed by an integral learning system, back to the planner system 1412.

The minimanipulation planner system 1412 takes in all these input data streams 1416, 1418 and 415, and performs a series of steps on this data, in order to arrive at a set of sequential command stacks for task execution commands 1492 developed for the macro-manipulation subsystem, which are fed to the minimanipulation parallel task execution planner 1430 for additional checking and combining before being converted into machine-readable minimanipulation commands 1470 provided to each macro- and micro-manipulation subsystem separately for execution. The minimanipulation planner system 1412 generates said command sequence 1492, through a set of steps, including but not limited to nor necessarily in this sequence but also with possible internal looping, passing the data through: (i) an optimizer to remove any redundant or overlapping task-execution timelines, (ii) a feasibility evaluator to verify that each sub-task is completed according a to a given set of metrics associated with each subtask, before proceeding to the next subtask, (iii) a resolver to ensure no gaps in execution-time or task-steps exist, and finally (iv) a combiner to verify proper task execution order and end-result, prior to forwarding all command arguments to (v) the minimanipulation command generator that maps them to the physical configuration of the macro-manipulation subsystem hardware.

The process is similar for the generation of the command-stack sequence of the minimanipulation subsystem 1420, with a few notable differences identified in the description below. As above, input data used to generate the respective minimanipulation command stack sequence for the micro-manipulation subsystem, includes raw and processed sensor feedback data 1490 from the EoA tooling, product process and modelling data 1480 from the interaction perception modeller 340. The incoming minimanipulation component candidates 1492 are provided to the micro minimanipulation database 1421 with its respective integral descriptors, which organizes them by type and sequence 1425, before they are processed further by its dedicated minimanipulation planner 1422; additional input to said database 1421 occurs by way of minimanipulation candidate descriptor updates 1424 provided by a separate learning process described previously and again below. Said micro manipulation subsystem planner 1422 also receives input from the minimanipulation progress tracker 1423, which is responsible to provide progress information on task execution variables and status, as well as observed deviations, to said planning system 1422. The progress tracker 1423 carries out its tracking process by comparing inputs comprising of the required baseline performance 1427 for each task-execution element with sensory feedback data 1490 (raw & processed) from the instrumented EoA-tooling as well as product and process perception and modelling data 1480 in a comparator, which generates deviation data 1426 and process improvement data 1428 comprising of performance increases through descriptor variable and constant modifications, developed by an integral learning system, back to the planner system 1422.

The minimanipulation planner system 1422 takes in all these input data streams 1426, 1428 and 1425, and performs a series of steps on this data, in order to arrive at a set of sequential command stacks for task execution commands 1493 developed for the micro-manipulation subsystem, which are fed to the minimanipulation parallel task execution planner 1430 for additional checking and combining before being converted into machine-readable minimanipulation commands 1470 provided to each macro- and micro-manipulation subsystem separately for execution. AS for the macro-manipulation subsystem planning process outlined for 1412 before, the minimanipulation planner system 11422 generates said command sequence 1493, through a set of steps, including but not limited to nor necessarily in this sequence but also with possible internal looping, passing the data through: (i) an optimizer to remove any redundant or overlapping task-execution timelines, (ii) a feasibility evaluator to verify that each sub-task is completed according a to a given set of metrics associated with each subtask, before proceeding to the next subtask, (iii) a resolver to ensure no gaps in execution-time or task-steps exist, and finally (iv) a combiner to verify proper task execution order and end-result, prior to forwarding all command arguments to (v) the minimanipulation command generator that maps them to the physical configuration of the macro-manipulation subsystem hardware.

FIG. 2K depicts the process by which minimanipulation command-stack sequences are generated for any robotic system, in this case deconstructed to generate two such command sequences for a single robotic system that has been physically and logically split into a macro- and micro-manipulation subsystem, which provides an alternate approach to FIG. 2J. The process of generating minimanipulation command-stack sequences for any robotic system, in this case a physically and logically split macro- and micro-manipulation subsystem receiving dedicated macro- and micro-manipulation subsystem command sequences 1491 and 1492, respectively, requires multiple processing steps be executed, by a minimanipulation action-primitive (AP) components selector module 1510, on high-level task-executor commands 1550, combined with input utilizing all available action-primitive alternative (APA) candidates 1540 from an AP-repository 1520.

The AP-repository is akin to a relational database, where each AP described as AP₁ through AP. (1522, 1523, 1526, 1527) associated with a separate task, regardless of the level of abstraction by which the task is described, comprises of a set of elemental APᵢ-subblocks (APSB₁ through APSBₘ; 1522a_{1->m}, 1523a_{1->m}, 1526a_{1->m}, 1527a_{1->m}) which can be combined and concatenated in order to satisfy task-performance criteria or metrics describing task-completion in terms of any individual or combination of such physical variables as time, energy, taste, color, consistency, etc.. Hence any complexity of task can be described through a combination of any number of AP-alternatives (APAₐ through APA_{z}; 1521, 1525), which could result in the successful completion of a specific task, well understanding that there is more than a single APAᵢ that satisfies the baseline performance requirements of a task, however they may be described.

The minimanipulation AP components sequence selector 1510 hence uses a specific APA selection process 1513 to develop a number of potential APA_{a thru z} candidates from the AP repository 520, by taking in the high-level task executor task-directive 1540, processing it to identify a sequence of necessary and sufficient sub-tasks in module 1511, and extracting a set of overall and subtask performance criteria and en-states for each sub-task in step 1512, before forwarding said set of potentially viable APs for evaluation. The evaluation process 1514 compares each APAᵢ for overall performance and en-states along any of multiple stand-alone or combined metrics developed previously in 1512, including such metrics as time required, energy-expended, workspace required, component reachability, potential collisions, etc. Only the one APAᵢ that meets a pre-determined set of performance metrics is forwarded to the planner 1515, where the required movement profiles for the macro- and micro manipulation subsystems are generated in one or more movement spaces, such as joint- or Cartesian-space. Said trajectories are then forwarded to the synchronization module 1516, where said trajectories are processed further by concatenating individual trajectories into a single overall movement profile, each actuated movement s synchronized in the overall timeline of execution as well as with its preceding and following movements, and combined further to allow for coordinated movements of multi-arm/-limb robotic appendage architectures. The final set of trajectories are then passed to a final step of minimanipulation generation 1517, where said movements are transformed into machine-executable command-stack sequences that define the minimanipulation sequences for a robotic system. In the case of a physical or logical separation, command-stack sequences are generated for each subsystem separately, such as in this case for the macro-manipulation subsystem command-stack sequence 491 and the micro-manipulation subsystem command-stack sequence 1492.

FIG. 2L depicts a block diagram illustrating another embodiment of the physical layer structured as a macro-manipulation/micro-manipulation.

The hardware systems innate within each the macro- and micro-manipulation subsystems are reflected at both the macro-manipulation subsystem level through the instrumented articulated and controller-actuated articulated base 1810, and the micro-manipulation level through the instrumented articulated and controller-actuated humanoid-like appendages 1820 subsystems. Both are connected to their perception and modelling systems 1830 and 1840, respectively.

In the case of the macro-manipulation subsystem 1810, a connection is made to the world perception and modelling subsystem 1830 through a dedicated sensor bus 1870, with the sensors associated with said subsystem responsible for sensing, modelling and identifying the world around the entire robot system and the latter itself, within said world. The raw and processed macro-manipulation subsystem sensor data is then forwarded over the same sensor bus 1870 to the macro-manipulation planning and execution module 1850, where a set of separate processors are responsible for executing task-commands received from the task minimanipulation parallel task execution planner 1430, which in turn receives its task commands from the high-level minimanipulation task/action parallel execution planner 1470 over a data and controller bus 1880, and controlling the macro-manipulation subsystem 1810 to complete said tasks based on the feedback it receives from the world perception and modelling module 1830, by sending commands over a dedicated controller bus 1860. Commands received through this controller bus 1860, are executed by each of the respective hardware modules within the articulated and instrumented base subsystem 1810, including the positioner system 1813, the repositioning single kinematic chain system 1812, to which is attached the central control system 1811.

The positioner system 1813 reacts to repositioning movement commands to its Cartesian XYZ positioner 1813a, where an integral and dedicated processor-based controller executes said commands by controlling actuators in a high-speed closed loop based on feedback data from its integral sensors, allowing for the repositioning of the entire robotic system to the required workspace location. The repositioning single kinematic chain system 1812 attached to the positioner system 1813, uses the same architecture described above, where each of their articulation subsystems 1812a and 1813a, receive separate commands to their respective dedicated processor-based controllers to command their respective actuators and ensure proper command-following through monitoring built-in integral sensors to ensure tracking fidelity. The central control system 1811 receives movement commands to the head articulation subsystem 1811a, where an integral and dedicated processor-based controller executes said commands by controlling actuators in a high-speed closed loop based on feedback data from its integral sensors.

The architecture is similar for the micro-manipulation subsystem. The micro-manipulation subsystem 1820, communicates with the interaction perception and modeller subsystem 1840 responsible for product and process perception and modelling, through a dedicated sensor bus 1871, with the sensors associated with said subsystem responsible for sensing, modelling and identifying the immediate vicinity at the EoA, including the process of interaction and the state and progression of any product being handled or manipulated. The raw and processed micro-manipulation subsystem sensor data is then forwarded over its own sensor bus 1871 to the micro-manipulation planning and execution module 1851, where a set of separate processors are responsible for executing task-commands received from the minimanipulation parallel task execution planner 1430, which in turn receives its task commands from the high-level minimanipulation planner 1470 over a data and controller bus 1880, and controlling the micro-manipulation subsystem 1820 to complete said tasks based on the feedback it receives from the interaction perception and modelling module 1840, by sending commands over a dedicated controller bus 1861. Commands received through this controller bus 1861, are executed by each of the respective hardware modules within the instrumented EoA tooling subsystem 1820, including the one or more single sinematic chain system 1823, to which is attached the wrist system 1825, to which in turn is attached the hand-/end-effector system 1823, allowing for the handling of the thereto attached cooking-system 1822. The single kinematic chain system contains such elements as one or more limbs/legs and/or arms subsystems 1824a, which receive commands to their respective elements each with their respective dedicated processor-based controllers commanding their respective actuators to ensure proper command-following through monitoring built-in integral sensors to ensure tracking fidelity. The wrist system 1825 receives commands passed through the single kinematic chain system 1824 which are forwarded to its wrist articulation subsystem 1825a with its respective dedicated processor-based controllers commanding their respective actuators to ensure proper command-following through monitoring built-in integral sensors to ensure tracking fidelity. The hand system 1823 which is attached to the wrist system 1825, receives movement commands to its palm and fingers articulation subsystem 1823a with its respective dedicated processor-based controllers commanding their respective actuators to ensure proper command-following through monitoring built-in integral sensors to ensure tracking fidelity. The cooking system 1822, which encompasses specialized tooling and utensil subsystem 1822a (which may be completely passive and devoid of any sensors or actuators or contain simply sensing elements without any actuation elements), is responsible for executing commands addressed to it, through a similar dedicated processor-based controller executing a high-speed control-loop based on sensor-feedback, by sending motion commands to its integral actuators. Furthermore, a vessel subsystem 822b representing containers and processing pots/pans, which may be instrumented through built-in dedicated sensors for various purposes, can also be controlled over a common bus spanning from the single kinematic chain system 1824, through the wrist system 1825 and onwards through the hand/effector system 1823, terminating (whether through a hardwired or a wireless connection type) in the operated object system 1822.

FIG. 2M depicts a block diagram illustrating another embodiment of an architecture for multi-level generation process of minimanipulations and commends based on perception and model data, sensor feedback data as well as minimanipulation commands based on action-primitive components, combined and checked prior to being furnished to the minimanipulation task execution planner responsible for the macro- and micro manipulation subsystems. As tends to be the case with manipulation system, particularly those requiring substantial mobility over larger workspaces while still needing appreciable endpoint motion accuracy, as is shown in this alternate embodiment in FIG. 2M, they can be physically and logically subdivided into a macro-manipulation subsystem comprising of a large workspace positioner 1940, coupled with an articulated body 1942 comprising multiple elements 1910 for coarse motion, and a micro-manipulation subsystem 1920 utilized for fine motions, physically joined and interacting with the environment 1938, which may contain multiple elements 1930.

For larger workspace applications, where the workspace exceeds that of a typical articulated robotic system, it is possible to increase the systems' reach and operational boundaries by adding a positioner, typically capable of movements in free-space, allowing movements in XYZ (three translational coordinates) space, as depicted by 1940 allowing for workspace repositioning 1943. Such a positioner could be a mobile wheeled or legged base, aerial platform, or simply a gantry-style orthogonal XYZ positioner, capable of positioning an articulated body 1942. Such an articulated body 1942 targeted at applications where a humanoid-type configuration is one of the possible physical robot instantiations, said articulated body 1942 would describe a physical set of interlinked elements 1910, comprising of upper-extremities 1917 and lower-extremities 1917a. Each of these interlinked elements within the macro-manipulation subsystem 1910 and 1940 would consist of an instrumented articulated and controller-actuated sub-elements, including a head 1911 replete with a variety of environment perception and modelling sensing elements, connected to an instrumented articulated and controller-actuated shouldered torso 1912 and an instrumented articulated and controller-actuated waist 1913. The waist 1913 may also have attached to its mobility elements such as one or more legs, or even articulated wheels, in order to allow the robotic system to operate in a much more expanded workspace. The shoulders in the torso can have attachment points for minimanipulation subsystem elements in a kinematic chain described further below.

A micro-manipulation subsystem 1920 physically attached to the macro-manipulation subsystem 1910 and 1940, is used in applications where fine position and/or velocity trajectory-motions and high-fidelity control of interaction forces/torques is required, that a macro-manipulation subsystem 1910, whether coupled to a positioner 1940 or not, would not be able to sense and/or control to the level required for a particular domain-application. The micro-manipulation subsystem 1920 comprises of shoulder-attached linked appendages 1916, such as one (typically two) or more instrumented articulated and controller-actuated jointed arms 1914 to each of which would be attached an instrumented articulated and controller-actuated wrist 1918. It is possible to attach a variety of instrumented articulated and controller-actuated end-of-arm (EoA) tooling 1925 to said mounting interface(s). While a wrist 1918 itself can be an instrumented articulated and controller-actuated multi-degree-of-freedom (DoF; such as a typical three-DoF rotation configuration in roll/pitch/yaw) element, it is also the mounting platform to which one may choose to attach a highly dexterous instrumented articulated and controller-actuated multi-fingered hand including fingers with a palm 1922. Other options could also include a passive or actively controllable fixturing-interface 1923 to allow the grasping of particularly designed devices meant to mate to the same, many times allowing for a rigid mechanical and also electrical (data, power, etc.) interface between the robot and the device. The depicted concept need not be limited to the ability to attach fingered hands 1922 or fixturing devices 1923, but potentially other devices 924, through a process which may include rigidly anchoring them to the surface, or even other devices.

The variety of end effectors 1926 that can form part of the micro-manipulation subsystem 920 allow for high-fidelity interactions between the robotic system and the environment/world 1938 by way of a variety of devices 1930. The types of interactions depend on the domain application 1939. In the case of the domain application being that of a robotic kitchen with a robotic cooking system, the interactions would occur with such elements as cooking tools 1931 (whisks, knives, forks, spoons, whisks, etc.), vessels including pots and pans 1932 among many others, appliances 1933 such as toasters, electric-beater or—knife, etc., cooking ingredients 1934 to be handled and dispensed (such as spices, etc.), and even potential live interactions with a user 1935 in case of required human-robot interactions called for in the recipe or due to other operational considerations.

FIG. 2N depicts one of a myriad number of possible decision trees that may be used to decide on a macro-/micro-logical and physical breakdown of a system for the purpose of high fidelity control. Potential decision types 1010 in diagram 1000, can include the a-priori type 1020 which are made before or during the design of the hardware and software of the system and are thus by default fixed and static and can not be changed during the operation of the system, or the continuous type 1030, where a supervisory software module monitoring various criteria could make decisions as to where the changing demarcation line of macro-vs-micro structure should be drawn.

In the case of the a-priori method 1020, the decision could be based on design constraints 1021, which may be dictated by the physical layout or configuration 1021a of a robotic system, or the computation architecture and capability 1021b of the processing system responsible for its planning and control tasks. Rather or better yet in addition to basing a decision on design constraints 1021, the decision could be reached through a simulation system, which would allow the study of its constraints 1022 off-line and beforehand, in order to decide on the macro-vs-micro boundaries location based on the capabilities of various inverse kinematic (IK) solvers or algorithms and their associated complexity 1022a, as the ultimate goal is to have the system planner and controller operate in real time using deterministic solutions at each time-step.

The use of a dynamic decision process 1030 capable of re-drawing the logical separation of the macro and micro manipulation subsystems, potentially ranging from each domain application to each task or even down to every time-step, would allow for as-optimal as possible a solution to operate a complex robotic system consisting of multiple kinematic elements arranged individually or as chains, in as effective a manner as possible. Such processes could include evaluation of criteria such as real-time operations 1031, energy consumption or extent of required movements 1032 at each time-step or (sub-)task, the expected (sub-)task execution time 1033, or other alternate criteria subjected to a real-time minimization/maximization technique 1034.

Real-time operations 1031 could be based on a software module looking ahead one or more time-steps or even at the sub-task or complete-task level, to evaluate which logical macro-/micro boundary configuration is capable to rune in real-time and specifically, which boundary configuration or dynamically configured boundary lines minimize real-time computations and guarantee real-time operations. Another approach, whether run as a stand-alone or in combination with any of the processes 1031, 1033 or 1034, could evaluate the required energy or movement extent (as measured by total distance travelled by each articulated element) at various levels such as at each time-step or at the s-task or full-task level in a look-ahead manner, to again decide which potentially continually altered sequence of macro-/micro-manipulation logical boundary should be utilized to minimize total energy expended and/or minimiaze overall motions. Yet another approach, whether run as a stand-alone or in combination with any of the processes 1031, 1032 or 1034, could evaluate also in a look-ahead manner, which of a subset of feasible macro-/micro-boundary configurations could minimize overall (sub-)task execution times, and deciding on the one or combinations of boundary configurations, that minimize sub-task or overall task execution time. And another possible approach, whether run as a stand-alone or in combination with any of the processes 1031, 1032 or 1033, could maximize or minimize any single or combination of criteria of importance to the application domain and its dedicated tasks, in order to decide on which potentially changeable macro-/micro-manipulation boundary to implement to allow for the most optimal operation of the robotic system.

FIG. 2O is a block diagram illustrating an example of a macro manipulation (also referred to as macro minimanipulation) of a stir process with todo parameters divided into (or composed of) multiple micro manipulations. FIG. 2P is a flow diagram illustrating the process of a macro/micro manager in allocating one or more macro manipulations and one or more micro manipulations. In this example, there are five manipulations: 2, 3, 4, 5, 6. When the macro manipulation is sent to the execution module, all the micro manipulations contained are executed in sequence. The micro manipulations 2 and 6 are hardcoded in the macro manipulation: they are always present. The micro-manipulations 3, 4, 5 are dynamically generated by the software module MacroMicroManager 7. First, the MacroMicroManager, analyzes (8) the incoming manipulation. Next, the MacroMicroManager generates (9) all dynamic micro manipulations based on the previous analysis. Then, the MacroMicroManager sets (10) the parameters for each micro manipulation, based on the macro manipulation parameters. The dynamically generated micro manipulations can be of any number N, in this example N=3. Before the execution the robot posture 11 is with the spoon in one hand and any other hand empty. In the micro manipulation (also referred to as micro minimanipulation) 2, the robot moves to a specific pre-defined posture (Robotic multi joints apparatus Joint State Pose) 12 positioning the utensil inside the cookware. In each of the dynamically generated micro manipulations (3, 4, 5, 6) the robot starts from the posture 12, stirs with spoon inside the cookware, performing a trajectory which ends exactly at the same pre-stored posture 12. In the micro manipulation 6, the robot starts with the posture 12, moves the spoon away from the cookware configuring itself to the macro ap posture 11. Before the execution of the macro-manipulation, the system checks the area of operation, defined inside the macro-manipulation, to ensure only the expected objects are in this area and also in the correct position wrt a specific robot part (usually the robot base or the arm base, depending on the instrumental environment (kitchen embodiment). In one embodiment the micro-manipulation 2 moves the robot from posture 11 to posture 12 using a pre-stored joint trajectory, which moves one arm to bring the spoon in the cookware and the other arm and hand to grasp the cookware and hold it firmly, the micro-manipulation 3 moves the robot from posture 2 to the same posture 2 using a pre-stored joint trajectory (for example stirring trajectory cycle, as a round stirring, forward/backward stirring cycle, fast/slow stirring cycle), by moving mostly the arm which holds the spoon. Starting and ending in the same posture 2 allows the robot to execute again next joint trajectory (same or different) which starting and ending by predefined posture 2 multiple times without discontinuities between each trajectory, without requiring a motion planning between them, so all the micro-manipulations generated dynamically (3,4,5) in this stirring example use the same pre-stored joint trajectory. The last micro-manipulation 6 moves the robot from posture 12 to posture 11, using a pre-stored joint trajectory which moves the spoon with one arm and releases the cookware with the other arm and hand. So the overall macro manipulation execution starts and ends with the defined or same robot posture 11 if the robot holds the same object by the same end effector. To make robotics control system more robust and reliable, the structure of manipulations is simplified by defining each initial and final posture of the robot for associated manipulation as a one or limited numbers predefined postures with the held objects combination. As an example for two arm robotic arms and corresponding two end effectors with shared shoulder joint, the following can be defined: one posture for two empty end effectors, one posture for spatula held in right end effector and empty left end effector, one posture of held pasta pot cookware by left and right end effectors, etc. In this case each minimanipulation starts and finishes by only one (or limited numbers) of robotic apparatus postures that give the opportunity to execute a sequence of minimanipulations without additional robotic apparatus risky reconfiguration procedure. Before each macro or micro minimanipulation execution processor checks the potential collisions with regards of robotic apparatus minimanipulation motion versus current Virtual World state. In case, a processor finds the collision, another version of the same macro or micro minimanipulation should be applied or new motion and cartesian plan could be generated and validated. As a simple example, the MicroMacroManager 7 generated only 3 stirring mini-manipulations (3,4,5) based on the parameters in the macro-manipulations (example parameter:stirring duration) but in other executions, with different parameters, the number of stir iterations could have been less or more.

During all macro/micro manipulations, the system can get and store real time data 16 automatically or on demand (by user request). These data may contain information about robot status, executed macro-manipulations 16, 1, 17, execute micro-manipulations 2, 3, 4, 5, 6, objects 18, ingredients 19, sensors 13, smart appliances 15, and any other parameters to store in retrieve from Virtual World model 14. For each object or ingredient the data processed includes shape, size, weight, smell, temperature, texture, colour, dimension, position and orientation wrt robot or the kitchen structure. For each manipulation the data stored or retrieved may include: execution start time, duration, delay before/after manipulation, meta-parameters which customize the specific manipulation, level of success of the particular operation. The system continuously updates the virtual world model 14 based on the outcome of each manipulation, example: when executing a manipulation called ‘pour completely the ingredient I from the container X into the cookware Y’, the system stores that ingredient I is now located inside cookware Y and the container X is empty. Some objects in Virtual World can have also additional descriptors and flags, for example object can have list of ingredients inside, or been dirty/clean, or empty/half empty/full, or appliance battery can have low energy, or oven can have aspecific error during operation execution, or object and be covered by lid. Any of these additional objects specific parameters regularly updated in the virtual instrumented environment (kitchen or other) world in accordance with their current state in the corresponded physical instrumental environment world.

FIG. 3A depicts robotic kitchen 10 in user operating mode which is completely compatible with human user. Gantry system 12 and robot 20 is not powered and in resting position. User 40 operating cooking zone, hob 16 particularly.

FIG. 3A depicts safeguard 40 in upper position, compatible with user.

FIG. 3C depicts different subsystems which are enabling user to user the kitchen in guided recipe execution. Vision system 32 which has multiple function in user mode. For instance, it is monitoring the state of the ingredient while cooking, it can perform recipe recording action, enabling user to record his movements and save it as the recipe for further execution. GUI touchscreen 41 is central part of user interaction with robotic kitchen, he is enabled to control and observe virtual kitchen model, program the recipes and more. There is a tool storage 42 in the robotic kitchen which is responsible for storing cooking equipment.

FIG. 3D depicts robot 20 is safely parked inside robot storage area 45, behind automated doors 43 which are opening and closing automatically by system command.

FIG. 3E depicts situation when robot 20 is activated, doors 43 are opening to allow it to travel inside the kitchen workspace 46.

FIG. 3E depicts the automated robot doors mechanism. When robot is not active, the doors are interlocked 47, making sure that user is not able to open those doors. Linear actuators 48 which can be of any type (hydraulic, pneumatic, electric etc.) are providing the required motion for moving the doors along the guide systems 49 which have specific shape and type to make sure doors are flushed with the panel structure after closing. Profile supports 50 and sheet metal supports 51a 51b are creating the structure

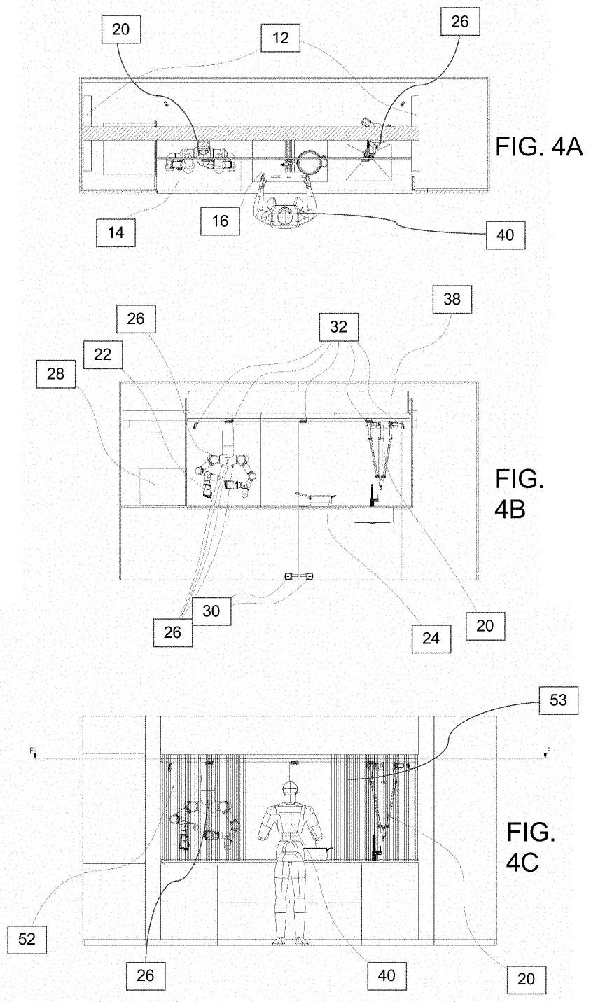

FIG. 4A depict robotics kitchen in collaborative operating mode “robot 1” 20, example “robot n” 26 are working with human user 40 in collaboration, user is visible operating the hob 16. gantry systems 12 are enabled, however they are running in a special safety mode.

FIG. 4B depict safeguard 38 is in upper position and there are number of sensors 30 which are indicating user position in the kitchen so robots are not able to harm him. A There are cameras 32 which are also acquiring the position of the user and feeding back to robot control system. Sensors in the feet level of the system 30 can be different types i.e. laser scanners, radar technology-based scanners or any type of other sensor able to indicate user position are acquiring the position of the human user and feeding back to the system to ensure safety operation.

FIG. 4C depicts light curtains safety scanning system 52 53 which are enabling the system to zone operations between human user 40 and robots 20 26.

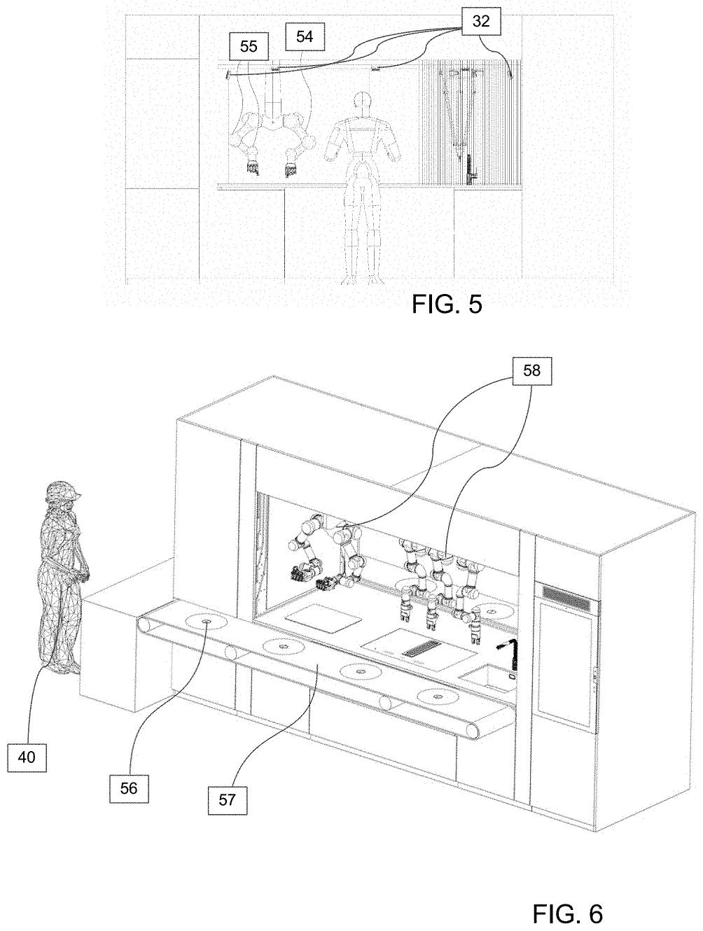

FIG. 5 depicts robot which is equipped with collaborative and sterile sleeves 54 and impact prevention bumpers 55. They are generating safety signal when they are in collision with any surface. Bumpers 55 also have soft cushioned impact safety mechanism, which is crucial in case of unlike failure mode crash. Sleeves are also made from clean room material and they are also sterile indicator, vision system 32 can detect if they are not sterile, they are also flexible and easy to exchange.

FIG. 6 depicts human robot collaborative station with autonomous conveyor belt system 57, with ability to transport prepared food to the human 40 or raw ingredients to the robotic system 58. Conveyor belt system has presence detection sensors 56 which indicates presence and type placed item and transports it accordingly to desired place using conveyor belt system 56.

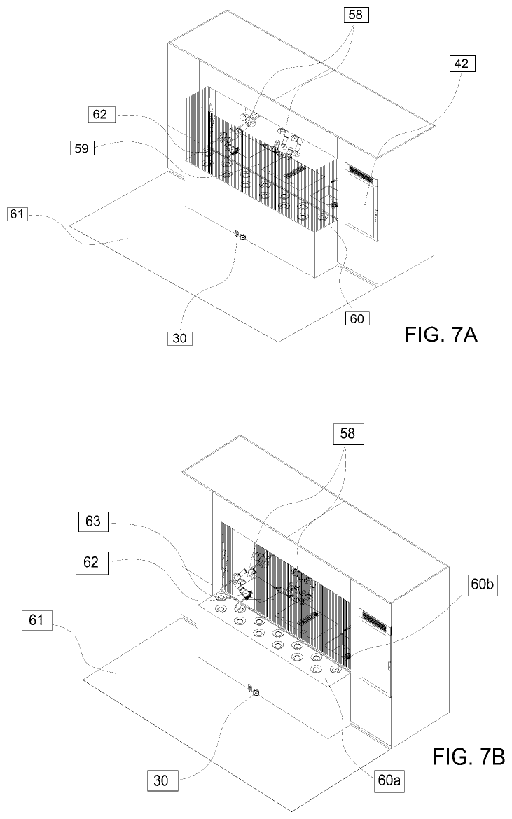

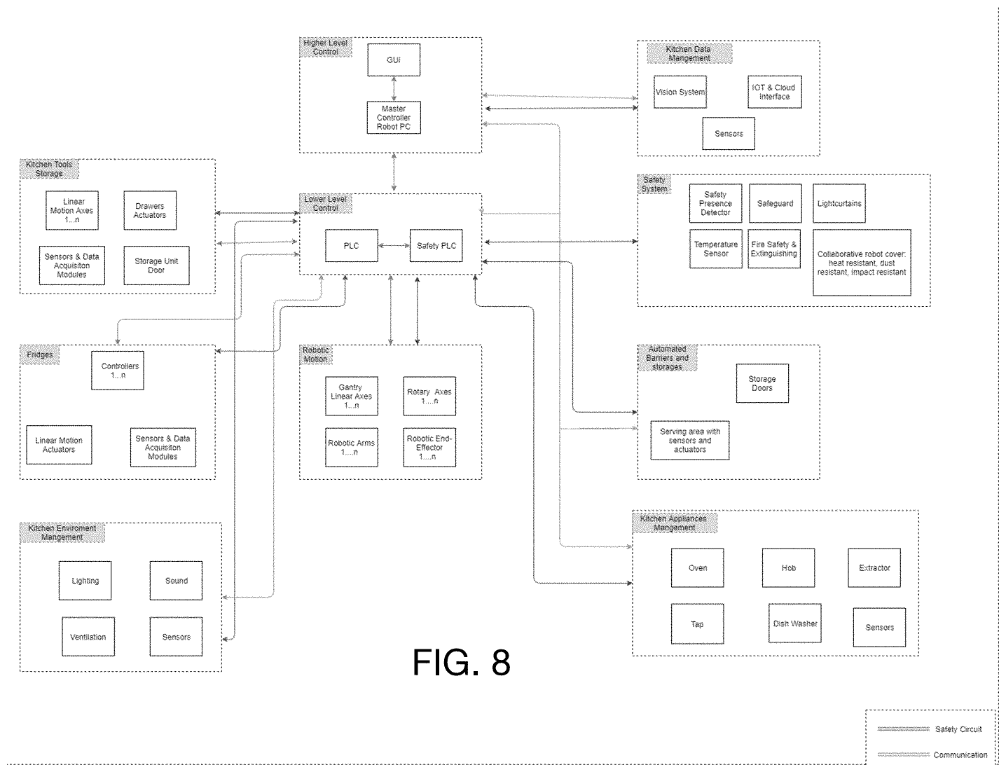

FIG. 7A depicts stationary collaborative station. The station has multiple sensors to ensure safety collaboration between human and robot 58. Among other there is safety scanner 30 which is able to detect position of the human, safety matt 61 which gets the signal once human steps to the potential hazardous environment and external light curtain zoning system 59, which automatically detects if user has entered potential dangerous environment, called common operating environment 60. The main collaborative feature in this setup is the fact, that robot is physically unable to reach human user, maximum extended position of the arms 62 is visible on the drawing. User can use GUI 42 to control the system.

FIG. 7B depicts stationary collaborative station. The station has multiple sensors to ensure safety collaboration between human and robot 58. Among other there is safety scanner 30 which is able to detect position of the human, safety matt 61 which gets the signal once human steps to the potential hazardous environment and internal light curtain zoning system 63, which automatically detects if robot has entered potential dangerous environment, called common operating environment 60. The main collaborative feature in this setup is the fact, that robot is physically unable to reach human user, maximum extended position of the arms 62 is visible on the drawing. User can use GUI 42 to control the system.

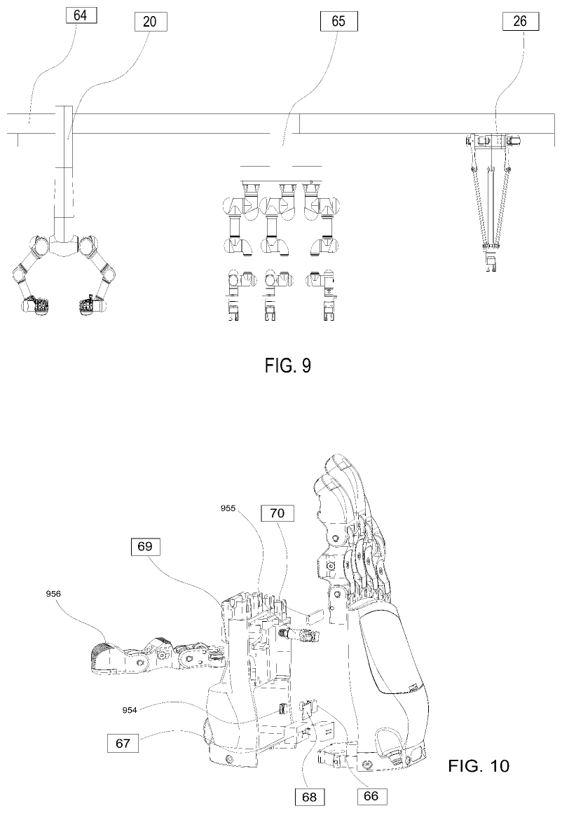

FIG. 9 depicts example robotic carriages systems. Carriages are mounted on linearly actuated gantry. Dual arms 20, multiple manipulator structure 65 or delta robot 26 are used as an example of robotic systems.

FIG. 10 depicts robotic hand comprised with vision system 66 and has the ability to perform visual surveying operations as well as visual object recognition operations. This allows the system to determine ID of object before grasping, another way of determining object type and ID is by using barcode scanner 67 and RFID tag reader 68, however, in this scenario objects needs to be tagged. Hand also comprises of LED light 69, which can enlighten the environment for the purpose of better performing vision system 66 if such operation would be required due to lightning conditions inside operating environment. Hands also compromises UV light 70 indicators which have ability to sterilize certain areas or objects precisely, with direct operational success feedback from vision system 66.

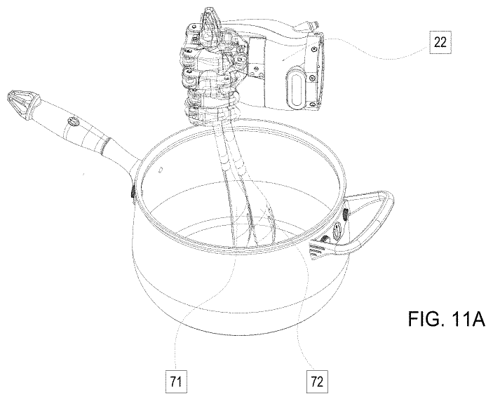

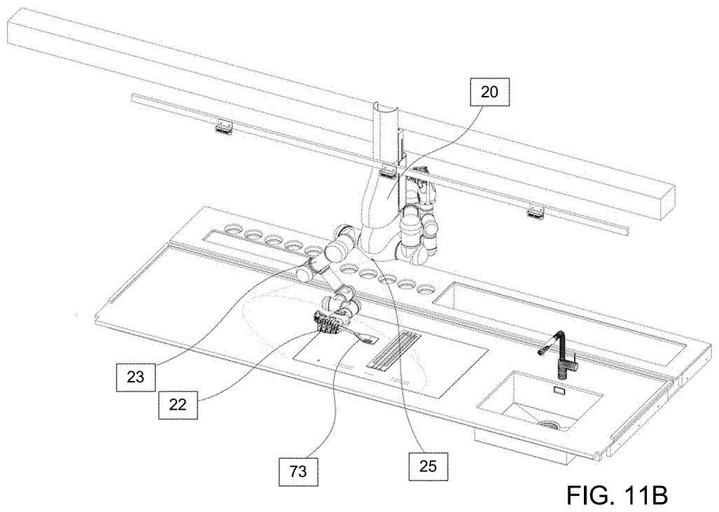

FIG. 11A depicts regrasping sequence procedure. Visible example robotic operation (stirring) which could potentially affect the initial position 71 of the operation tool. After performing the stirring operation object position is displaced 72 in regard to initial position 71. Each robotic hand finger has motors with constant position feedback. When object is displaced, finger position reading is affected. After receiving different reading, motors are automatically trying to reach initial commanded position. This way, displaced object 72 is coming back to initial position 71. Regrasping sequence outcome can be validated with vision system inside the kitchen.

FIG. 11B depicts essential part required for robot operation is a robot carriage 20 vision system 25 it is allowing to develop understanding about the environment around the carriage. Main functionality of this system is to do the object grasp validation. After the grasp operation is performed, robot would go to standard arm configuration 23 where the grasped object 73 would be visible to the camera 25. Then vision system would recognize grasped object and its exact position in relation to the hand 22. System acknowledges geometry of the grasp and cartesian position and orientation of the objects tip, which is crucial for the execution. In this scenario the system could recalculate the motion planning in cartesian library based on this data, and get rid of possible error, cause by slight grasp inaccuracy. It could also add the offset point to execution commands in joint state library execution. Shift on different axis and orientation would be compensated on different actuated axis.

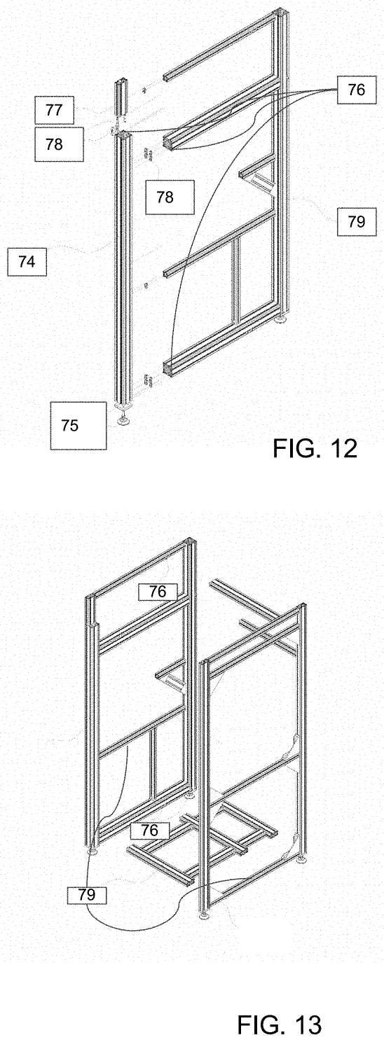

FIG. 12 depicts kitchen frame assembly procedure. Frame is the skeleton of the robotic kitchen system. Important factor of successful operation is the ability to rely on certain accuracy and repeatability of the physical model. Reliable and repeatable assembly process of the frame is crucial. Parts of the frame 74 are interfaced to another elements 77 with the help of the fasteners 78. There is in only one way to interface the elements one to another, through high precision machined inserts/drilled holes 76. There are feets 75 to adjust the height to required height.

FIG. 13 depicts how the pre assembled kits of the frames are assembled on the final stage one way of connecting the kits 79 with precision interfaces 76 using special fasteners enables reliable, repeatable and robust connection, with high accuracy that can be relied on. The main value in this assembly technique is the repeatability and ease of scaling up the product of the machines that have the same geometry. In this case pretested execution trajectory are valid in all units that have been manufactured and do not need to be retested on each kitchen.

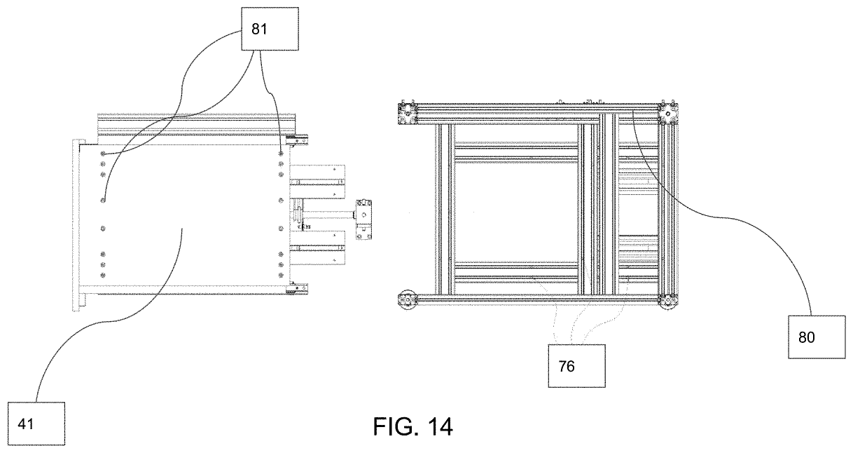

FIG. 14 depicts interfacing technique between the frame and subsystems. Frame 80 is the base for all subsystems like tool storage 41 inside the robotics kitchen. Interfaces of the subsystems 81 are always high precision machined, even if the entire construction of the subsystem is not (i.e. construction is a piece of furniture, however it would have metal mounting plate with high precision interface), and they are interfaced to high precision interfaces on the frame 76. High accuracy and repeatability inside the system is ensured, there is no chance of misplacing components and risking inaccuracy in the physical model.

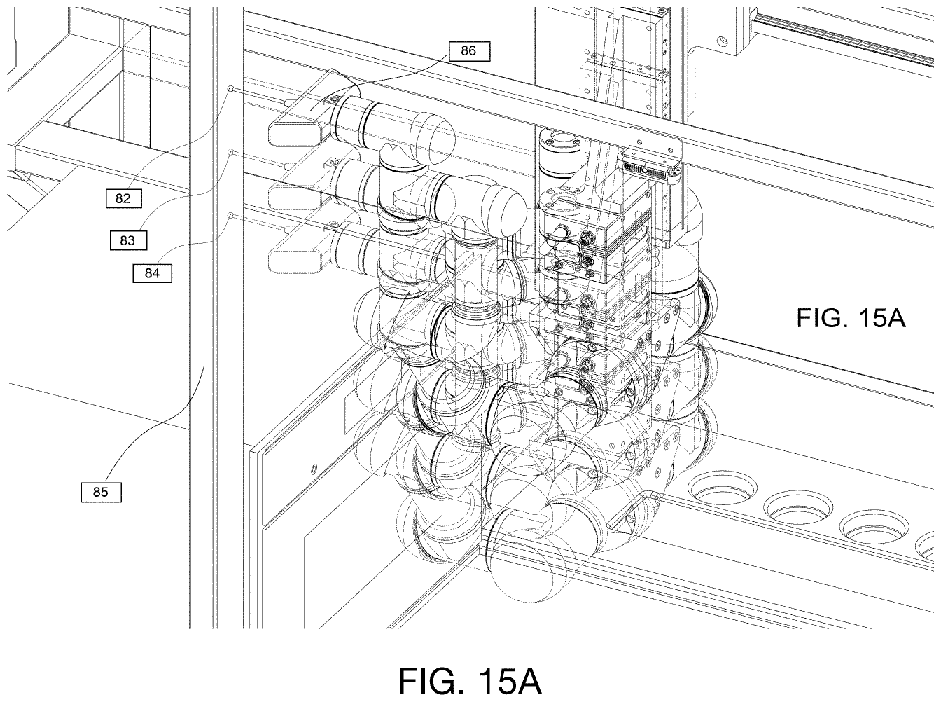

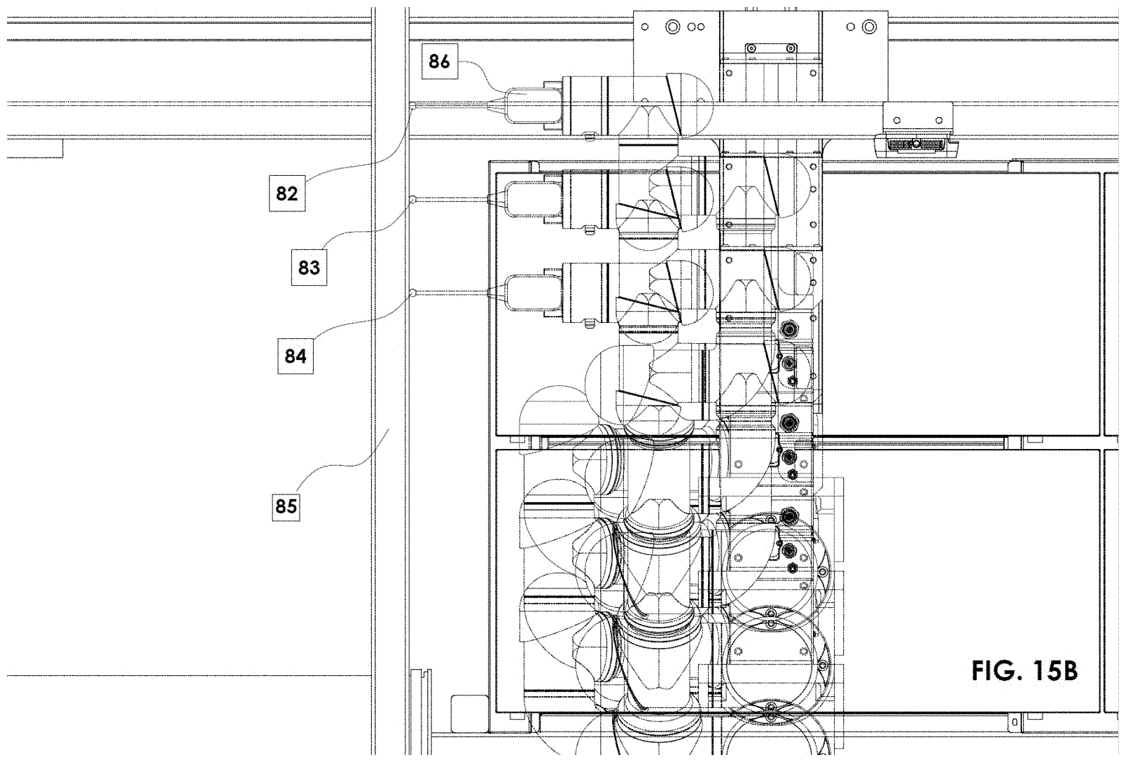

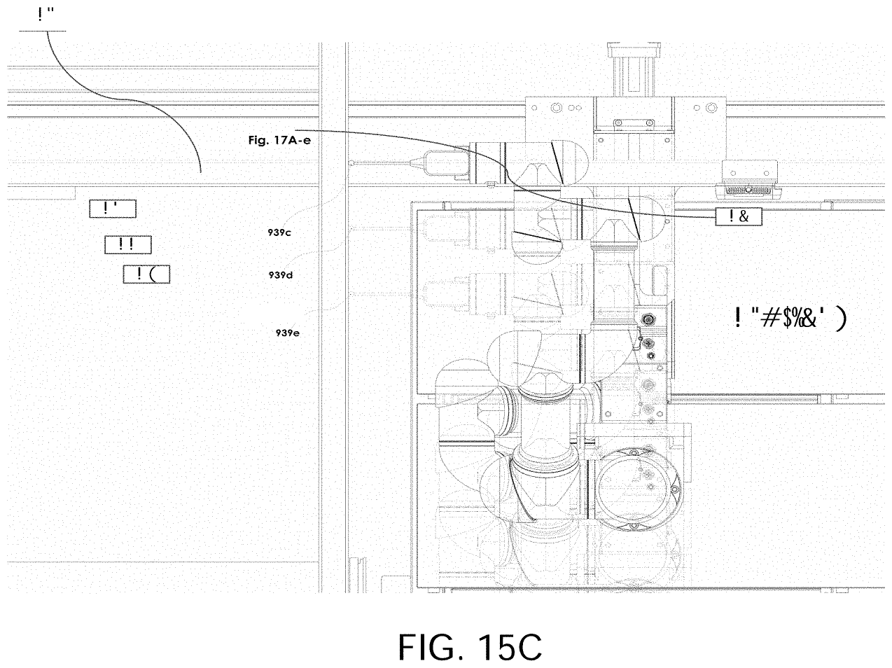

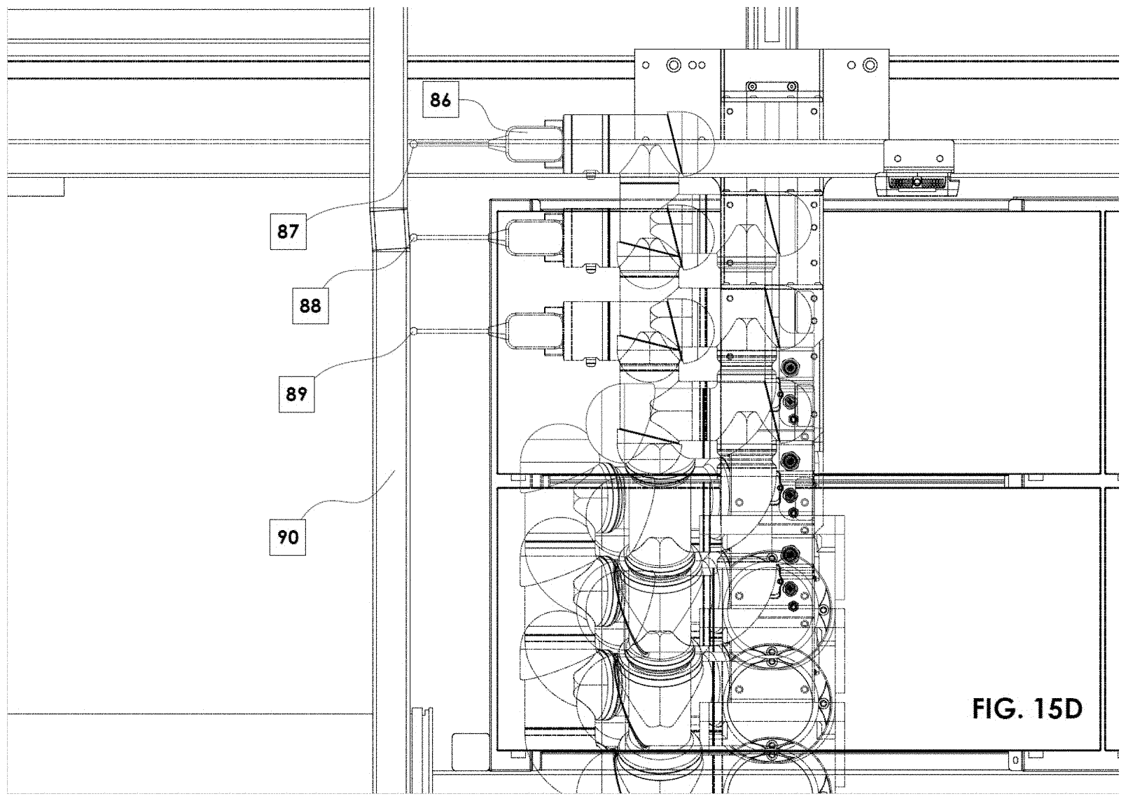

FIG. 15A depicts an isometric view of etalon model virtual model. Automatic adjustment procedure is visible on the drawing is a crucial procedure, ensuring reliable operation and scalability of the robotic kitchen system. The robot is probing several positions in a virtual model. The procedure is starting with comparing etalon model virtual model geometry with physical model. Probe 86 is represented on the virtual model measuring robotic system geometry. The geometry observed on the drawing is the reference geometry from the virtual model. Probe 86 has several sensors inside able to acquire data about the environment: point cloud sensor, high precision IR sensor, high precision proximity sensor, high precision physical limit switch/bumper along other sensors. The probe is approaching the certain point in virtual model kitchen 82, which is the reference point. After that it is moving to point 83, and point 84.

FIG. 15B depicts a side view of etalon model virtual model. Automatic adjustment procedure is visible on the drawing and is a crucial procedure, ensuring reliable operation and scalability of the robotic kitchen system. The robot is probing several positions in a virtual model. The procedure is starting with comparing etalon model virtual model geometry with physical model. Probe 86 is represented on the virtual model measuring robotic system geometry. The geometry observed on the drawing is the reference geometry from the virtual model. Probe 86 has several sensors inside able to acquire data about the environment: point cloud sensor, high precision IR sensor, high precision proximity sensor, high precision physical limit switch/bumper along other sensors. The probe is approaching the certain point in virtual model kitchen 82, which is the first reference point. After that it is moving to point 83, and point 84.

FIG. 15C depicts an isometric view of the etalon model physical model. Automatic adjustment procedure is visible on the drawing and is a crucial procedure, ensuring reliable operation and scalability of the robotic kitchen system. The robot is probing several positions in a virtual model. The procedure is starting with comparing etalon model virtual model geometry with physical model. Probe 86 is represented on the physical model measuring robotic system geometry. The geometry observed on the drawing is the reference geometry from the physical model. It is acquiring data from the sensors to determine what is the offset between physical system position in relation to the point from the virtual model, the result is then compared with the virtual model data. The probe is approaching the certain point in physical model kitchen 87, which is the first comparison point. After that it is moving to point 88, and point 89. Then cartesian position and orientation of probing points is compared with virtual model points 82, 83, 84. Several points are measured on one plane, in such a way, displacement patterns can be observed, torsion, bending, displacement are fed back to the system, assumption about the model 85 can be cross checked with reality 90. Physical model column 90 is flawed, virtual model column 85, has to be adapted to match the reality. Adaptation is done using the offset data from the probe 86.

FIG. 15D depicts a side view of the etalon model physical model. Automatic adjustment procedure is visible on the drawing and is a crucial procedure, ensuring reliable operation and scalability of the robotic kitchen system. The robot is probing several positions in a virtual model. The procedure is starting with comparing etalon model virtual model geometry with physical model. Probe 86 is represented on the physical model measuring robotic system geometry. The geometry observed on the drawing is the reference geometry from the physical model. It is acquiring data from the sensors to determine what is the offset between physical system position in relation to the point from the virtual model, the result is then compared with the virtual model data. The probe is approaching the certain point in physical model kitchen 87, which is the first comparison point. After that it is moving to point 88, and point 89. Then cartesian position and orientation of probing points is compared with virtual model points 82, 83, 84. Several points are measured on one plane, in such a way, displacement patterns can be observed, torsion, bending, displacement are fed back to the system, assumption about the model 85 can be cross checked with reality 90. Physical model column 90 is flawed, virtual model column 85, has to be adapted to match the reality. Adaptation is done using the offset data from the probe 86.

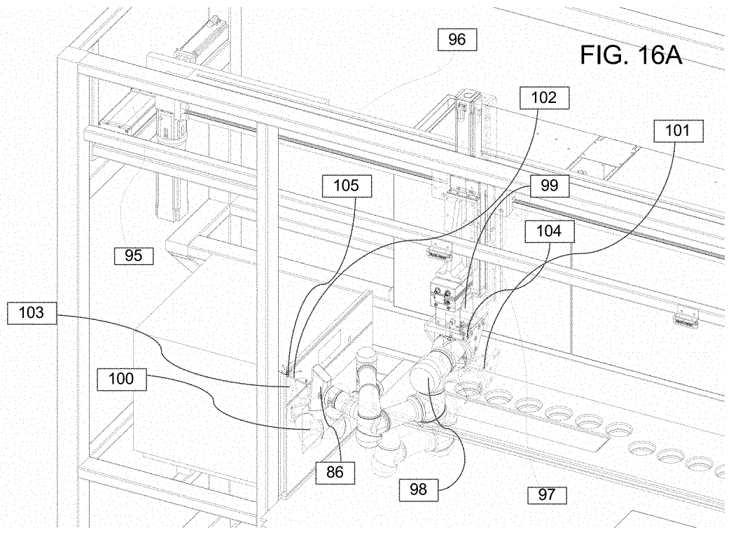

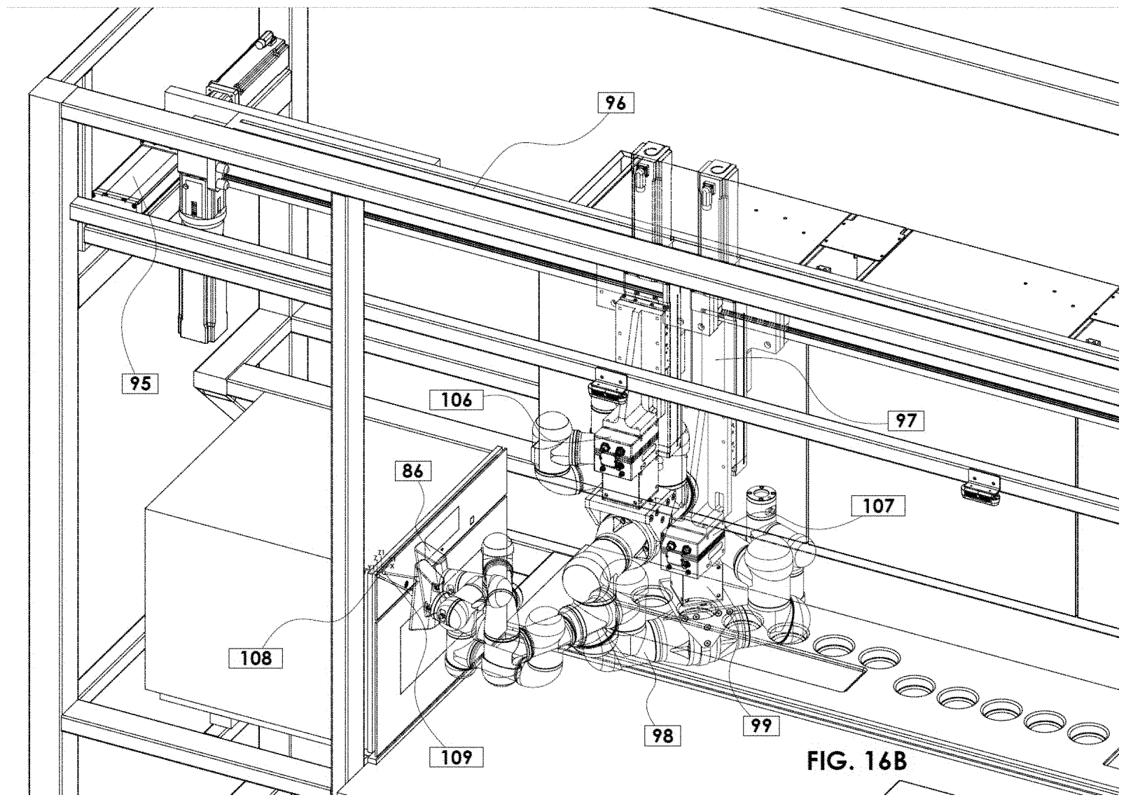

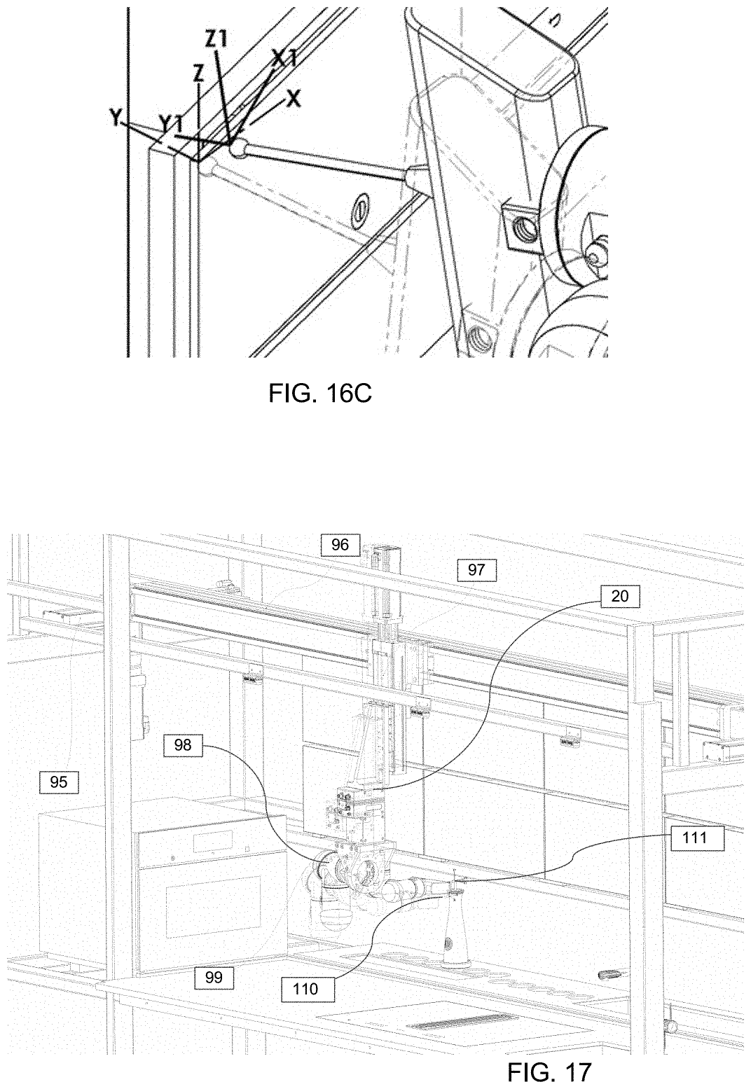

FIG. 16A depicts calibration of the robot automatic error tracking procedure. Every manufactured system can be flawed. The risk of inaccuracies in execution are eliminated using the following procedure. The robot is approaching a certain cartesian point in space 105 (X Y Z; R P Y), which is the robot configuration reference point, with certain robot joint state configuration 104. The feedback about the physical point positioning inside cartesian space comes from the probe 86. Then it is commanding different joint state values to all joints of the system to reconfigure robot joint state to the first probing robot configuration 101, with the certain probe position 102. Drawing identifies several axis and manipulators which are being reconfigured. X axis 96, Y axis 95, Z axis 97, rotational axis 99 and robot arm manipulator 98, however the procedure is applicable to different robot designs. Joints states are changing, however the goal is to keep the tip of the probe in the same cartesian space position. Desired position and orientation of the probe tip 103 (Xd Yd Zd; Rd Pd Yd) in first probing robot configuration 101 is known from the inverse kinematics. The physical position and orientation of the probe tip 103 (X1 Y1 Z1; R1 P1 Y1) is acquired from the sensors is then compared with the desired positions and orientation, which the X, Y, Z positions and the X1, Y1 and Z1 positions are illustrated in FIG. 16C. In case offset is present, the robot is not accurate, and has to be examined. In some cases offset of the position or orientation 103 can be planned, like it is visible on the drawing. Desired orientation shift is compared with the physical one based on the first. Automatic error procedure is excluding any reference model data, the robot is not accessing any etalon model points, it is calibrating itself automatically.

FIG. 16B depicts calibration of the robot automatic error tracking procedure, this time there is a planned position and orientation shift. The robot is approaching a certain cartesian point in space 108, (X Y Z; R P Y) and physical reference acquired by the probe 86 is saved. Cartesian position 108 is achieved with certain robot joint state configuration 106. Then it is commanding different joint state values to all joints of the system to reconfigure robot joint state to the first probing robot configuration 107, with the certain probe position 109 drawing identifies several axis and manipulators which are being reconfigured, X axis 96, Y axis 95, Z axis 97, rotational axis 99 and robot arm manipulator 98, however the procedure is applicable to different robots. Desired position and orientation of the probe tip 109 in first probing robot configuration 107 is known from the inverse kinematics. The physical position and orientation of the probe tip 109 is acquired from the sensors is then compared with the desired positions and orientation, Desired position and orientation shift is compared with the physical one based on the. Automatic error procedure is excluding any reference model data, the robot is not accessing any etalon model points, it is calibrating itself automatically.

FIG. 17 depicts calibration of the robot automatic position and orientation adjustment. Joint state positions in regards to all operational objects and crucial system fixtures has been recorded on etalon model kitchen. In etalon model referencing routing, in particular example visible on the figure robot 20 is approaching the bottle, so it is in “zero” position 110 (X Y Z; R P Y) in regards to the bottle. It is recording joint states of all joints in the system drawing identifies several axis and manipulators which are being recorded, X axis 96, Y axis 95, Z axis 97, rotational axis 99 and robot arm manipulator 98, however the procedure is applicable to different robots. After scaling the manufacturing, robot model n is produced. Automatic position and orientation adjustment procedure is then applied, the same joint state execution libraries recorded on the etalon model are compatible with robot model n. Robot 20 all joints are commanded with joint state position values previously recorded for bottle approach. The Cartesian position of the probe tip is then acquired 111 (X1 Y1 Z1; R1 P1 Y1). Offset between cartesian points in space between etalon model and robot n model is visible on the drawing. The shift is saved inside the system, positions and orientation shifts on each axis are applied to the actuators X axis 96, Y axis 95, Z axis 97, rotational axis 99 while the interaction with particular objects has been commanded by the system, in joint state execution mode in robot model n. Etalon model recorded and tested minimanipulations libraries can be executed in robotic system 1 . . . n. It is providing reliable scalability of the robotic system.

One of the most crucial parts of robotic kitchen are its storage areas. They work as tool changing stations. Cooking and cleaning the workspace are quite complicated processes with a lot of different objects involved, cookware, utensils, kitchen appliances such as hand blender, different types cleaning tools and the main one, cooking ingredients. Robotic kitchen has three storage areas providing the way to easily switch the tool while it is required for the operation. Each area has its specific functionality which allows the system to have more understanding of current situation inside. There are multiple types of storages, as an example three of them are listed in this document.

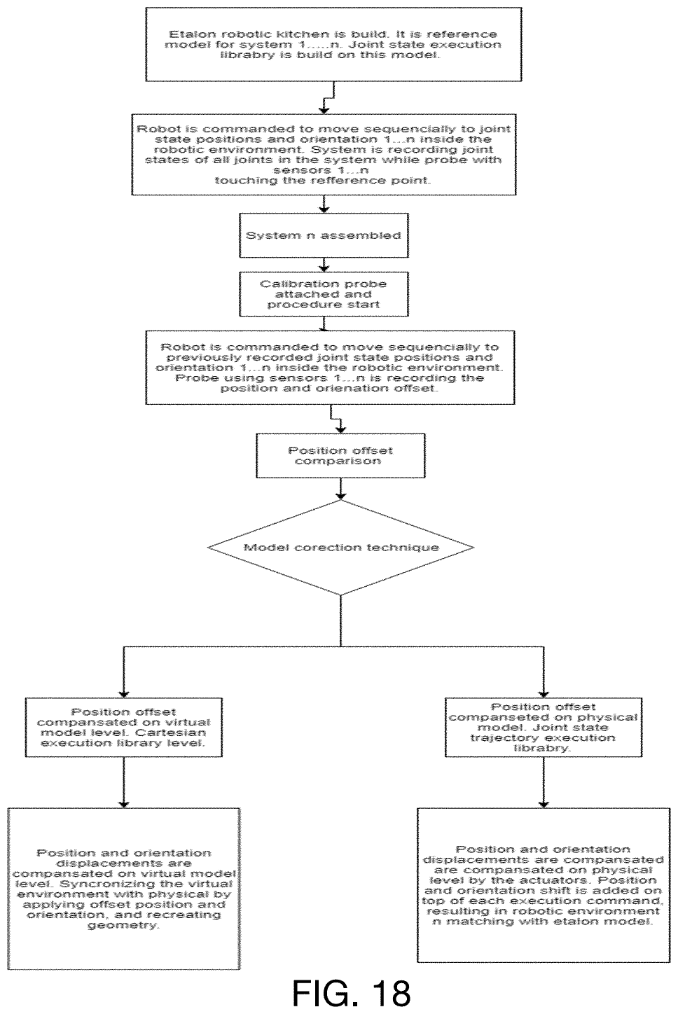

FIG. 18 is a calibration flow chart indicating sequence of operation during calibration in accordance with the present disclosure.

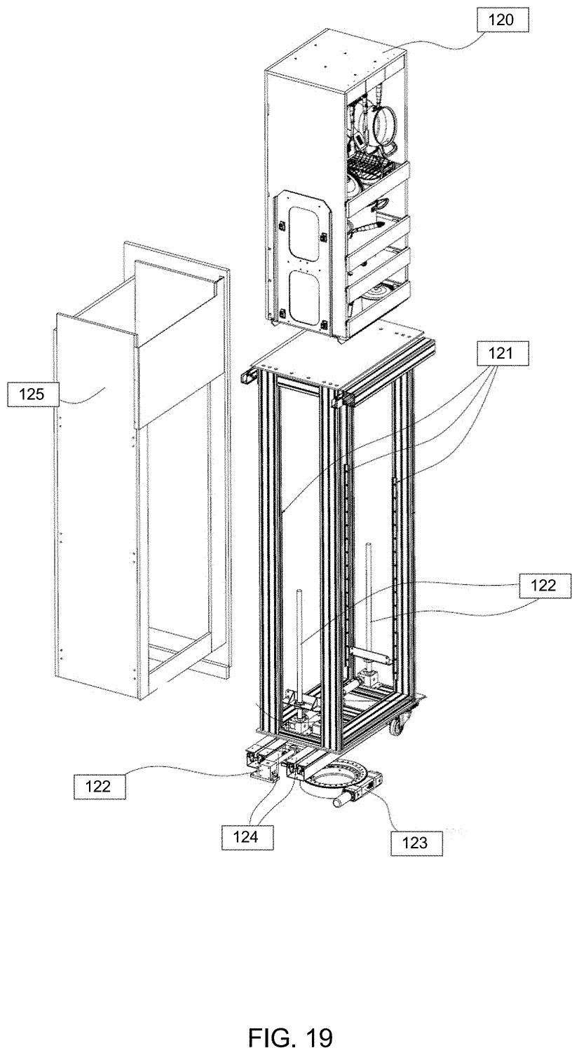

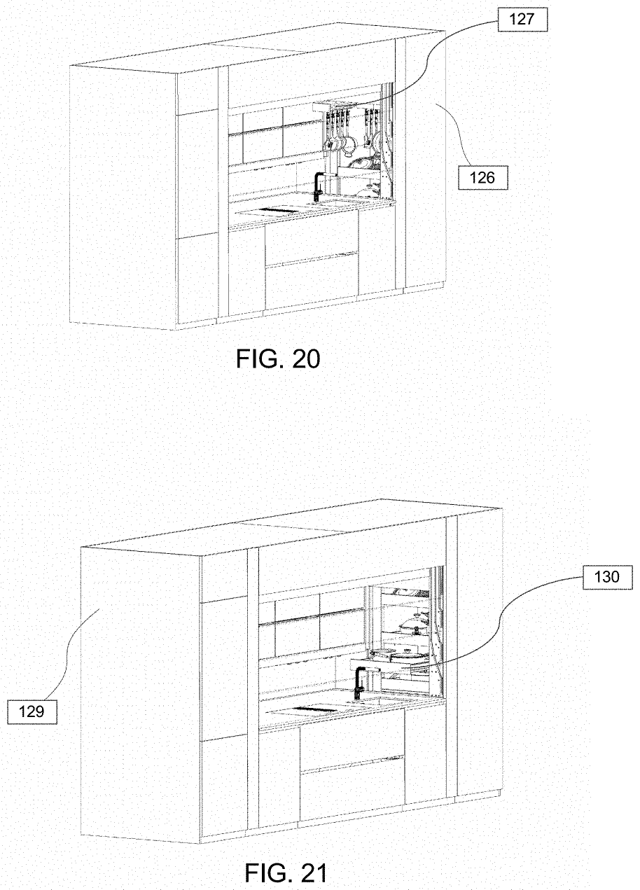

FIG. 19 depicts a tool storage is the place where all cooking manipulation equipment is stored 120. It is mounted on kitchen frame to ensure the high precision of the position. The drawing indicates actuator mechanisms, linear and rotary. Actuators can be of any types i.e., manual, pneumatic, hydraulic, and electric. Drawers, sensors, tool storage frame and panel body are visible. The tool storage comprises of many systems that supports the required functionality in robotic kitchen. There are many actuators to provide linear 122 and rotary 123 motion along or around many axes. Actuators can be of different types, along others pneumatic, hydraulic, and electric. To provide precise well supported movement of cabinetry with different velocities, guide systems 124 for all axes of motion has been incorporated inside. Frame 121 structure has been designed to support cabinetry 125 upon acting forces as well as system precision and repeatability. FIGS. 20 and 21 depict respectively a robotic kitchen system using motion systems which are allowing robot the access to grasping objects. The tool storage system is located in the lower position with the drawer extended into the kitchen cooking zone. In order to allow the system to be compact and maximize the functionality using minimum space tool storage has to be actuated in both directions horizontally in user mode and vertically in robot mode. Vertical actuators of any type i.e. hydraulic, pneumatic or electric allows up 126 and down 129 movement of the tool storage area. This motion is crucial for the robotic system as the dimensions of the tool changing station are more than the actual space accessible by the robot 127 128. By using this solution larger space of the utensil storage can be used. System is commanding to move up or down, to adjust itself before grasping operation. Robotic kitchen system is planning ahead which tool he needs to use, and system is then moved into accessible position, the space operable by robot is restricted, to maximize operational reliability adjustable cabinetry is introduced, commanding position depending on the tool that robot needs to use in certain scenario. In this way, system can use larger storage.

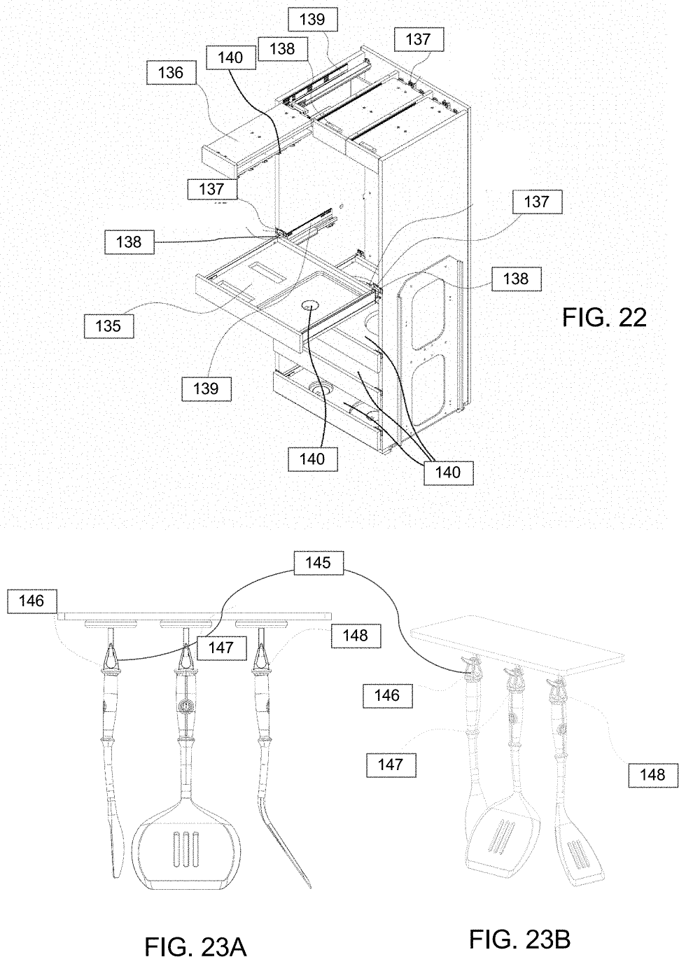

FIG. 22 depicts drawers where tools are stored 135 and hang on 136. Drawers are controlled automatically from the control system or manually. The tool storage inventory tracking and position allocation functionality is also visible. All drawers have automatic defined position systems using magnetic 137 or electromagnets with ferromagnetic interfaces 138. In case of using manual actuation, drawers need to have a defined position at the end of the stroke for the robot to rely on the Cartesian positioning of the objects inside the drawers to grasp them, the robot system can also use visual surveying to grasp objects reliably. Drawers also have limit switches integrated into the runners 139 to determine opened also closed position. Each drawer has linear actuator inbuilt into the runners 139 compatible with automatic and manual mode, it is able to extend the drawer to any position. Inventory inside tool storage system, and any other storage system inside robotic kitchen is being tracked by inventory tracking devices, each position inside the tool storage is defined 140.

FIGS. 23A and 23B depict a front view and an isometric view of a quadruple directional hook interface 145, respectively, designed to work with tools i.e. utensils and cookware. While the hook position and orientation may be stationary, orientation of a tool orientation can be changed easily due to the quadruple direction hook interface, which enables more reliable grasp in a challenging space restricted environment. This interface setup was designed to not restrict the robot and user from positioning the object in desired position and orientation, we can observe the object in different positions on the same hook, position 1 146, position 147, and position 3 148. It is essential for the robotic operation, as it is allowing the robot to access the tools from different orientation. It is especially important while operating in tight workspaces.

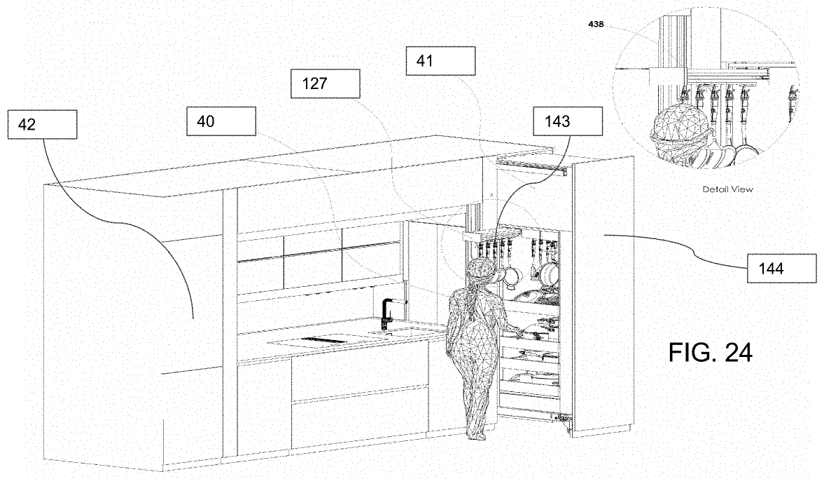

FIG. 24 depicts a user mode tool storage 41 in operation. The user mode tool storage 41 is acting as the piece of cabinetry; however, it has more functionality than the regular kitchen cabinet. The tool storage 41 is extended sideways using a linear actuation of any type: for example, pneumatic, electric, hydraulics or manual. A tool is passed to the user with the drawer position extended. The design of the tool storage area changes the way of cooking for a user 40. When the user requires the specific tool 143 to be used in the cooking process, he just informs the system about it using GUI 42 or voice command and system is passing this object to him 127, first it extends sideways 144 and then passing specific object using actuated drawers System is also passing automatically tools in recipe execution sequence, required tool is detected by inventory tracking system and then passed automatically based on recipe demand at exact required time. System is opening specific drawer 127 and indicating the pickup position 143 with light signal and voice command. Each drawer has its own opening actuating system. Signal is sent from the processing unit to trigger the opening of the drawer to allow the robot or human 40 user to grasp an object freely. Drawers can be opened both, automatically and manually.

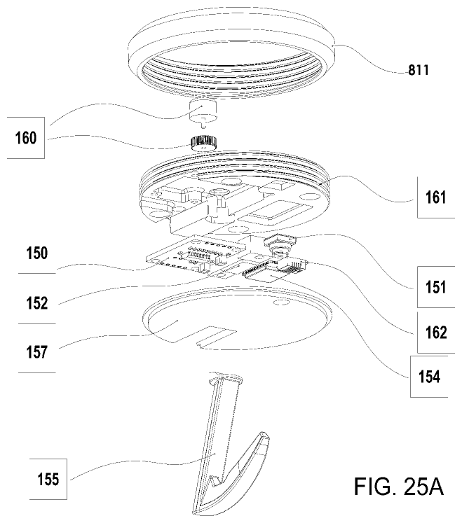

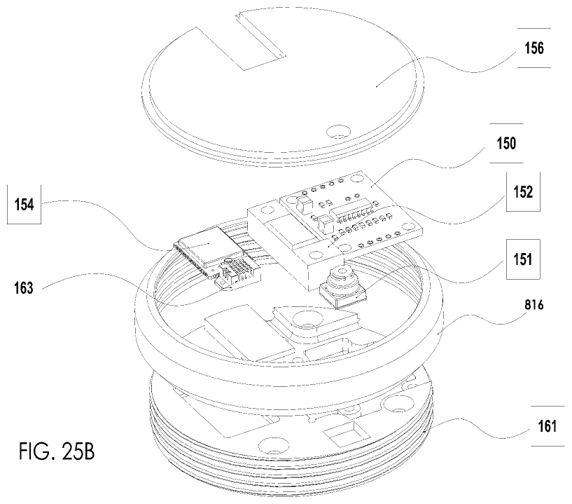

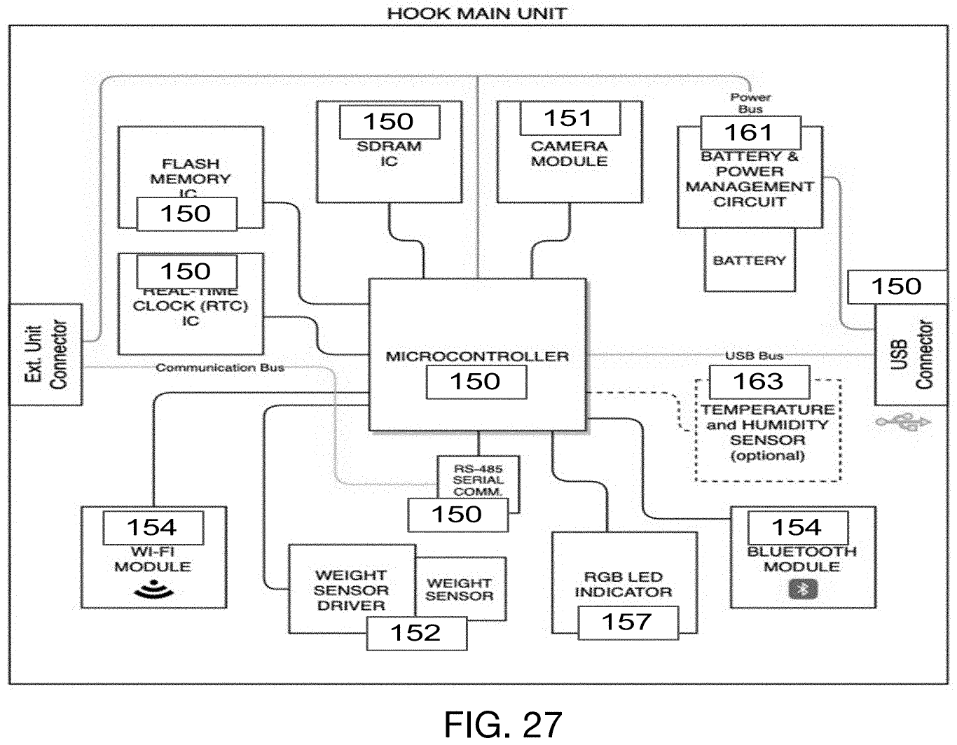

FIGS. 25A, 25B, and 27 depict an inventory tracking device system which is an automatic detection system for different type of objects. FIG. 25A is representing the inventory tracking device hook 155 and FIG. 25B is representing inventory tracking device base 156. System can understand multiple parameters about a given object such as its: ID, weight, colour, type etc. System is using multiple sensors to detect and determine those parameters, which are RFID readers 150, vision system 151, weight sensors 152 and more. Those sensors are placed inside specially designed base 161. The base is working as an attachment for the hook, worktop slots, refrigerator slots or any other type of defined placement. RFID tag reader integrated into 150, camera 151, weight sensor 152 among other sensors placed inside the base would recognize the ID of the object placed on the hook or on the base. Storage systems inside robotic kitchen comprises of multiple hooks and bases inside any system would be able to detect the presence and exact position and orientation of the object in the storage system. Human user or robot places the object on any desired hook in the storage area, and the system is automatically recognizing exact hook ID to determine the position. Each object will have a passive RFID tag, RFID tag reader would detect the object placed on inventory tracking device. The camera module 151 is located inside structure. The camera is tilted at an angle to observe the object hanging or placed on from the hook or base. Vision system will detect specific visual parameters such as: shape colour etc. and recognize the object type and ID. Camera system 151 comprises of smart camera processing unit. Using its functionality neural network is trained to recognize specific type of the object and output the specific object type that is currently present on the hook. The system can be trained with any object placed on the hook. Each object needs to be registered to the system with specific known weight. This information of the exact weight of a specific object with specific ID will be stored in the system internally or externally on data base. Once the object is placed on inventory tracking device it is detecting the object ID by comparing the current reading of the weight sensor 152 to the one stored in database. Described technologies, are integrated inside the inventory tracking device base with one PCB 150 environment, where CPU is also integrated, which is responsible for processing the signals from the sensors and for controlling the actuators and indicators. External communication modules i.e. Wireless (i.e. bluetooth or wifi) module 154 and USB module integrated onto PCB 150 for wired and wireless communication are passing data to external systems. LED light 157 acts as a indicator for the position. In case user have several objects on inventory tracking device and wants to locate the specific one, external system can communicate to all inventory tracking devices in the network that it is looking for the specific type of object. Inventory tracking device that holds this objects can activate the LED light. Lightning system can also be used for indicating that the weight currently on the inventory tracking device base is exceeding the nominated weight. It can blink fast in red, as the led lights color can be controlled. UV light 157 is also integrated onto the system, it can sterilize the object that it holds when requested, or automatically, when vision system recognizes need to sterilization. Each inventory tracking device has an actuator 160 which can rotate the hook so it can adjust its position as requested with 360 degree motion, also lower the hook to desired position for the user. When external system commands the hook number and position actuation, CPU 150 is passing position requirements to the actuator 160. Changing of the hook orientation can be observed on. External system can access each inventory tracking device via communication module either wired 150 or wireless 154. In case of wired communication, the system is using cable interface, for power and data. In case of wireless communication, unit needs to be charged, it has a battery module 161 inside. Wired communication and charging can also be performed using USB interface 150. Inventory tracking device will include temperature and humidity 163 sensor. The different environment parameters can be tracked by the inventory tracking device reliably. This system can be applied to all storage types i.e. drawers, hooks, hanging rails.

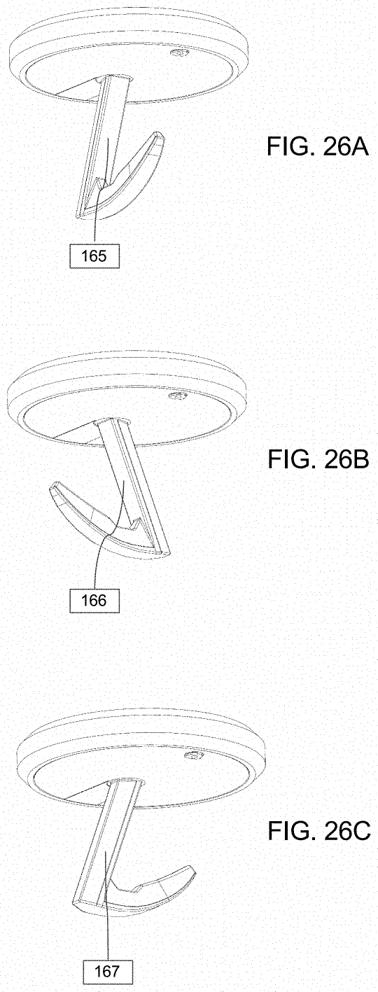

FIGS. 26A, 26B, 26C depict actuated hook principles of operations. Hook can rotate or be linearly moved to the requested position. Rotary actuation from initial position 165, clockwise with 90 degree rotation 166 and counter clockwise with 90 degree rotation 167. The hook actuation is used to maximize ease of approach for the robot and human user.

FIG. 27 depicts the use case for the connection of inventory tracking device. There is a cloud server 166 which connects with modem or access point 167. Inventory tracking device 170 is connected wirelessly or wired to the access point. Inventory tracking device can be accessed through user PC 169 as well.

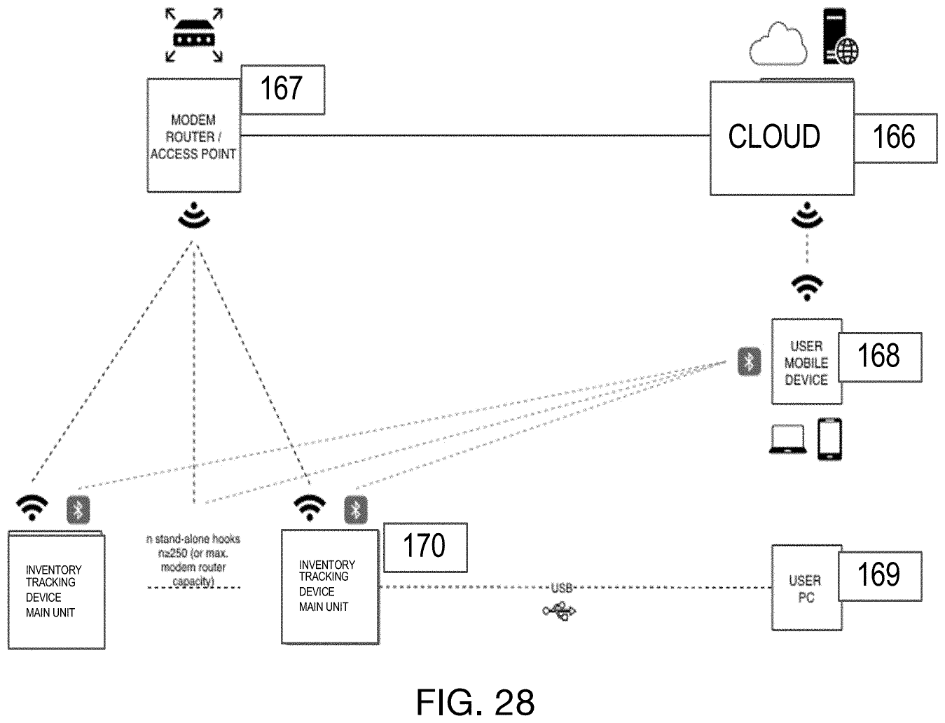

FIG. 28 is a system diagram illustrating inventory tracking device example communication architecture. Users are enabled to understand every single object position at his home in real or requested time. We can also understand and control and information parameters such: temperature sensors data, humidity sensors data, position sensors data, orientation sensors data, weight sensors data, camera sensors data, light control illumination for particular placement, electrical and mechanical Lock/Unlock storage units, time stamps of object placement/changing, multi modal devices sensors data, RFID/NFC sensors data, actuators control for each placement, other available sensors and control data. All these functions can be accessed via API's and can be integrated with any system 166. For example smart home systems.

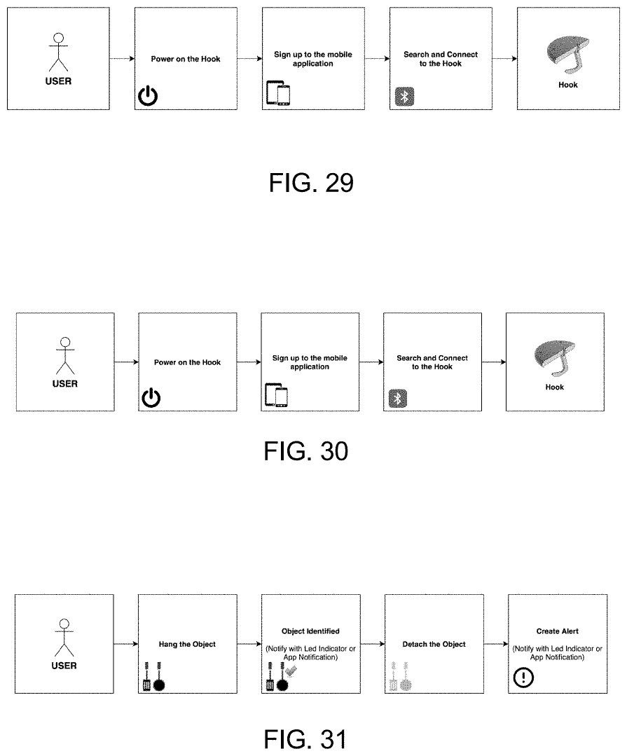

FIG. 29 is a system diagram illustrating one embodiment of an inventory tracking device for product installation in accordance with the present disclosure.

FIG. 30 is a system diagram illustrating one embodiment of an inventory tracking device for object training in accordance with the present disclosure.

FIG. 31 is a system diagram illustrating one embodiment of an inventory tracking device for object detection in accordance with the present disclosure.

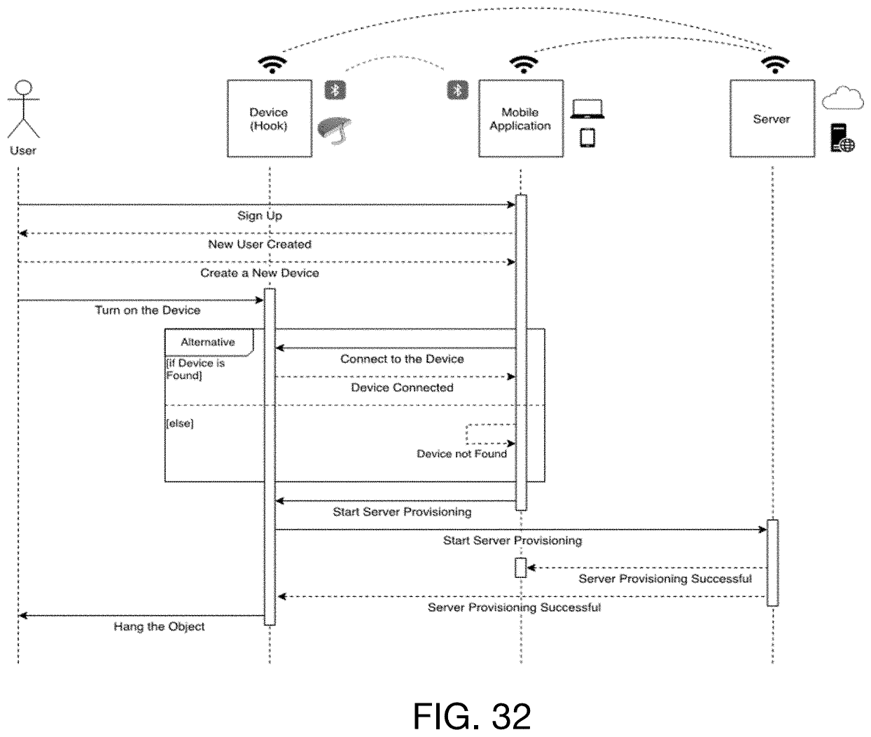

FIG. 32 is a system diagram illustrating one example of an inventory tracking device on the sequence behaviour for product installation in accordance with the present disclosure.

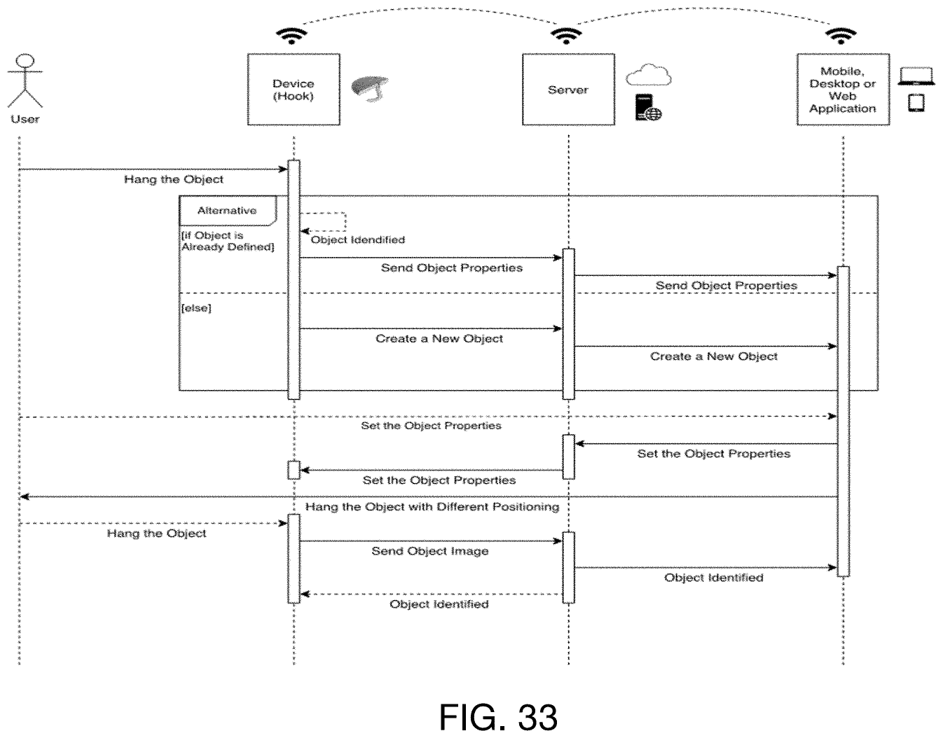

FIG. 33 is a system diagram illustrating one example of an inventory tracking device on sequence behaviour for object training and detection in accordance with the present disclosure.

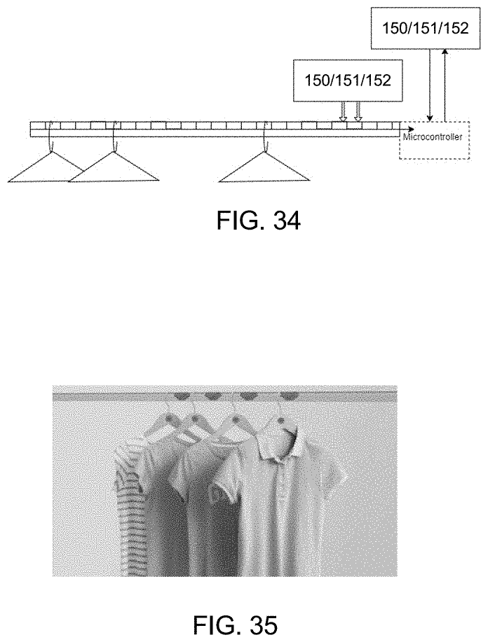

FIG. 34 is a system diagram illustrating one embodiment of a smart rail system in accordance with the present disclosure. In robotics kitchen application this would help the system to check the inventory state in real-time and also enabling the robot to understand the exact position of specific object, similar functionality could be used in shops, warehouses, laundry facilities, manufacturing facilities among many others. Any inventory tracking could be performed using this system. For instance, there are several options that this system could be applied to significantly improve the processes in the retail industry. Clothes would be placed on hangers. RFID tags would be placed either in the cloth label or on the hanger. RFID tag readers would be placed inside the actual rails. Rails would also comprise of cameras, weight sensors and RFID tags to recognize the objects. All objects parameters (shape, colour, weight etc) can be recognized by the system and assign to specific object ID and type. Robotic system can operate and interface with any ingredient storage system.

FIG. 35 depicts one example on the functionality of a smart rail system in accordance with the present disclosure.

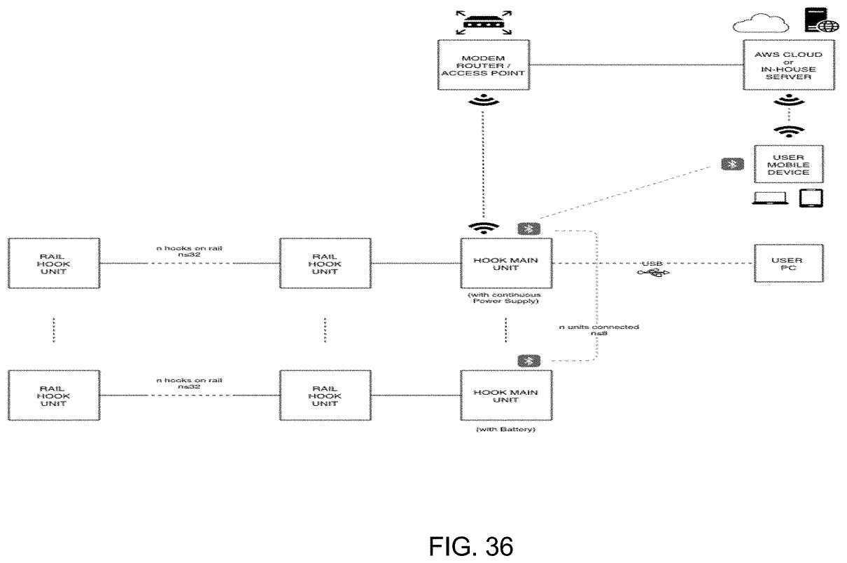

FIG. 36 is a system diagram illustrating one embodiment of a smart rail device example communication system in accordance with the present disclosure.

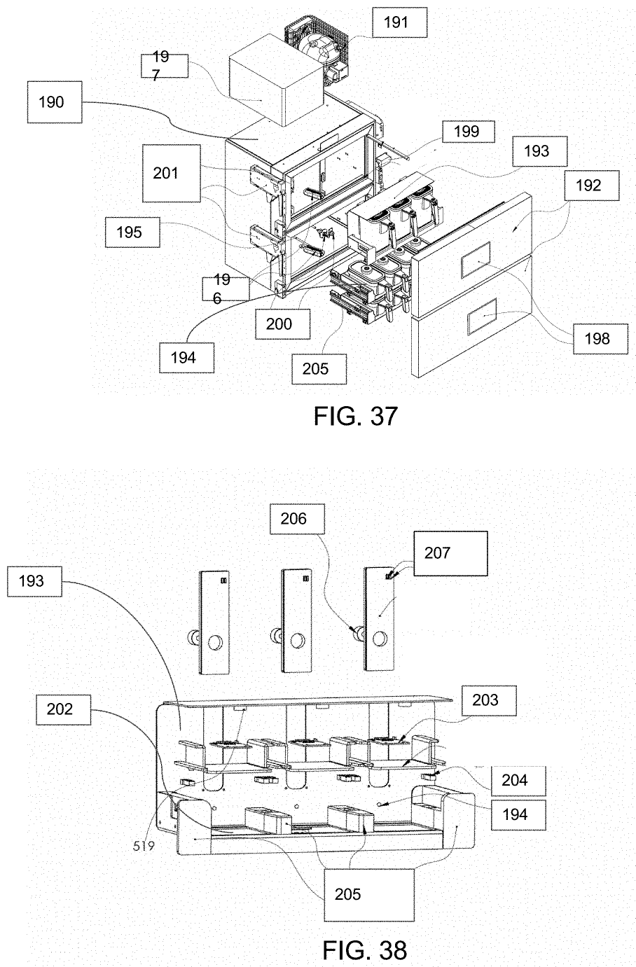

FIG. 37 depicts a smart refrigerated 190 and non-refrigerated ingredient storage 190 system exploded view, which is crucial for recipe execution. Refrigerated ingredient storage system is the storage place for ingredient storing containers. There are several requirements that ingredient storage system need to meet for robotic system compatibility There are several container sizes, each suitable for different ingredient groups, depending on the sizes. Ingredient storage doors 192 can be opened automatically as well as manually, using special adapted dual mode hinges 201, which creates the opportunity to fully automate the process in robot mode. In user operating mode user can ask the system to hand over the specific ingredient to him, because of automatic compartment opening, linear motion and LED indication for each container slot. User will easily understand which container needs to be used while performing recipe cooking. The container needed to be used will be passed the container on the exact time: doors of the ingredient storage 192 will automatically open, tray 193 will automatically extend using linear motion mechanism 200, and LED under container slot will be powered 194. UV light 195 which can perform sterilization procedure inside the refrigerator, either on user request or automatically, using data from camera 196 to determine when sterilization is required.

Each ingredient storage compartment has its own independent processing unit 197 which processes data from all sensors, commands actuators and indicators and exchanges information with other systems. In user mode, user is enabled to control and monitor the refrigerator via GUI 198 or externally i.e. using his phone. System has a compartment locking system 199. User can lock and unlock each compartment whenever needed.

FIG. 38 depicts adapted trays 193 that support the different container sizes. Each container has its slot 202. The refrigerator needs to be aware of the container presence, there are different sensors that indicate its presence. System is using a different type of sensor system: RFID detection 203 or vision 196 to be aware which position is filled with a container storing a certain food type. When a container is placed on the slot, sensors are triggered about environment change and the sensors are performing an ingredient recognition process. RFID tag reader 203 is detecting the data from the RFID tag. Which should comprise of ingredient type, parameters, and expiration date. Vision system 196 inside the fridge is making sure the ingredient type is correct. Each slot is equipped with weight sensors 204, system is always aware of amount of the ingredient inside the container. It allows the robot to perform cooking operation with correct ingredients and correct measures. To allow easier passing of the ingredient containers to user and robot.

FIG. 37 depicts fridge system. In operation, when system understands that certain container needs to be picked, it is sending the signal to appropriate actuator, which first opens the doors 192 then, it is sending the signal to appropriate actuator 200 which controls the motion for tray that desired container is placed on. The tray 193 moves forward to a defined position allowing the robot and user to reach and grasp the containers, easily without any obstructions, from other trays mounted on top or bottom. To maximize the repeatability of the container position within the tray structure, the guides for container sliding positions 205 are making sure that even slightly disoriented container is eventually end up in correct position and orientation, known by the robot. Another factor maximising the repeatability of the container position is magnetic-ferromagnetic or electromagnetic-ferromagnetic 206 interface between the food ingredient container and back wall of the refrigerator. Magnet on the back of refrigerator is pulling the ferromagnetic part mounted on the container towards it. This functionality assures repeatability of the position.

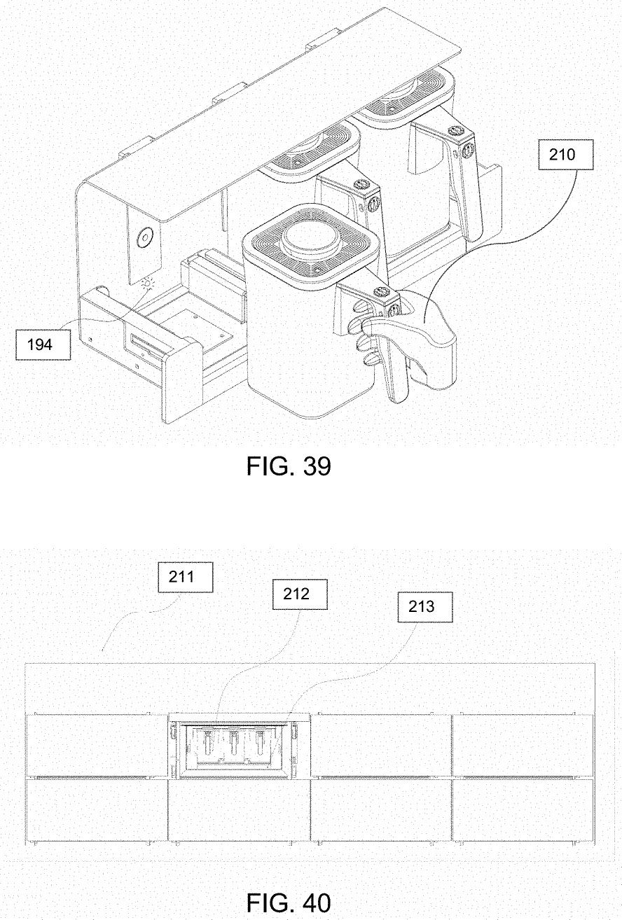

FIG. 39 is a system diagram illustrating a user grasping of a container 210 from container tray, with a light-emitting diode (LED 194) light projected on the position of the container in accordance with the present disclosure.

FIG. 40 is a visual diagram illustrating a refrigerator system 211 with an integrated container tray 212 and a set of containers 213 in a robotic kitchen in accordance with the present disclosure.

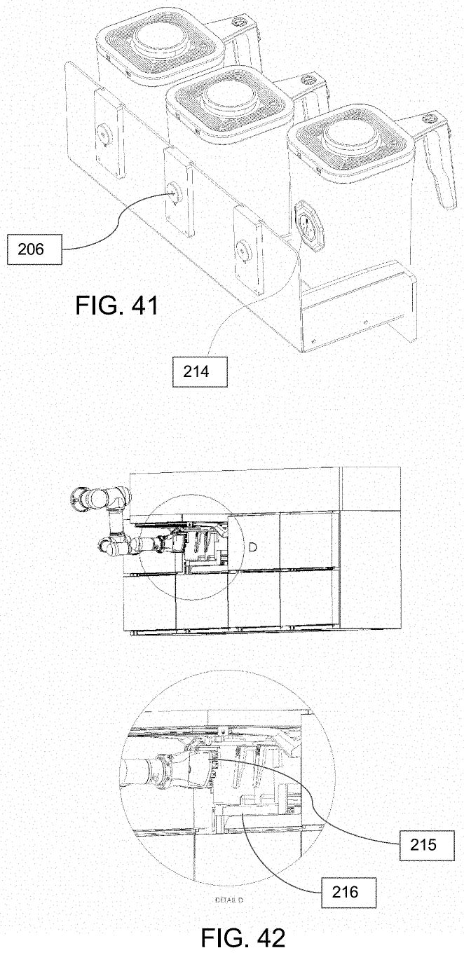

FIG. 41 is a visual diagram illustrating one or more containers with ferromagnetic part 214 placed on the tray with electromagnet 206 auto positioning functionality in accordance with the present disclosure.

FIG. 42 is a visual diagram illustrating the operational compatibility 215 representation with robot and a human hand. Containers placed inside the refrigerator system can be operated freely by anthropomorphic hands in accordance with the present disclosure. Tray is visible in extended position 216.

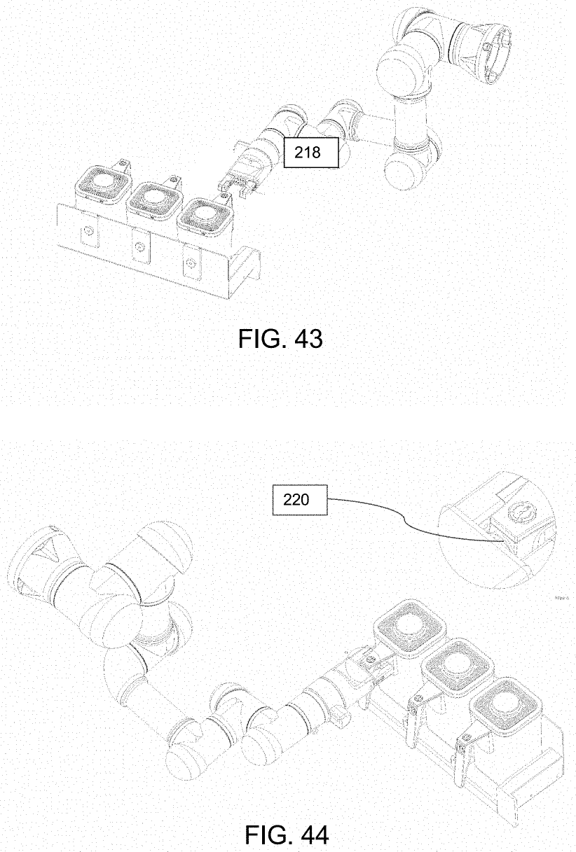

FIG. 43 is a system diagram illustrating the operational compatibility with a gripper 218 type (for example, parallel and electromagnetic) in accordance with the present disclosure. In the example, containers placed inside the refrigerator system can be operated freely by an anthropomorphic hand.

FIG. 44 is a system diagram illustrating a robotic system gripper with an electromagnet grasping 220 and operating one or more containers in accordance with the present disclosure.

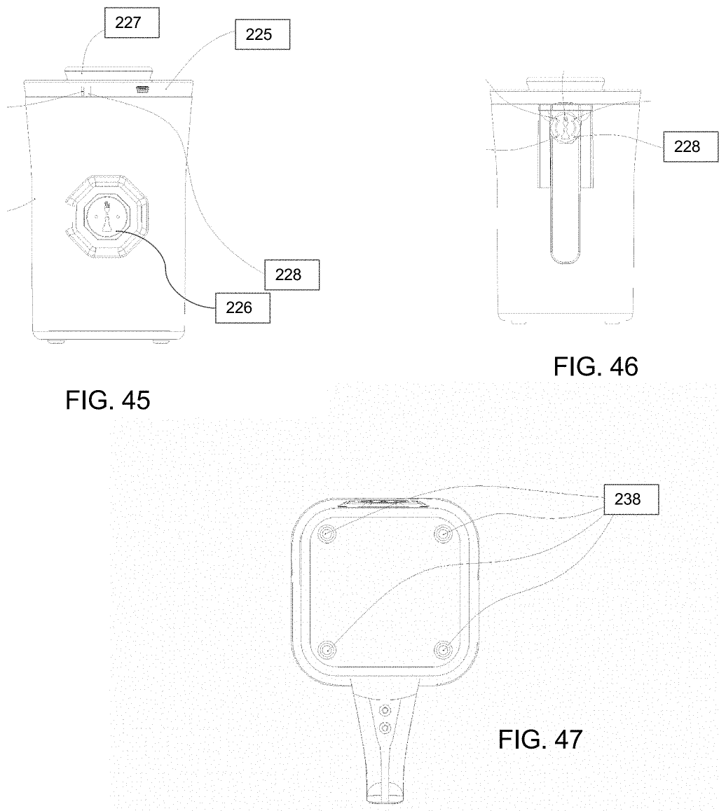

FIG. 45 is a visual diagram illustrating the back of a container with a lid 225 and a push button 227 in a closed position in accordance with the present disclosure. An automatic positioning ferromagnetic part 226 and power contacts 228 are visible.

FIG. 46 is a visual diagram of a coupler for robot gripper, with terminals for power 228 and data exchange, in accordance with the present disclosure.

FIG. 47 is a system diagram illustrating the bottom view of the container. A weight sensors 238 inside the feet of the container are visible.

Smart container, with variety of sizes to match all kinds to food sizes, has numerous sensors and actuators to fulfil wide functionality. This invention document will explain in depth what are those sensors and actuators and what purpose they are serving. All “smart” components are placed inside the containers lid, the most in depth drawing of the lid assembly can be found on

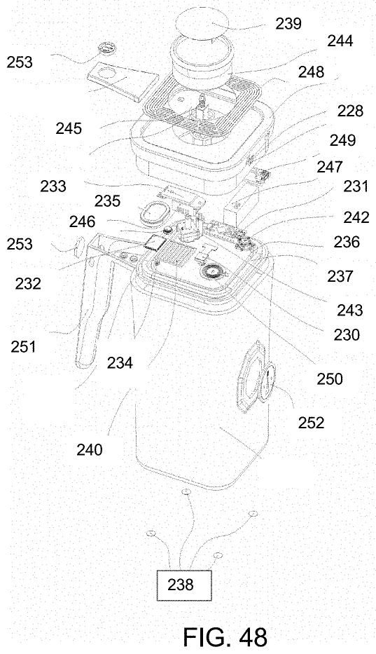

FIG. 48 depicts a smart container system. Camera 230 enables smart container to understand what ingredient is currently inside. It is mounted on the lid and pointed towards bottom of the container to see what it is inside. It can log the time of placing the ingredient inside the container to microprocessor 231 and inform the user that expiry date is coming to an end. It is able to monitor visual state of the ingredient, colour of ingredient inside the container indicating potential decaying of ingredient. It is also able to monitor the light intensity, which often has high effect on quality of the ingredients. It is able to recognize what exact ingredient has been placed inside the container. The camera is able to perform the process which is going to automatically assign the food to the container it is in. User is placing ingredient inside the container, then camera reading is passed to microprocessor 231 external data communication interfaces 232 are passing the data to the cloud, which is performing recognition procedure and passing data back to the container for it to understand what is currently inside the container. external communication data interfaces 232, are crucial in smart functionality of the container. They are providing the actual communication with the cloud and the user. Most operations which require high-computing power are performed on the cloud level, such as image recognition, data login etc. Container has multiprotocol communication system inside: Bluetooth, Wi-Fi, ZigBee, radio etc. Cloud server has the database of whole world's ingredients available. It knows all parameters about the food: ideal colour, temperature, humidity, light conditions to store the food, maximum storing time etc. It can feed all those information's back to the container, the container CPU can crosscheck and compare with conditions currently present inside the container, such as: temperature, humidity, light environment etc. Using external communication interfaces 232 it can also acquire the information about the time period that certain ingredient can be storeds for. This parameter would be saved on container microprocessor 231. When the expiry date would approach closer, external communication modules 232 would inform the container user about how much time left to consume the ingredient. Parameters such as ideal temperature, humidity and light inside the environment are crucial for the good quality of the food. Container has the sensors that can provide real life feedback loop for those parameters, to make sure that food stays up to highest quality. Inside container lid, there is a temperature and humidity sensor 233 and Light sensor 234, which are able to monitor the temperature, humidity and light reading inside the container. It is then passing the readings to systems CPU 231. System is able to log in those parameters along with the time of the reading, to give the history of readings when those would need to be accessed. It also understands what ingredient is placed inside; it can warn the user that the temperature is not appropriate thr specific ingredient. User is always able to access the real-time data that indicates, what are crucial parameters of the environment that food is stored in, and check if these are ideal for it. Container is also able to make sound indication when any of those parameters are not right using integrated speaker 235 or LED lights 236 inbuilt into the lid. Those two indicators can be helpful to people with different kinds of disabilities. LED light inside the lid of the container is also giving a lot of aesthetic value for presenting the food inside the container. All parameters of the light such as density, colour etc. can be adjusted easily by the user, or adjusted automatically by CPU 231 and camera 230 readings to match with the environment. For example, after light sensor 234 or camera 231 reading is changing dramatically, from bright one to darker one (refrigerator to dark kitchen at night) microprocessor 231 is triggering powering of LED's, then environment inside the container is enlighten for the user. LED lights 234 are also heavy support for camera 231 functionality in case the environment is too dark to recognize the ingredient inside the container can easily enlighten the environment to perform robust image recognition process. Another light system inside the container which support very crucial functionality are UV lights 237, which are mounted inside container lid, and pointing downwards to container body. User is enabled to run the sterilization process when ingredient has been removed from the container. It is able to detect that automatically, using its weight sensors 238 and camera 231, after the reading value has been changed, CPU 231 is going to ask the user, via cloud interface or physically, using sound signal 235 and indication on GUI screen 239 if the container has been cleaned after removal of the ingredient, based on user answer, sterilization process can run, UV lamps are going to be powered, and environment inside the container sterilized. Another sensor responsible for monitoring quality of the food is the food freshness sensor 240 the detection of volatile compounds with chemical gas sensors is can be reliable way for non-destructive way of determining the foods quality. The best results in maximizing the time period of food freshness could be achieved using vacuum inside the environment where the food is being kept. There is automated vacuum pump 242 inside the containers lid. There is a small hole to keep the air going in and out of the container. Using this component, user can command the container, using GUI touchscreen 239 or wireless communication interface 232 to remove the air, automatically from the environment. There is an air pressure sensor 243 that creates feedback loop for the automated vacuum pump to inform the system if vacuum sealing process was successful, and it is constantly monitoring if the pressure is kept on required level. In conjunction with camera 230 monitoring, data of ingredient entry time and date, temperature and humidity sensor 233 and light level sensor 234 monitoring, there is a strong case that food is going to be kept in high quality.

Lid button 244 placed on the container lid, it can be actuated by human user manually in order to open the container by pushing on it, however, user can also actuate the opening automatically, triggering the opening sequence using touchscreen 239, in this case actuation is performed by an actuator 245. Linear actuator is providing the tool for automated opening and closing as well as locking. Mini actuator providing linear movement is required for releasing the lid form the container body. In this case, once user has triggered automatic opening sequence, container cannot be opened manually, it can only open automatically, and triggering this event can be done only with prior authorization. The authorization can be done using GUI touchscreen 239, by entering password, or can be done using fingerprint sensor 246 this sensor can be either inbuilt inside the GUI touchscreen 239 or can be integrated into the system as separate component. In order to power all components in the system, container comprises of battery 247. There are several ways to charge the battery in smart container. There is a solar cell 248, 24V and 0V power terminals 228, USB interface 249, wireless charging module 250. To make the containers easier to operate, all container sizes have custom designed handle 251, and markers 252 253 which is compatible with human operator as well as robot operator. Robot can use several types of grippers such as: parallel gripper, electromagnetic couplers, robotic hands etc.

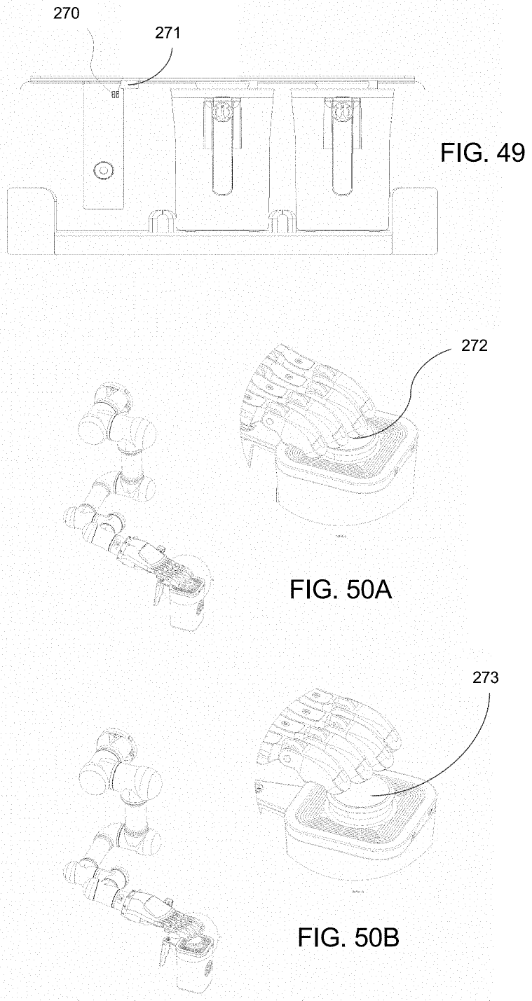

FIG. 49 is a system diagram illustrating an automatic charging station inside the tray for containers, with Physical contacts 270 and wireless charging modules 271, in accordance with the present disclosure.

FIG. 50A is a system diagram illustrating a robot actuating to push to open a container lid mechanism, with a visible closed position 272, in accordance with the present disclosure.

FIG. 50B is a system diagram illustrating a robot actuating the push to open a container lid mechanism, with a visible open position 273, in accordance with the present disclosure.

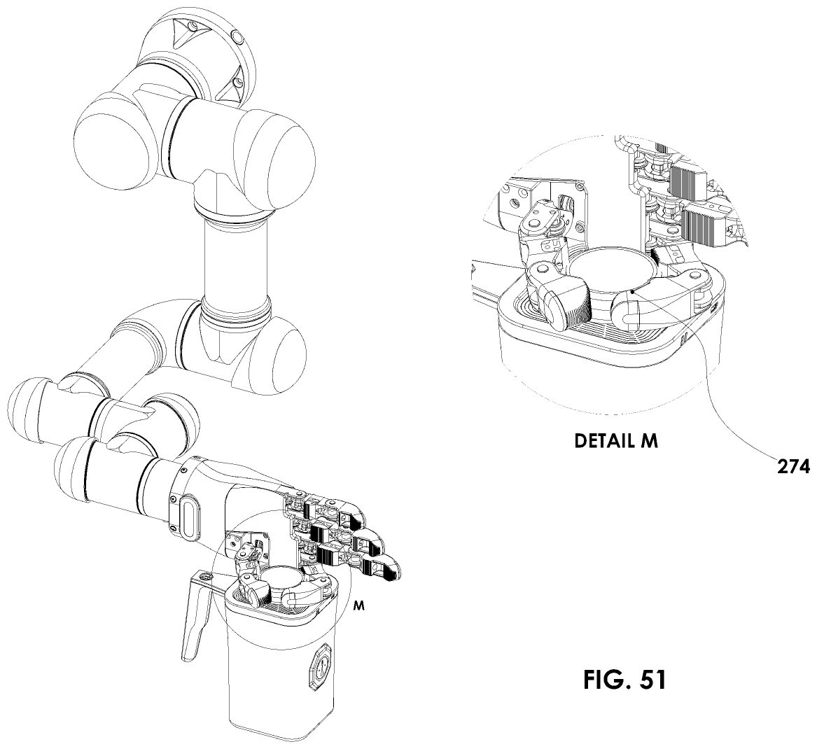

FIG. 51 is pictorial diagram illustrating an exploded view of a robot end effector compatibility 274 with a lid handle operation in accordance with the present disclosure.

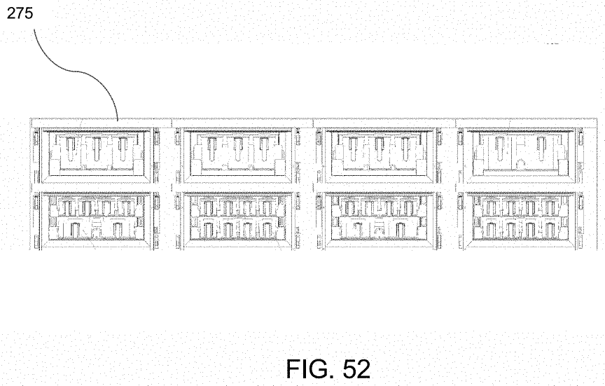

FIG. 52 is a system diagram illustrating the different sizes of containers 275 inside the robotic kitchen system refrigerator in accordance with the present disclosure.

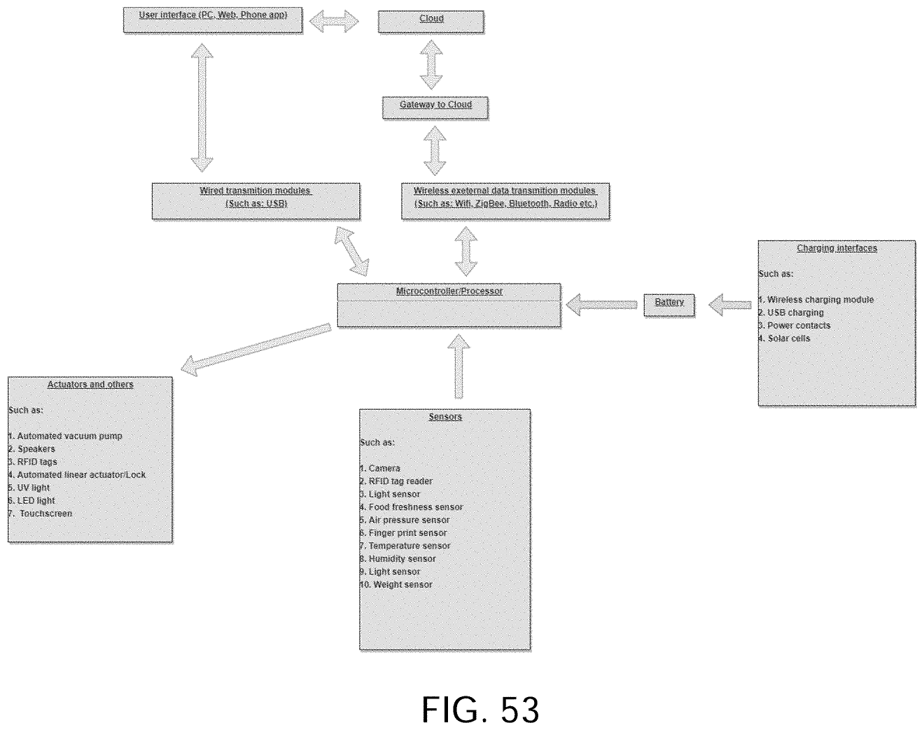

FIG. 53 is a block diagram illustrating overall architecture of the refrigerator system in accordance with the present disclosure.

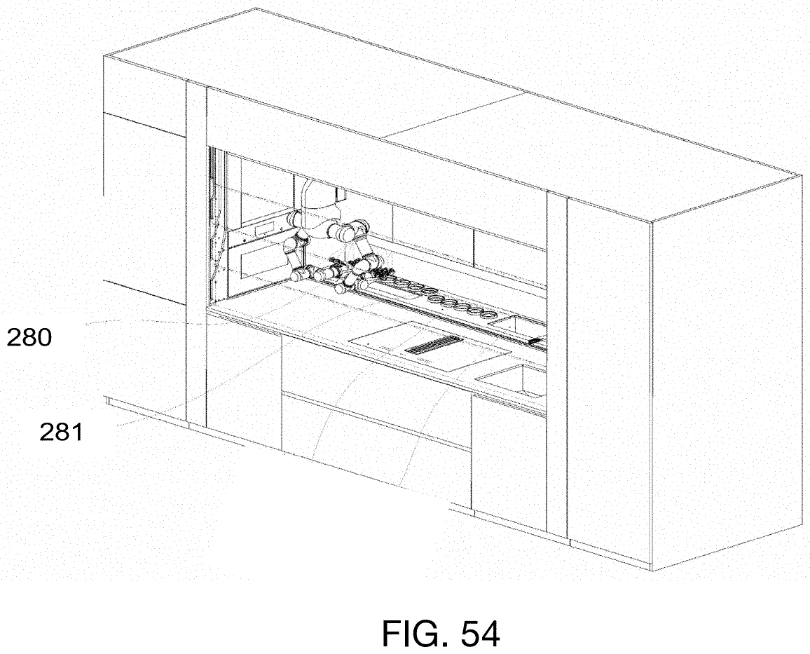

FIG. 54 is a system diagram illustrating a generic storage space with inventory tracking, position allocation and automatic sterilization functionality 280, with an automatic hand sterilization procedure, in accordance with the present disclosure. Inventory tracking device base 281 is visible.

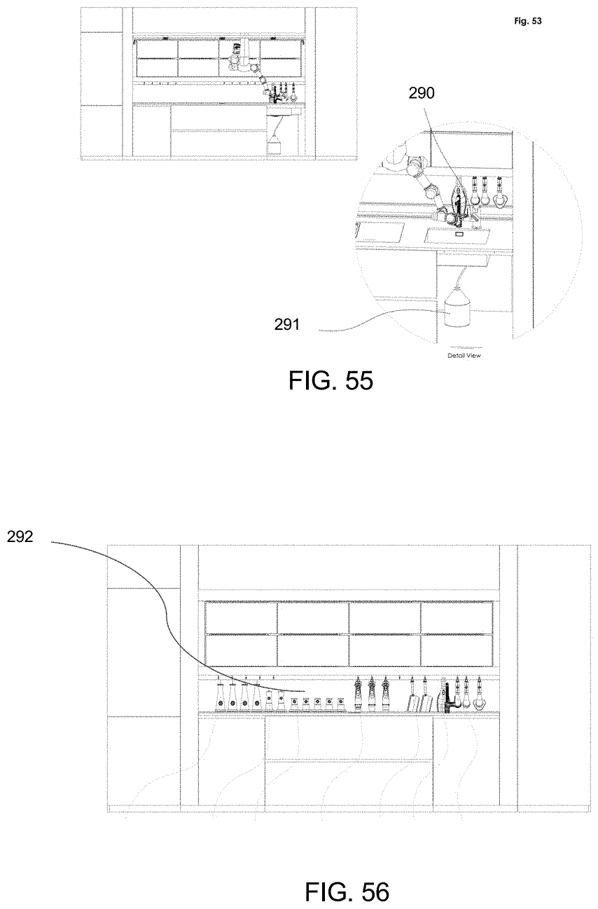

FIG. 55 is a system diagram illustrating a robotic kitchen environment sterilization equipment, with an automatic hand sterilization procedure in accordance with the present disclosure. The robotic kitchen environment sterilization equipment includes various types of cleaning tools 290, with a sterilization liquid tank 291 with automated and manual dispensing vision system responsible for detecting dirt inside the environment and adapting sterilization procedure.

FIG. 56 is a visual diagram illustrating a robotic kitchen in which one or more robotic kitchen equipment 292 are placed inside and under refrigerator storage in accordance with the present disclosure.

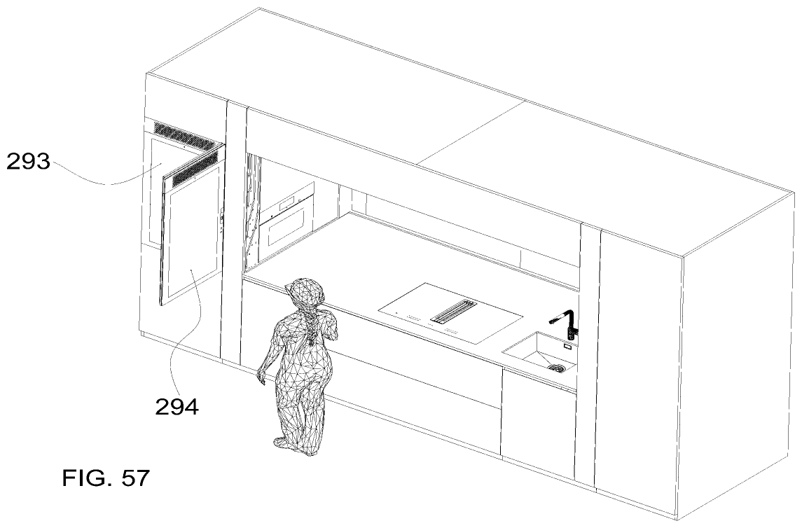

FIG. 57 is a visual diagram illustrating a human user operating a graphical user interface (“GUI”) screen in accordance with the present disclosure.

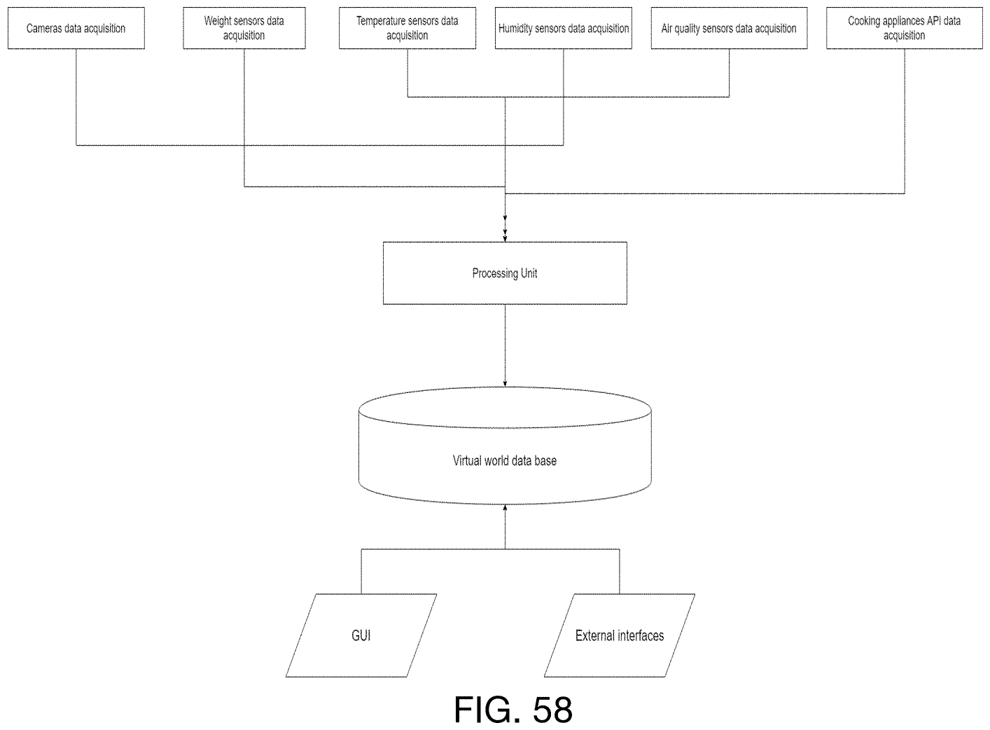

FIG. 58 is a system diagram illustrating a virtual world real time update data stream diagram in accordance with the present disclosure.

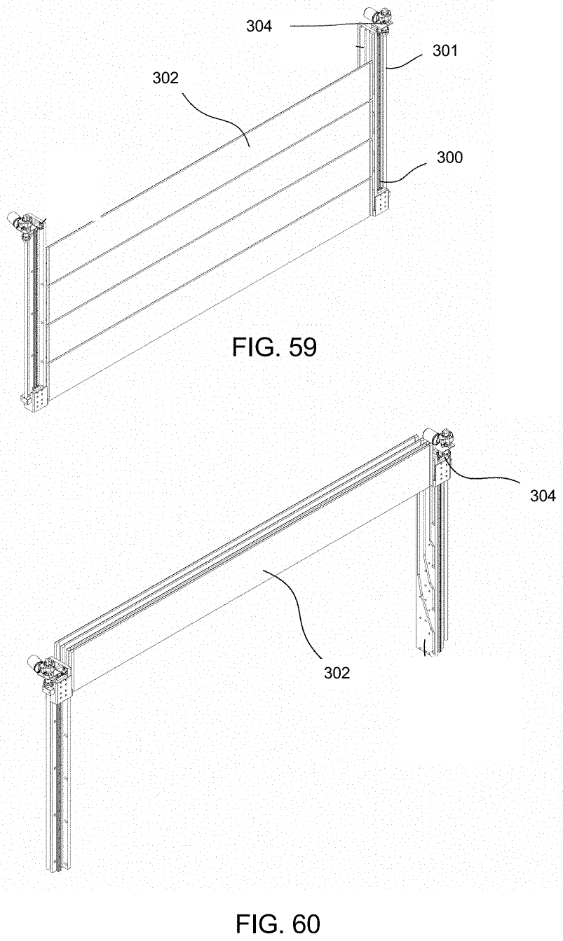

FIG. 59 is a visual diagram illustrating automated safeguard closed position (of a robotic kitchen) in accordance with the present disclosure.

FIG. 60 is a visual diagram illustrating a system with an automated safeguard opened position (of a robotic kitchen) in accordance with the present disclosure.

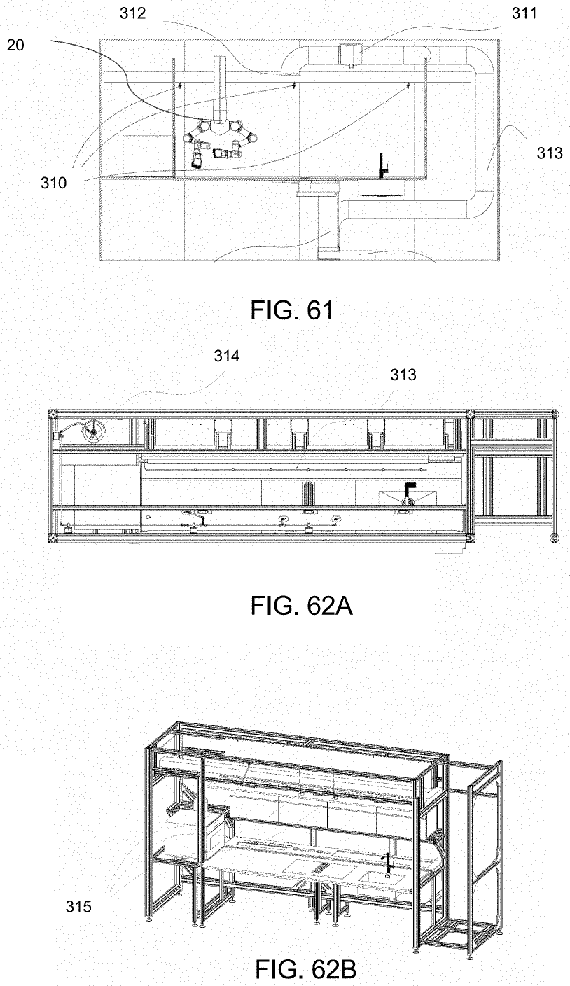

FIG. 61 is a block diagram illustrating a smart ventilation system inside of a robotics system environment in accordance with the present disclosure.

FIGS. 62A and 62B are block diagrams illustrating a top view of a fire safety system along with the indications of nozzles 315 and fire detect tube 313, agent bottle 314 in accordance with the present disclosure.

In one embodiment, a manipulation system in a robotic kitchen includes functionalities as to how to prepare and execute a food preparation recipe, macro manipulation, micro minimanipulation, action primitive, other core components, how a manipulation uses parameter mapping to action primitives, how a system manages default postures, how a sequence of action primitive is executed, a macro/micro action primitive, a micro posture, how the system in a robotic kitchen works with pre-calculated joint trajectories and/or with planning, and the creation process with reconfiguration, as well as elaboration on manipulation to action primitive (AP) to APSB structure.

In one embodiment, a robotic kitchen includes N arms, i.e. the robotic kitchen comprises more than two robot arms. In one example, the robotic arms in a robotic kitchen can be mounted in multiple ways to one or more moving platforms. Some robotic kitchen examples include: (1) three arms single platform, (2) four arms single platform, (3) four platforms and one arm per platform, (4) two platforms with two arms per platform, or any combination and additional extensions of N arms, M platforms. Robotic platforms and arms may also be different, such as having more or less degrees of freedom.

In default postures, robot default postures are typically defined for each robot side: left, right, or dual. Other robotic kitchens may have more than two arms, represented by N arms in which in case a posture for each arm can be defined. In one embodiment of a typical robotic kitchen, for each side, there is a list of possible objects, and for each one object there is one and only one default posture. In one embodiment, default postures are only defined for arms. Torso is typically at predefined centre rotation and height and the horizontal axis is decided at runtime.

An empty hand could refer to a left side, a right side, or a dual side. Held objects can also be on the left side, the right side, or the dual side.

A manipulation represent a building block for a food preparation recipe. A food preparation recipe comprises a sequence of manipulations, which could occur in sequence or in parallel. Some examples of manipulations: (1) “Tip contents of SourceObject onto TragetZones inside a TargetObject then place SourceObject at TargetPlacement”; (2) “Take Object from current placement and place at TargetPlacement”; (3) “Stir ingredients with a Utensil into a Cookware then place Utensil at Target Placement”; and (4) “Select the Temperature of the CombiOven”. Each manipulation operates on one or more objects and has some variable parameters to customization. The variable parameters are usually set by a chef or a cook at recipe creation time.

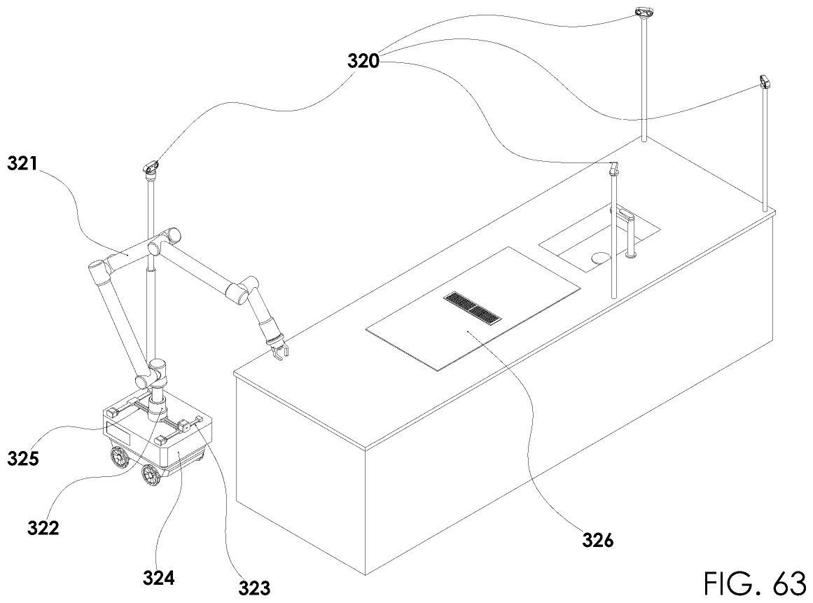

FIG. 63 system diagram illustrating mobile 324 robot manipulator 321 interacting with the kitchen. System sensory data is acquired from sensors 320, robot manipulator is placed on gantry system with X axis 325, Y axis 323, telescopic Z axis 322.

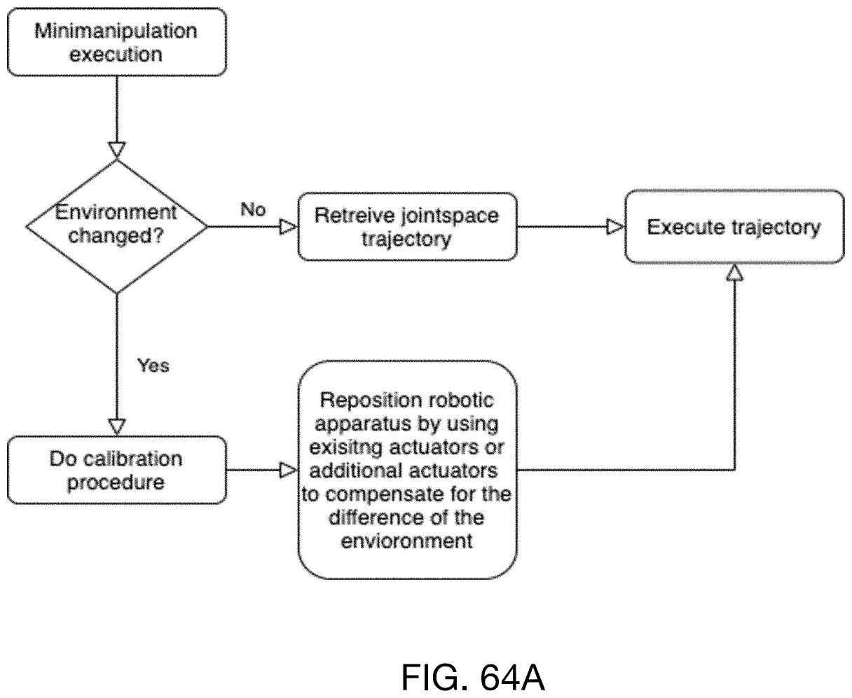

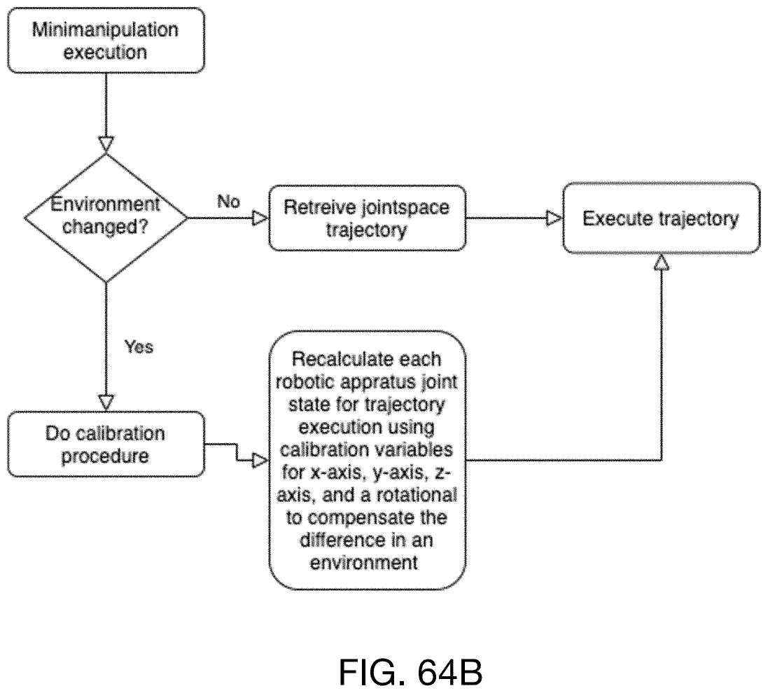

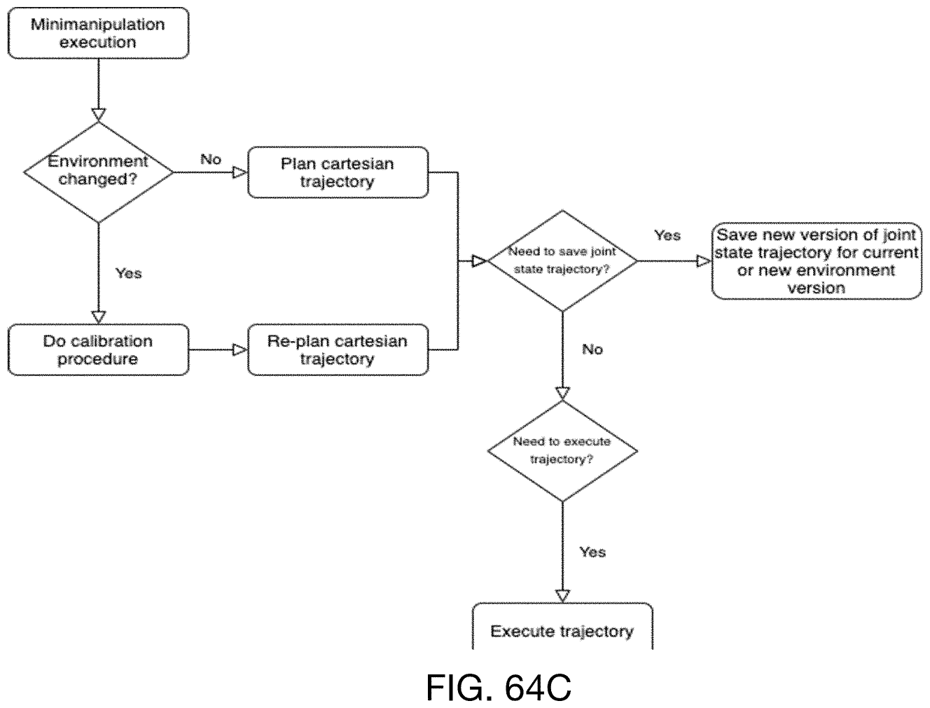

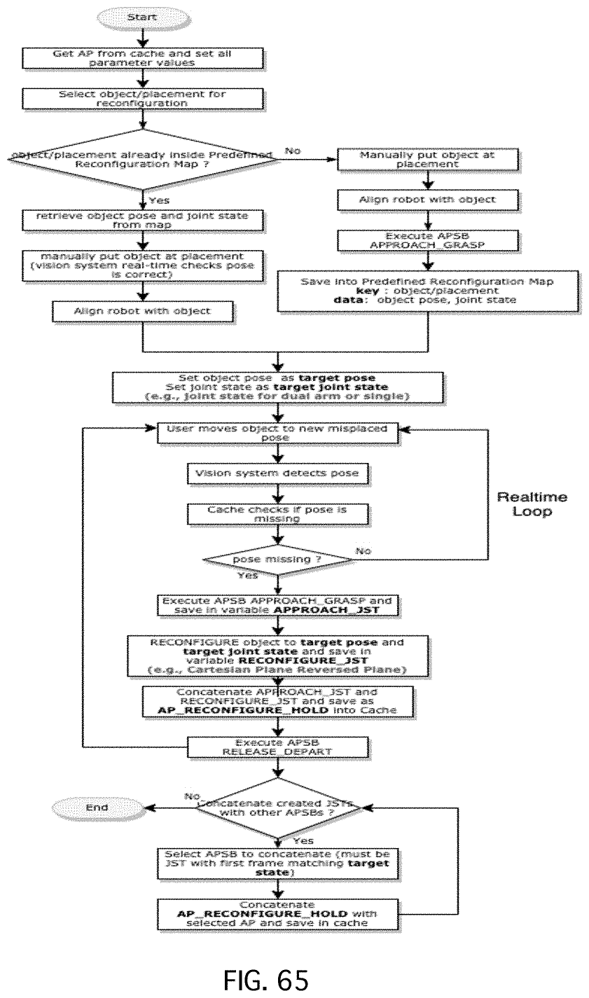

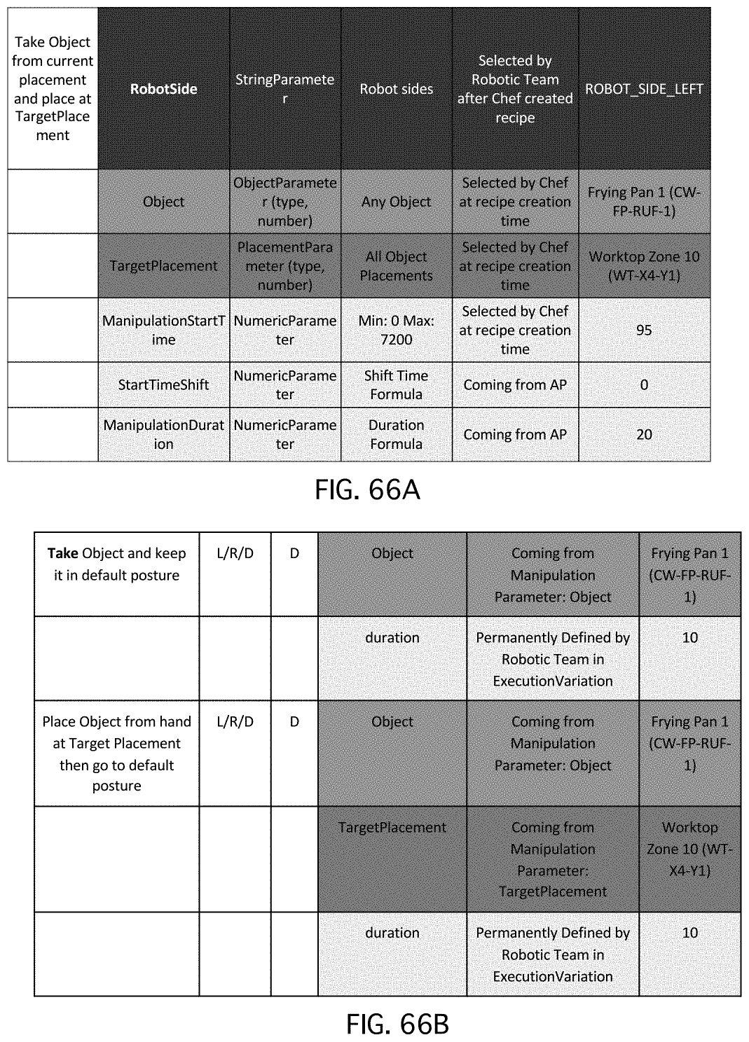

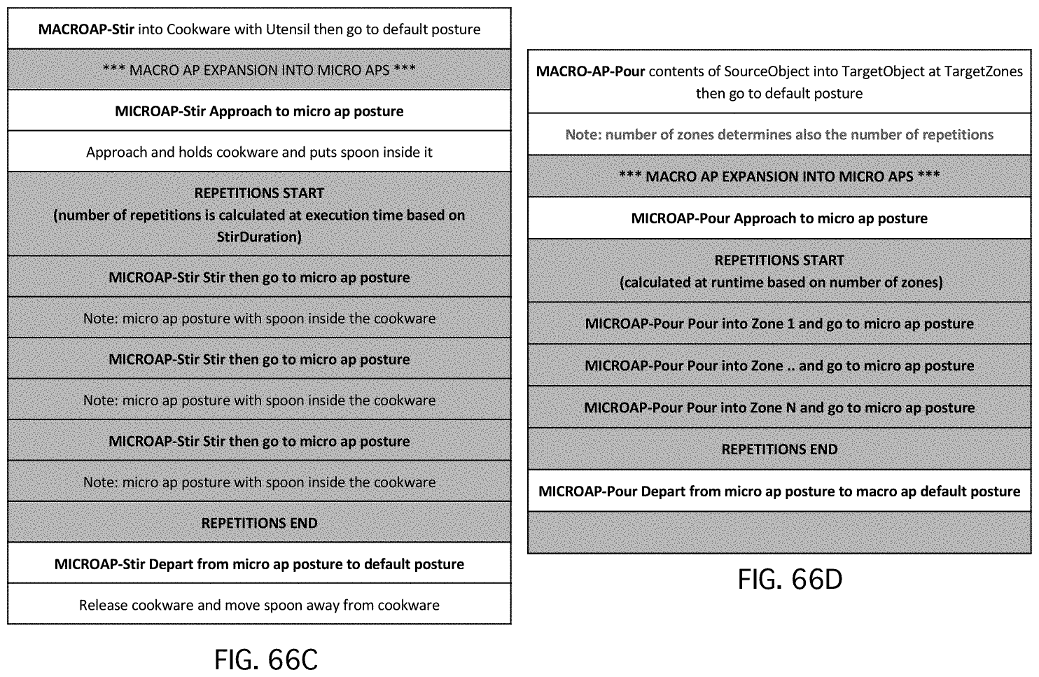

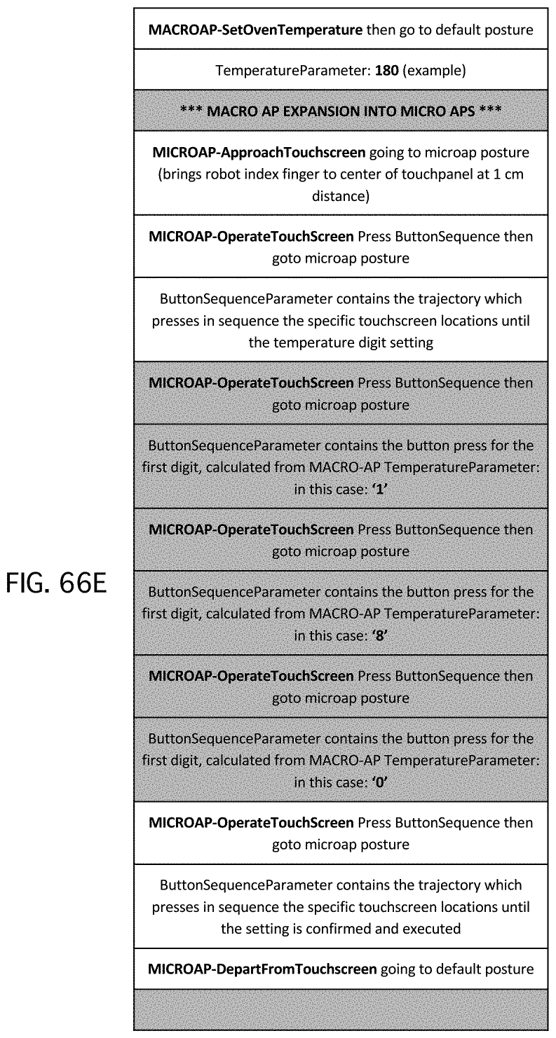

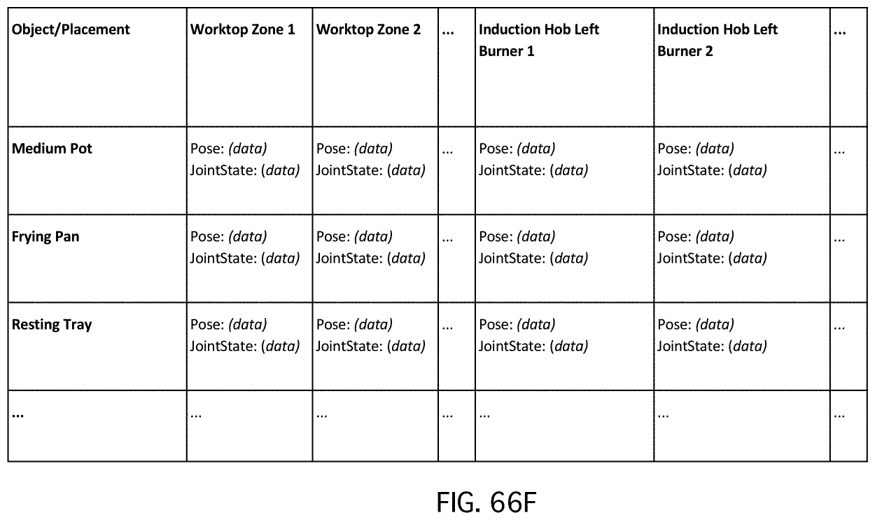

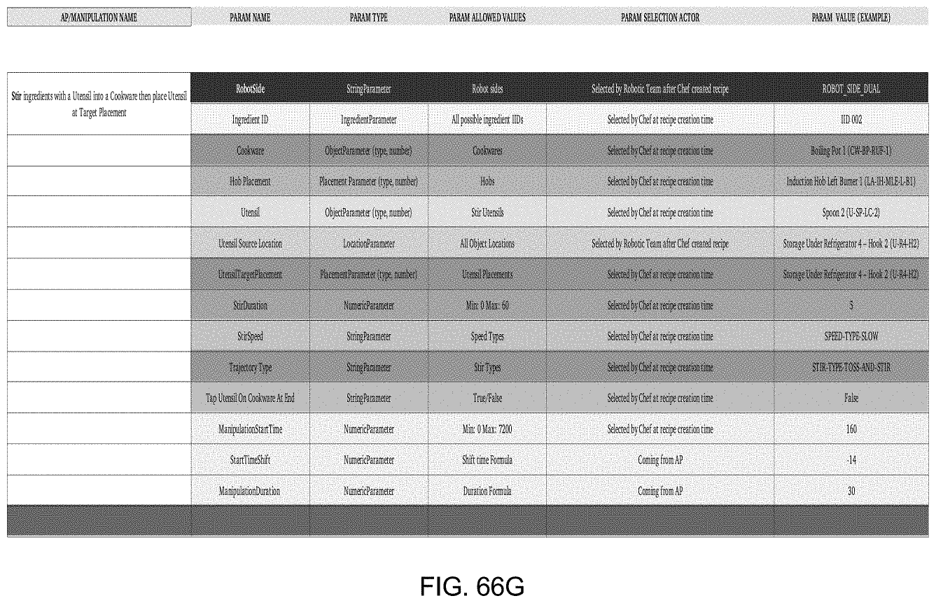

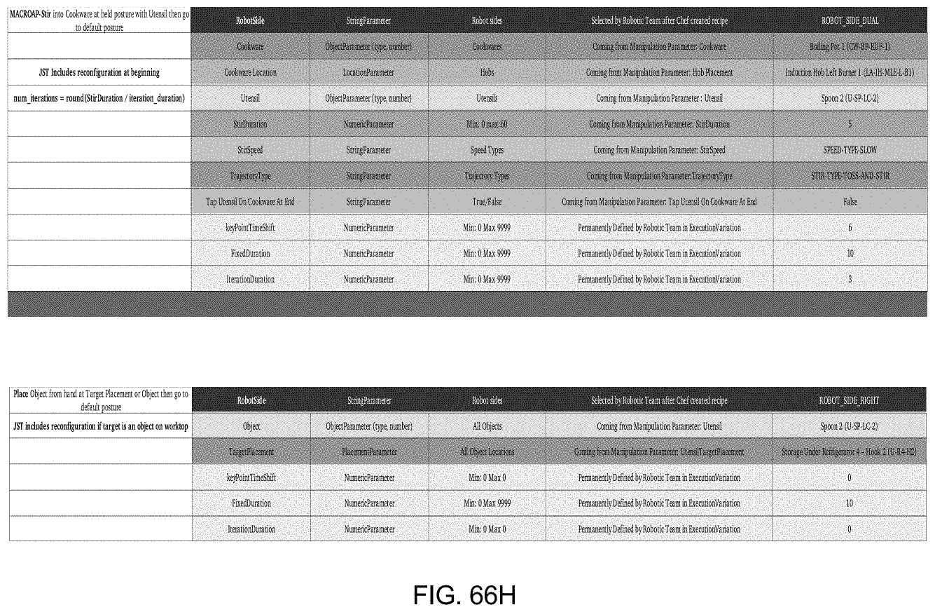

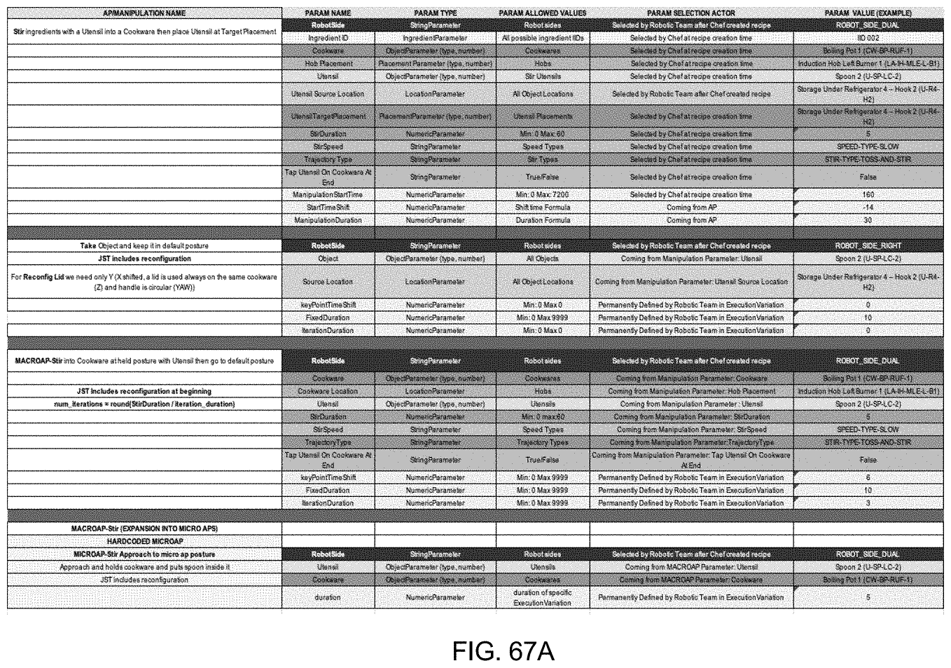

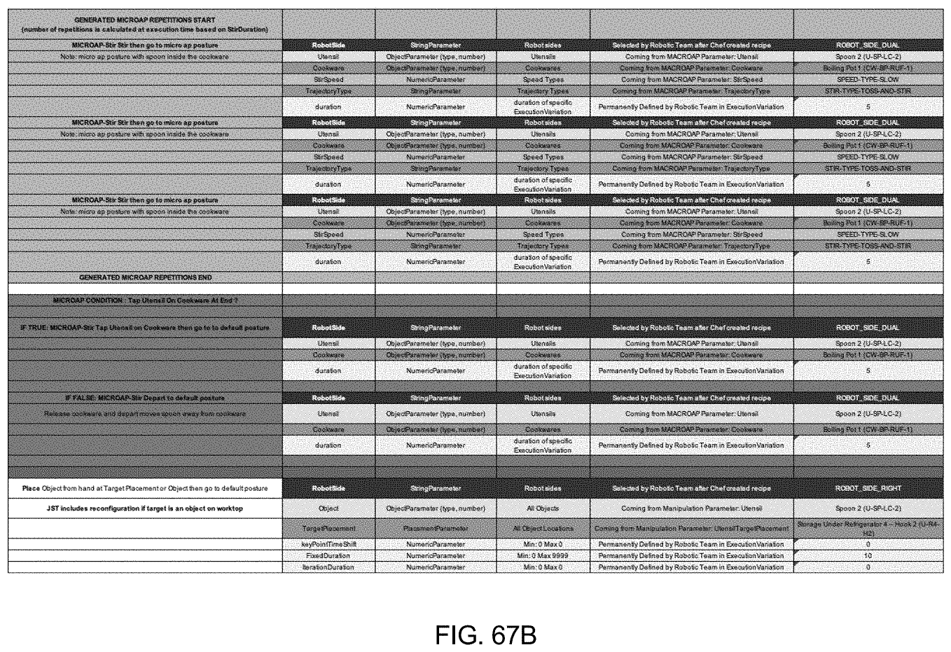

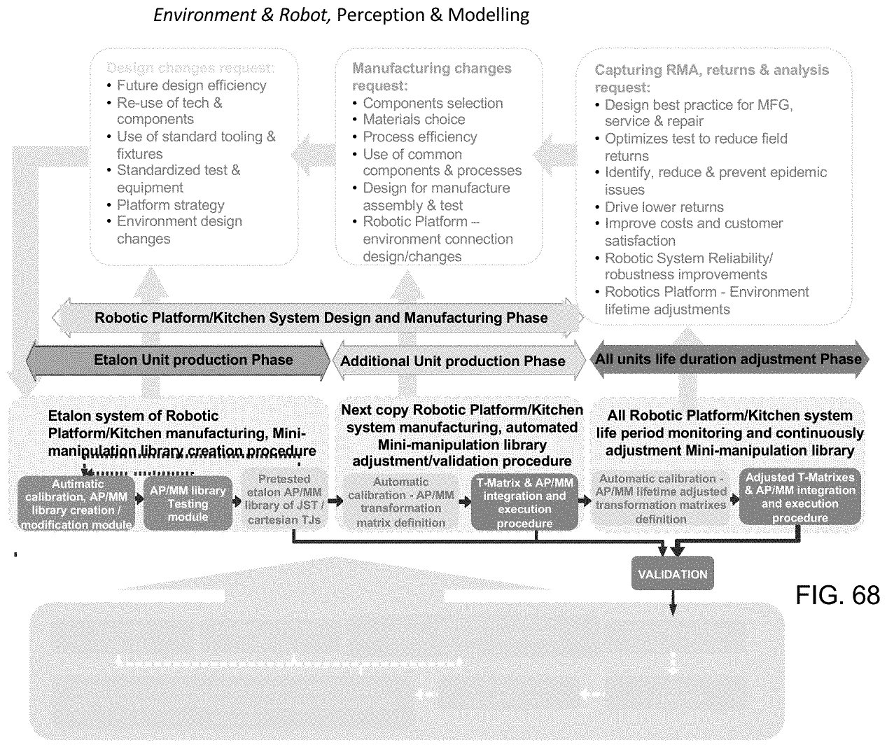

FIG. 64A is a flow diagram illustrating the repositioning a robotic apparatus by using actuators for compensating the difference of an environment in accordance with the present disclosure; FIG. 64B is a flow diagram illustrating the recalculation each robotic apparatus joint state for trajectory execution with x-y-z and rotational axes for compensating the difference of an environment in accordance with the present disclosure; and FIG. 64C is flow diagram illustrating cartesian trajectory planning for environment adjustment. FIG. 65 is a flow diagram illustrating the process of placement for reconfiguration with a joint state. FIGS. 66A-H are table diagrams illustrating one embodiment of a manipulations system for a robotic kitchen. FIGS. 67 A-B are tables (intended as one table) illustrating one example of a stir manipulation to action primitive. FIG. 68 is a block diagram illustrating a robotic kitchen manufacturing environment with an etalon unit production phase, an additional unit production phase, and all units life duration adjustment phase in accordance with the present disclosure.

FIG. 66A shows a sample table in a recipe creation and the relationships with manipulations and action primitives. In the example with manipulation parameters, to take a frying pan an put on the left burner of the induction hob, a chef uses the manipulation: “Take Object from current placement and place at TargetPlacement” and will set the internal parameters this way. In the second column of FIG. 67A, the parameter names show that: Object, TargetPlacement, ManipulationStartTime, StartTimeShift and ManipulationDuration.

Each parameter's value can be set choosing from a predefined allowed list of values (or also range, if it's numeric). Only selectable parameters can be set, others are automatic and cannot be changed by the user which creates the recipe but are a property of the manipulation itself. Selectable parameters which can be set by the user: Object, TargetPlacement, and ManipulationStartTime.

Automatic parameters (property of the manipulation) include StartTimeShift and ManipulationDuration. The automatic parameters are used by the recipe software to manage the creation of the recipe. Some of the automatic parameters can have more than one possible value, depending on the specific values of the selectable parameters.

An Action Primitive (AP) represents a very small or small functional operation, where a sequence of one or more APs compose a Manipulation. For example, the Manipulation is shown in FIG. 67A, while is composed of a sequence of Action Primitives as shown in FIG. 67B. Each manipulation parameter is mapped to one or more action primitive parameters.

The first thing to explain is the side: it can be Left/Right/Dual. For 1 hand operation its only R/L, for dual hand operation it's D.

Note: In other kitchens there may be more than 2 arms, let's say N arms, in that case instead of the variable ‘side’, a vector of arm ids can be used. For example arms_used: [1], or arms_used: [1,2,3], or arms_used: [1,5], any combination can be valid.
In this example Dual is used (‘D’), because the frying pan has 2 handles so 2 hands are needed.
Another dual ap example is “Stir”, because we need one hand to hold the cookware and another hand to move the utensil (spoon for example)
1.1 Manipulation Execution and arm alignment
In the above example:
1. Required Arm base (can also be more arms) is shifted (along the possible axis, depending on the particular kitchen configuration) until it's aligned with the object to take
2. The 1^{st} AP, starting from default posture, approaches and grasp the Frying Pan, then lift it up, then go to default posture
3. Required Arm base (can also be more arms) is shifted (along the possible axis, depending on the particular kitchen configuration) until it's aligned with the target placement
4. The 2^{nd} AP, starting from default posture, places the Frying Pan at the target placement, then release it and go back to default posture

### 2 Recipe Preparation

### 2.1 Compilation

As we previously said, the recipe comprises of a list of Manipulation, where each manipulation is filled with a value for each customizable parameter.
Once each parameter value has been set, for each manipulation, then the recipe is considered complete.
This process of compiling the recipe is done by the chef using Recipe Creator Application

### 2.2 Ingredient Preparation

Once the recipe is compiled, the Cooking Process Manager Application can be started for the next step: Ingredient Preparation.
For each ingredient specified in the recipe (as parameters in the several manipulations), the application will guide the user (typically the owner of the kitchen) to put the specific ingredient inside a specific container, and to put the container in a specific free compatible slot of the kitchen.
The preparation process must be done only once.
Once it's done, the system knows in which container each ingredient is stored, for that specific recipe. Other recipes will have a separate set of assigned ingredients/containers/slots, even if the ingredients used are the same: this limitation is applied to ensure each recipe has exclusive access and availability of its own ingredients.
This information is stored inside an ingredient assignment map.
Each container is an object as the other objects (cookwares, utensils) and it refer to each container with an object parameter which specifies the object type and the object number.
Example of the assignment map after ingredient preparation:
Rice is stored in object_type: medium_container, object_number: 1
Garlic is stored in object_type: medium_container, object_number: 2
Potato is in object_type: long_container, object_number: 1
Salt is in object_type: spice_container, object_number: 1
Pepper is in object_type: spice_container, object_number: 2
Oil is in stored in object_type: bottle, object_number: 1
Red Wine is in stored in object_type: bottle, object_number: 2
Water is in stored in object_type: bottle, object_number: 3

### 2.3 Recipe Conversion

Once the ingredient preparation is done, the recipe must be converted for the robotic system.
The robotic system works only with objects, not with ingredients (a part specific special Manipulations that we will explain afterwards).
So each Ingredient Parameter used in the recipe must be replaced by the Cooking Process Manager to an Object Parameter of the type/number as specified in the ingredient assignment map.
Once the recipe is converted this way, is saved and it's ready to be executed (now or in a future moment, depending on the user's choice).
The conversion process must be done only once.

### Recipe Execution

Once the recipe is converted as explained above, it can be executed by the Cooking Process Manager (aka CPM) and the AP Executor.

### Execution:

1. The CPM processes each manipulation at the time specified in the ManipulationStartTime parameter.
2. For each Manipulation, each AP is sent to the AP Executor and it's executed by the robotic system.
3. The outcome of each AP is sent back to CPM: if not successful the CPM can decide to do it again or abort the recipe.

### AP Execution

Each AP is executed by AP Executor, which reads all parameters, shifts the arm or the platform so it's aligned with the required object or placement, then finally executes the AP.
Each AP starts and ends with a default posture, based on: robot side, held object/s.
This means that the AP execution will start with a default posture and end with a default posture. The start/end posture will be different if during the AP the object is grasped or released.
The following example is based on a simple kitchen configuration with one moving platform with 2 arms (left and right).
4.1 Example: AP sequence
Initial kitchen state

### AP No 1

name: TAKE Object
Variable Parameters: Object, side
Assigned parameter values:
   Object.type: spoon
   Object.number: 1
   side: left
Default Posture configuration
   startposture_left_object: NONE
   startposture_right_object: ANY
   endposture_left_object: Object
   endposture_right_object: ANY
      Align with object
      Note: Robot moved left close to the spoon aligning the left arm base with the spoon handle

### AP Execution

Start posture
side:left, object_type:NONE
side:right, object_type:ANY

End posture
side:left, object_type:spoon
side:right, object_type:ANY

### AP No 2:

name: TAKE Object
Variable Parameters: Object, side
Assigned parameter values:
   Object.type: medium_container
   Object.number: 3
   side: right
Default Posture configuration
   start_posture_left_object: ANY
   start_posture_right_object: NONE
   end_posture_left_object: ANY
   end_posture_right_object: Object
      Align with Object
      Note: robot moved right close to container aligning the right arm base with the container handle.

### AP Execution

Start posture
side:left, object_type:ANY
side:right, object_type:NONE

End posture
side:left, object_type:ANY
side:right, object_type:medium_container

AP No 3:
name: MOVE STICKY INGREDIENT from SourceObject into TargetObject with Utensil
Variable Parameters: SourceObject, TargetObject, Utensil, side
Assigned parameter values:
   SourceObject.type: medium_container
   SourceObject.number: 3
   TargetObject.type: frying_pan
   TargetObject.number: 1
   Utensil.type: spoon
   Utensil.number: 1
   side: dual
Default Posture configuration
   start_dual_posture_left_object: Utensil
   start_dual_posture_right_object: SourceObject
   end_dual_posture_left_object: Utensil
   end_dual_posture_right_object: SourceObject
      Align with Object
      Note: robot moved down close to frying pan aligning the robot platform with the center of the frying pan.

### AP Execution

Start posture
side:left, object_type: spoon
side:right object_type: medium_container

End posture
side:left, object_type:spoon
side:right object_type: medium_container
   Ap Execution: The stirring ap is performed (not shown here) and the robot moves to the end posture (in this case it's the same as the start posture because the held objects are the same.

### 5 Micro/Macro Action Primitives and Micro Postures

### 5.1 MicroAP

Action Primitives can execute a single functional action, which is composed by a pre-determined number of internal steps.
For some special APs, the number of internal steps may depend on the ap parameters specific values, so it cannot be pre-determined once for all.
For example when stirring some contents inside a frying pan with a spoon, we need to do it for a specific time, specified by the duration parameter.
The core robotic movement of a stirring action comprises of the held spoon moved in a circle inside the cookware. It also may not be a circle, but the simplification we made for the kitchen system is this: the spoon performs ‘some stirring movement’ inside the cookware, with the spoon starting and ending at the same specific pose inside the cookware.
This can schematically described this way:
The core action for stir comprises of a movement for the utensil (spoon) wrt the cookware, where:
start/end utensil pose wrt cookware is the same
start/end jointstate for robot is the same (dual side joint state in this case)
   This core-action is called microAP (micro action primitive).
   The start/end jointstate for robot inside this mircoAP is called micro-default-posture.
   The micro-default-posture is something completely unrelated to the default postures that we discussed earlier, and it's used only in its specific microAP.

### 5.2 MACROAP

MicroAPs cannot be executed alone, but only in a sequence of microAPs packed together in a special AP called MACROAP.
This sequence of microAPs is not pre-defined: for example depending on the stirring time, a certain number of required microAP stirring steps is dynamically created at runtime and the sequence is updated.
The MACROAP can also contain some pre-defined microAPs, usually at the beginning and end of it, other than the dynamically created ones.
The execution of the MACROAP Stir is described below. 67 C

### 5.2.1 MACRO-AP Stir

The microAP: Stir Approach is always at beginning of MACRO-Stir
The microAP: Stir Depart is always at end of MACRO-Stir
All the microAPs: Stir Stir are dynamically created at the beginning of the MACROAP execution, based on the parameter: “StirDuration”.
Each microAP, apart the last one, brings the robot to the micro-ap-posture with spoon inside the cookware at the place of start/end of stirring.
In this example we discussed AP Stir, but there are also other types of microAPs, which are calculated based on different parameters as we can see below.

### 5.2.2 MACRO-AP Pour

### 67D

Each microAP, apart the last one, brings the robot to the micro-ap-posture with source object above the center of target object.

### 5.2.3 MACRO-AP SetOvenTemperature

### 66E

Each microAP, apart the last one, brings the robot to the micro-ap-posture with index finger in front of the center of the touchscreen at 1 cm distance

### 6 Planning Modes

The Robotic Kitchen can execute an AP in several different planning modes:
pure real-time planning
   motion plan
   cartesian plan
mixed mode
   motion plan and pre-planned JST
   motion plan, cartesian plan and pre-planned JST (depending on the AP or the internal AP part)
   other combinations of motion plan, cartesian plan, pre-planned JST
pure pre-planned JST
   The pure real-time planning mode allows to execute an AP wherever the manipulated object is located in the kitchen, because the JST is planned right before the execution, based on the object position detected by the vision system.

The drawback is the calculation complexity, it can take much time depending on the complexity of the problem (number and complexity of collision objects, working space, duration and properties of the trajectory, number of robot's degrees of freedom)

This calculation complexity can be a problem for the motion planning, but even more for the cartesian planning, because it may cause long delays before the execution can be done, and it could also find a solution (the planned JST) which could be non optimal for the requirements, for several reasons.
This is a well known problem in robotics.
In order to avoid this problem, in some cases the robotic system can work with a pre-planned JST, which was previously tested multiple times and saved inside a cache, and then it can be retrieved and executed when required.
It's also possible to make the robotic system to work with only pre-planned JSTs.
In the following chapter is explained the method for using pre-planned JSTs.
6.1 Pre-planned JST mode
An Action Primitive with pre-planned JST can work only on a pre-defined object placement and pre-defined object pose in the kitchen.
The pre-planned JST works only if the operated object pose is the one (or it's very close to the one) used when the JST was initially planned.
If an object moves from it's pre-defined placement the AP doesn't work any more and the robot will collide with or miss the object to manipulate.
To overcome this problem, we decided to pre-plan, for each AP, a set of JSTs for each combination of objects/placements.
This set contains each possible object pose (wrt kitchen structure coordinate frame system) inside a limited area around the specified placement.
All these JST sets are saved inside a cache in the software system. When an AP is executed, the system retrieves from the cache the JST for the specific combination of object_type/placement/object_pose Example of query to the cache:

Query parameters:
AP name: TAKE
object_type: frying_pan
object_placement: left_hob_1
object_pose:
   x: 1 m
   y: 20 m
   z: 0 m
   yaw: 10 deg
Note: The number and name of parameters can be different, it's a vector with dynamic size.
This means we can ask to cache using different combinations of parameters, having different filtering rules in order to obtain the required JST.
   The Cache returns the JST associated to the above parameters.
   The reason to specify the placement (lef_thob_1) is because the AP was designed for that placement, but the object could have been moved so much to go closer to a different placement (example: right_hob_1) then we want to be sure the system executes the full AP designed for the original placement and not another one.

### 1 Overview

In the JST Kitchen each Action Primitive expects the manipulated object is located at a pre-defined pose in the kitchen and the robot state is at pre-defined posture.
Sometimes the object to manipulate may move from the pre-defined pose, then the AP cannot be executed.
Reconfiguration is a method to bring back the object to the pre-defined placement and the robot to the pre-defined posture, so then the AP can be executed.
Pre-defined data

### 2.1 Supported Predefined Placements

In the kitchen we have some pre-defined placements where an object is not mechanically constrained, so it may move unexpectedly:
Induction Hob Left Burner 1 (LA-IH-MLE-L-B1)
Induction Hob Left Burner 2 (LA-IH-MLE-L-B2)
Induction Hob Right Burner 1 (LA-IH-MLE-R-B1)
Induction Hob Right Burner 2 (LA-IH-MLE-R-B2)
Worktop Zone 1 (WT-X1-Y1)
Worktop Zone 2 (WT-X1-Y2)
Worktop Zone 3 (WT-X1-Y3)
Worktop Zone 4 (WT-X2-Y1)
Worktop Zone 5 (WT-X2-Y2)
Worktop Zone 6 (WT-X2-Y3)
Worktop Zone 7 (WT-X3-Y1)
Worktop Zone 8 (WT-X3-Y2)
Worktop Zone 9 (WT-X3-Y3)
Worktop Zone 10 (WT-X4-Y1)
Worktop Zone 11 (WT-X4-Y2)
Worktop Zone 12 (WT-X4-Y3)

### 2.2 Supported Objects

For each pre-defined placement, any Object which can be placed on it must be supported by reconfiguration, because it may move unexpectedly during the recipe execution.

### 2.3 Supported Predefined Object Poses

The object pose is expressed as mesh_origin frame wrt kitchen structure frame.

For each pre-defined placement/object combination, the reconfiguration data is defined as:
object pose wrt kitchen
robot reconfiguration posture

These data can be called predefined reconfiguration map and must be saved in a permanent structure in the system and used by the reconfiguration process. It can be yaml, DB, ros msg or any other appropriate data structure usable at runtime.

### 2.3.1 Example: Predefined Reconfiguration Map

### 2.3.2 67F

### 3 Reconfiguration Process

For each used placement/object combination (used by any AP), a set of misplaced-object-poses must be supported.

For each misplaced-pose, a JST should be created and saved in cache.

These JSTs may be too many, so the solution is to use a range.

When object is inside this range, 1 JST is used.

So for example we can define for frying pan on hob 1, 20 possible ranges for Y and 20 for YAW, and we can discard Z (always 0) and X (orthogonally shifted by gantry which moves the robot platform).

Then in this case we need to create 20×20=400 JST and save all of them inside the cache.

### 3.1 Sharing Reconfiguration

For other placements which only differ by X, reconfiguration can be shared by shifting X (example: Induction Hob Left Burner 1 and Induction Hob Right Burner 1)

In some cases this could be also applied to other axes (example: Z axis).

### 3.2 Creation Process

See flow chart in the next page.

* * * IMPORTANT * * * : we want to keep in cache all the created reconfiguration APs before final concatenation in the full AP, because if in the future we need to correct or recreate the subsequent AP (example: STIR) we don't have to re create all the JSTs !

### Stir Manipulation

[1] A Manipulation (‘Stir’ in the example) comprises of several parameters and a sequence of APs.
[2] The Recipe Creator performs a Parameter Propagation Step from AP to Manipulation. Example: it set the value of ManipulationDuation based on the value of AP Duration parameter of each AP in the sequence.
[3] The manipulation parameters are propagated to ap during the recipe preparation step, by CookingProcessManager, to set the ap parameters of each ap in the sequence. This process propagates some parameters from manipulation to ap (almost all of them,).
[4] Each manipulation parameter is selected by different actors at different moments. Some manipulation parameters are selected by Chef at recipe creation time: ‘Ingredient ID’, ‘Cookware’, ‘Hob Placement’, ‘Utensil’, ‘UtensilTargetPlacement’, ‘StirDuration’, ‘StirSpeed’, ‘TrajectoryType’, ‘Tap Utensil On Cook Cookware at End’, ‘ManipulatioonStartTime’. Some parameters are selected by Robotic Team after Chef created recipe: ‘Utensil Source RobotSide’, ‘Location’. Some parameters are propagated back from the APs in the sequence: ‘StartTimeShift’, ‘ManipulationDuration’.

### Stir Manipulation Expanded in APs

[5] The stir manipulation is composed by 3 APs:
1) Take Object and keep it in default posture
2) MACROAP-Stir into Cookware at held posture with Utensil then go to default posture
3) Place Object from hand at Target Placement or Target Object then go to default posture
   [6] Cooking Process Manager, at the end of the recipe preparation step, outputs the executable sequence of APs, each one with all its parameters set. Each AP in this sequence is associated with a timestamp, calculated based on the Manipulation parameter ‘ManipulationStartTime’ and the ‘Duration’ parameter of each AP before it.
   [7] Cooking Process Manager sends each AP to AP Executor for execution at the timestamp specified in the executable sequence.
   [8] AP Executor will execute each AP one by one, reporting any failure to the Cooking ProcessManager. The next ap is executed only if the previous is successful.
   [9] If an AP execution failed, the CookingProcessManager can decide to apply countermeasures to resolve the problem and try again. This retrial can be done multiple times. Based on internal logic, the CookingProcessManager can decide to abort the recipe if the failure is unresolvable.
   [10] There are 3 types of AP
AP
MacroAP
MicroAP
   [12] The Manipulation can be composed only by AP and MacroAP, but not by MicroAP.
   [13] Cooking Process Manager is not aware of the MicroAP type, indeed it will output a sequence of APs which can be only of these types:
AP
MacroAP
   [13] The simple AP type is just executed directly by the executor. MACROAP-Stir expanded in MICROAPs
   [14] The MacroAP type is composed internally by a sequence of MicroAPs
   [15] AP Executor expands MacroAp into the MicroAPs sequence at runtime, based on the MacroAP parameters.
   [15] Depending on the specific MacroAp, the logic to expand it into MicroAP may vary.
   [16] In the Stir MacroAp, the sequence of MicroAP is composed dynamically, based on the MacroAp parameters.
   [17] In MacroAP, some MicroAps are hardcoded (always present), some are dynamically generated at execution time, some are conditional.
   [18] The Stir MACROAP-Stir is composed by these MICROAPs:
1. (HARDCODED): MACROAP-Stir Approach to micro ap posture
2. (DYNAMICALLY GENERATED):
   1. MICROAP-Stir Stir then go to micro ap posture
   2. MICROAP-Stir Stir then go to micro ap posture
   3. MICROAP-Stir Stir then go to micro ap posture
   4. . . .
3. (CONDITIONAL: Tap Utensil on Cookware at End ?)
   1. (IF TRUE): MICROAP-Stir Tap Utensil on Cookware then go to default posture
   2. (IF FALSE): MICROAP-Stir Depart to default posture

### Stir Manipulation

[1] A Manipulation (Stir′ in the example) comprises of several parameters and a sequence of APs.
[2] The Recipe Creator performs a Parameter Propagation Step from AP to Manipulation. Example: it set the value of ManipulationDuation based on the value of AP Duration parameter of each AP in the sequence.
[3] The manipulation parameters are propagated to ap during the recipe preparation step, by CookingProcessManager, to set the ap parameters of each ap in the sequence. This process propagates some parameters from manipulation to ap (almost all of them,).
[4] Each manipulation parameter is selected by different actors at different moments. Some manipulation parameters are selected by Chef at recipe creation time: ‘Ingredient ID’, ‘Cookware’, ‘Hob Placement’, ‘Utensil’, ‘UtensilTargetPlacement’, ‘StirDuration’, ‘StirSpeed’, ‘TrajectoryType’, ‘Tap Utensil On Cook Cookware at End’, ‘ManipulatioonStartTime’. Some parameters are selected by Robotic Team after Chef created recipe: ‘Utensil Source RobotSide’, ‘Location’. Some parameters are propagated back from the APs in the sequence: ‘StartTimeShift’, ‘ManipulationDuration’.

### Stir Manipulation Expanded in APs

[1] The stir manipulation is composed by 3 APs:
   1) Take Object and keep it in default posture.
   2) MACROAP-Stir into Cookware at held posture with Utensil then go to default posture.
   3) Place Object from hand at Target Placement or Target Object then go to default posture.
[2] Cooking Process Manager, at the end of the recipe preparation step, outputs the executable sequence of APs, each one with all its parameters set. Each AP in this sequence is associated with a timestamp, calculated based on the Manipulation parameter ‘ManipulationStartTime’ and the ‘Duration’ parameter of each AP before it.
[3] Cooking Process Manager sends each AP to AP Executor for execution at the timestamp specified in the executable sequence.
[4] AP Executor will execute each AP one by one, reporting any failure to the Cooking ProcessManager. The next ap is executed only if the previous is successful.
[5] If an AP execution failed, the CookingProcessManager can decide to apply countermeasures to resolve the problem and try again. This retrial can be done multiple times. Based on internal logic, the CookingProcessManager can decide to abort the recipe if the failure is unresolvable.
[6] There are 3 types of AP
   AP
   MacroAP
   MicroAP
[12] The Manipulation can be composed only by AP and MacroAP, but not by MicroAP.
[13] Cooking Process Manager is not aware of the MicroAP type, indeed it will output a sequence of APs which can be only of these types:
   AP
   MacroAP
[13] The simple AP type is just executed directly by the executor.

Calibration of a robotic kitchen can be executed in a different methodologies. In one embodiment, the calibration of the robotic kitchen is conducted with cartesian trajectory. Before any execution of minimanipulation/action primitive, system should check status of environment. In case of no changes, the system will get cartesian trajectory associated with given minimanipulation/action primitive, plan it and execute. In case of changed environment, the calibration procedure should be performed with measuring the actual positions of placements and objects in the kitchen and then providing this data to the system. After this, cartesian trajectory will be re-planned based on updated environment state and then executed.

Calibration with cartesian trajectory diagram description: Before any execution of minimanipulation/action primitive, system should check status of environment. In case of no changes, the system will get cartesian trajectory associated with given minimanipulation/action primitive and plan it. In case of changed environment, the calibration procedure should be performed with measuring the actual state of the system (such as positions of placements and objects in the kitchen) using multiple sensors and then providing this data to the system. After this, cartesian trajectory will be re-planned based on updated environment state. The output from planning is joint state trajectory which can be saved as a new version for current or changed environment. After this, joint state trajectory can be executed.

Calibration with Jointspace Trajectory Diagram Description:

Before any execution of minimanipulation/action primitive, system should check status of environment. In case of no changes, the system will get jointspace trajectory associated with given minimanipulation/action primitive and execute it. In case of changed environment, the calibration procedure should be performed with measuring the actual positions of placements and objects in the kitchen and then providing this data to the system. After this, joint values in joint state trajectory will modified based on updated environment state in order to shift joints and get new robot joint configuration for the whole trajectory along with usage of additional joints for compensation of the movement in all axes (x-y-z) including rotational movements around each axis and then executed.

In another embodiment, the calibration of the robotic kitchen is conducted with a jointspace trajectory. Before any execution of minimanipulation/action primitive, system should check status of environment. In case of no changes, the system will get jointspace trajectory associated with given minimanipulation/action primitive and execute it. In case of changed environment, the calibration procedure should be performed with measuring the actual positions of placements and objects in the kitchen and then providing this data to the system. After this, joint values in jointspace trajectory will modified based on updated environment state in order to shift joints and get new robot joint configuration for the whole trajectory along with usage of additional joints for compensation of the movement in all axes (x-y-z) including rotational movements around each axis and then executed.

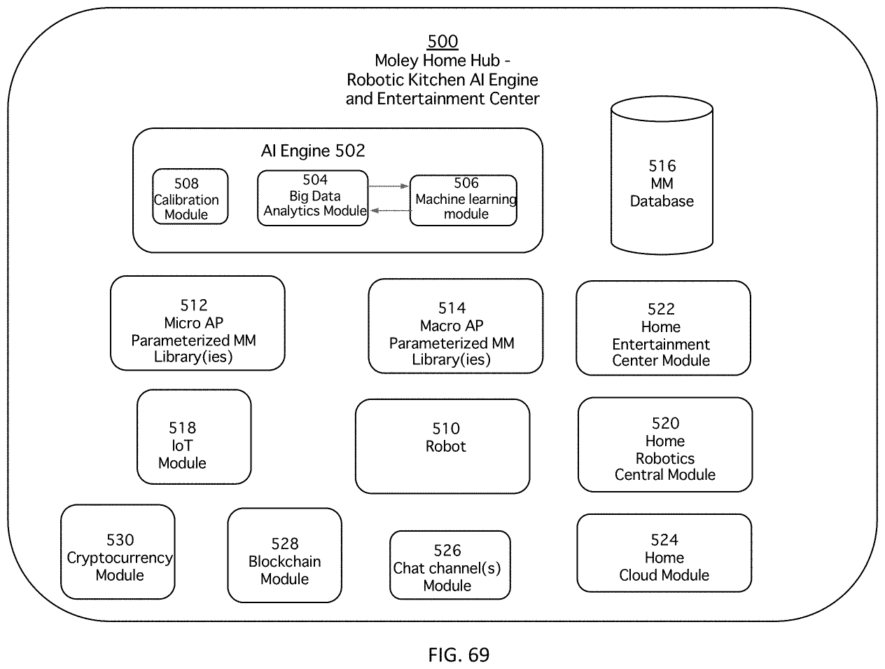

FIG. 69 is a block diagram illustrating a first embodiment of a home hub 500 with a robotic kitchen artificial intelligence (“AI”) engine (“AI Engine”, “AI Brain”, or “Moley Brain) and an home entertainment center. The home hub 500 includes an artificial intelligence engine (“AI Engine”, “AI Brain”, or “Moley Brain) 502 for computing big data analytics from a big data analytics module 502 and a machine learning module 504. The artificial intelligence engine 502 includes a calibration module 508 for calibration the robotic kitchen and other electronic devices in a home or in the vicinity of the home. The robotic kitchen artificial engine 500 and the entertainment center 500 includes a robot 510 that executes one or more micro AP parameterized minminmanipulation (MM) libraries 512, and/or one or more micro AP parameterized minminmanipulation libraries 514 to perform a particular task or a set of tasks by accessing a minminmanipulation database 516. The kitchen artificial engine and the entertainment center 500 includes also includes an IoT module (Internet of things) 518 for connected devices to the Internet to collect and share data with the AI Engine 502. The robot includes one or more robotic arms and one or more robotic end effectors.

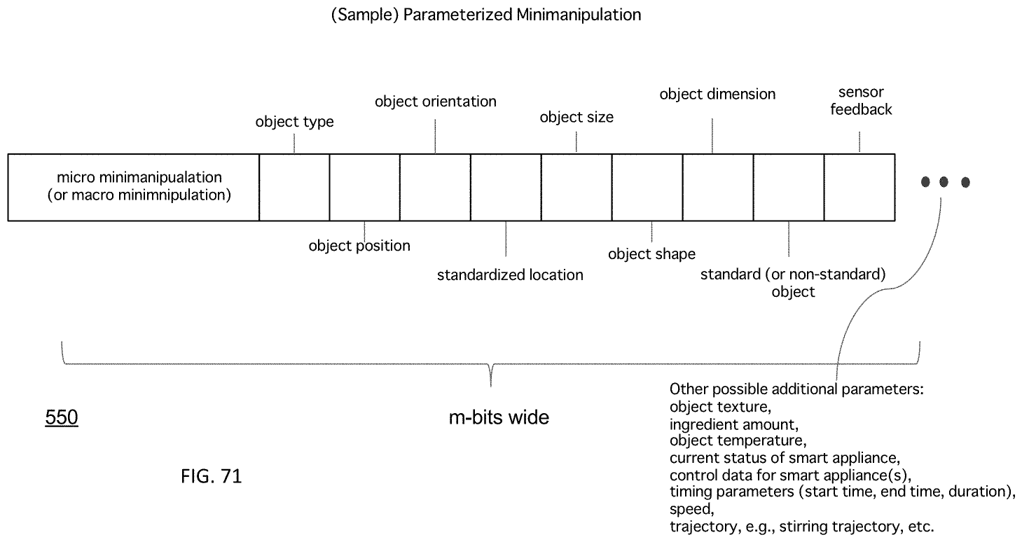

The AI engine 502 may be a hardware, a software, or a combination of hardware and software units, that use machine learning and artificial intelligence to learn their functions properly. As such, the AI engine 502 can use multiple training data sets from the micro minimanimanipulation libraries and macro minimanimanipulation libraries to train the execution units to route, classify, and format the various incoming data sets received from sensors, a computer network, or other sources. The data sets came be sourced from parameterized, pretested minimanipulations, and the parameters in a minimanipulation, as described further in FIG. 71 and configured to be m-bits wide that includes (1) a micro minimanipulation or a macro manimanipulation, and (2) a plurality of bits that are used related to that particular micro minimanipulation or a macro manimanipulation. The plurality of bits in the parameterized and pretested minimanipulation 550 includes an object_type, an object position, an object orientation, a standardized location, an object size, an object shape, an object dimention, a standard (or non-standard) object, one or more sensor feedback signals, an object object, an object texture, an ingredient amount, an object temperature, a current status of smart appliance, a control data for smart appliance(s), one or more timing parameters (start time, end time, duration), a speed, and a trajectory, e.g., stirring trajectory. Some select parameters in a parameterized, pretested minimanipulation may have more impact to the taste of the food dish than other parameters, depending on the particularly minimanipulation to be executed, the object to be cooked, and the taste preference by a user.

The AI engine 502 may use machine learning to continuously train neural network-based analysis units. Training data sets may be used with the analysis units to ensure that the outputs of the analysis units are suitable for use by the system. Additionally, outputs from the analysis units that are suitable may be used for further training data sets to reinforce the suitable/acceptable results from the analysis units. Other types and/or forms of artificial intelligence may be used for the analysis units as necessary. AI engine 502 may be configured such that a single configurable analysis unit is used with the configuration of the analysis unit being changed every time a different analysis/different inputs are used/desired. Conversely, instead of having a single analysis unit per type of analysis to be performed on the data, an analysis unit may have different analysis types that it can perform. Then, depending on the data being sent to that analysis unit and the type of analysis to be performed, the configuration of the analysis unit may be adjusted/changed.

The home hub 500 further includes a home robotic central module 520, a home entertainment module 522, a home cloud 524, a chat channel module 526, a block chain module 528, and a cryptocurrency module 530. The home robotic central module 520 is configured to operate with one or more robotics within a home (or a house, or an office), such as a robot carpet cleaner, a robot humanoid, and other robots, as well as other robots within the vicinity of the home, such as a robo automonous vehicle, an robo lawn mower, and other robots. The home entertainment center 520 serves as the entertainment center control of the home by controlling, interacting and monitoring a plurality of electronic entertainment devices in the home, as a home stereo, a home television, a home electronic security system, and others. The home cloud module 524 serves as a central cloud repository for the home to have the data and control setting at the cloud computing to control the various operations and devices at the home. The chat channel module 526 provides a plurality of electronic chat channels within the members of the household, the neighbors in a community, and service providers generally or in a community. The blockchain module 528 facilitates any blockchain transactions between the home hub and any applicable transactions available on blockchain technology. The cryptocurrency module 530 provides the capability for the home hub 500 to execute any financial transactions that another entity by exchanging cryptocurrency.

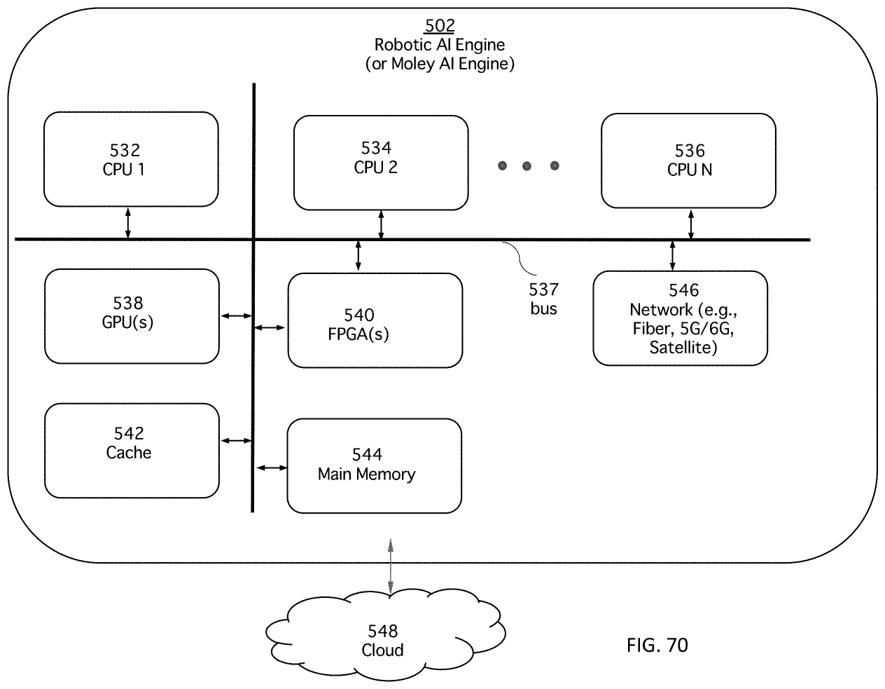

FIG. 70 is a block diagram illustrating the robotic artificial intelligence engine 502 that includes one or more processors (CPUs) 532, 534, 536, one or more graphics processing units (GPUs) 538, and one or more optional field-programmable gate arrays (FPGAs) 540 with one or more caches 542, a main memory 544, for communicating via a network 546 (e.g., 5G or 6G network, a fiber network, WiFi, Bluetooth, etc.), as well as with a cloud computing 548. The electronic components, CPUs 532, 534, 536, GPUs 538, FPGAs 540 with one or more caches 542, a main memory 544, are interconnected on a birdirectional bus 537.

FIG. 71 is a block diagram illustrating an example of a parameterized minimanipulation 550. The parameterized minimanipulation 550 is also referred to as parameterized and pretested minimanipulation 550. The robot executes one or more parameterized minimanipulation 550 to carry out a cooking operation, preparing food, or preparing a food dish. In this example, the parameterized and pretested minimanipulation 550 is configured to be m-bits wide that includes (1) a micro minimanipulation or a macro manimanipulation, and (2) a plurality of bits that are used related to that particular micro minimanipulation or a macro manimanipulation. The plurality of bits in the parameterized and pretested minimanipulation 550 includes an object_type, an object position, an object orientation, a standardized location, an object size, an object shape, an object dimention, a standard (or non-standard) object, one or more sensor feedback signals, an object object, an object texture, an ingredient amount, an object temperature, a current status of smart appliance, a control data for smart appliance(s), one or more timing parameters (start time, end time, duration), a speed, and a trajectory, e.g., stirring trajectory.

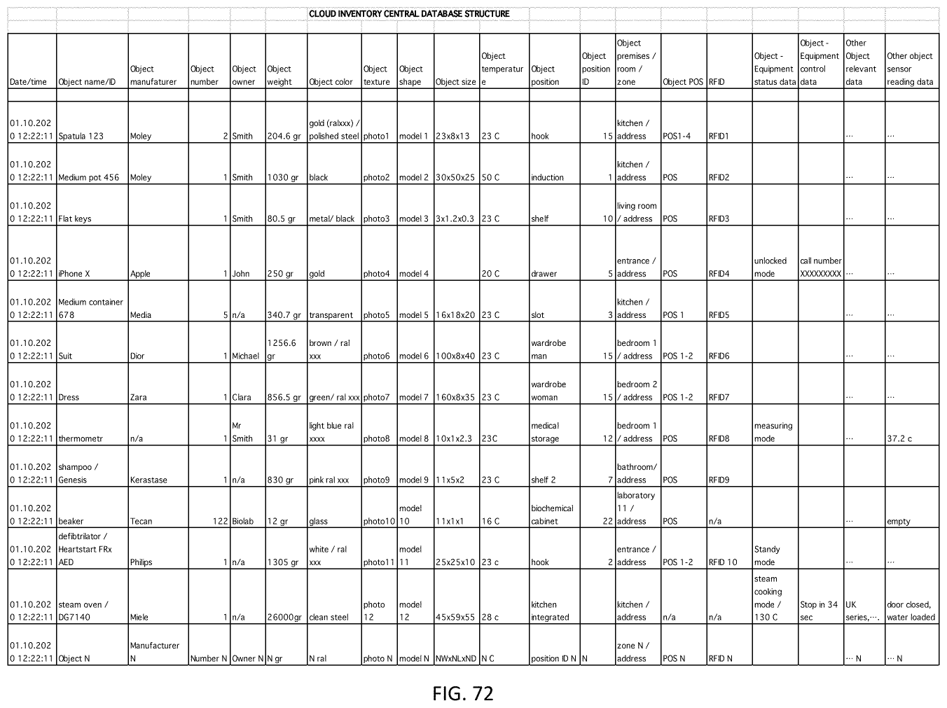

FIG. 72 is a block diagram illustrating an example of a cloud inventory central database structure in executing a sequential operation of minimanipulations with a plurality of data fields (or parameters) on the horizontal rows, and a plurality of dates and times on the vertical columns. The central database provides a central location in a cloud computer (or a local computer) to keep track and store the a list of inventor items for the robotic kitchen. That way, the central processor of the robotic kitchen knows the status and locations of a wide variety of objects in the robotic kitchen, as to facilitate the one or more robotic arms and the one or more robotic end effectors, as well as one or more smart appliances, in navigating within in the instrumented environment of the robotic kitchen. For example, a hook in the robotic kitchen has different positions to place an object on the hook. The central database would maintain the current status and position of the object placed on a particular hook, the one or more robotic arms and the one or more robotic end effectors would know how to properly retrieve the object from the hook. Without such central database structure, the one or more robots and one or more smart appliances may encounter difficulty not only in retrieving an inventory object, but the one or more the one or more robotic arms and the one or more robotic end effectors may clash against an object that has not bee properly identified and tracked.

The object name/ID column lists the various objects, with the respective (or corresponding) object weight, object color, object texture, object shape, object size, object temperature, object position, object position ID, object premises/room/zone, and an associated RFID. Initially, the robotic kitchen through the sensors reads the list of inventory objects. One or more sensors in the robotic kitchen then provides feedback to the cloud inventory database structure to track the plurality of objects as to the different states, different status, current mode, as well keeping track of the inventory items for replacement, and update the timeline of the plurality of objects.

### Calibration

Calibration of any robotic system during multiple points in its life-cycle should be self-evident, regardless of the application. The need for calibration becomes even more pressing for systems that represent substantial system installations based on size and weight due to such issues as material properties as well as shipping and setup and even wear-and-tear over time as a function of loading and usage.

Calibration is essential during and at the conclusion of the manufacture of main subsystems and certainly the finished assembly. This allows the manufacturer to certify and accept the system as performing to the required specifications, thereby also being able to verify to the buyer the system performs to its as-sold performance envelope. Sizeable robot systems, whether due to size and weight and even setup complexity at the customer facility, will require some form of disassembly for the ease and cost-effectiveness of shipping and thus require a setup at the client's facility. Such a setup has to conclude with yet another calibration step to allow the manufacturer to certify, and the client to verify, the systems operation to its advertised performance specifications. Calibration is even a required setup after any maintenance or repair was performed on any one or the overall system assembly. Some systems where utilization is high or even accuracy is critical over the lifetime of the system, or where a large number of components have to work flawlessly together ensuring critical availability, such as in the sizeable robotic kitchen system disclosed herein, it will become important to perform system-calibration at regular intervals. These calibrations can be triggered automatically or be completely automated and self-directed without any human interventions. Such a system self-calibration can even be performed during offline or non-critical times during the utilization-profile of a robotic system, thereby not having any negative impact on the availability of the system to the user/owner/operator.

The importance in calibration to the overall accurate performance of the robotic system, is to be seen in the generation and usage of the calibration data generated thereby. In the case of the robotic kitchen, it is important to carry out measurements of the six-dimensional (mainly cartesian) linear XYZ- and angular agd-offsets between actual and commanded positions of any robotic system. In one of the embodiments in this disclosure, the robot uses an endeffector-held probe capable of making position/angular offset measurements through a variety of built-in internal and external sensor modalities. Such offsets are determined between where the virtual robot representation commands the robot to go to and what the physical world position (linear and angular) is determined to be. Such data is collected at various points, and then used as a locational (and temporal) offset that is fed into the various subsystems, such as the modeling and planning modules, in order to ensure the system can continue to accurately execute all the commands fed to it.

The use of this calibration data is important as it reduces the number and accuracy of required environment sensors that might be needed to continuously measure positional/orientational errors in real time to continuously be used to recompute any trajectories or points along pre-computed trajectories—such an approach would not only be overly complex but also excessively costly in terms of hardware and prohibitive in terms of computational power, software module number and complexity and software (re-)planning and control real-time execution requirements. In effect it represents a critical approach to ensure the robotic kitchen is financially and technically viable, without requiring excessively costly and complex sensing hardware while also simplifying control and planning software, resulting in critically viable approaches and processes to ensure a commercially viable product.

For the specific robotic kitchen being considered here, there are three types of calibration errors that are important to consider: (1) Linear Errors due to deviations in manufacturing and assembly, (2) Non-linear errors due to wear and deformation, and (3) Deviation Errors due to miss-matched virtual and physical kitchen systems—all these three are elaborated on below.

First Embodiment—Deviations in Manufacturing (Linear Differences). In a first embodiment, a manufacturer in production builds many kitchen frames. Due to possible manufacturing imprecisions, physical deviations, or part variations between each kitchen frame, the resulting manufactured kitchen frames may not be exactly identical, which would require calibration to ensure and adjust any deviations of a particular kitchen frame in order to meet the specification requirements. These parameter deviations from the kitchen specification could be, first in a range that is sufficiently small and acceptable, or in a range that exceeds a threshold of a specific parameter deviation range and would require processing through a software algorithm to calculate these differences and add the parameter differences to compensate for the differences between the different kitchen frames to the ideal kitchen frame (etalon). The deviations between a kitchen frame and the kitchen frame specification reflect the linear differences, which then may require linear compensations, e.g., 5 mm or 10 mm. In one embodiment, the robotic kitchen would use simple compensation values for each deviation for all affected parameters, while in a second embodiment it would use one or more actuators accessing the same mini-manipulation libraries (MMLs) to compensate for the linear differences by adjusting x-axis, y-axis, z-axis, and rotary/angular axis. For the first and second embodiments, all MMLs are pre-tested and pre-programmed. The robot will operate in identical joint state spaces, which does not require live/real-time (re-) planning. The MML is a joint state library, with joint state values only in one example.

Second Embodiment—Kitchen Deformation (Non-Linear Differences)/Joint State MML. In a second embodiment, over the course of time in the usage of the robotic kitchen, the kitchen frame may wear and/or deform in some aspects within the kitchen frame relative to an etalon kitchen, resulting in differences manifested as non-linear deformations. In some embodiments, the term “etalon frame” refers to an ideal kitchen without any deformation (or in other embodiments, significant deformation). In an etalon frame, the robot (robotic arms or robotic end effectors) can touch the different points with different orientations in the kitchen frame. The deformation could be linear or non-linear. There are two ways to compensate for these errors. The first way to compensate for these errors is by repositioning the actuators though x-axis, y-axis, z-axis, x-rotation, y-rotation, z-rotation, and any combination thereof, thereby obviating the need to re-calculate the MMLs. A second way is to apply the displacement errors to the transformation matrices and re-calculate the joint state libraries. Since the robotic kitchen utilizes a plurality of reference points to identify and determine specific shifts/displacements, it is straightforward to identify the applicable calibration compensating-parameters/shift-parameters. Calibration compensation variables are thus re-calculated and applied to the mini-manipulation libraries and used to recalculate the joint state table, in order to compensate for the displacements from the reference points.

Third Embodiment—Virtual Kitchen Model and the Physical Kitchen. In a third case embodiment, usually all of the planning is done in a virtual kitchen model. The planning is done inside of a virtual kitchen platform in a software environment. In the third case scenario, mini-manipulation libraries use a cartesian planning approach to execute robot motions. Since the virtual and physical world will differ there will be deviations between the virtual environment and the physical environment. The robot may be executing an operating step in the virtual environment but unable to touch an object in the physical environment it is expecting to touch in the virtual world. If there are some differences between the virtual model of the kitchen and the physical model of the robotic kitchen, there is thus a need to reconcile the two models (between the virtual model and the physical world). Modifications to the virtual model may be necessary to match the physical model, such as adjusting the positions (linear and angular) of the objects in the virtual world to match the objects in the physical world. If the robot is able to touch an object in the physical world, but the robot is unable to touch the same object in the virtual model, the virtual model will require adjustment to match the physical model so that the robot is also able to touch the object in the virtual model. These adjustments are carried out purely in cartesian space through a set of required translations and angular orientations applied to the kinematic robot joint-chain, since the MMLs are structured in cartesian space, which includes the cartesian planner and motion planner to execute any operation.

Calibration is important to create the same virtual operating theater for calculation and execution. If the virtual model is incorrect, and is used for planning and execution in the physical world, the operating procedures that merge the two will not be identical, resulting in serious real-world errors. We avoid this situation by calculating the deviation for each reference point between the physical world and virtual model, and then adjust the geometric dimensions in the virtual model to match a plurality of reference points in the virtual to those reference points in the physical world.

The calibration step that is carried out as an example unfolds as described below. The robot is commanded to touch each reference point with a specific position and a specific orientation, and saves the robot current motor position values and joint values. This data is sent to the joint values in the virtual model, theoretically resulting in the robot in the virtual model to also touch the same reference points. If the robot in the virtual model is unable to touch the required reference points, the system will automatically make adjustments to the applicable reference points in the virtual model so that the robot in the virtual model touches the reference points with the same position and the same orientation (saving all joint values, transferring the joint values to the virtual world, and modifying/changing the virtual model). Thus, the modified set of reference points in the virtual model will match the reference points in the physical world. The modified set of reference points will result in moving and orienting the robot closer to the reference points, or make the robot's end effector longer or arm longer or the position of a gantry system described by a different height. The system will then combine multiple reference points to determine which adjustment to choose, either moving the robot closer to the reference points, or making the robot's end effector or arm longer. Different robot configurations would thus have different ways to touch a single reference point. Iterative and/or repetitive process can determine the best required virtual model modification or adjustment in order to compensate differences and minimize all reference points deviations.

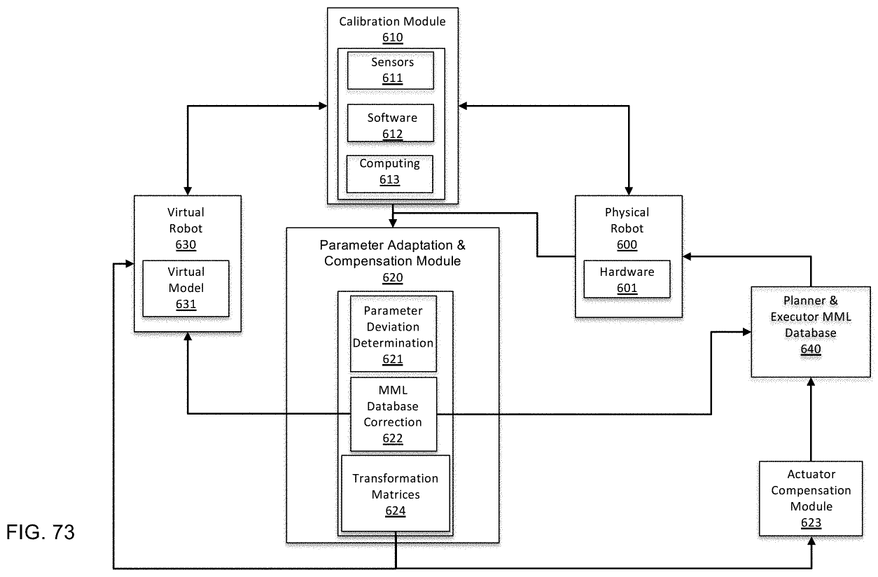

FIG. 73 is a block diagram depicting the process of calibration whereby deviations of the position and orientation of the physical world system are compared to the reference positions and orientations from the virtual world etalon model, allowing a set of parameter deviations to be computed in accordance with the present disclosure. The deviations serve as the basis from which to allow for adaptation in one of three ways: Utilization of the parameter adaptation dataset to (i) modify the virtual world etalon model to match the physical world, or (2) generation of a asset of transformation matrices that are used in real time to modify planned trajectories and velocities to ensure the real-world physical system tracks the desired model-based trajectories, or (3) re-computation of all commanded trajectory-points and -velocities as well as all mini-manipulation libraries (MMLs) using the parameter adaptation transformation matrices. The process of system calibration and adaptation undertaken to update an as-built system database to compensate between the as-sensed configuration of the real-world robotic system and the idealized representation of its configuration in a virtual world model representation. The process is critical to allow for the proper operation of the system and align the virtual representation of the system to the real-world configuration. The process by which an as-built robotic system 600 with all its associated hardware 601, including but not limited to actuators, sensors, structural members, etc., undergoes a calibration in order to ensure the system will perform as expected. Towards that end a calibration software module 610, with software modules 612 responsible to acquire sensory data 611 and process it via multiple computational steps 613. The acquired and processed data is fed by calibration module 610 to the parameter adaptation and compensation module 620. Within the module 620, parameter deviations between an ideal virtual-world representation of the robotic system and the as-measured robot configuration as determined by the sensors 611 is determined in 621, and used to compute transformation matrices 624 and corrective steps made to the MML database 622. The database 622 corrections are then fed to the virtual robot 630 to update its virtual model 631, as well as the real-world planner and executor MML database 640 so as to ensure all MMLs are updated for proper execution with the as-built robotic system. The transformation matrices 624 are furthermore used as potential offset drivers for both the virtual robot 630 for future simulation and planning steps, as well as the physical robot 600 by way of the actuator compensation module 623 that feeds its data to the planner and executor MML database 640.

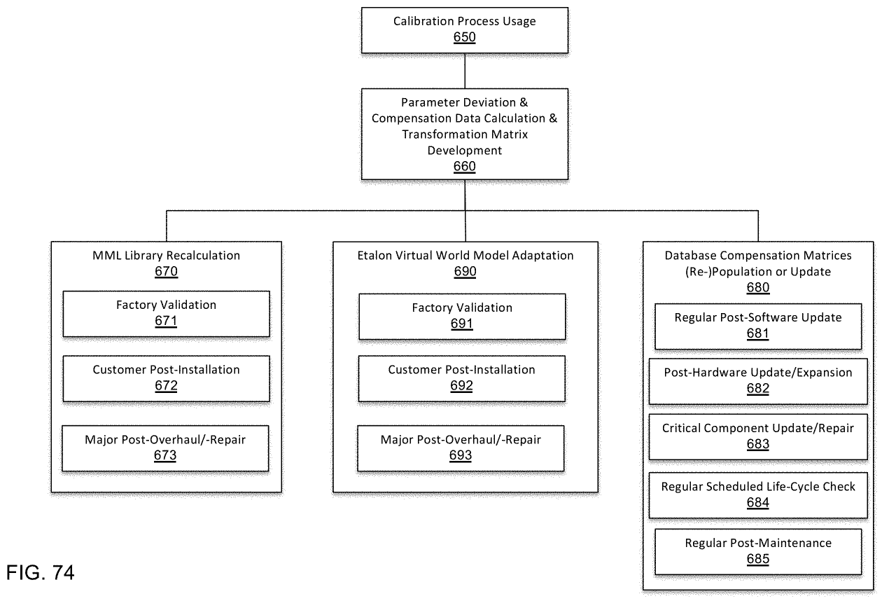

FIG. 74 is a block diagram depicting a situational decision-tree to be used to determine when to apply one of three parameter adaptation and compensation techniques in the calibration process in accordance with the present disclosure. The process of calibration and adaptation, whether virtual or databases, provides examples of when the calibration process might be warranted during the lifetime of the robotic system. The calibration data 650 is used to generate compensation data filtered into a transformation matrix development process 660, which in turn can be used for multiple purposes. The compensation data and parameters developed in 660 can be used in the MML Library Recalculation Process 670; the process could be undertaken as part of the factory validation step 671, as part of a customer post-installation step 672, or even after a major post-overhaul or -repair 673. Alternatively, the compensation data and parameters developed in 660 can be used in the adaptation of the Etalon Virtual World Model 690; the process could be undertaken again as part of factory validation 691, customer post-installation 692 or again as part of a major post-overhaul or -repair step 693. Lastly, the compensation data and parameters developed in 660 can be used to modify or update matrices within one or more databases 680; the step can be undertaken as part of a regular post-software revision or update 681, post-hardware update or expansion/modification 682, a critical component update or repair 683, as part of a regularly scheduled lifecycle check 684, or even as a regular post maintenance step 685.

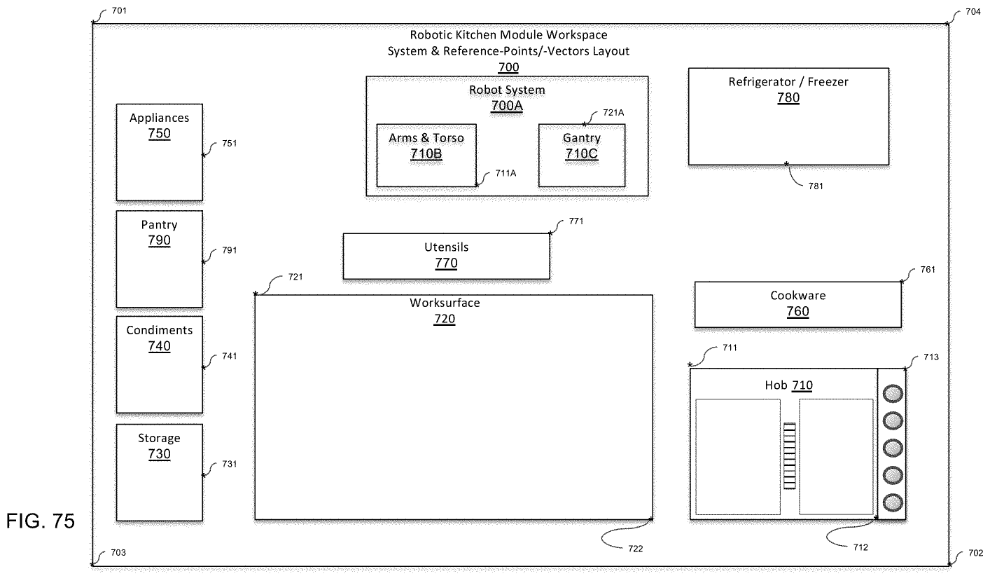

FIG. 75 is a block diagram depicting a schematic fashion a plurality of reference points and associated state configuration vector locations, not limited to two dimensions, but rather in multi-dimensional space, where the robotic kitchen could be commanded to carry out a (re-)calibration procedure to ensure proper performance within the entire workspace as well as within specific portions of the workspace in accordance with the present disclosure. In this embodiment, one possible layout of physical world calibration points or collection of points is shown and described that a robotic cooking system operating in a robotic kitchen module workspace 700 utilized for robotically preparing dishes based on computerized recipe execution instructions. The layout is not intended to be all-encompassing, but illustrates the variety of types and locations for calibration points that a system might use to verify and adapt the system execution and transformation parameters captured in scalar, vector or matrix form within software libraries, to ensure the real-world system operates according to the execution plan captured and represented in the idealized representation of a model within a virtual world.

The robotic kitchen workspace 700 may include, but is not necessarily limited to, a robot system 700A consisting of an arm and torso assembly 710B possibly mounted to a multi-dimensional (XYZ-coordinate typically) Gantry 710C, each with respective one or more reference points 721A and 711A, respectively. The reference points can be positions or coordinates that the system is commanded to move to in order to use internal and external sensors to verify the actual position and compared it to the commanded position, in order to determine any offsets resulting in potentially needed compensation and adaptation parameters for future operation in a more accurate model-prescribed fashion.

Additional items within the robotic kitchen module workspace 700, will include such items as one or more refrigerator/freezer units 780, dedicated areas for appliances 750, cookware 760, holding-areas for utensils 770, as well as storage areas for cooking ingredients in a pantry 790, condiments 740, and general storage place 730. Each of these units and discrete elements within the kitchen will at least have one reference point or sets of reference points (labelled as 781, 751, 761, 771, 791, 741, and 731 respectively) that the robot system 700A can use in order to calibrate its position and location with respect to the locations and units.

The more dynamic and typically two-dimensional area used for cooking/grilling, shown as hob 710, will have at least a set of two diametrically opposed reference points or sets of points 711 through 713 in order to allow the calibration system operating the robot system 700A to properly define the boundaries of the respective areas such as the cooking surface using reference points 711 and 712 or the control-knob areas for the cooking surface using reference points 712 and 713. The robot work surface 720 where many of the ingredient and preparation steps are carried out will as in the case of the hob 710 also use at minimum a set of two reference points or sets of points, which in the case of a tow-dimensional surface would be sufficiently defined by reference points 721 and 722, but could employ more reference points or sets of points if the worksurface is multi-dimensional rather than just two-dimensional as is the case of a counter surface.

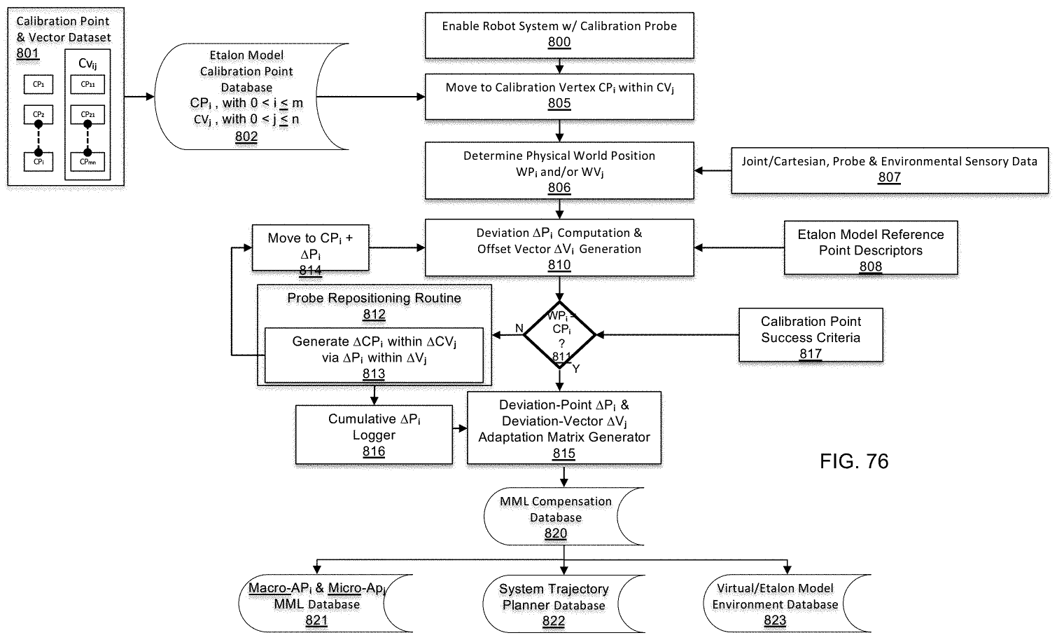

FIG. 76 is a block diagram depicting the process of a flowchart by which one or more of the calibration processes can be carried out in accordance with the present disclosure. The process utilizes a set of calibration-point and -vector datasets from the etalon model, which are compared to real-world positions, allowing for the computation of parameter adaptation datasets to compensate for the misalignment between the robot system in the physical world and that in the ideal virtual world, and how such compensation data cab ne used to modify one or more databases in accordance with the present disclosure. In this embodiment, a calibration routine outlines the main process steps that lead to the generation, processing and storage of any required calibration data to be applied to the real-world robotic system to ensure its operation tracks the commanded motions as referenced to a simulated model-based robotic system in a virtual computer-representation of the world or workspace.

The process begins with the robotic system and calibration probe 800 being enabled and commanded in 805 to a vertex point CPᵢ, or a set of points described by points within a vertex vector CV,. The calibration vertex points CPᵢ within vertex vectors CVⱼ are contained within the etalon model database 802, which itself is fed by the pre-defined calibration-point and -vector dataset 801. The next step is for the calibration routine determine the physical world position WPᵢ and position-vector WVⱼ of the robot and its calibration probe in step 806, as-measured by all internal and external joint-/cartesian-, probe- and environmental sensory data 807. A deviation computation 810 results in the generation of offset scalar and vector representations of the deviation DPᵢ and DVⱼ between the real-world position and orientation and that of the same within the idealized virtual world representation of the etalon model points and vectors 808 of the robotic system 800. Should the comparison 811 of the actual world-position and the cartesian position not coincide, the system will enter a robot (and thus also a probe-) repositioning routine 812, whereby step 813 is undertaken to move the commanded calibration point within the calibration vector by the measured error amount DPᵢ and in a direction defined by the error vector DVⱼ, thereby generating a motion-offset DCPᵢ and a motion offset vector DCVⱼ which is fed into a new commanded position offset value 814. The process is repeated until the real-world position WPᵢ coincides with the calibration point CPᵢ, at which point the loop exits and the cumulative offsets DPᵢ and vectors DVⱼ logged in 816 are used in adaptation matrix generator process 815, which collects all values in a mathematically usable computer representation. The adaptation matrices are then logged within the mini-manipulation library (MML) compensation database 820, which in turn can be accessed by other databases, such as the Macro-APᵢ and Micro-APⱼ MML database 821, the database 822 used for all robotic system trajectory planning, as well as the virtual-world etalon model environment database (which includes the robotic system, its workspace and the entire environment within which it operates).

### AP-Transition

The use of pre-defined entry and exit transition states/points/configurations in the execution of any AP (Action-Primitive), regardless of whether it be a MACRO or MICRO manipulation action is an important factor in developing a commercially viable robotic system prototype, in particular a robotic kitchen as detailed herein. Such pre-defined transition configuration(s), allow for the use of pre-computed actions represented by clearly defined cartesian locations and trajectories in 6-dimensional space (XYZ position and ABC angular orientations), requiring each sequence of Micro-AP mini-manipulations that describe a Macro-AP mini-manipulation to be executed in open-loop fashion without the need for real-time 3D environmental sensing, which avoids excessive number and complexity of sensory systems (hardware and data-processing) and complex and computationally expensive (in terms of hardware and execution time) software routines for real-time re-planning and controller-adjustment.

The transition configurations are defined for all macro-AP and micro-AP mini-manipulations as part of the manipulation-library development process, whether done automatically, via teach-playback or in real time by a master chef monitored during a recipe creation process. Such transition states for any individual macro-AP and micro-AP mini-manipulation step need not be of a singular type, but could be comprised of various transition-configurations, which can be a function of other variables. These multiple transition configuration, in the case of a robotic kitchen, could be based on the presence or use of a particular tool (spoon or spatula during stirring or frying as an example), or even the type of succeeding macro-AP or micro-AP mini-manipulation; an example might be the conclusion of a spoon stirring action, which upon having been concluded, might require the transitional state to involve a re-orientation and alignment of the spoon with the container edge to allow it to be tapped against the edge to remove any attached cooking-substance form the spoon prior to returning the tool to a pre-determined location (sink or holder), instead of a halted stirring position to decide if more stirring cycles are needed.

In terms of a process execution it should be clear that such an approach requires at most only a single internal- and external-sensor environmental sensory data-acquisition and -processing step to ensure the environment and all required elements (robot, utensils, pots, ingredients, etc.) are in their proper expected locations and orientations as expected by the pre-computed planner, before engaging one or more macro-AP mini-manipulations, which themselves each consist of many micro-AP mini-manipulations executed in series or in parallel, with each macro-/micro-AP manipulation transitioning through its start/end states by way of a pre-defined transition state. All transition states are based on a pre-recorded set of state variables consisting of all measurable positional and angular robot actuator sensors, as well as other state-variables related to any and all physically measured variables of all other robotic kitchen subsystems contained within the state variable vector defining the subsystems critical to the execution of the respective macro-AP and micro-AP mini-manipulations, respectively. Each start/end configuration is defined by these set of transition state variables, and is based on the set of variables measured by those sensors responsible for returning state information for those systems defined in the critical systems vector, to any and all supervisory and planning/control modules active during the macro-AP and micro-AP mini-manipulation(s). The robotic kitchen elements involved in a particular step of a recipe creation process, created by a sequence of serial/parallel macro-AP mini-manipulations, which themselves each are made up of many more micro-AP mini-manipulation entities, are monitored by the control system to ensure the start and end configurations of any such macro-/micro mini-manipulation are properly achieved and communicated to the planning and control systems, before any transition to the next macro-/micro mini-manipulation AP is authorized.

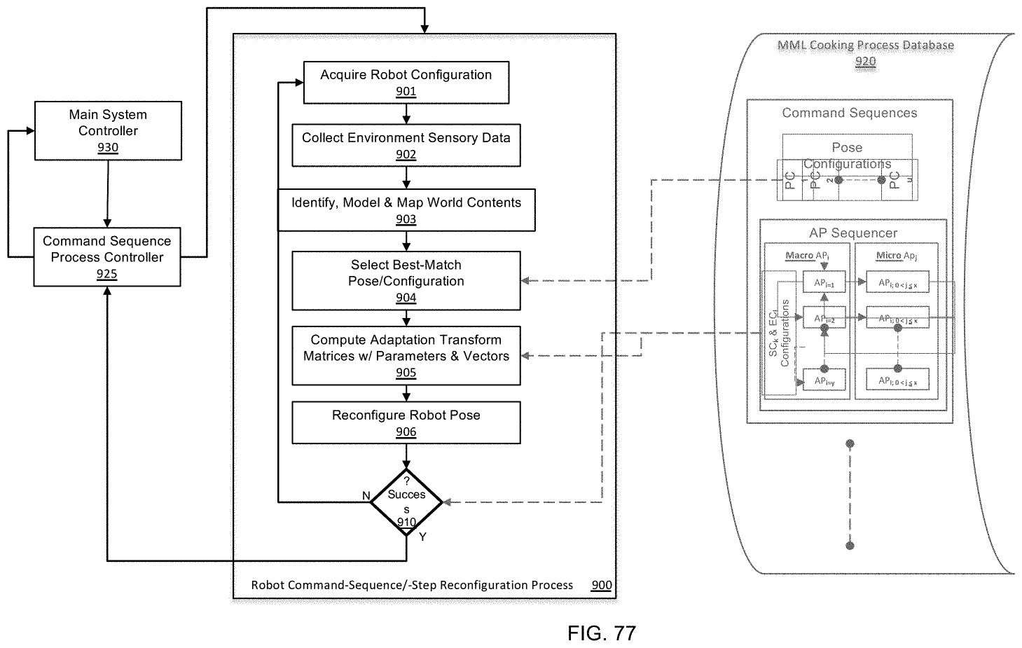

FIG. 77 is a block diagram depicting a flowchart by which one or more of the pre-command sequence step execution deviation compensation processes can be carried out in accordance with the present disclosure. The process utilizes a suite of robot-internal sensors (position, velocity, force/torque, contact, etc.), as well as environment world sensing systems (cameras, lasers, etc.) to image the position and configuration of the robot and its intended working space volume, and any and all tools/appliances/interfaces contained therein. The system then carries out a deviation measurement between the physical world and the pre-computed starting configuration for the start of the execution of a particular command sequence. The system uses a best-match process to determine the closest pose/configuration for the robot system to best start the execution of the command sequence. The deviation parameters are then assembled into vectors and combined into transformation matrices used to modify the robot configuration into the best-match pose for the start of the command sequence. Once reconfigured the robot system can then start the execution of the pre-determined command sequence through a series of macro-APs, with embedded serial sequences of micro-APs, without the need for re-sensing/re-imaging and re-interpreting the environment for any detected deviations requiring adaptation/compensation at every time step of the execution sequence.

The robot adaptation and reconfiguration 900 executes or carries out a particular cooking-sequence macro-AP mini-manipulation sequence. Theoretically this step need only be carried out at the beginning of each major recipe execution sequence, at the start of the first macro-AP step within a mini-manipulation sequence, or even at the start of each macro-AP mini-manipulation within a given recipe execution sequence. This same process 900 can also be invoked by the command sequence controller 925 whenever the system begins to detect excessive deviation in measured success criteria from the ideal/required values between successive macro-AP execution steps, allowing for continual open-loop execution without the need for continual Sense-Interpret-Replan-Act-Resense steps at every time-step of a the high-frequency process controller.

The main system controller 930 issues a command to the recipe execution process controller 925 to execute the recipe-specific sequence. The system executes a robot command-sequence/-step reconfiguration process 900 prior to executing the first recipe execution sequence. The process 900 involves measuring the robot configuration 901, as well as collecting environmental sensory data 902, which are all used to identify, model and map 903 all the elements within the workspace of the robotic system. At this point the MML Cooking Process Database 2020 provides possible starting configuration pose data to the best-match configuration selection process 904, which then selects the configuration pose PCI_{1 thru u} that best matches the sensed real-world configuration. Each PC has associated with it a set of ideal and precomputed macro- and micro-AP mini-manipulation sequences. Each macro- and micro-AP have associated with them a pre-defined (and pre-validated and -tested) Start- and Exit-configuration SCₖ and EC₁, respectively, which are then used in a set of adaptation parameters/vectors/matrices in the computation of the appropriate transformation step 905. The robot system is then commanded to reconfigure itself in 906 based on this set of parameters, allowing for a one-time alignment of the robotic system prior to the execution of the first step within the selected recipe execution sequence with the best-match configuration and its associated configurations that will allow open-loop execution of each macro-AP, gated to succeeding macro-APs in the sequence using a set of micro- and macro-AP success criteria.

Upon completion of the robot command-sequence/-step reconfiguration process 900, control is returned back to the process controller 925 to continue stepping through the cooking sequence 2420 through 2426 (see FIG. 170) until it is completed, before returning control back to the main system controller 930, awaiting further instructions.

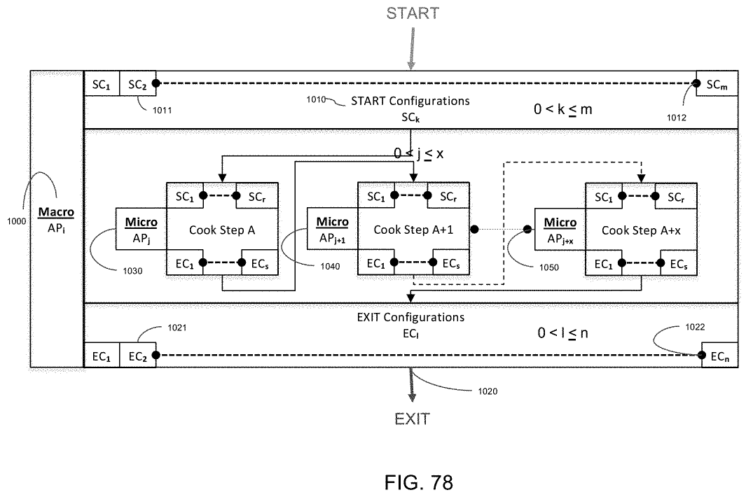

FIG. 78 is a block diagram depicting the structure and execution flow of Action-Primitive (AP) Mini-manipulation Library (MML) commands in accordance with the present disclosure. The process illustrates as to how a given cooking command is structured into a sequence of macro-APᵢ, where each macro-AP itself contains a sequence of finer-movement micro-APⱼs, with each micro-APⱼ as well as each macro-APᵢ has one or more pre-defined user-generated and planner/controller system-selectable starting-(SCₖ) and ending-configurations (EC₁), requiring each micro-AP to be completed by way of the defined/selected exit-configuration, before the next micro-AP can be executed through its own defined starting configuration (where the exit configuration of a prior macro- or micro-AP need not necessarily be identical). The overall structure of a particular Macro-AP includes one or more pre-defined starting configurations SC as well as corresponding one or more exiting configurations EC, where the macro-AP itself is composed of one or more sequentially executed micro-APs, who themselves have their own set of respective starting and exit configurations, each defined by a pre-determined set of specification parameters/variables.

The particular macro-APᵢ labelled 1000 has one or more starting configurations SC_{K} labelled 1010, numbered with the suffix ‘k’ ranging from 0 to a number ‘In’, labelled as 1011 through 1012. The first micro-APⱼ labelled 1030 that constitutes the starting execution sequence for the macro-APᵢ, will have an identical starting configuration SCₖ to that of the starting configuration for the particular macro-APᵢ 1030. Upon completion of this first micro-Apⱼ 1030 constituting cooking step A, the selected exiting configuration EG_{1->s}, will be identical to the starting configuration SC_{1->r} of the next micro-APⱼ₌₁ A 1040, which constitutes cooking step A+1. Upon completion of all sequential micro-AP_{j->x} cooking steps, the macro-APᵢ 1000 concludes with the final micro-Apⱼ₊ₓ, whereby the exiting configuration ECₛ of the micro-Apⱼ₊ₓ 1050, will be identical to the exiting configuration 1020 defined by EC_{1; 0<i≤n} for the macro-APᵢ 1000. Upon successfully completing this specific macro-APᵢ, the process will continue and sequence into the next process step as defined by the MML libraries for a particular cooking process, which could entail the execution of the next macro-APᵢ₊₁ in a sequential manner, whereby the exiting configuration 1020 of the macro-APᵢ will be identical to the starting configuration SCₖ for the next macro-APᵢ₌₁.

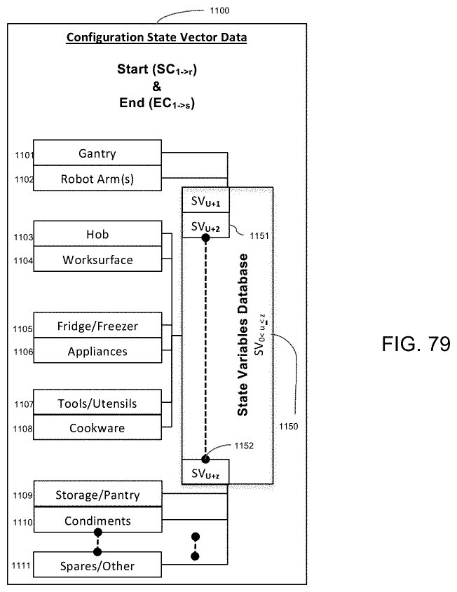

FIG. 79 is a block diagram depicting how the starting- and ending configurations for any given macro- or micro-AP can be defined not only for each specific subsystem within a robotic kitchen but also contain state variables not limited solely to physical position/orientation, but also other more generic system descriptors in accordance with the present disclosure. Each configuration is associated with the structure of the configuration state vector dataset of any and all starting and ending configurations and any parameter variable value, as applies to all the elements within the robotic kitchen and its workspace. The data is critical to not only describe physical configurations for any one of the respective systems, but to also describe other measurable quantities related to the status of each system, as measured by key process variables deemed critical to the performance of the overall system as part of a recipe cooking operation.

The configuration state vector data set 1100, which includes all starting configurations SC_{1->r} and exiting configurations EC_{1->s}, has associated to each also a set of state variables SV_{u->z}, labelled 1151 to 1152 herein, within a database 1150, which describe any necessary variable required for fully describing the state of the respective system beyond just its starting and exiting configuration. Note that the suffixes for each of these data points start at 1 and are denoted having a range denoted by an arrow ‘->’ and ending at some value, denoted by placeholder values labelled as ‘r’, ‘s’ and ‘z’. Individual systems within the robotic kitchen can include, but are not limited to such elements as, any robot arms 1102 mounted to or with a multi-dimensional gantry system 1101, relying on the presence of workspace elements such as a hob 1103 and a worksurface 1104, within reach of necessary appliances 1106, tools and utensils 1107 as well as cookware 1108, supported by the presence of freezer and fridge 1105 and any peripheral appliances 1106. Additional elements holding potentially necessary ingredients include a storage and pantry unit 1109 as well as a condiment module 1110 and any other necessary spare areas 1111 containing further elements needed in a robotic recipe cooking execution sequence.

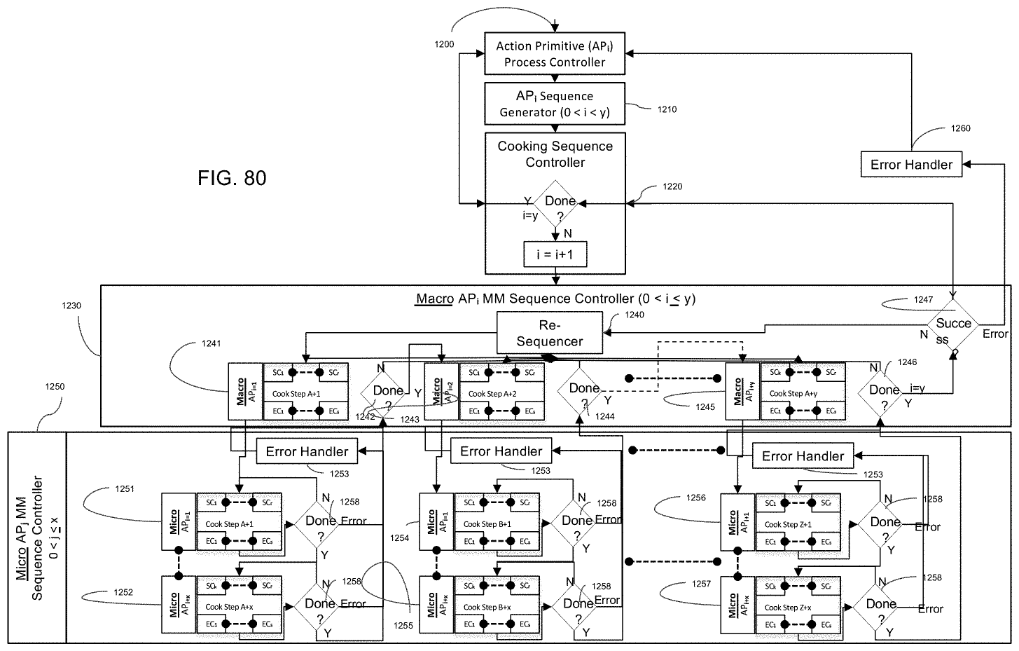

FIG. 80 is a block diagram depicting illustrating a flowchart of how a specific cooking step made up of multiple sequential macro-Aps, themselves each described by a multitude of micro-Aps would be executed by a cooking sequence controller executing a particular cooking step within a particular recipe in accordance with the present disclosure. The recipe execution sequence shows where a particular recipe selected by a user results in the selection of a cooking sequence stored within a database, which is fed to a process controller, which in turns executes a cooking sequence, where the sequence consists of a sequence of one or more macro-APs, with each macro-AP consisting in turn of a sequence of one or more micro-APs, which are in turn also executed in a sequential manner. Errors are handled internal to each process step, resulting in turn in one of many steps, including re-execution or re-sequencing of one or more particular cooking steps or sequences, until all prescribed macro- and associated micro-APs are fully and successfully executed.

Given a particular recipe, a database provides the sequence of APs described within one or mini-manipulation libraries and/or databases, to the Action Primitive (AP) controller 1200. The APᵢ sequence generator 1210, which creates the proper sequence for macro-AP_{i; 0<i≤y} feeds the proper sequence to the cooking sequence controller 1220, which steps through the steps i=i+1 until the counter reaches i=y, which indicates the conclusion of the cooking sequence. The sequential execution of the macro-AP_{i; 0<i≤y} is handled by a dedicated controller 1230. The sequence begins with the first macro-APᵢ₌₁ labelled 1241, which is defined by one of many pre-determined starting configurations SC. The macro-APᵢ₌₁ 1241 is made up by a its own sequence of one or more sequentially executed micro-AP_{j, j<0≤x}, each with its own pre-determined and well-defined starting and exiting configuration, where the starting configuration for each micro-Apⱼ is identical to the exit configuration of the preceding micro-APⱼ₋₁. The macro-APᵢ₌₁ 1241 leads to the sequential execution of micro-APs labelled 1251 through 1252 in a sequential manner, with checks for completion 1258 at the conclusion of each micro-AP. An internal error handler 1253 routes the process to a resequencer 1240 which can shuffle the macro-AP sequence as needed to ensure successful completion of a particular cooking step within the entire sequence. Upon completion of the entire micro-APⱼ sequence associated with macro-APᵢ₌₁, the last micro-APⱼ₊ₓ completes with an exit configuration that is identical to the exit configuration of its macro-APᵢ₌₁, which in turn is identical to the starting configuration of the next macro-APᵢ₌₂. The micro-APᵢ₌₂ will again step through a sequence of micro-APs labelled 1254 through 1255, with commensurate completion-checks 1258 and error-handling 1253, before proceeding to the next macro-AP in the sequence. This identical set of steps continues until the end of the sequence denoted by i=y is reached in macro-AP_{i+y} 1245 for cooking step A+y, which concludes with the last micro-APⱼ₊ₓ 1257 being checked for completion in step 1246, with a check for successful completion in 1247. Any remaining errors are again handled by the error handler 1260, and regardless of status control is returned to the beginning of the Action Primitive APᵢ process controller 1200.

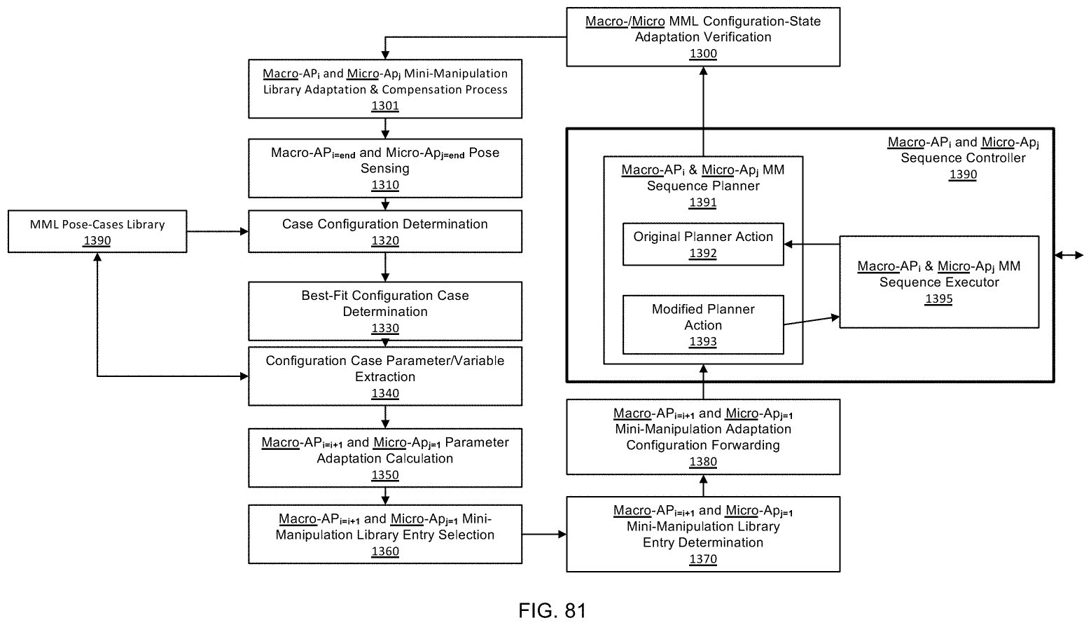

FIG. 81 is a block diagram depicting a decision-tree flow for a given AP adaptation. The notion revolves around the potential need to adapt a given AP based on deviations in the sensed configuration of the robotic system in accordance with the present disclosure. Based on a set of pre-determined configuration case options, the etalon-model based pre-computed AP steps can be modified by matching the closest configuration case from the pre-computed MML pose-case library to adapt and compensate execution of the cooking step so that the AP is adapted to ensure a successful outcome in the physical world, by picking the adaptation to the closest match based on a comparison of the physical world configuration to that of the closest pose-/configuration-case within the pre-computed MML library. The process flow by which a given macro- or micro-AP to be executed by a robotic system is compared to a number of similar APs contained within a MML library based on sensory data input, in order to determine the macro- or micro-AP with the closest fit in terms of starting and ending configuration respectively, before selecting the closest-fit macro-/micro-AP for execution. The purpose of this process is to try to use only those macro-/micro-APs that have already been pre-determined and pre-validated in terms of performance that most closely match the required next-step macro-/micro-AP, in order to obviate the need for time- and computationally-costly and cumulative-error prone re-computation of the entire motion- and execution plan of the robotic system for a given commanded action. Should however the deviation between the currently-sensed configuration at the conclusion of a current macro-/micro-AP be too large from that of any pre-computed next-step macro-/micro-AP within the ML library, yielding too high a best-fit matching-error metric, it will become necessary to perform the recalculation of the entire motion- and execution plan, albeit based on existing pre-determined and pre-validated MML sequences of library-stored macro- and micro-APs.

The process 1300 for determining the adaptation to a particular macro-micro-AP entails the MML library adaptation and compensation process 1301, which as a first step requires collection of all relevant sensory data to determine the current pose in step 1310 for a currently executed macro-APᵢ and micro-APⱼ. The determined configuration entails determining the exit-configuration of a current macro-AP_{i=end} or micro-AP_{j=end}, in order to determine the configuration case in step 1320. The configuration will be compared to all relevant poses-cases from the MML library in step 1390, so as to determine a best-match configuration case in step 1330, where the exiting configuration for a current macro-AP_{i=end} or micro-AP_{j=end}, has a best-match in terms of minimal configuration-error to that of the next-step macro-APᵢ₌ᵢ₊₁ or micro-APⱼ₌₁ and their associated starting configuration or pose within the next step in the execution sequence, as determined by the sequence executor 1395. The parameters and variables associated with the best-fit next-step macro-APᵢ₌ᵢ₊₁ or micro-APⱼ₌₁ are identified in step 1340, allowing for a calculation of the adapted parameters of the macro-/micro-APs in step 1350, allowing the identification and determination of the specific macro-APᵢ₌ᵢ₊₁ or micro-APⱼ₌₁ MML library entry in steps 1360 and 1370, respectively. The appropriate library entries are forwarded from the library 1390 to the macro-APᵢ/micro-APⱼ sequence controller 1390 in step 1380.

The macro-APᵢ/micro-APⱼ sequence executor 1395 now uses the newly identified next-step macro-AP/micro-AP in the MM sequence planner 1391 to shuffle the execution sequence determined in the previous time-step by planner 1392, to generate a modified sequence as provided by planner 1393. It is important to note that this adaptation process may occur at any time-interval within a given execution sequence, ranging from every time-step, at the beginning or end of any micro-APⱼ or macro-APᵢ or even the beginning or end of a complete execution sequence entailing one or more macro-APᵢ or micro-APⱼ steps. Furthermore, all adaptations are based and rely solely on the selection of pre-determined, pre-computed and -validated macro-APs and micro-APs, thereby obviating the need for any re-calculation of sequence- or motion-planning affecting the entire robot systems and their associated configurations or poses. This again saves valuable execution-time, reduces hardware complexity and -cost as well as limits execution mishaps due to error-accumulation, which will ultimately impact overall performance which can put a guarantee of successful task-execution at risk.

### MML Adaptation & AP-Execution

In order for a robotic system to be able to timely, accurately, and effectively execute commanded steps in a highly interactive dynamic and non-deterministic environment, execution typically requires continuous sensing and re-planning execution steps for the robot at every (control) time-step. Such a process is costly in terms of execution time, computational load, sensory hardware and data-accuracy, sensory and computational error-accumulation and does not necessarily yield a guaranteed solution at every time-step nor necessarily an eventual successful outcome. These detrimental attributes can however be mitigated and even removed, through the use of a simple yet effective adaptation process.

By splitting all the main robotic activities into basic manipulation steps, comprised of execution steps with multiple APs at the macro- and micro-levels, and forcing each AP to begin and end at known and pre-determined and -tested/-verified start and exit configurations, allows the system to theoretically perform only a single sensing/modelling step at the beginning of each controlled execution sequence. The required transformation to the robot configuration is performed only once, to adapt the robotic system to match the starting configuration by way of use of a compiled transformation process involving transformation-parameters/-vectors/-matrices applied to the robot system configuration (again, only once) defined for the first AP in the execution sequence. Thereafter the robot can theoretically carry out all pre-determined and pre-verified motions and task-steps along well-defined sequences with attached success-criteria at each AP conclusion in a virtually open-loop fashion, to eventually complete the entire process (like frying an egg, or making hot oatmeal), with a minimal number of (theoretical just a single) sensing and robotic system adaptation steps.

The above-described process varies dramatically from the standard Sense-Readjust-Execute-(Re)Sense infinite loop typical in complex robotic systems operating in complex and dynamic non-deterministic environments, where the above step is carried out at every time-step to maximize accuracy and ensure performance fidelity. The newly described process accomplishes the same goal at minimal computational and execution-delays with a guaranteed performance success by carrying out the adaptation process a minimal number of times (theoretically only at the beginning of the process-sequence, but it can be executed any number of additional times during the execution sequence, but is not required at every time-step), and forcing the execution to be carried out through a predefined set of pre-tested and pre-verified AP sequences with associated start/exit configurations and completion-success criteria with guaranteed performance and outcomes, all contained within a MML database or repository used to define each respective robotic sequence; in the case of the robotic kitchen, these would be defined as recipes, each of them containing multiple preparation steps and cooking sequences to result in a finished dish. For high-frequency controllers needed for robotic systems in highly environment-interaction and dynamic environments, controller sampling times are on the order of 100s of Hz, implying computational steps be completed in less than fractions of 1/10-ths of a second, placing daunting demands on computational power and sensory data processing, not to speak of issues related to sensory-errors and their propagation which will ultimately impact system performance and elicit concerns regarding guarantees related to successful step- or sequence-completion.

While the above description has been focused on the application in a robotic kitchen, the same logic and elements and processes can be applied to other applications, such as (i) an automated/robotic laboratory processing cell, (ii) component sub-assembly cell in a manufacturing setting, or (iii) order-assembly and packing in an automated order-fulfillment setting, but to name a few possible alternate candidate application scenarios.

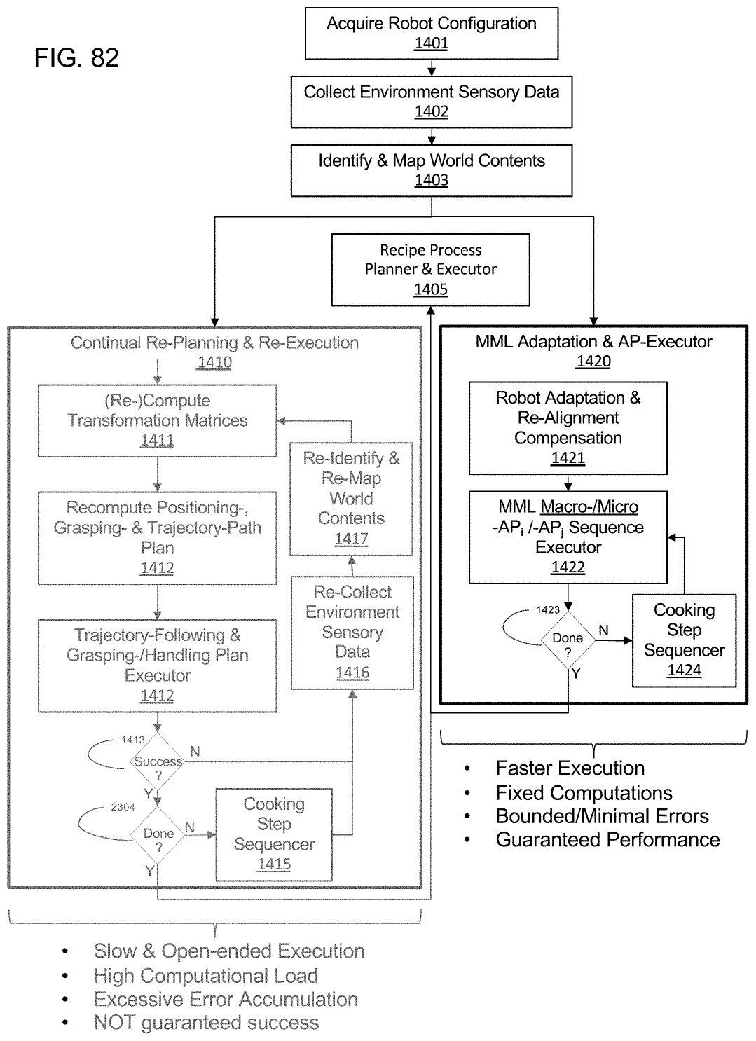

FIG. 82 is a block diagram depicting a comparison of a standard robotic control process, to that of a MML-driven process with minimal adaptation in accordance with the present disclosure. The point taken is that a standard robot operating in an uncertain and dynamic world requires continuous environmental (re-)sensing and identification and modelling to determine all process variables, prior to re-calculating all position-/velocity-, grasping and handling trajectories and strategies, with continuous re-computation at nearly every time-step, resulting in a slow and computationally-expensive and non-deterministic loop-time, capable of accumulating execution and computational errors, with a high likelihood of a non-successful outcome. The use of pre-determined and -verified MML libraries with defined AP-sequences, both at the macro- and micro-levels, with guaranteed successful outcomes, as long as simple adaptation and compensation via a one-time transformation based on the sensed environment, is made at the beginning of each process-step, requires a highly reduced and deterministic computational load, resulting in faster execution with minimal and bounded (known) errors, yet more importantly, a guaranteed successful and known outcome. In the case of an MML-Adaptation driven AP-execution, sensing complexity and cycle-time and error-presence and -accumulation are highly reduced, while a successful outcome is guaranteed if the execution structure of the MML APs is observed.

This embodiment illustrates a visual comparison of the standard approach vs. the present disclosure to achieve a reliable and robust robotic system performance in a dynamic non-deterministic environment characterized by high degrees of grasping and object handling with non-trivial high-contact interactions between a robotic system within its workspace. All such systems involve the measurement of the robotic system configuration 1401, the collection of environmental workspace sensory data 1402, coupled with a subsequent step 1403 to identify and map the world contents/objects, and a recipe process planner and executor 1405.

The standard approach 1410 of continual sensing, re-planning and re-execution requires the use of continually collecting sensory data 1416 at every time-step, in order to generate a set of transformation parameters 1411, many captured within matrices, allowing for the re-computation 1411 of a-priori determined ideal-world position-/velocity-trajectories as well as grasping and handling strategies, which are then executed by a dedicated controller/executor 1412. A continual series of commanded steps are thereby executed and the need for collecting new sensory data 1416 and re-identifying and re-mapping the robot and its surrounding world contents 1417 is needed at every time-step of the execution loop. Successful completion of each step is verified in 1413, and continual sequence operation is also verified in 1414, as part of the cooking step sequence controller 1415. Upon completion of the cooking sequence, the system returns control back to the recipe process planning and executor 2105 awaiting instructions for the next step in the recipe preparation/execution.

The present disclosure illustrates the MML Adaptation and AP-executor 1420. In this implementation the system only performs a single measurement and mapping step 1401 through 1403, prior to determining the best-match configuration stored within the database upon which it will base its robot-adaptation and compensation 1421 for a one-time re-alignment of the robotic system to begin the sequence execution 1422. The execution relies on a set of macro-AP and micro-AP MML steps, which are executed by the executor 1422, allowing progress and transitions between pre-validated and -verified macro- and micro-APs based on a set of clearly defined success criteria. The process requires no validation and checking of system performance at every time-stamp of the high-frequency controller, but only at the start and end of each cooking sequence, as each of the macro- and micro-AP sequences have already been pre-tested and can thus be executed open-loop as any possible error accumulation is so small to be imperceptible and thus not impacting the outcome of the process. The cooking step sequencer 1424 is responsible for the successful execution of the entire sequence within a specific recipe completion sequence.

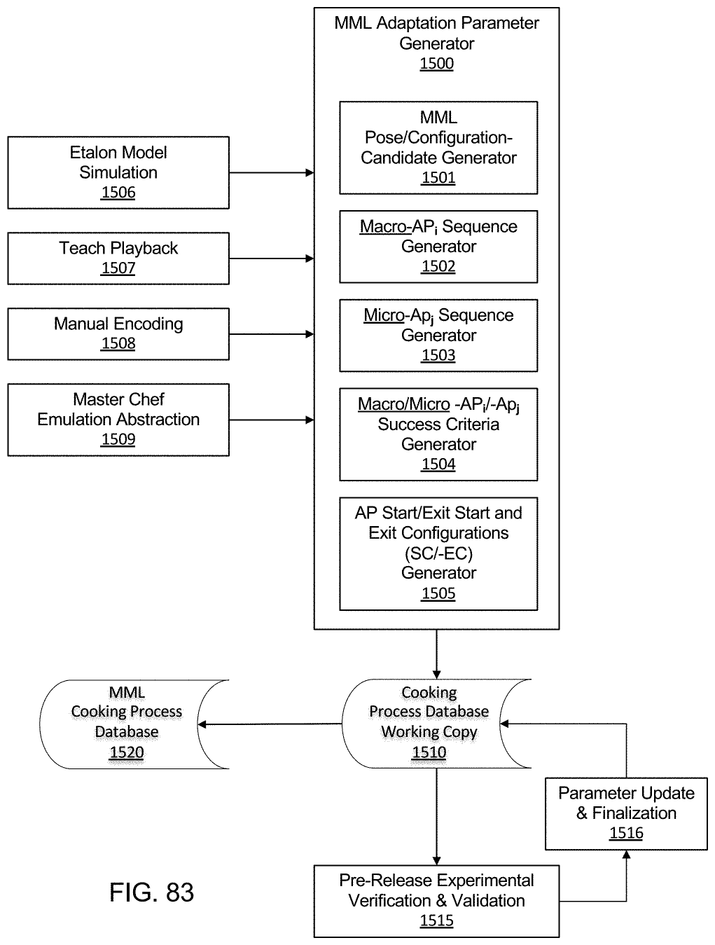

FIG. 83 is a block diagram depicting the MML Parameter Adaptation elements, which have parameters that can be developed through a variety of methods, including through simulation, teach/playback, manual encoding or even by watching and codifying the process of a master in the field (chef in the case of a kitchen) in accordance with the present disclosure. The parameters can be grouped into critical groupings required for rapid MML AP execution, such as allowable poses/configurations, AP-sequences (both macro- and mini-MMLs), success criteria for AP completion, as well as start and exit configurations of the stored AP MML sequences. The parameter data is verified via experimentation, and optimized/updated if needed, prior to validation and release into the MML Cooking Process Database.

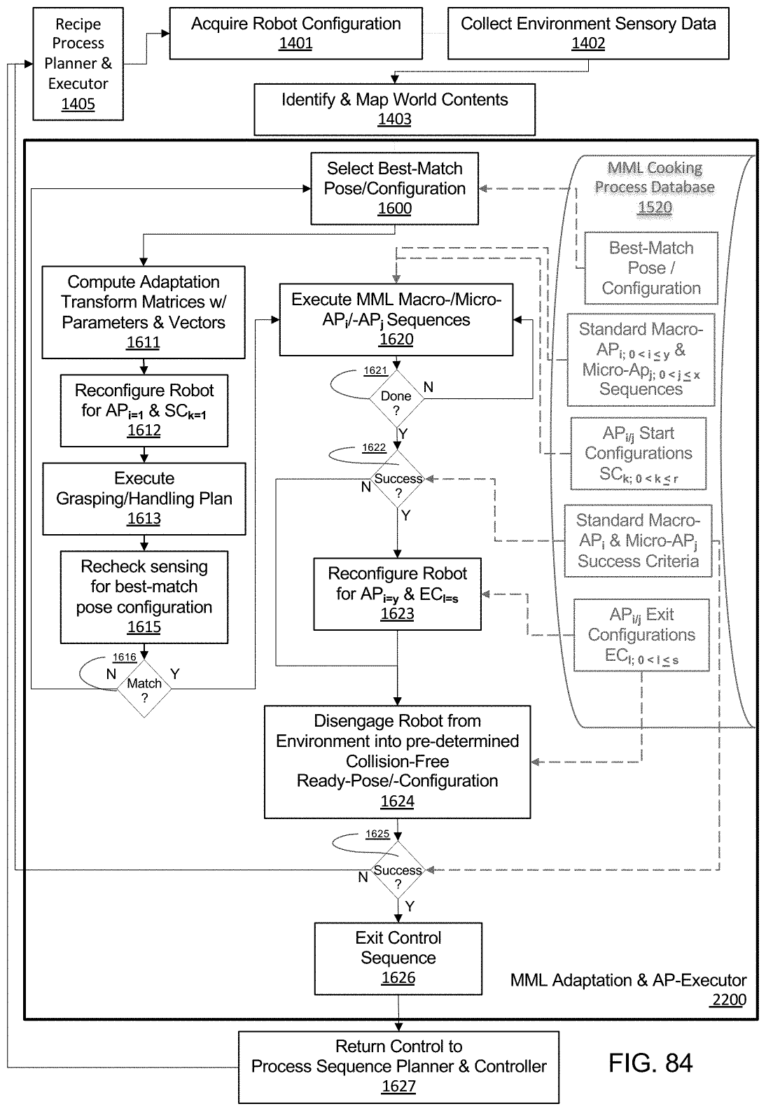

The structure and inputs in FIG. 83 illustrate the influence to the MML Adaptation Parameter Generator 1500. In order for the robot process sequence planner and controller 1627 (see FIG. 84) to function properly. A set of key parameters for each cooking sequence need to have been developed. Such parameters can be developed for example through an Etalon model 1506 that allows a user to generate ideal configuration data to be processed for extractable parameters. A similar process can be used by way of a teach playback 1507 method, allowing for the generation and extraction of the same parameters. It is further possible to have humans manually encode 1508 these parameters based on a series of pre-computed parameters carried out offline and manually. Lastly it is possible to have a master chef carry out a set of cooking and recipe generation steps that a computer system 1509 can monitor and abstract into key sequences with same such parameters being generated. Such parameters will be used to define a set of pose configuration candidates 1501 that serve as templates to match a real-world configuration in order to minimize the search-space for allowable robot configurations. A sequence generator 1502 is used to generate a set of macro-AP recipe preparation sequences, with each macro-AP having a more detailed set of mini-manipulations defined by a micro-AP generator 1503. All success criteria 1504 associated with each macro- and micro-AP step or sequence will also be generated and captured and associated with each of its respective mini-manipulations. More importantly, each macro- and micro-AP will also have a set of start (SC) and exit (EC) configurations associated with it by a dedicated process 1505, allowing the robotic system to readily transition in and out of each macro- and micro-manipulation step or sequence without requiring a continuous Sense-Interpret-Replan-Act-Resense cycle at each time-step. This is an important distinction, as it implies that mini-manipulations can be carried out almost open-loop, subject of course to their associated success criteria being (measured and) met, thereby dramatically reducing system complexity and cost as well as guaranteeing performance and a successful outcome. The parameters are stored in a temporary database 1510, allowing for a verification and validation process 1515 to experimentally verify and validate the accuracy and adequacy of each parameter set, with any needed updates applied prior to finalization 1516, and being stored in the final MML Cooking Process Database 1520.

FIG. 84 is a block diagram depicting the actual process steps that form part of an MML Adaptation and AP-execution. The robot configuration in the world is coupled with the sensed environmental data allowing the system to identify, model and map all entities therein. The MML (in this case) Cooking Process Database provides all the needed pre-defined AP-criteria and variables/constants. In the case of a process-step to be performed by the robot, the best-match pose/configuration for the robot configuration and its grasping and -handling steps is selected from the MML Cooking Process Database, proper positioning and process-start configurations are confirmed for all macro- and micro AP-sequences, before the AP process-steps are executed along their pre-defined sequence(s) via standard start and exit configurations for each, without the need for continuous re-imaging (the robot and the environment) and re-computation of process steps (positions/velocities, trajectories, grasping- and handling steps, etc.) via continuously modified transformations based on sensory data at each sampling time-step. Successful MML-defined macro-AP sequences are clear and pre-defined and are responsible for allowing the process sequence to progress until the cooking-sequence is completed, and the robotic system is returned to a pre-determined pose in a collision-free pose, ready for the next process-step. While re-sensing at the conclusion of each macro-AP is possible, the pre-defined macro-/micro structure for all AP-processes allows for execution of each with simple success- and termination-criteria checking, without the need for any massive sensing- and computationally-costly steps at every execution time-step.

The operations within the MML Adaptation and AP-Executor 1400 are illustrated in FIG. 82. The executor 1400 relies on a first step carried out by the recipe process planner and executor 1405 that requests that a set of standard measurement steps be carried out, involving determining the robot configuration 1401, the state of the workspace and the environment surrounding the robot system 1402, In order to create a complete world model 1403 by identifying all objects, modeling them and mapping them within the world. All succeeding steps are thereafter supported by parameter data provided by the MML cooking process database 1420.

All this data is passed to the configuration matching process 1600, which performs a best-match between the real-world pose of the system, compared to the possible and acceptable pre-computed and defined process-start configurations. The process 1600 determines the best-match pose/configuration, allowing it to compute the proper transformation matrices populated by parameters in vectors and matrices provided by MML database 2020. The controller then reconfigures the robot system in 1612, by selecting the starting configuration SCₖ₌₁ for the first macro-manipulation step macro-APᵢ₌₁. The system then executes the associated grasping and handling step 1613, and re-checks its configuration matches the best-match configuration identified in 1600 in step 1615. The system then checks for pose-fidelity in step 1616. If the configuration is not within acceptable deviation bounds from the selected pose, the system returns to re-select a different configuration in the best-match configuration selection step 1600. If however the measured configuration parameters are sufficiently close to the selected pose configuration parameters provided, the system proceeds to execute all succeeding macro-APᵢ and micro-APⱼ steps within the pre-determined sequence(s) provided by the MML cooking process database 2020. The sequence executor 1620 is provided by all the parameters for each of the sequential macro-APᵢ sequences and therein contained micro-APⱼ steps, which in turn also have associated with them clearly defined start-configuration parameters SC_{k; 0<k≤r}, and exit-configuration parameters EC_{1, 0<1≤s}.

The execution loop 1620 is carried out in an open-loop fashion without any need to perform any of the usually-required sense-plan-act loop at every time-step of the high frequency controller, as each of the macro-APᵢ and micro-APⱼ steps have been pre-tested and -verified for successful execution in an open-loop fashion, guaranteeing successful completion with little to no detrimental execution-error accumulations. It is this feature that allows the system to operate with minimal and pre-determined computational load and high execution speeds, with little to no (bounded and acceptable) error accumulation and guaranteed successful completion and outcomes.

In one embodiment, the system calls for a renewed Sense-ID/Model/Map sequence at any time it deems necessary. Such a situation might arise if the recipe execution process is fairly sensitive to particular steps in the recipe requiring the system to check for successful completion of one or more macro-AP steps within the cooking sequence; or it might detect appreciable deviations between measurements of macro-AP completion-states and the required/associated success-criteria that need to be met before proceeding to the next macro-AP step within a particular cooking sequence. The executor 830 could thus be triggered to request another such a Sense-ID/Model/Map sequence 2101 through 2103 to decide on restarting or reorganizing the cooking sequence by selecting a different macro-AP sequence or re-ordering the original macro-AP sequence it was working with. All this paragraph describes is a potential use of the same process and databases described in our novel approach, and while not explicitly represented in this or any figure, its implementation could readily be envisioned.

The sequence executor 1620 carries out each macro-APᵢ and micro-APⱼ step and checks for completion 1621 with a successful outcome 1622 of the same using the success criteria parameters clearly defined for each macro-AP_{i, 0<i≤y} and micro-AP_{j; 0<j<x} step. Upon completion of all the required macro- and micro APs, the controller then uses the exit configuration parameters for the last macro-AP_{i=y} and its associated exit configuration EC₁₌ₛ, to reconfigure the robot in step 1623 to its completion pose. The controller then proceeds to disengage from any tool/appliance or world-surface into a ready-pose in step 1624, verifying that the outcome of the cooking sequence meets the defined success criteria in step 1625. If the outcome is negative, the system returns control to the executor 2105 with an error to be handled. If successful, the cooking sequence is tagged as complete and the system exits the control sequence and resets any system variables to a completion-status in step 1627, before again returning control to the overall recipe planner and executor 2105.

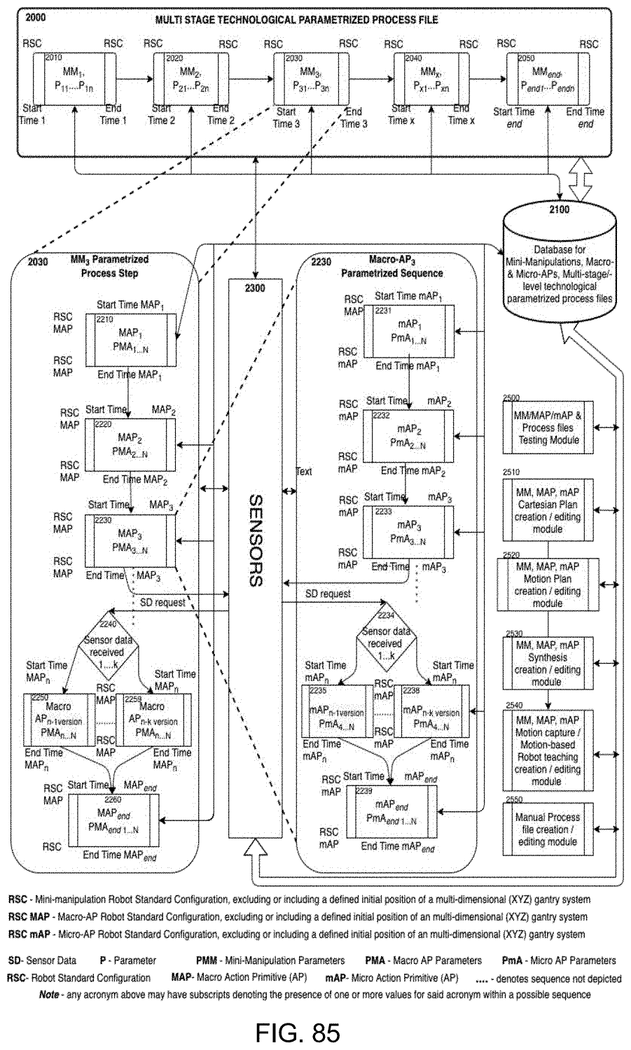

FIG. 85 is a block diagram illustrating a multi-stage parameterized process file with the notion of using pre-defined execution steps at the micro- and macro-levels within separate mini-manipulations, by transitioning through pre-defined robot-configurations for each of these steps, thereby avoiding any robot reconfiguration and replanning during the entire process-step execution, as all mini-manipulations consist of pre-computed and -verified starting- and ending robot configurations as part of a their pre-validated execution sequence in accordance with the present disclosure. Specifically, it depicts the process by which a robotically executed task described by a sequence of parameterized process steps described as separate mini-manipulations, is executed in a layered and sequential fashion. It clarifies how an interactive task is described as a set of sequentially executed parameter-defined mini-manipulations with pre-defined starting and ending robot configurations and associated time-stamps, transitioning sequentially into each other through the pre-defined robot configurations. Each of the individual mini-manipulations is in turn partitioned into one or more sequentially-executed Macro-APs with their own respective starting- and ending robot configurations and associated time-stamps. Each of these Macro-APs furthermore may consist of one or more sequentially executed Micro-APs, again each having a set of pre-defined starting- and ending configurations and associated time-stamps. All Macro- and Micro-APs executions are based on real-time sensory data, where the sensory data is used to adaptively search for the next best-match pre-defined Macro- or Micro-AP with its associated started- and ending configurations in its execution sequence, to continue the execution sequence in the overall execution process.

The configuration and execution of a robotic task-command is illustrated in FIG. 85. A central database 2100 containing all parameters for all mini-manipulations (MM) and associated macro-APs (MAPs) and micro-APs (mAPs) within process files, can be populated and verified through a variety of ways, including but not limited to, a (i) synthetic creation and editing execution module 2530 operating with a virtual robot and world representation, or (ii) a software module 2540 capable of creating and editing/modifying abstracted representations as part of a motion-capture or teach-playback process, and (iii) a manual process-file creation module 2550 where a user or developer can directly shape and input a particular process step or sequence thereto. Separate software modules to perform cartesian motion planning 2510 and joint-based motion-planning 2520 generate the path and time-stamp parameters needed to define the starting and ending-configurations and their associated time-stamps. All MM/MAP/mAP steps and sequences within a process file are then also passed through a Testing module 2500, which validates all the MMs/MAPs/mAPs and their associated parameters, whether through simulation in a virtual world or pre-delivery physical system walk-through. All data describing these MMs/MAPs/mAPS are then stored and made available in the central execution database 2100 for retrieval in a process-step execution.

The database 2100 containing the parameterized processes in a variety of digital formats within one or more files, is relied upon to compile and configure a parametrized process file 2000, where the process itself is comprised of one or more mini-manipulations (MM₁ through MM_{end}, numbered 2010 through 2050) that are sequentially executed to achieve the desired end-result specified for the specific process or execution sequence. Each MM transitions into the next by way of a pre-defined robot configuration at the end of the preceding MMᵢ, and a pre-defined starting-configuration in the next MMᵢ₊₁, each with a respective time-stamp associated therewith. Real-time sensor data 2300 is continually used to guide and verify the execution process during the entire process.

In order to highlight the use of task-execution steps by way of mini-manipulations with pre-configured robot-configurations transitions to avoid the need for computationally-slow and -expensive re-planning and reconfiguration, can be seen in a detailed view of a particular mini-manipulation 2030 within a sequence of a particular process execution file 2000. The mini-manipulation 2030 is comprised by a sequence of macro-APs (MAPs), each with a particular and pre-defined starting- and ending configuration that is met before the particular MAPⱼ (like MAP2) can either start execution or transition to the next MAPⱼ₊₁ (like MAP3), where the ending-configuration of MAPⱼ (MAP2) will be identical to the starting-configuration of MAPⱼ₌₁ (MAP3). Furthermore the sequence of MAPs, shown here as MAP1 through MAP3 labelled as 2210/2220/2230 need not be rigidly pre-defined in database 2100, but can also be modified within each MM, by using an array of sensory data 2300 that can be used to optimize the sequence of MAPs at each step of the execution by collecting and using sensory data 2240 by selecting the next-best MAP option labelled 2250 through 2259 to suit the current robot configuration and the next prescribed MAP. This adaptive MAP selection-process is taken in order to minimize and even obviate the need for any robot reconfiguration and replanning despite the presence of errors and uncertainty when executing a robotic task in a real-world environment (as compared to in a simulated or virtual world where all sensory data is without noise or measurement errors, and all executed motions are deprived of any errors due to real-world phenomena, such as friction, slop, wear-and-tear, etc.). It is thus possible to dynamically adapt the sequence of MAPs selected for sequential execution at every time-step between MAPs to best fit a maxim of minimal-to-no reconfiguration at the time-steps in order to improve execution-speed and maximize successful and guaranteed performance execution by using optimal pre-tested and -verified MAPs that best suit the situation at hand.

In order to further highlight that the drive to use pre-verified and -validated execution steps within each sequence, it is important to note that each macro-AP, is itself broken down into a sequence of smaller and finer micro-APs (mAPs). As an example, take Macro-AP labelled MAP3 as a parameterized sequence 2230, shown in this figure again as a sequence of micro-APs APₖ, labelled as 2231 through 2233, each again transitioning with pre-defined ending- and starting robot configurations and their associated time-stamps. Again, each micro-AP is executed driven by sensory data 2300 allowing the system to monitor progress and verify that one mAPₖ transitions with e pre-defined ending configuration which is identical to the succeeding mAPₖ₊₁ starting configuration at a mutual time-stamp instance. As before, the sequence of mAPs need not be rigidly defined by database 2100, but rather be driven by collection of a suite of sensory data 2300 at every time-step where transition from one mAPₖ to the next mAPₖ₊₁ occurs, where all received sensory data 2234 is in turn used to select from an array of pre-defined mAPs labelled 2235 through 2238 that best suit the current real-world configuration of the robot system in order to continue the execution of the required mAPs to yield a guaranteed outcome within a deterministic timeframe without the need for reconfiguration and robot motion replanning

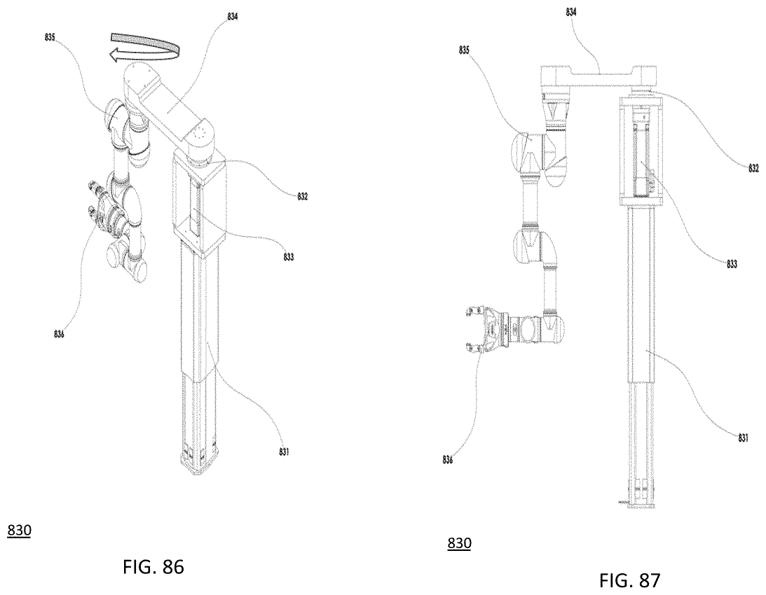

FIG. 86 is a pictorial diagram illustrating a perspective view of a robotic arm platform 830 with a robotic arm with one or more actuators and a rotary module, while FIG. 87 is a pictorial diagram illustrating a robotic arm platform with a robotic arm with one or more actuators and a rotary module. The robotic arm platform 830 includes a linear actuator 831 that can move vertically up and down (e.g., along the z-axis), if positioned upright (or move horizontally if positioned sideway to move from left to right). The linear actuator 831 in the robotic arm platform 830 extends the reachability of the robotic arm 835 (and therefore also extends the reachability of the corresponding robotic end effector). The robotic arm platform 830 further includes a rotary module 832, coupled to a robotic arm and rotary module interface bracket 834, that functions like an actuator to extend the reachability of the robotic arm platform 830 around the rotary axis (e.g., along the y-axis).

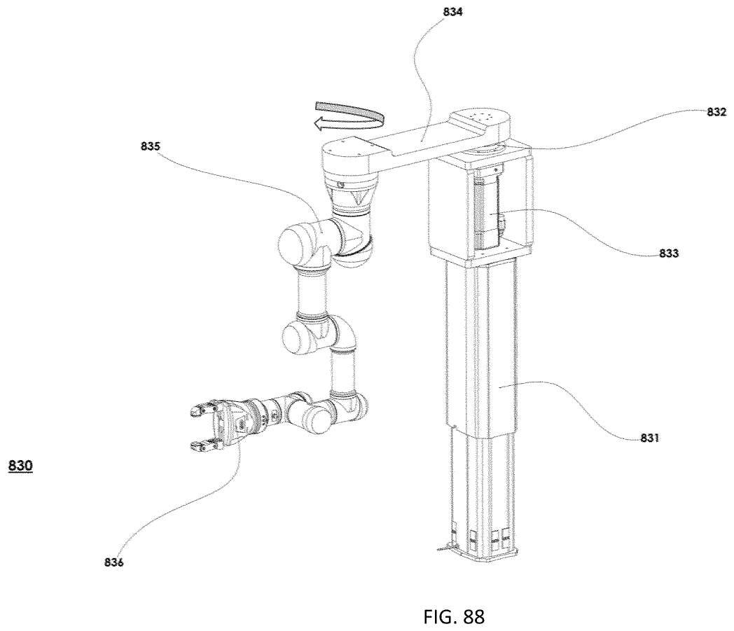

FIG. 88 is a pictorial diagram illustrating another perspective view of the robotic arm platform 830 with the robotic arm 835, a robotic gripper 836, the one or more actuators 1 (such as a linear actuator) and the rotary module 832. The robotic arm platform 830 includes the linear actuator 831 that can move vertically up and down (e.g., along the z-axis), if positioned upright (or move horizontally if positioned sideway to move from left to right). The linear actuator 1 in the robotic arm platform 830 extends the reachability of the robotic arm 835 (and therefore also extends the reachability of the corresponding robotic end effector). The robotic arm platform 830 further includes a rotary module 832, coupled to the robotic arm and rotary module interface bracket 834, that functions like an actuator to extend the reachability of the robotic arm platform 830 around the rotary axis (e.g., along the y-axis).

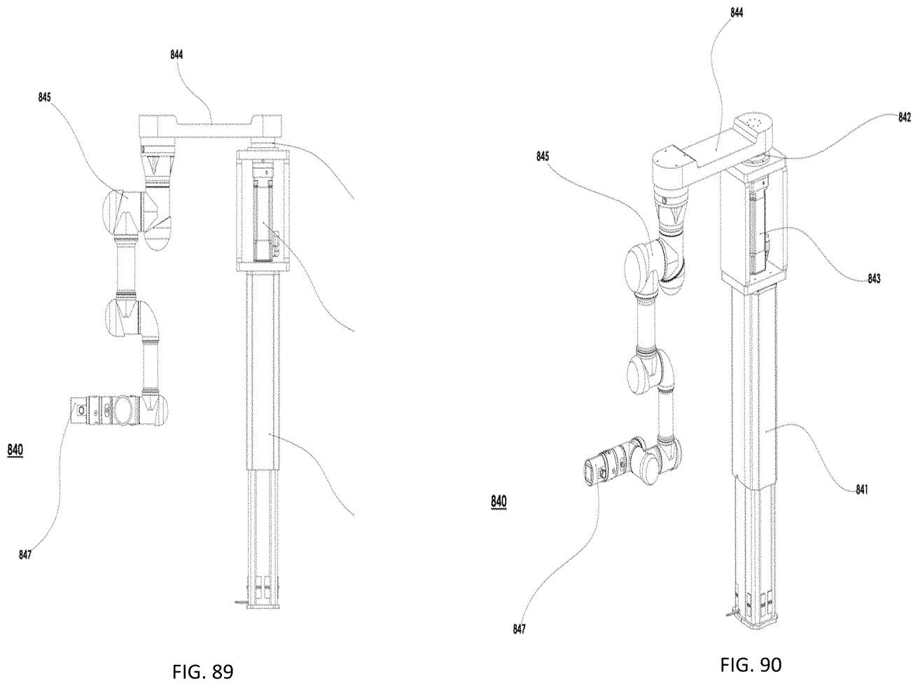

FIG. 89 is a pictorial diagram illustrating a first embodiment of a robotic arm magnetic gripper platform 840 including the robotic arm 845, a magnetic gripper 847, the one or more actuators 841 and the rotary module 842. The robotic arm magnetic gripper platform 840 includes a magnetic gripper 847 for attaching to a device, such as an utensil handle, for moving the utensil handle based on the execution of a particular minimanipulation. The linear actuator 841 in the robotic arm platform 840 extends the reachability of the robotic arm 845 and the magnetic gripper 847. The rotary module 842, coupled to the robotic arm and rotary module interface bracket 844, that functions like an actuator to extend the reachability of the robotic arm 845 and the magnetic gripper 847 (e.g., along the y-axis). FIG. 90 is a pictorial diagram illustrating a perspective view of the first embodiment of robotic arm magnetic gripper platform 840 including a robotic arm with the one or more actuators 841 and the rotary module 842.

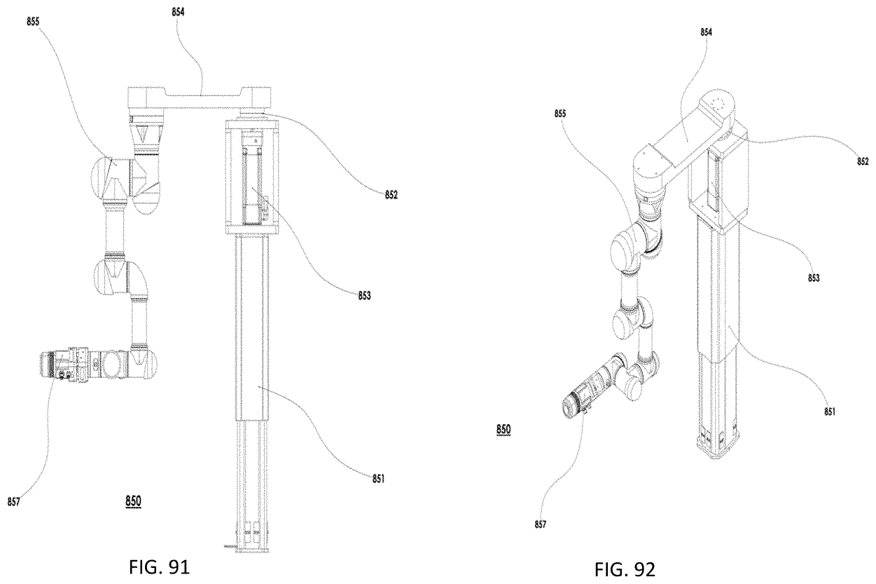

FIG. 91 is a pictorial diagram illustrating a second embodiment of the robotic arm magnetic gripper platform 850 including the robotic arm 855, the magnetic gripper 856, the one or more actuators 851 and the rotary module 852. FIG. 92 is a pictorial diagram illustrating a perspective view of the second embodiment of the robotic arm magnetic gripper platform 850 including the robotic arm 855, the magnetic gripper 856, the one or more actuators 851 and the rotary module 852.

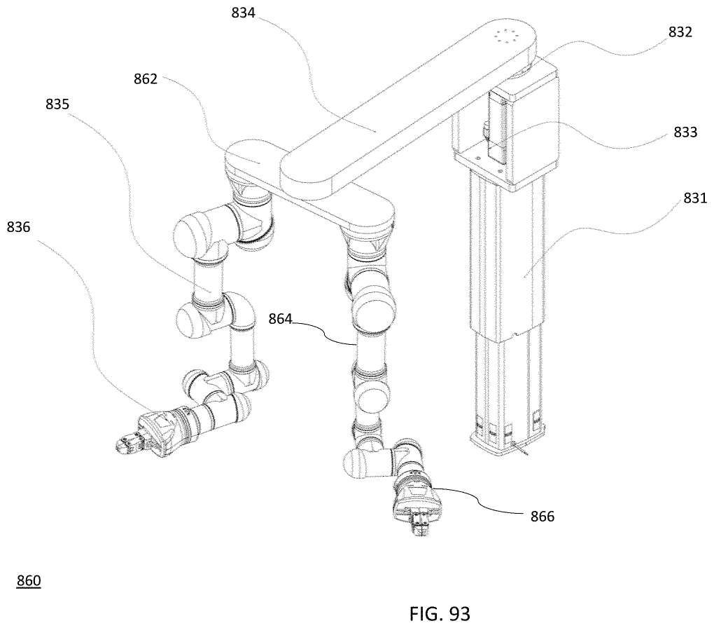

FIG. 93 is a pictorial diagram illustrating a perspective view of a dual robotic arm platform 860 with a pair (or a plurality) of the robotic arms 835, 864 and a pair (or a plurality) of the magnetic grippers 836, 866, and a rotary module 862 for moving the plurality of robotic arms 835, 864 and the plurality of the magnetic grippers 836, 866. The linear actuator 831 in the robotic arm platform 860 extends the reachability of the robotic arms 835, 864 and the magnetic grippers 836, 866. The rotary module 862, coupled to the robotic arm and rotary module interface bracket 834, that functions like an actuator to extend the reachability of the robotic arms 835, 864 and the magnetic grippers 836, 866 (e.g., along the y-axis), which can be used to compensate for any physical shift in the robotic kitchen over time.

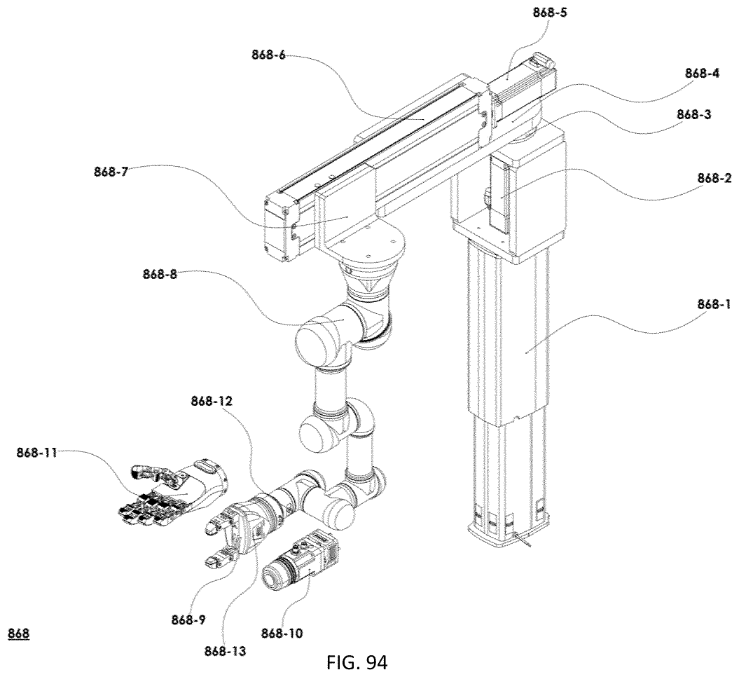

FIG. 94 is a pictorial diagram illustrating a perspective view of the third embodiment of a robotic arm magnetic gripper platform 868 with the robotic arm, the magnetic gripper, the one or more actuators and the rotary module, force and torque sensor for robotic arm, and an integrated camera for the robot. Reference numbers 1-13 used in FIG. 94 are specific to these figures. The robotic arm magnetic gripper platform 868 includes a linear actuary 868-1 for vertical motion (up and down), a rotary module motor 868-2, a rotary module 3, a rotary module and horizontal motion drive interface 868-4, a horizontal motion drive motion 868-5, a horizontal motion drive 868-6, a horizontal motion drive and robot arm interface bracket 868-7, a robot arm 868-8, a parallel gripper 868-9, a magnetic gripper 868-10, a robotic end effector (or a robotic hand) 868-11, a force & torque sensor for the robotic arm 868-12, and an integrated camera 868-13 for the robot 868. The force and torque sensor for the robotic arm 868-8 for measuring reaction, dynamic or rotary from the robot arm 868-8 or the robotic end effector 868-13 into another physical variable, such as into an electrical signal that can be measured, converted and standardized.

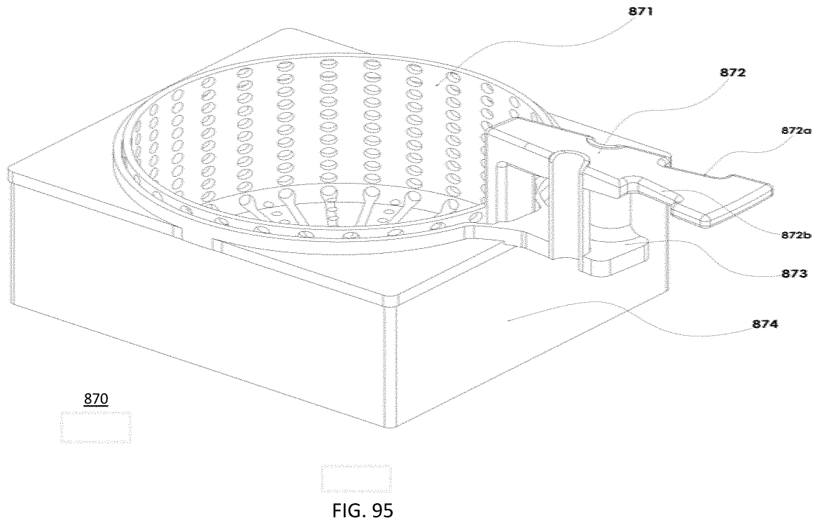

FIG. 95 is a perspective view of a frying basket module 870 for use with a round frying module 4. The frying basket module 870 includes a frying basket 871 that has a frying basket handle 872 which has a contour with a right indent 872a and a left indent 872b with gripping one a robotic end effector. The robotic end effector places the frying basket 1 and the frying basket handle 872 into a frying basket fixture 873 in one fixed position as to fix the bowl in one standard orientation and one particular position, as to ensure that the robotic end effector xx places and retrieves the frying basket 871 and the frying basket handle 872 into a frying basket fixture 873 from the same fixed position. Although the shape of the frying basket 871 (and the corresponding frying module 874) is round as illustrated in this embodiment, one of skilled in the art would recognize that other shapes, such as rectangular, square, oval, may be practiced without departing from the spirits of the present disclosure.

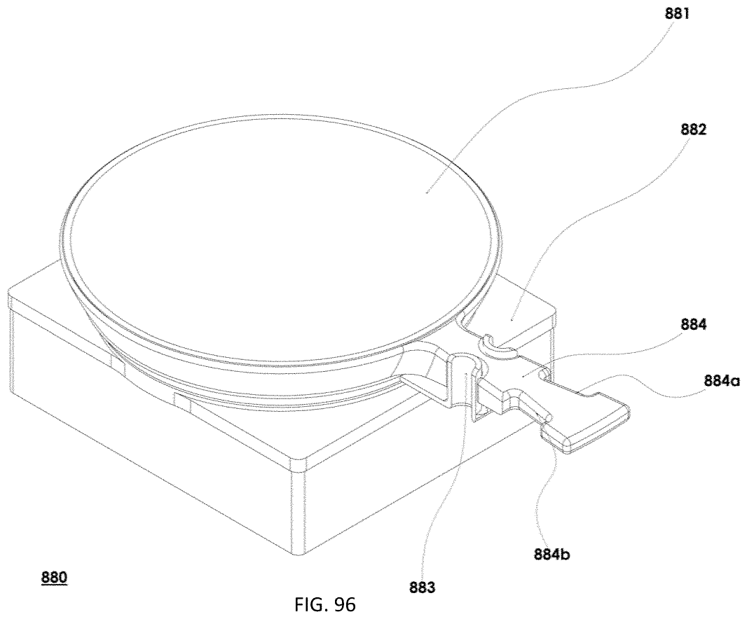

FIG. 96 is a perspective view of a wok 880 for use with the round, rectangular, or other robotic module assembly. The wok 880 has a wok body 881, an induction wok module 882, a wok fixture 883, and a wok handle 884. The induction wok module 882 which has a contour with a right indent 884a and a left indent 884b with gripping one a robotic end effector. The robotic end effector places the wok body 1 and the induction wok module 882 into a wok fixture 883 in one fixed position as to fix the bowl in one standard orientation and one particular position, as to ensure that the robotic end effector places and retrieves the wok body 881 and the induction wok module 882 into a wok fixture 883 from the same fixed position. The wok body 88 is structured to compensate for a slight movement or a slight displacement of the wok body 881 during stirring by a utensil as to remain within a deviation of a single fixed position for a robotic end effector to successfully grip the right indent 884a and the left indent 884b of the wok handle 884. Although the shape of the wok body 881 (and the corresponding induction work module 882) is round as illustrated in this embodiment, one of skilled in the art would recognize that other shapes, such as rectangular, square, oval, may be practiced without departing from the spirits of the present disclosure.

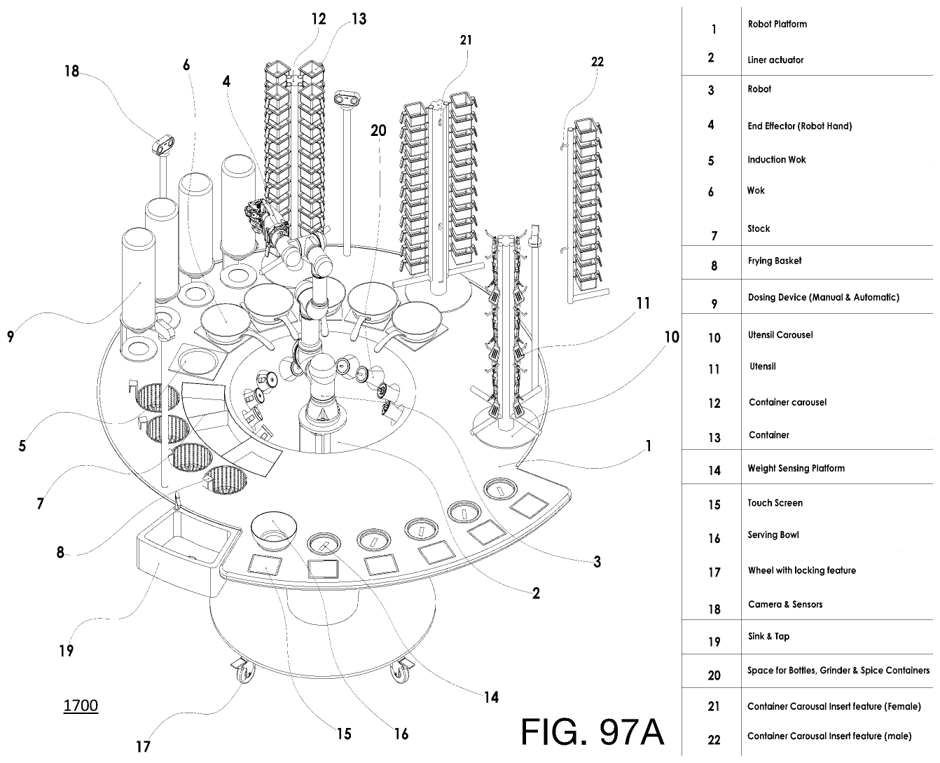

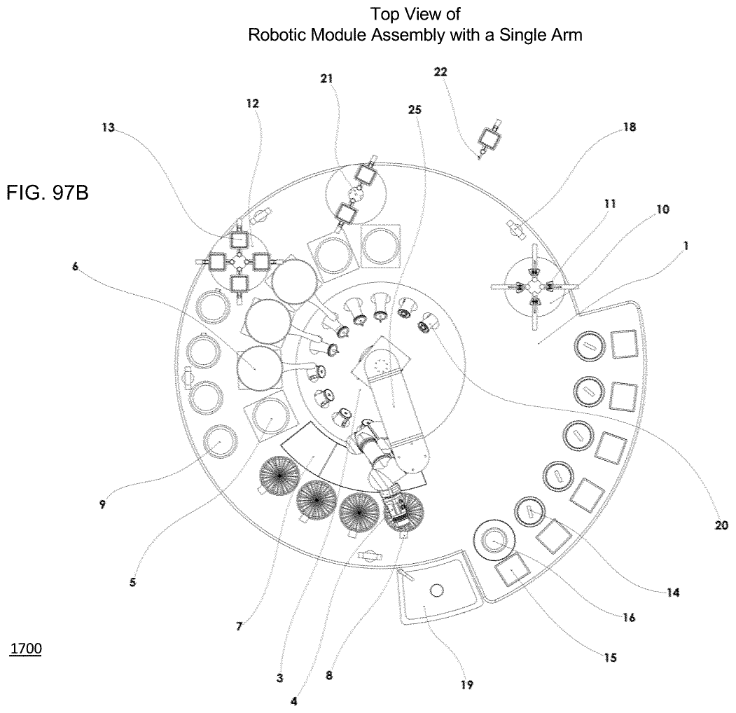

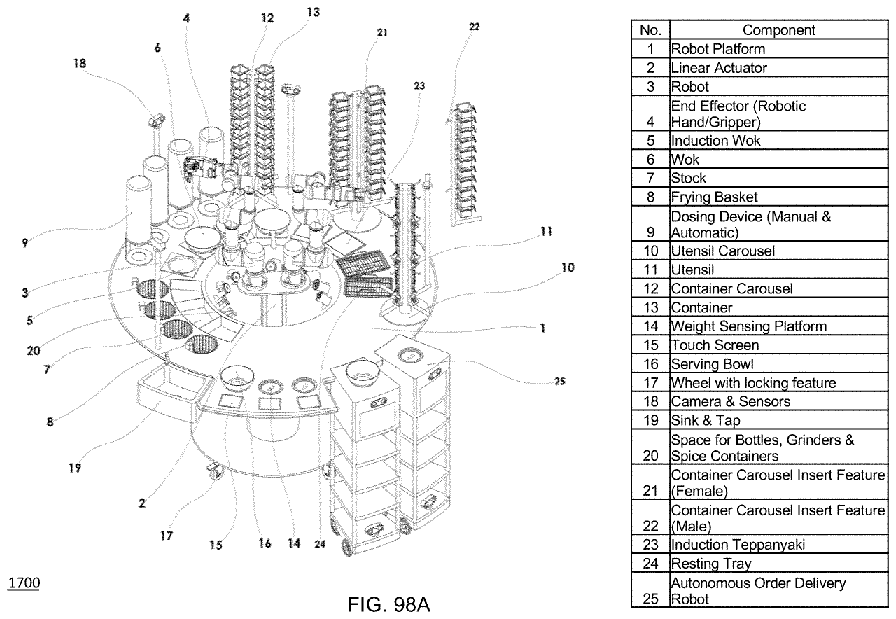

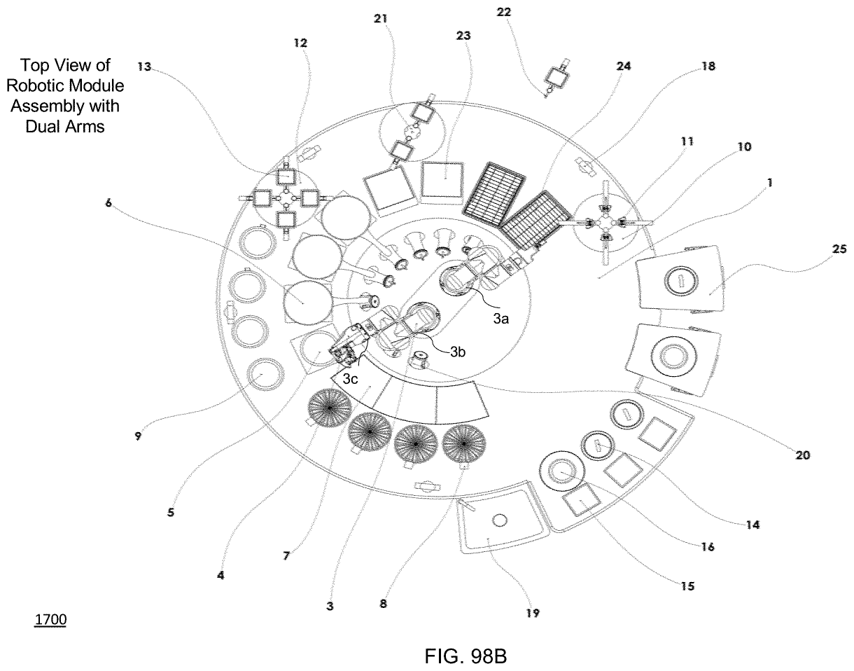

FIG. 97A is a pictorial diagram illustrating an isometric view of a round (or a spheric) robotic module assembly 1700 with a single robotic arm and a single end effector, while FIG. 97B is a pictorial diagram illustrating a top view of a round (or a spheric) robotic module assembly with a single robotic arm and a single end effector. FIG. 98A is a pictorial diagram illustrating an isometric view of a round (or a spheric) robotic module assembly two robotic arms and two end. FIG. 98B is a pictorial diagram illustrating a top view of a round (or a spheric) robotic module assembly with a plurality of robotic arms 3a, 3b and a plurality end effectors 3c. Reference numbers 1-25 used in FIGS. 97A, 97B, 98A and 98B are specific to these figures. The robotic module assembly 1700 comprises a commercial kitchen suitable for restaurant, hotel, shopping malls, other commercial locations, as well as residential usage. The robotic module assembly includes one or more robotic arms and one or more robotic end effector 4 for preparing food dishes to customers who are dining at the commercial kitchen. When a customer sits or stand at one location near a touch screen, the customer can select a food dish from among a menu offering a variety of food dishes from a plurality of cooking stations from the commercial kitchen. After the customer has made a food dish selection, the one or more robotic arms and the one or more robotic end effectors moves the ingredients associated with selected food dish from one or more container carousel 12, one or more containers 13, one or more container carousal insert feature (female) 21, and one or more container carousal insert feature (male) 22, into a bowl 16. A weight sensor 14 detects whether a proper weight has been reached that is associated with the selected food dish. If the weight sensor 14 detects that a proper weight has been reached that is associated with the selected food dish, the one or more robotic arms and one or more robotic end effector 4 moves the bowl 16 to one of the cooking stations 06 for cooking the food dish from the received ingredients. The one or more robotic arms and one or more robotic end effector 4 retrieves one of the spice containers 20, or using an automated dousing devices 09, such as an electrical dousing wheel, to add spice flavors, either when the bowl 16 is receiving the ingredients, or when one of the cooking stations 6 is cooking the food dish. One of more frying baskets 8 can be used to boil food, such as Udon, Ramen, or pasta. A sink 19 in the commercial kitchen is for the one or more robotic arms and one or more robotic end effector 4 to move the dirty dishes to the sink 19. The robotic module assembly has a plurality of wheels 17 for conveniently move the robotic module assembly around, with a locking feature of the plurality of wheels to hold in a steady position. The one or more robotic arms and one or more robotic end effector 4 includes one or more camera or sensor for detecting any ID/bar code on the one more containers 13, and inside the one or more containers 12. The robotic module assembly also includes an utensil carousel 10 for holding a plurality of utensils. One or more stocks 7 for placement of flavorful liquids used in the preparation of soups, sauces, stews, and others. One or more linear actuators 2 in the robotic module assembly is coupled to the one or more robotic arms and one or more robotic end effector 4 to extend the x-y-z axis and rotary angles the one or more robotic arms and one or more robotic end effector 4. One or more sensors 18 in the robotic module assembly comprises a camera sensor, a stereo camera, an infrared camera, a depth camera, a laser sensor, a weight sensor, a motion capture sensor, a pressure sensor, a humidity sensor, a temperature sensor, a magnetic sensor, a haptic sensor, a sound sensor, a light sensor, a force torque sensor, a smell sensor, or a multimodal sensing device, or any combination thereof, for identifying a current kitchen environment in the commercial kitchen on a processor request basis, wherein the current kitchen environment comprises one or more object identifications, positions, orientations, or associated properties including temperature, texture, color, shape, smell or weight. One or more teppanyaki inductions 23 is placed in the robotic module assembly for the robot 3 to grill the food. One or more rest trays 24 is for used to place food in the rest trays. One or more autonomous order delivery robots is stationed in the robotic module assembly for take a food dish from the robotic module assembly and deliver to a specified location, such as an identified customer table. In one embodiment, for safety measures, the one or more robotic arms and one or more robotic end effector 4 operates within the dimensions within the robotic module assembly as not to extend to the customer space to cause potential harm.

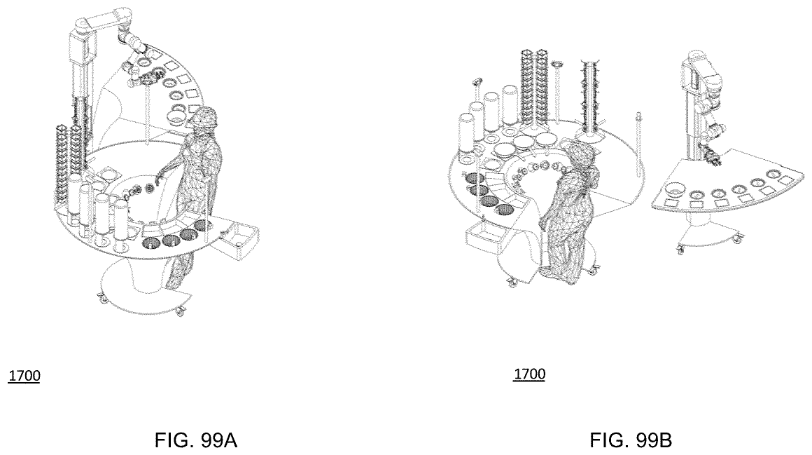

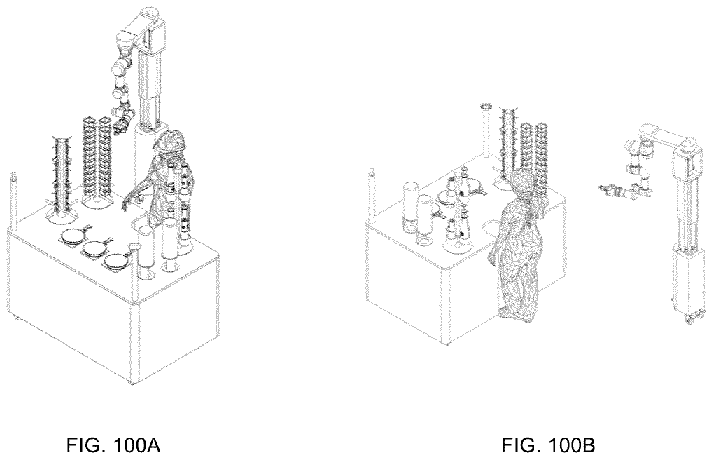

Optionally, the robotic module assembly 1700 with either the single robotic arm assembly or the dual robotic arms assembly is a movable part, which can be disconnected from the robotic module assembly 1700, which a human can step in at the place vacated by the single robotic arm or the dual robotic arms. FIG. 99A is a pictorial diagram illustrating an isometric front view of a round (or a spheric) robotic module assembly with two robotic arms and two end effectors which the robot is a moveable portion, while FIG. 99B is a pictorial diagram illustrating an isometric back view of a round robotic module assembly with two robotic arms and two end effectors which the robot is a moveable portion. The moveable robot portion can be moved way from round robotic module assembly which then a human can step in to cook in the round robotic module assembly. FIG. 100A is a pictorial diagram illustrating an isometric front view of a rectangular robotic module assembly with two robotic arms and two end effectors which the robot is a moveable portion. FIG. 100B is a pictorial diagram illustrating an isometric back view of a rectangular robotic module assembly with two robotic arms and two end effectors which the robot is a moveable portion.

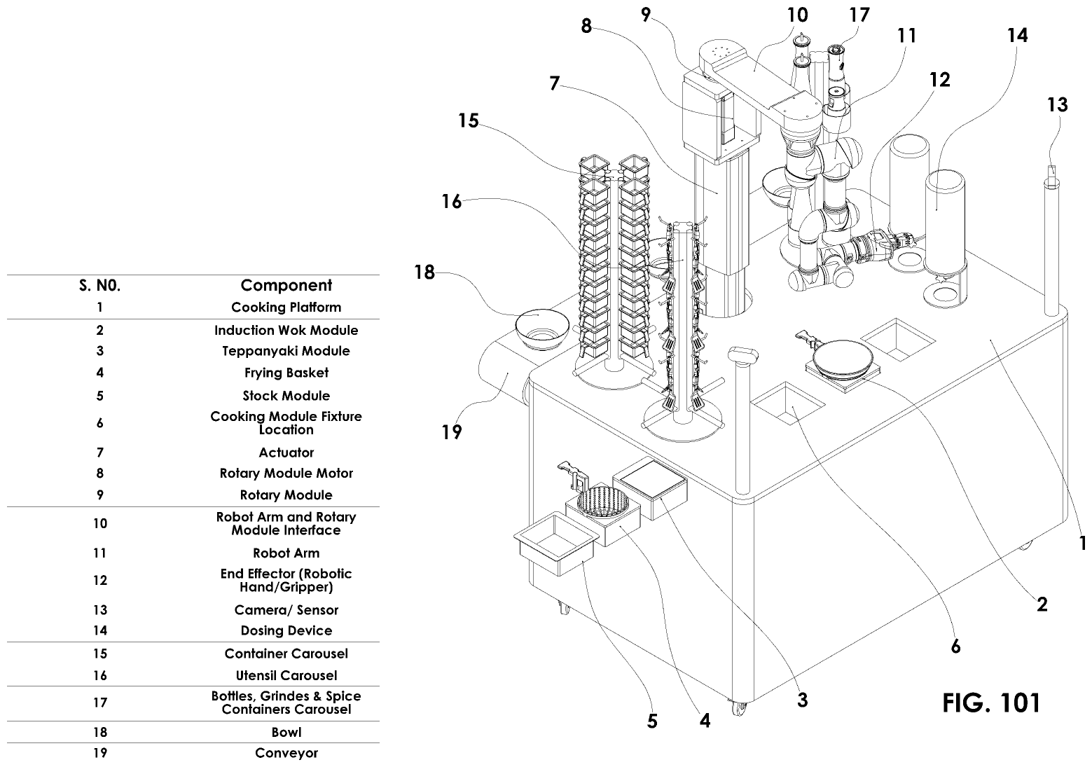

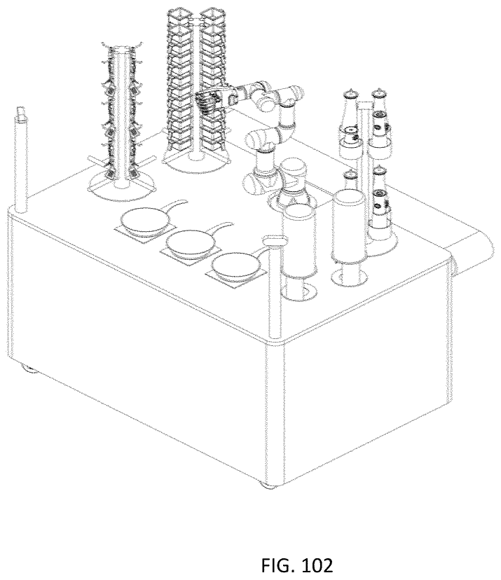

FIG. 101 is a pictorial diagram illustrating an isometric front view of a rectangular (or a square) robotic module assembly 20 with one or more robotic arms and one or more end effectors with a conveyor belt located in the back side of the rectangular robotic module assembly (with optional wheels). FIG. 102 is a pictorial diagram illustrating an isometric back view of a rectangular robotic module assembly 20 with one or more robotic arms and one or more end effectors with the conveyor belt located in the back side of the rectangular robotic module assembly. The rectangular robotic module assembly 20 comprise one or more robotic arms, one or more end effectors, a cooking platform 1, an induction wok module 2, a teppanyaki module 3, a frying basket 4, a stock module 5, a cooking module fixture location 6, an actuator 7, a rotary module motor 8, a rotary module 9, a robot arm and rotary module interface 10, a robot arm 11, an end effector (or a robotic gripper, or a robotic hand) 12, a camera or sensor 13, a dosing device 14, a container carousel 15, a utensil carousel 16, a bottles, grinders, spice containers carousel 17, a bowl 18, and a conveyor 19. The conveyor 19 is used to move a food dish along the robotic module assembly 20. The robotic module assembly (or commercial kitchen) comprises a commercial kitchen suitable for restaurant, hotel, shopping malls, other commercial locations, as well as residential usage. The robotic module assembly includes one or more robotic arms and one or more robotic end effector 4 for preparing food dishes to customers who are dining at the commercial kitchen. When a customer sits or stand at one location near a touch screen, the customer can select a food dish from among a menu offering a variety of food dishes from a plurality of cooking stations from the commercial kitchen. After the customer has made a food dish selection, the one or more robotic arms and the one or more robotic end effectors moves the ingredients associated with selected food dish from one or more container carousel 12, one or more containers 13, one or more container carousal insert feature (female) 21, and one or more container carousal insert feature (male) 22, into a bowl 16. A weight sensor 14 detects whether a proper weight has been reached that is associated with the selected food dish. If the weight sensor 14 detects that a proper weight has been reached that is associated with the selected food dish, the one or more robotic arms and one or more robotic end effector 4 moves the bowl 16 to one of the cooking stations 6 for cooking the food dish from the received ingredients. The one or more robotic arms and one or more robotic end effector 4 retrieves one of the spice containers 20, or using an automated dousing devices 9, such as an electrical dousing wheel, to add spice flavors, either when the bowl 16 is receiving the ingredients, or when one of the cooking stations 6 is cooking the food dish. One of more frying baskets 8 can be used to boil food, such as Udon, Ramen, or pasta. A sink 19 in the commercial kitchen is for the the one or more robotic arms and one or more robotic end effector 4 to move the dirty dishes to the sink 19. The robotic module assembly has a plurality of wheels 17 for conveniently move the robotic module assembly around, with a locking feature of the plurality of wheels to hold in a steady position. The one or more robotic arms and one or more robotic end effector 4 includes one or more camera or sensor for detecting any ID/bar code on the one more containers 13, and inside the one or more containers 12. The robotic module assembly also includes an utensil carousel 10 for holding a plurality of utensils. One or more stocks 7 for placement of flavorful liquids used in the preparation of soups, sauces, stews, and others. One or more linear actuators 2 in the robotic module assembly is coupled to the one or more robotic arms and one or more robotic end effector 4 to extend the x-y-z axis and rotary angles the one or more robotic arms and one or more robotic end effector 4. One or more sensors 18 in the robotic module assembly comprises a camera sensor, a stereo camera, an infrared camera, a depth camera, a laser sensor, a weight sensor, a motion capture sensor, a pressure sensor, a humidity sensor, a temperature sensor, a magnetic sensor, a haptic sensor, a sound sensor, a light sensor, a force torque sensor, a smell sensor, or a multimodal sensing device, or any combination thereof, for identifying a current kitchen environment in the commercial kitchen on a processor request basis, wherein the current kitchen environment comprises one or more object identifications, positions, orientations, or associated properties including temperature, texture, color, shape, smell or weight. One or more teppanyaki inductions 23 is placed in the robotic module assembly for the robot 3 to grill the food. One or more rest trays 24 is for used to place food in the rest trays. One or more autonomous order delivery robots is stationed in the robotic module assembly for take a food dish from the robotic module assembly and deliver to a specified location, such as an identified customer table. In one embodiment, for safety measures, the one or more robotic arms and one or more robotic end effector 4 operates within the dimensions within the robotic module assembly as not to extend to the customer space to cause potential harm.

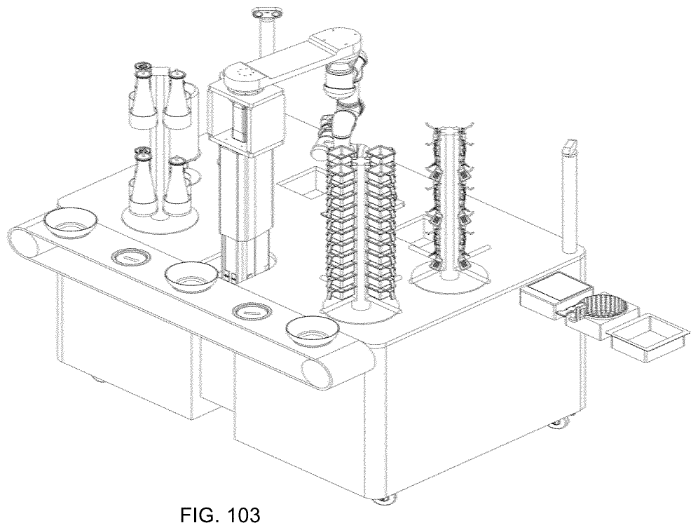

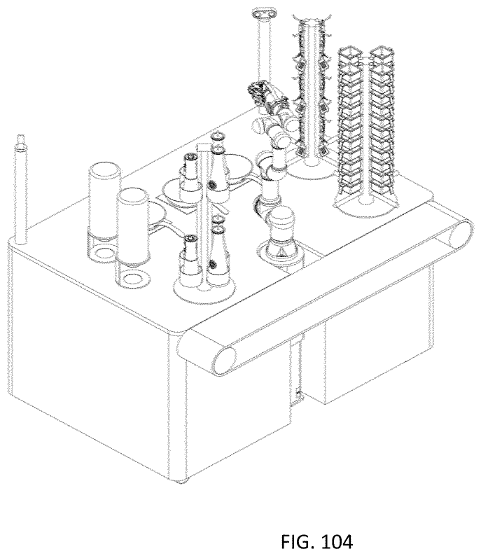

FIG. 103 is a pictorial diagram illustrating an isometric back right view of a rectangular (or a square) robotic module assembly with one or more robotic arms and one or more end effectors with the conveyor belt located in the back side of the rectangular robotic module assembly. FIG. 104 is a pictorial diagram illustrating an isometric back left view of a rectangular (or a square) robotic module assembly with one or more robotic arms and one or more end effectors with the conveyor belt located in the back side of the rectangular robotic module assembly.

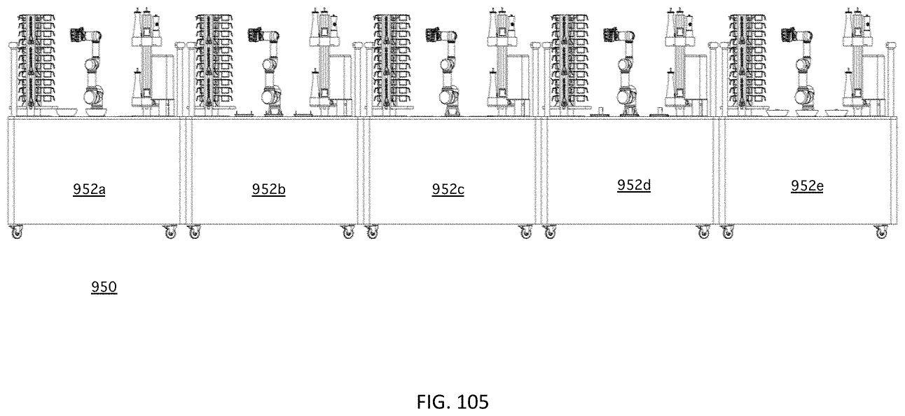

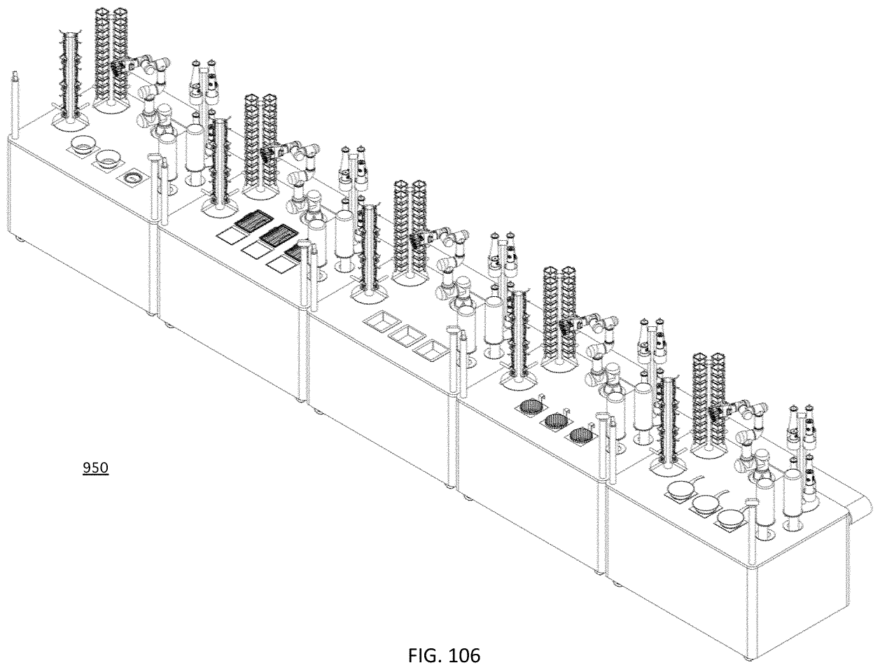

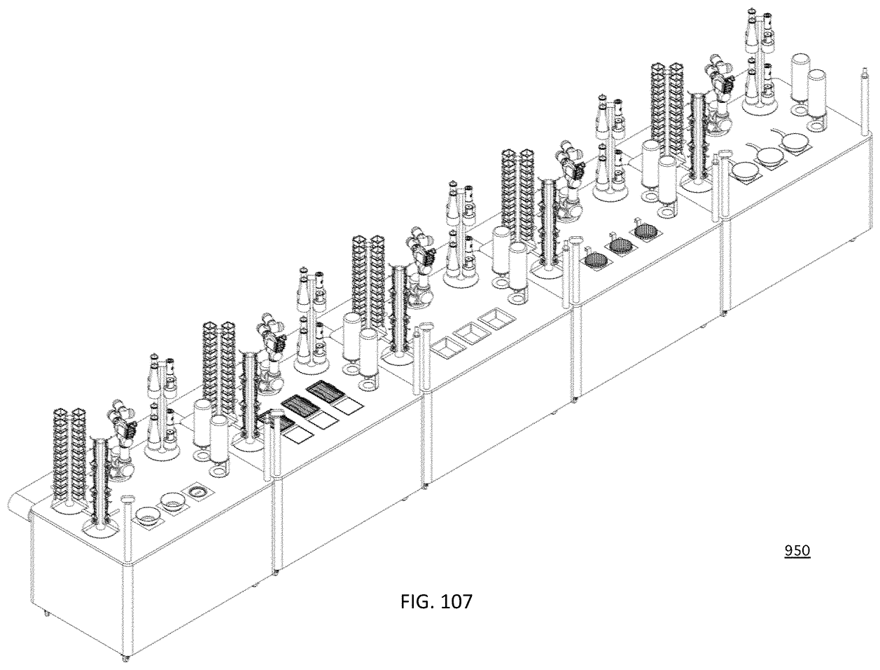

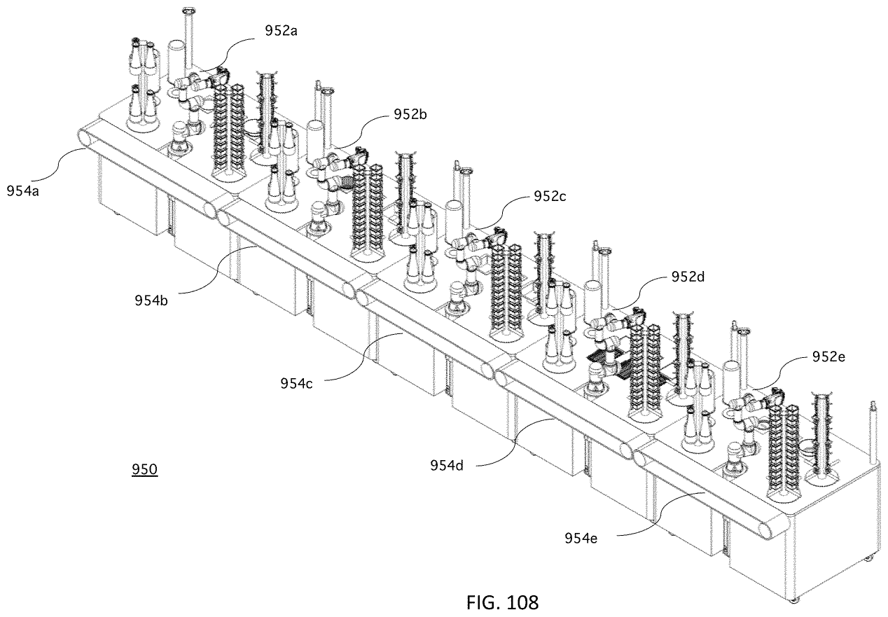

FIG. 105 is a block diagram illustrating a first embodiment of a front view of commercial robotic kitchen with a plurality of robotic module assemblies 952a, 952b, 952c, 952d, 952e that are coupled to operate together collectively, partially or individually. FIG. 106 is a block diagram illustrating the first embodiment of an isometric front right view of a commercial robotic kitchen with a plurality of robotic module assemblies with respect to FIG. 105. FIG. 107 is a block diagram illustrating the first embodiment of an isometric front left view of a commercial robotic kitchen with a plurality of robotic module assemblies with respect to FIG. 105. FIG. 108 is a block diagram illustrating the first embodiment of an isometric back right view of a commercial robotic kitchen with a plurality of robotic module assemblies with respect to FIG. 105. In this embodiment, commercial robotic kitchen 950 comprises five multiunit robot module assemblies 952a, 952b, 950c, 950d, 950e, which are coupled together in this embodiment, but can also be separated apart. Each of the five multiunit robot module assemblies 952a, 952b, 952c, 952d, 952e has a respective transport system for food, such as conveyor belts 954a, 954b, 954c, 954d, 954e, respectively. The overall cooking operations of the plurality of robot module assemblies 952a, 952b, 952c, 952d, 952e can vary depending on the applications. For example, in one operation mode, a restaurant with commercial robotic kitchen may like to set up the commercial robotic kitchen 950 to operate collectively (or somewhat collectively) in preparing a food dish at the restaurant. In this instance, each of the robot module assemblies 952a, 952b, 952c, 952d, 952e operates to serve different functions to prepare a dish. For example, the robot module assembly 952a prepares a first side dish (e.g., some vegetables), the robot module assembly 952b prepares a second side dish (e.g., rice), the robot module assembly 952c prepares a third side dish (e.g., mushrooms), the robot module assembly 952d prepares to fry an entrée (e.g., Chilean sea bass), and the robot module assembly 952e adds sauce on top of the fish. The preparation of the main entrée dish would pass through sequentially on the conveyor belts 954a, 954b, 954c, 954d, 954e. At the robot module assembly 952a, the robot module assembly 952a prepares a first side dish and places the first side dish on the conveyor belt 954a, which moves the dish to the conveyor belt 954b. The robot module assembly 952b prepares the second side dish and places the second side dish on the conveyor belt 954b, which moves the dish to the conveyor belt 954c. The robot module assembly 952c prepares the third side dish and places the third side dish on the conveyor belt 950c, which moves the dish to the conveyor belt 954d. The robot module assembly 952d prepares the main dish and places the main dish on the conveyor belt 950d, which moves the dish to the conveyor belt 954e. The robot module assembly 952e prepares the sauce and add the sauce over the entrée on the dish on the conveyor belt 950e, which moves the completed dish to a station.

In one embodiment, each of the plurality of robotic module assemblies 952a, 952b, 952c, 952d, 950e has a conveyor belt on the back side of the robot (or the robotic arm). In another embodiment, the plurality of robotic module assemblies 952a, 952b, 952c, 952d, 950e have one or more ordering stations, wherein the one or more ordering stations have conveyor belts on the front as well as on the back side. In some embodiment, the conveyor belts have slots which a user can place his or her bowl while ordering the food.

The commercial robotic kitchen 950 comprising the plurality of robotic module assemblies 952a, 952b, 952c, 952d, 950e that are coupled to operate together can be programmed and operate in different modes. In a first mode, the five robotic module assemblies 952a, 952b, 952c, 952d, 950e operate collectively together to prepare one food dish. Each of the robotic module assemblies 952a, 952b, 952c, 952d, 950e can be loaded with software containing a set of minimanipulations that serves as a respective set of standard functions, such as the robotic module assembly 952a containing a first set of standard functions and a corresponding first set of minimanipulations, the robotic module assembly 952b containing a second set of standard functions and a corresponding second set of minimanipulations, the robotic module assembly 952c containing a third set of standard functions and a corresponding third set of minimanipulations, the robotic module assembly 952d containing a fourth set of standard functions and a corresponding fourth set of minimanipulations, and the robotic module assembly 952e containing a fifth set of standard functions and a corresponding fifth set of minimanipulations. In a second mode, the five robotic module assemblies 952a, 952b, 952c, 952d, 950e can divide up the cooking operations which some of the robotic module assemblies 952a, 952b, 952c, 952d, 950e collaborate together on a food dish, while some other robotic module assemblies 952a, 952b, 952c, 952d, 950e operate independently on a food dish.

The robotic module assemblies 952a, 952b, 952c, 952d, 950e can be customized to tailored to a specific operating food environment, while may maintain the multi-stage cooking process by putting a plurality of robotic module assemblies to operate in a particular food provider environment, such as a restaurant, a restaurant in a hotel, a restaurant in a hospital, a restaurant at an airport, and other environments.

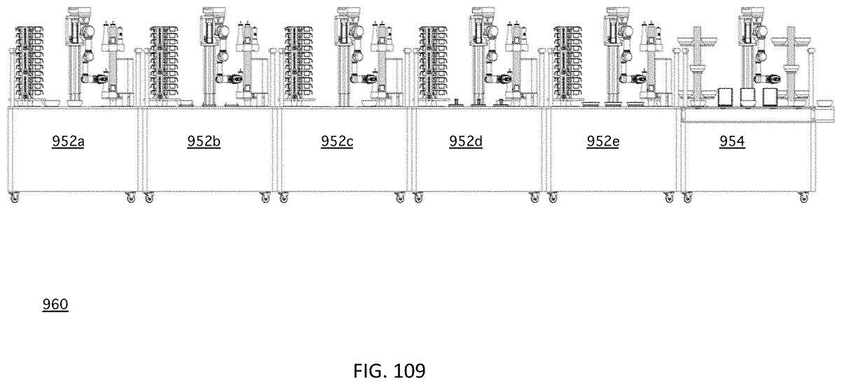

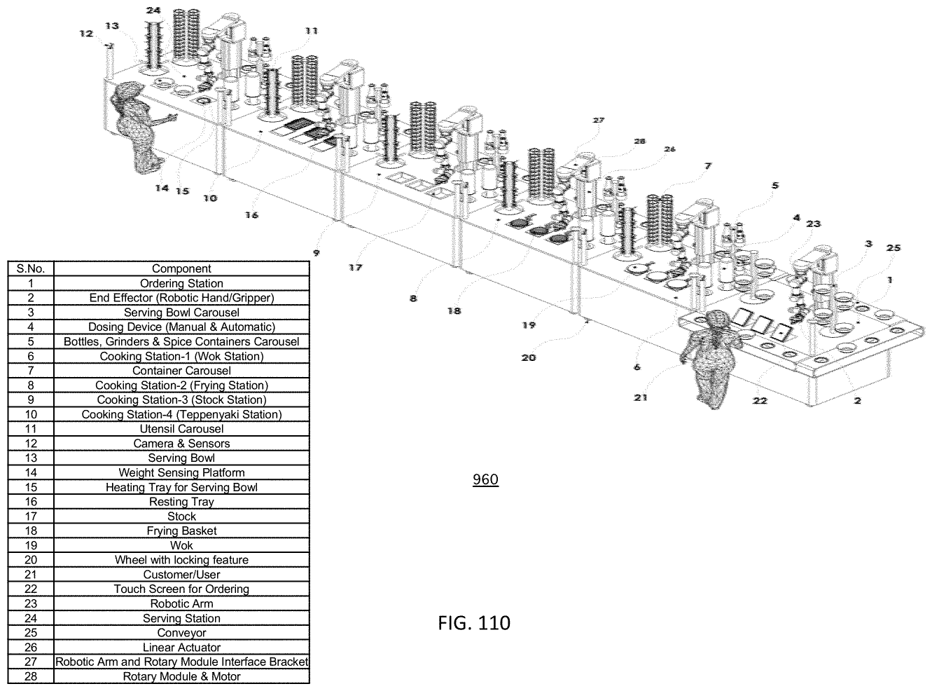

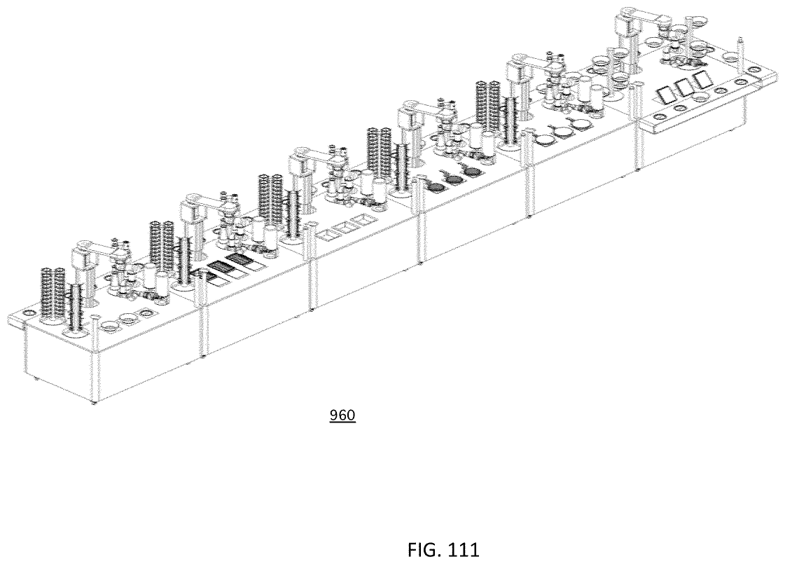

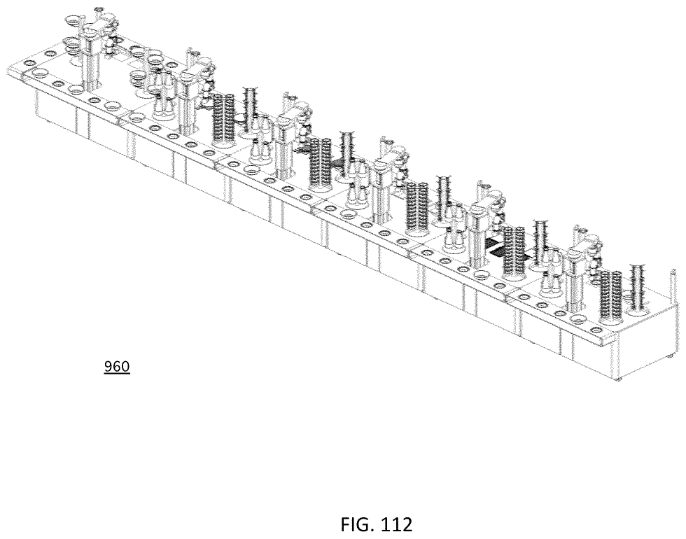

FIG. 109 is a block diagram illustrating a second embodiment of a front view of commercial robotic kitchen 960 with a plurality of robotic module assemblies 952a, 952b, 952c, 952d, 950e with an end robotic module assembly 954 with a front side conveyor belt and a back side conveyor belt. FIG. 110 is a block diagram illustrating the second embodiment of an isometric front right view of commercial robotic kitchen 960 with the plurality of robotic module assemblies 952a, 952b, 952c, 952d, 950e with an end robotic module assembly 954 with a front side conveyor belt and a back side conveyor belt with respect to FIG. 109. FIG. 111 is a block diagram illustrating the second embodiment of an isometric front left view of commercial robotic kitchen 960 with the plurality of robotic module assemblies 952a, 952b, 952c, 952d, 950e with an end robotic module assembly 954 with a front side conveyor belt and a back side conveyor belt with respect to FIG. 109. FIG. 112 is a block diagram illustrating the second embodiment of an isometric back view of commercial robotic kitchen 960 with the plurality of robotic module assemblies 952a, 952b, 952c, 952d, 950e with an end robotic module assembly 954 with a front side conveyor belt and a back side conveyor belt with respect to FIG. 109. Reference numbers 1-28 used in FIGS. 109, 110, 111 and 112 are specific to these figures.

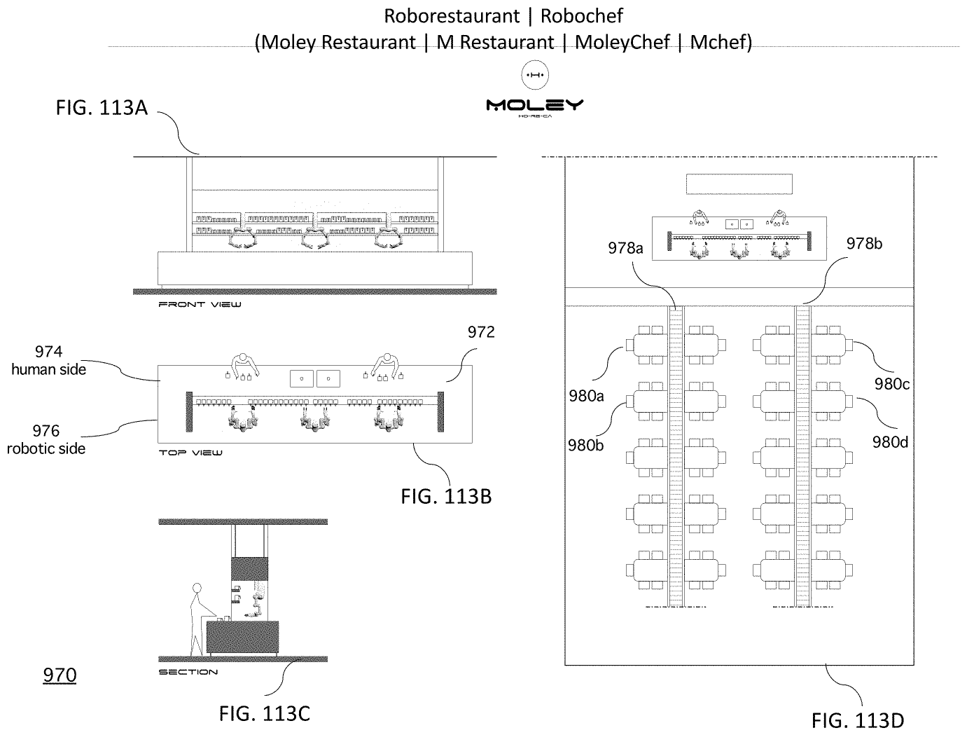

FIGS. 113A-D are block diagrams illustrating the various layouts of a commercial robotic kitchen 970 including a front view in FIG. 113A, a top view in FIG. 113B, and a sectional view in FIG. 113C. The flow diagram in FIG. 2B illustrates one embodiment of the process steps applicable to FIGS. 113A-D. FIG. 113D shows the commercial robotic kitchen 970 and a plurality of tables 980a, 980b, 980c, 2110d and so on. The commercial robotic kitchen 970 has a cooking area 972 which is arranged with humans working on a first side 2014 of the cooking area 972 and the robots working on a second side 986 of the cooking area 972. The humans and the robots are working together to prepare food dishes in a restaurant. For example, the human side 974 can cut some customized ingredients and pass the customized ingredients to the robotic side 2016 to prepare food or cook. In one embodiment, the commercial robotic kitchen 970 has a conveyor 978a for the robotic to distribute the prepared dishes to customers 980a, 980b, and a conveyor 978b for the robotic to distribute the prepared dishes to customers 980c, 980d. In the commercial robotic kitchen 980, either the robot or a human can serve as a host of the recipe in preparing a food dish. If the human serves as a host, the robot executes a minimanipulation based on a human command. If the robot serves as a host, the human executes based on one or more commands from the robot. For example, when a recipe may require a hand dexterity (or fingers dexterity) that is more complicated than a robotic end effector is able to perform, the robot serves as a host and delegates one or more specific complex tasks to the human and when (as to the timing in a recipe) to delegate to the human, such as making sushi, making ravioli, or cutting vegetables, which could be as part of a prep stage of a recipe. After the human finishes cutting the vegetables, the human places into a container and passes the container for the robot. The robot then continues with cooking the recipe, as the robot is able to precise on the execution timing of the recipe, the sequence of the operations or minimanipulations, and/or the precise duration of the cooking. The robot would then serve as the host and responsible for managing the recipe, with a possible support from the human. With the human serves to support the robot, the robot can then cook a complex or a very complex recipe, with assistance from the human. Also, for a human that is not great at cooking, the human can simply do some prep food work or handle some simple tasks, such as cutting vegetable, which the robot then be able to execute and prepare a complex dish. The robot can also conduct cooking in parallel on multiple dishes at the same time, which the robot can simultaneous manages the timing, adding ingredients, cooking actions, for the multiple dishes simultaneously, to ensure perfect execution and perfect timing in preparing the multiple dishes without errors.

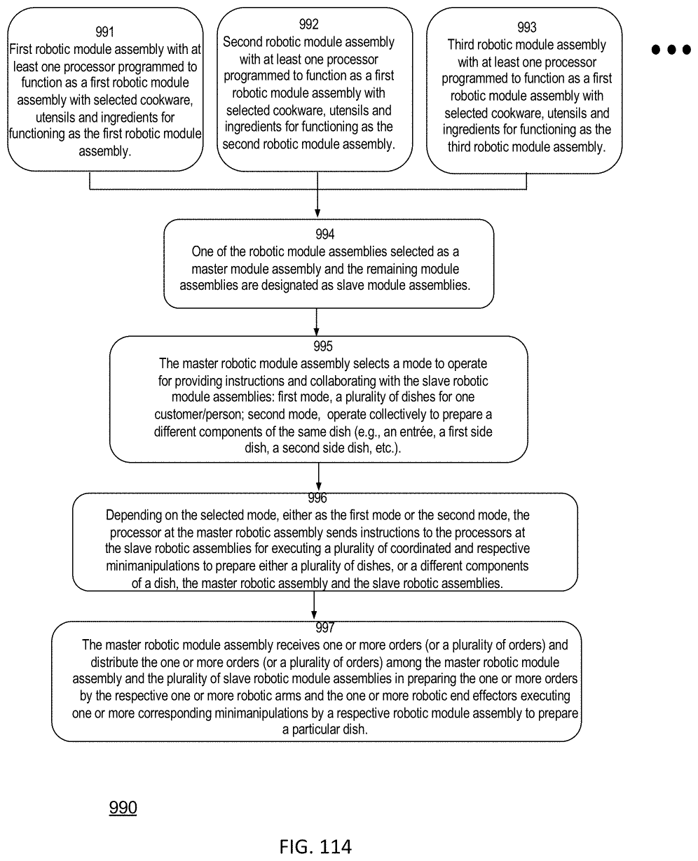

FIG. 114 is a flow chart 990 illustrating the process of steps in operating a commercial robotic kitchen with the plurality of robotic module assemblies 952a, 952b, 952c, 952d, 950e and the end robotic module assembly 954. At step 991, the processor 532 programs the first robotic module assembly to function as a first robotic module assembly with selected cookware, utensils and ingredients for functioning as the first robotic module assembly. At step 992, the processor 532 programs the second robotic module assembly to function as a first robotic module assembly with selected cookware, utensils and ingredients for functioning as the second robotic module assembly. At step 993, the processor 532 programs third robotic module assembly to function as a first robotic module assembly with selected cookware, utensils and ingredients for functioning as the third robotic module assembly. At step 994, the processor 532 selects one of the robotic module assemblies as a master module assembly and the remaining module assemblies are designated as slave module assemblies. At step 995, the processor 532 selects a mode for the master robotic module assembly to operate for providing instructions and collaborating with the slave robotic module assemblies: first mode, a plurality of dishes for one customer/person; second mode, operate collectively to prepare a different components of the same dish (e.g., an entrée, a first side dish, a second side dish, etc.). At step 996, depending on the selected mode, either as the first mode or the second mode, the processor 532 at the master robotic assembly sends instructions to the processors at the slave robotic assemblies for executing respective minimanipulations to prepare either a plurality of dishes, or a different components of a dish, the master robotic assembly and the slave robotic assemblies. At step 997, the process 532 at the master robotic module assembly receives one or more orders (or a plurality of orders) and distribute the one or more orders among the master robotic module assembly and the plurality of slave robotic module assemblies in preparing the one or more orders by the respective one or more robotic arms and the one or more robotic end effectors executing one or more corresponding minimanipulations by a respective robotic module assembly to prepare a particular dish.

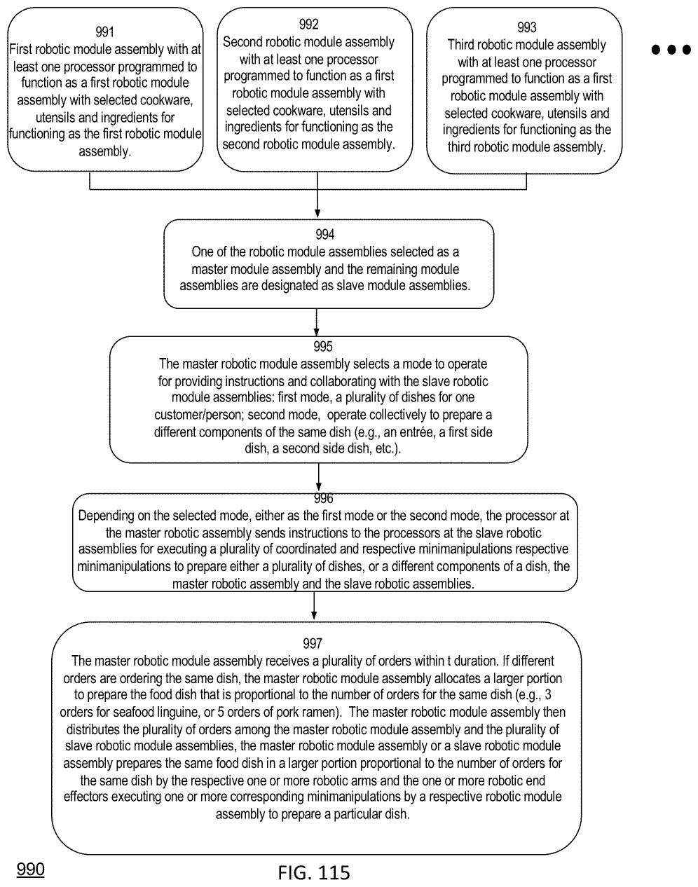

FIG. 115 is a flow chart 960 illustrating a second embodiment of the process of steps in operating a commercial robotic kitchen with the plurality of robotic module assemblies 952a, 952b, 952c, 952d, 950e with a master robotic module assembly or a slave robotic module assembly preparing a plurality of orders for the same dish in a larger portion at the same time. The process steps 991, 992, 993, 994, 995. 996 are similar to FIG. 114. At step 997, the processor 532 The master robotic module assembly receives a plurality of orders within t duration. If different orders are ordering the same dish, the master robotic module assembly allocates a larger portion to prepare the food dish that is proportional to the number of orders for the same dish (e.g., 3 orders for seafood linguine, or 5 orders of pork ramen). The master robotic module assembly then distributes the plurality of orders among the master robotic module assembly and the plurality of slave robotic module assemblies, the master robotic module assembly or a slave robotic module assembly prepares the same food dish in a larger portion proportional to the number of orders for the same dish by the respective one or more robotic arms and the one or more robotic end effectors executing one or more corresponding minimanipulations by a respective robotic module assembly to prepare a particular dish.

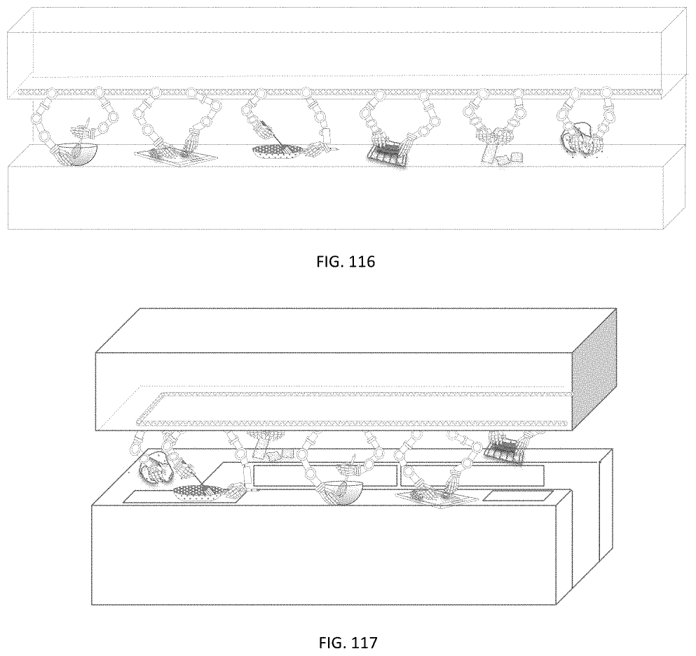

FIG. 116 is a block diagram illustrating one embodiment of a commercial robotic kitchen with a plurality of cooking stations line suitable for restaurants, hotels, hospitals, offices, academic institutions and work places. Multiple sets of a dual-arm (or a pair of robotic arms) and corresponding end effectors are arranged in a linear cooking line, which each pair of robotic arms serve as a station. FIG. 117 is a block diagram illustrating one embodiment of a commercial robotic kitchen with an open kitchen suitable for restaurants, hotels, hospitals, offices, academic institutions and work places in accordance with the present disclosure. Each station with a pair of robotic arms can be programmed to perform a different set of minimanipulations, or some pair of the robotic arms can operate collectively to perform a set of minimanipulations to carry out a food dish or a plurality of food dishes jointly.

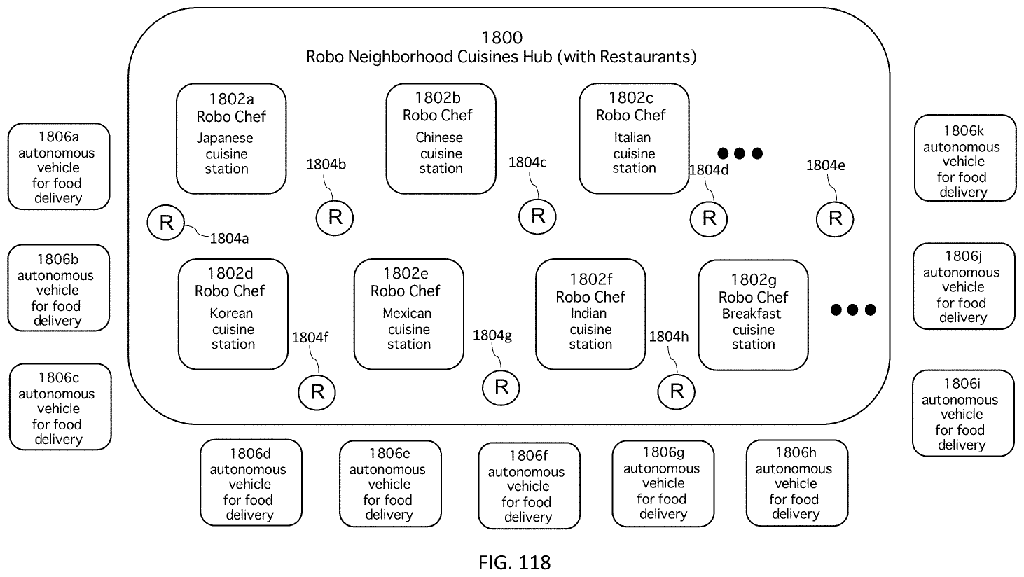

FIG. 118 is a block diagram illustrating a robo neighborhood cuisines hub 1800 with a plurality of robot module assemblies (or robot chefs) 1802a, 1802b, 1802c, 1802d, 1802e, 1802f, 1802g, a plurality of transport robots 1804a, 1804b, 1804c, 1804d, 1804e, 1804f, 1804g, 1804h, that transport the food dishes prepared by the robo chefs and move the food dishes to the autonomous vehicles (or robotaxi) for deliveries of the food dishes to the customers in accordance with the present disclosure. The robo neighborhood cuisines hub 1800 provides different types of cuisines restaurant at a particular neighborhood which (1) a plurality of robo chefs, where each robo chef prepares a particular type of cuisine, such as the robo chef Japanese cuisine station (or Japanese cuisine restaurant) 1802a, the robo chef Chinese cuisine station 1802b, the Italian cuisine station 1802c, the robo chef Korean cuisine station 1802d, the robo chef Mexican cuisine station 1802e, the robo chef Indian cuisine station 1802f, the robo chef breakfast cuisine station 1802g, etc., (2) the plurality of robotic transports 1804a, 1804b, 1804c, 1804d, 1804e, 1804f, 1804g, 1804h that transport the food dishes prepared by the robo chefs and move the food dishes to a plurality of autonomous vehicles 1806a, 1806b, 1806c, 1806d, 1806e, 1806f, 1806g, 1806h, 1806i, 1806j, 1806k for deliveries of the food dishes to the customers in the neighborhood or a defined geography or an identified cities or counties. Each transport (from the plurality of robotic transports 1804a, 1804b, 1804c, 1804d, 1804e, 1804f, 1804g, 1804h) would move one or more dishes from a particular robo chef cuisine station (from the robot module assemblies 1802a, 1802b, 1802c, 1802d, 1802e, 1802f, 1802g) to a particular autonomous vehicle for delivery to a particular customer based on the food order that has been placed with the robo neighborhood cuisines hub 1800.

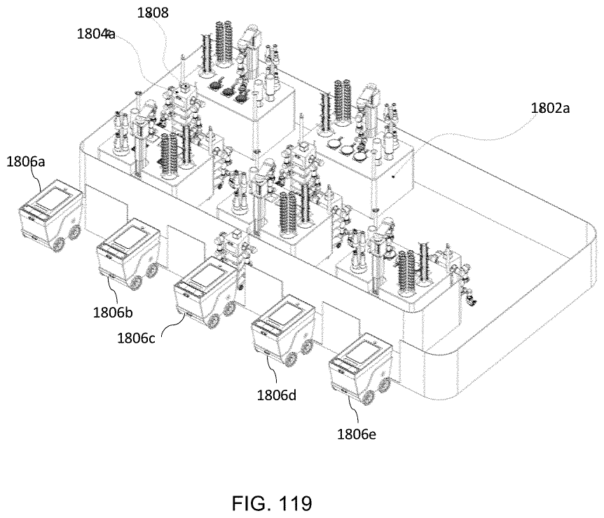

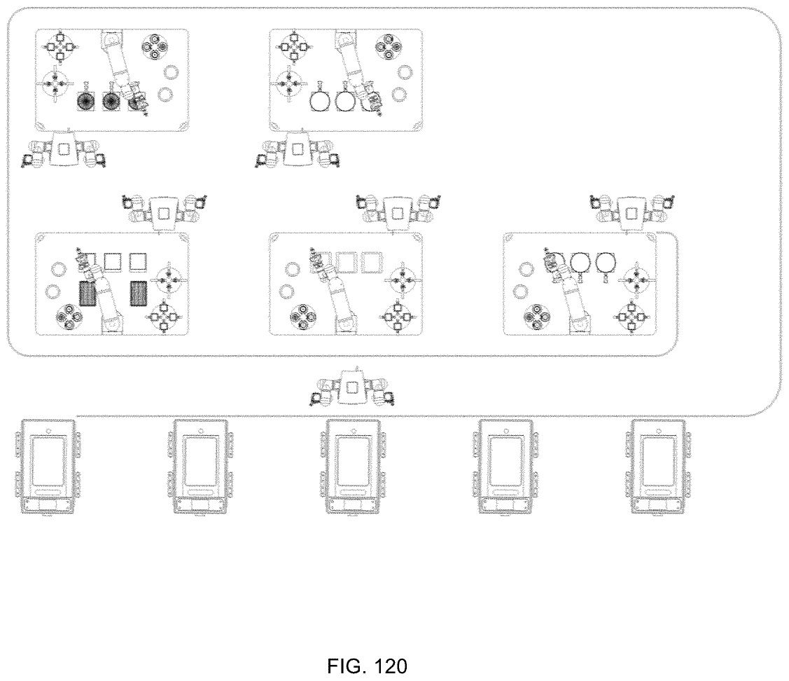

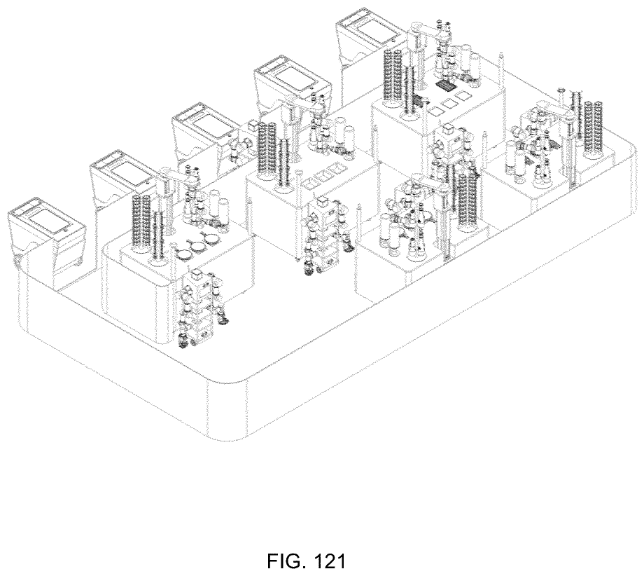

FIG. 119 is a block diagram illustrating an isometric view of the robo neighborhood cuisines hub 1800 with a plurality of robot chefs and a plurality of transport robots with respect to FIG. 118. FIG. 120 is a block diagram illustrating a top view of the robo cuisines hub with a plurality of robot chefs and a plurality of transport robots with respect to FIG. 118. FIG. 121 is a block diagram illustrating a back view of the robo cuisines hub with a plurality of robot chefs and a plurality of transport robots with respect to FIG. 118. The robo chef cooking station 1802a prepared one or more food dishes and place the prepared food in a packaged food container 1808, which the food transport robot 1804a then move the packaged food container 1808 to the autonomous vehicle 1806 to delivery the packaged food container 1808 to a particular customer. The autonomous vehicle 1806 as illustrated here is just one example of a simple autonomous vehicle. The use of autonomous vehicle can be expanded to a automobile or a truck which drives on the road or highway to delivery the prepared food to the customer.

In another embodiment, the robo neighborhood cuisines hub 1800 can be applied a food court at a shopping mall, at an office restaurant, at a hospital, etc.

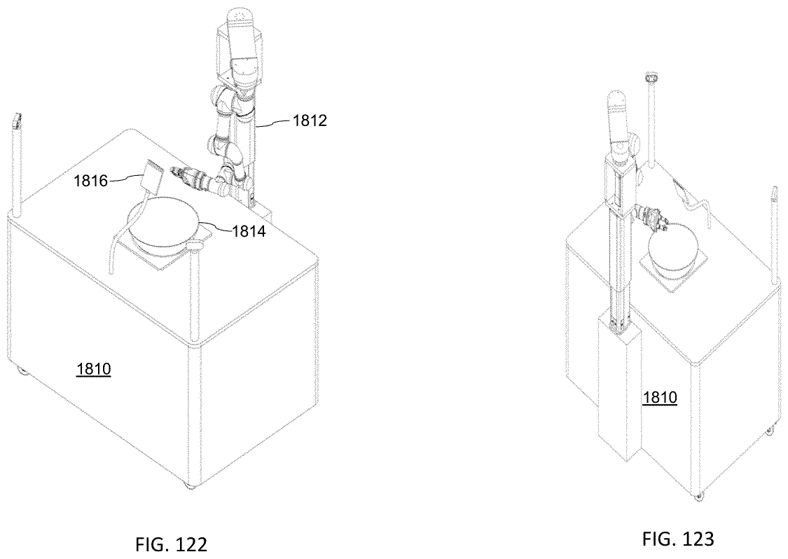

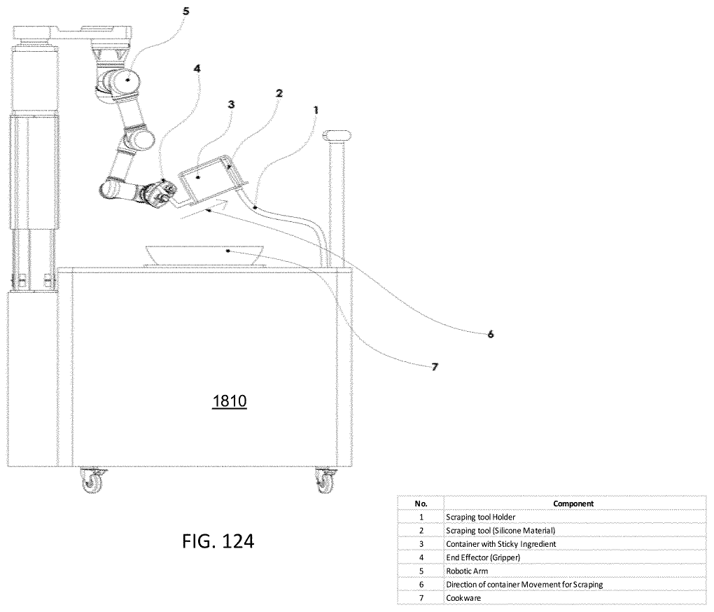

FIG. 122 is a block diagram illustrating an isometric front view of a robotic kitchen module assembly 1810 with a scrapping tool component 2. FIG. 123 is a block diagram illustrating an isometric back view of a robotic kitchen module assembly 1810 with a scrapping tool component 2 with respect to FIG. 122. FIG. 124 is a block diagram illustrating a side view of a robotic kitchen module assembly 1810 with a scrapping tool component 2 with respect to FIG. 122. Reference numbers 1-7 used in FIGS. 122, 123 and 124 are specific to these figures. The robotic kitchen module assembly 1810 includes a robotic arm 5, a robotic end effector 4, a container with sticky ingredient 3, a cookware 7, a scrapping tool holder 1, and a scraping tool 2. The scrapping tool 2 can be made of silicon material, plastic material, stainless metal material, aluminum material, nylon material, some mixed compositions, or other types of suitable materials for scrapping food out of a container. The robotic arm 4 and the robotic effector (or gripper) 3 holds a handle of the container 3 with sticky ingredient that flips the container 3 over and positioned at an angle, which the scrapping tool holder 1 positions the scrapping tool inside the container 3. The robotic arm 4 and the robotic effector (or gripper) 3 then moves the handle on the container 3 in a tilted upward motion as to enable the scrapping tool 2 to scrap out completely or substantially completely of the sticky ingredient out of the container 3. The tilting upward motion can vary in the number of degrees or angles, e.g., 15 degrees, 20 degrees, 30 degrees, 45 degrees, which in part is dependent on the type, form and amount of ingredient, and any pre-testing information about the ingredient, and the exact robotic arm motion process, as well as the amount of pressure in the robot placing the container 3 against the scrapping tool 2.

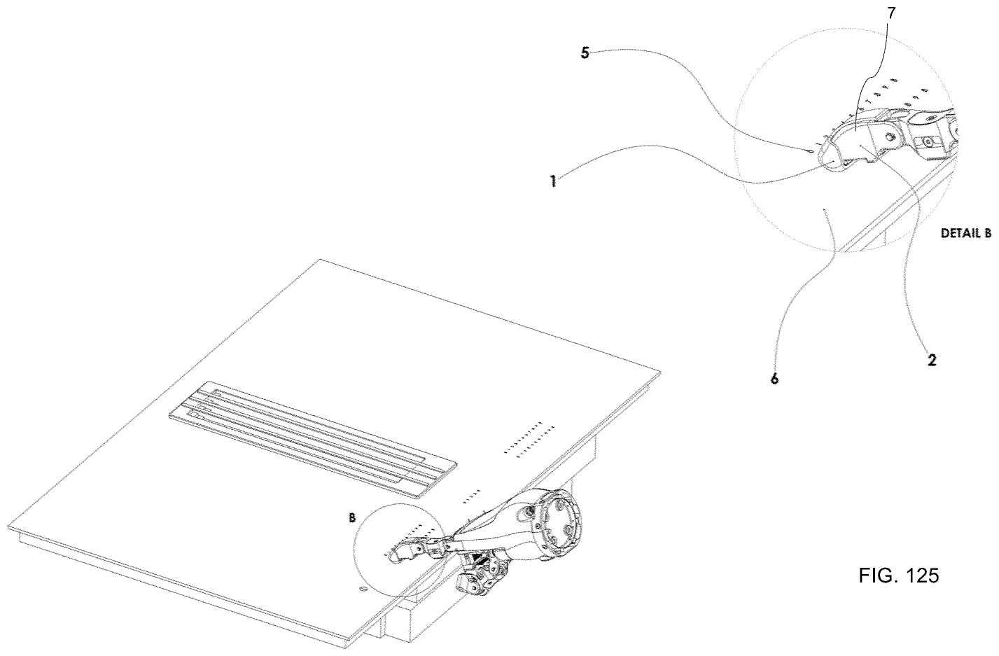

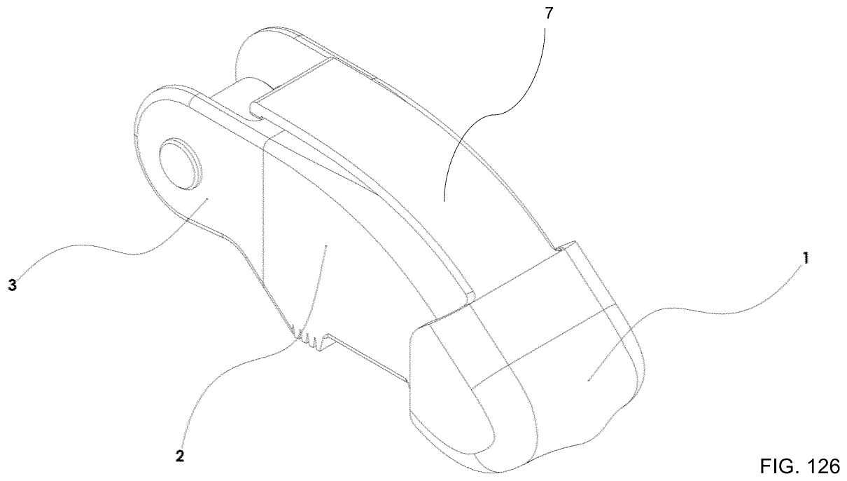

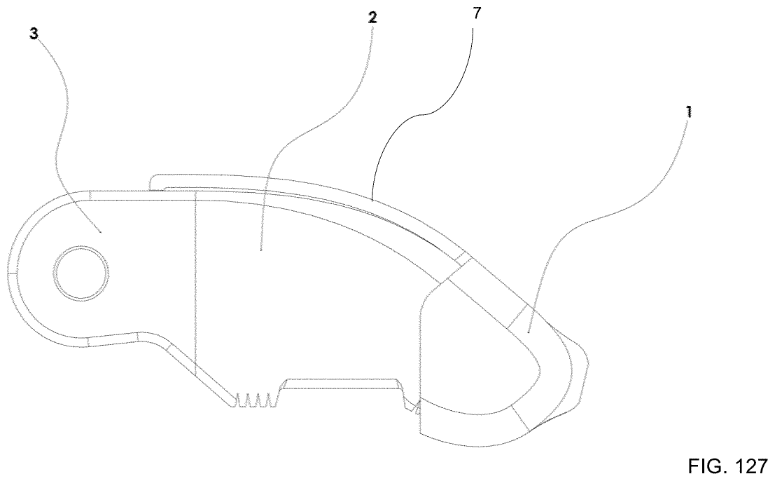

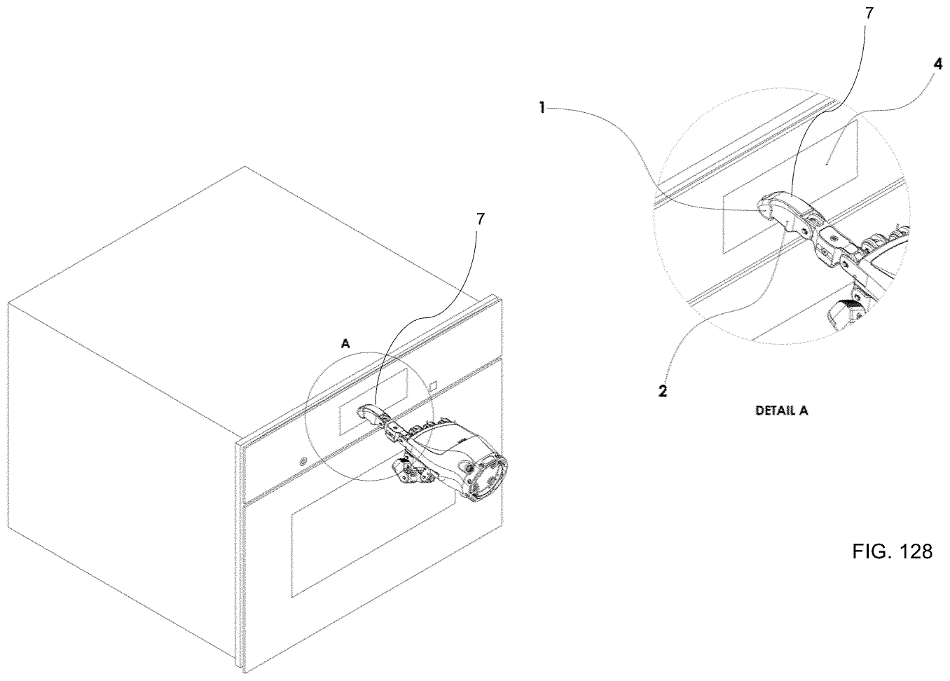

FIGS. 125, 126, 127, 128 are pictorial diagrams illustrating a touch screen operation finger 1709 including a conductive material (metal or aluminum) fingertip 1, finger rubber part 2, finger metal part 3, a screen 4, and one or more capacitive buttons 5. In one embodiment, the finger cap 1, the connecting piece 7 and the finger body 3 are all made of aluminum. Other types of materials can also be used with various components, including rubber, metal, aluminum, conductive materials, semi-conductive materials, etc. In this illustration, the fingertip 1 (in a robotic effector coupled to a robotic arm) is shown in touching the one or more capacitive buttons 5, a touchscreen surface 6, and a connecting piece 7. FIGS. 222 and 224 illustrates one finger on a robotic effector, where the rubber portion is attached between the finger tip (or finger cap) 1 and the finger body 3, and the connecting piece 7 is connected between the finger tip 1 and the finger body 3. In this embodiment, the connection piece 7 is a conductive material that provides a conductive connection between the finger tip 1 and the finger body 3, as to facilitate the finger tip 1 to operate an optical screen (or optical keyboard), or a capacitive screen (or capacitive keyboard), or a resistive touchscreen. The touchscreen surface 6 could be a touchscreen in FIG. 124, or a touchscreen surface on an oven in FIG. 127. In one embodiment, an optical touchscreen (or optical keyboards) comprises two or more image sensors, such as CMOS sensors, are placed around the edges (e.g., the corners) of the screen. A capacitive touch screen is a device display screen that relies on finger pressure for interaction. A resistive touchscreen is a touch-sensitive computer display comprises of two flexible sheets coated with a resistive material and separated by an air gap or microdots.

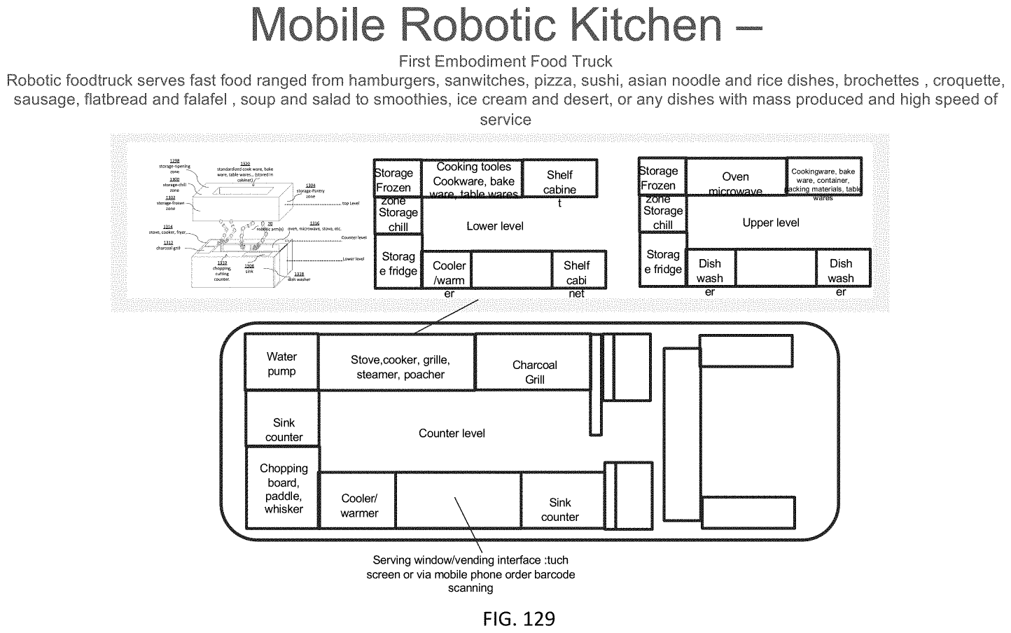

FIG. 129 is a block diagram illustrating a first embodiment of a mobile robotic kitchen on a food truck in accordance with the present disclosure.

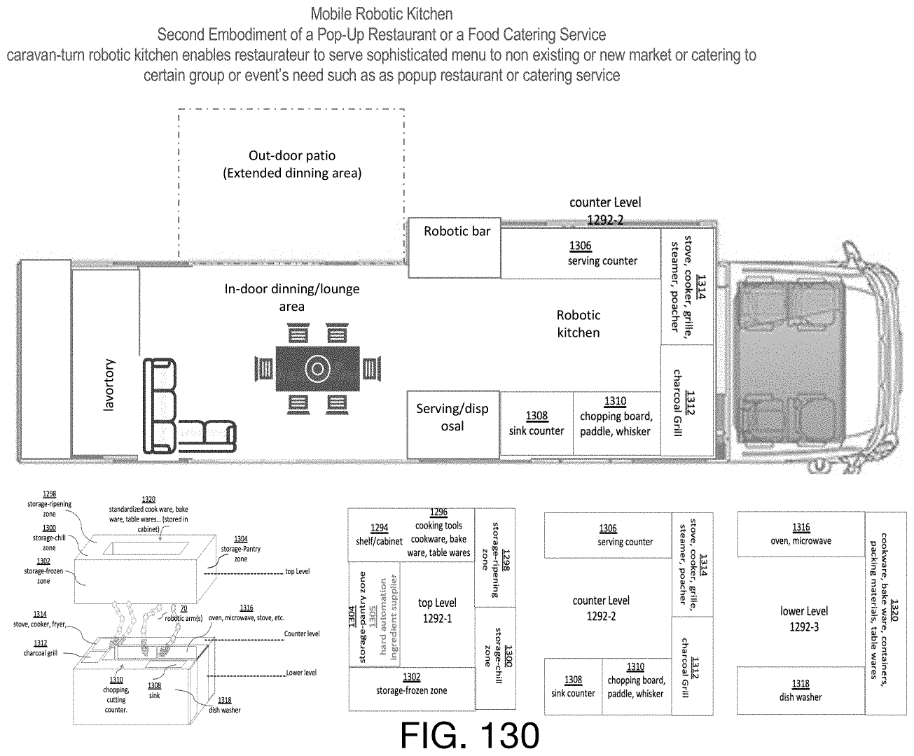

FIG. 130 is a block diagram illustrating a second embodiment of a pop-up restaurant or a food catering service in accordance with the present disclosure.

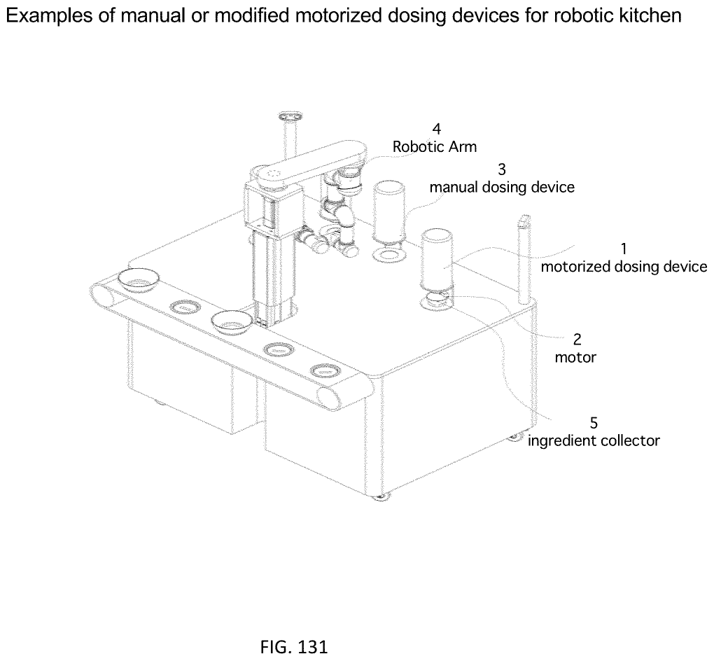

FIG. 131 is a block diagram illustrating one example of a robotic kitchen module assembly with a motorized (or automatic) dosing device and a manual dosing device that can be tailored for the robotic kitchen which the one or more robotic hands coupled to one of more robotic end effectors can operate a dosing device manually, or the computer processor in the robotic kitchen can send an instruction signal to a dosing device to dispense the amount of dosing automatically in accordance with the present disclosure.

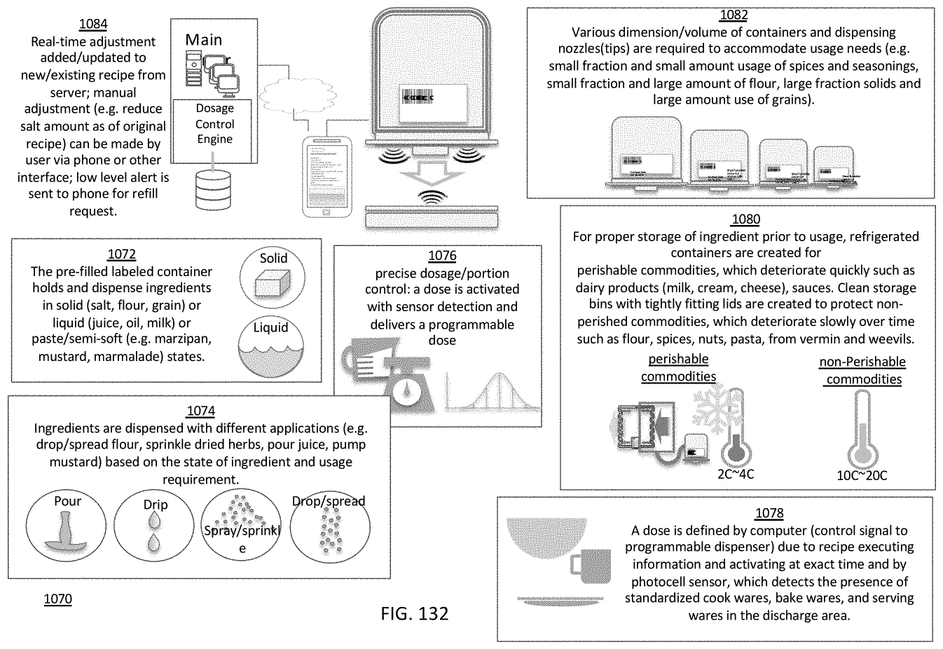

FIG. 132 depicts the functionalities and process-steps of pre-filled ingredient containers 1070 with one or more program ingredient dispenser controls for use in the standardized robotic kitchen 50, whether it be the standardized robotic kitchen or the chef studio. Ingredient containers 1070 are designed in different sizes 1082 and varied usages are suitable for proper storage environments 1080 to accommodate perishable items by way of refrigeration, freezing, chilling, etc. to achieve specific storage temperature ranges. Additionally, the pre-filled ingredient storage containers 1070 are also designed to suit different types of ingredients 1072, with containers already pre-labeled and pre-filled with solid (salt, flour, rice, etc.), viscous/pasty (mustard, mayonnaise, marzipan, jams, etc.) or liquid (water, oil, milk, juice, etc.) ingredients, where dispensing processes 1074 utilize a variety of different application devices (dropper, chute, peristaltic dosing pump, etc.) depending on the ingredient type, with exact computer-controllable dispensing by way of a dosage control engine 1084 running a dosage control process 1076 ensuring that the proper amount of ingredient is dispensed at the right time. It should be noted that the recipe-specified dosage is adjustable to suit personal tastes or diets (low sodium, etc.), by way of a menu-interface or even through a remote phone application. The dosage determination process 1078 is carried out by the dosage control engine 1084, based on the amount specified in the recipe, with dispensing occurring either through manual release command or remote computer control based on the detection of a particular dispensing container at the exit point of the dispenser.

The calibration concepts, the action primitive micro mininmanipulations, the action primitive macro mininmanipulations, and other robotic hardware and software concepts applicable to the robotic kitchen, including commercial robotic kitchens and residential robotic kitchens, are also applicable to telerobotics, chemical environments, hospital environments, nursery environments, and other commercial applications. One of ordinary skill in the art would also recognize the robotic description in this application can be practiced in a variety of applications without departing from the spirits of the present disclosure.

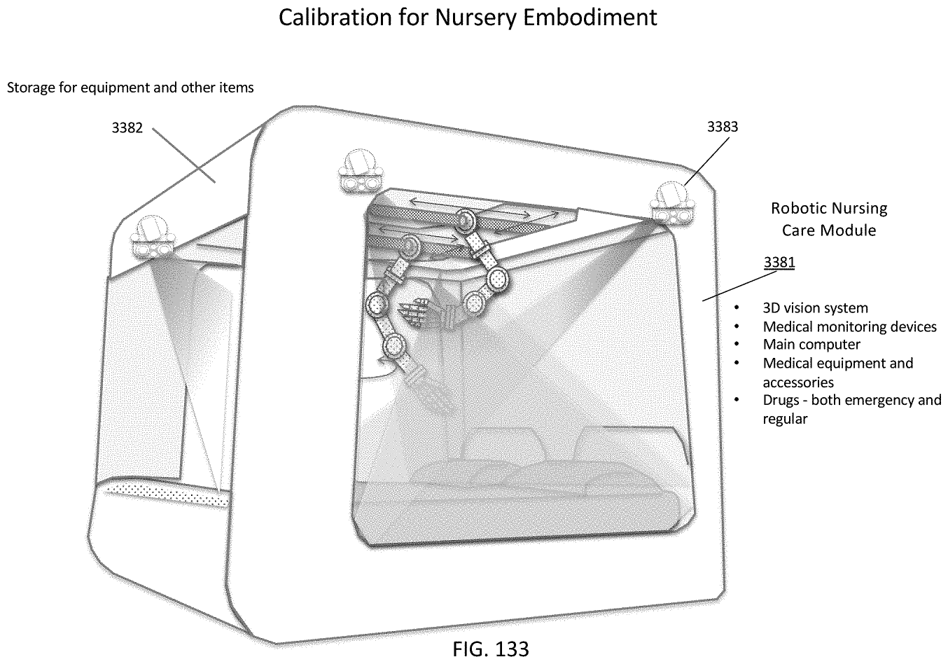

FIG. 133 is a block diagram illustrating a robotic nursing care module 3381 with a three-dimensional vision system in accordance with the present disclosure. Robotic nursing care module 3381 may be any dimension and size and may be designed for a single patient, multiple patients, patients needing critical care, or patients needing simple assistance. Nursing care module 3381 may be integrated into a nursing facility or may be installed in an assisted living, or home environment. Nursing care module 3381 may comprise a three-dimensional (3D) vision system, medical monitoring devices, computers, medical accessories, drug dispensaries or any other medical or monitoring equipment. Nursing care module 3381 may comprise other equipment and storage 3382 for any other medical equipment, monitoring equipment robotic control equipment. Nursing care module 3381 may house one or more sets of robotic arms, and hands or may include robotic humanoids. The Robotic arms may be mounted on a rail system in the top of the nursing care module 3381 or may be mounted from the walls, or floor. Nursing care module 3381 may comprise a 3D vision system 3383 or any other sensor system which may track and monitor patient and/or robotic movement within the module.

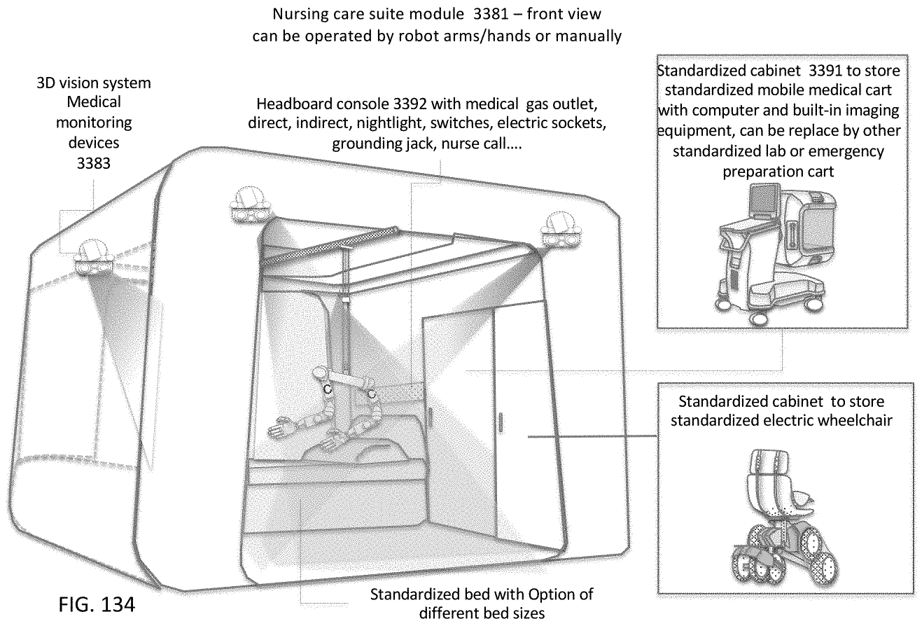

FIG. 134 is a block diagram illustrating a robotic nursing care module 3381 with standardized cabinets 3391 in accordance with the present disclosure. As shown in FIG. 130, nursing care module 3381 comprises 3D vision system 3383, and may further comprise cabinets 3391 for storing mobile medical carts with computers, and/or in imaging equipment, that can be replace by other standardized lab or emergency preparation carts. Cabinets 3391 may be used for housing and storing other medical equipment, which has been standardized for robotic use, such as wheelchairs, walkers, crutches, etc. Nursing care module 3381 may house a standardized bed of various sizes with equipment consoles such as headboard console 3392. Headboard console 3392 may comprise any accessory found in a standard hospital room including but not limited to medical gas outlets, direct, indirect, nightlight, switches, electric sockets, grounding jacks, nurse call buttons, suction equipment, etc.

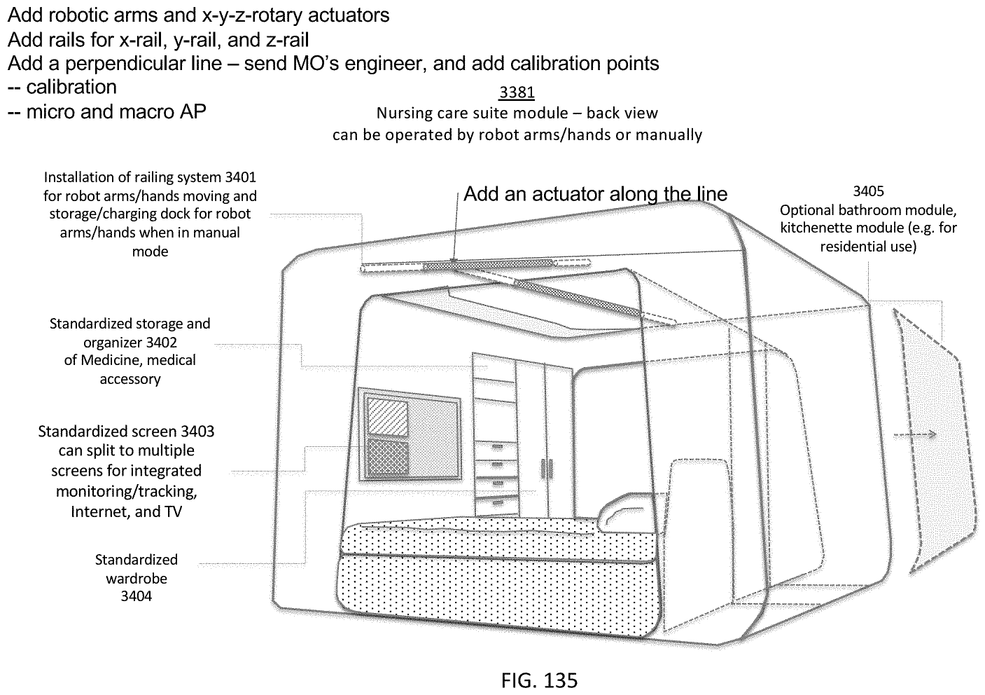

FIG. 135 is a block diagram illustrating a back view of a robotic nursing care module 3381 with one more standardized storages 3402, a standardized screen 3403, a standardized wardrobe 3404 in accordance with the present disclosure. In addition, FIG. 130 depicts railing system 3401 for robot arms/hands moving and storage/charging dock for robot arms/hands when in manual mode. Railing system 3401 may allow for horizontal movement in any direction and left/right. Front and back. It may be any type of rail or track and may accommodate one or more robot arms and hands. Railing system 3401 may incorporate power and control signals and may include wiring and other control cables necessary to control and or manipulate the installed robotic arms. Standardized storages 3402 may be any size and may be located in any standardized position within module 3381. Standardized storage 3402 may be used for medicines, medical equipment, and accessories or may be use for other patient items and/or equipment. Standardized screen 3403 may be a single or multiple multi purpose screens. It may be utilized for internet usage, equipment monitoring, entertainment, video conferencing, etc. There may be one or more screens 3403 installed within a nursing module 3381. Standardized wardrobe 3404 may be used to house a patient's personal belongings or may be used to store medical or other emergency equipment. Optional module 3405 may be coupled to or otherwise co-located with standardized nursing module 3381 and may include a robotic or manual bathroom module, kitchen module, bathing module or any other configured module that may be required to treat or house a patient within the standard nursing suite 3381. Railing systems 3401 may connect between modules or may be separate and may allow one or more robotic arms to traverse and/or travel between modules.

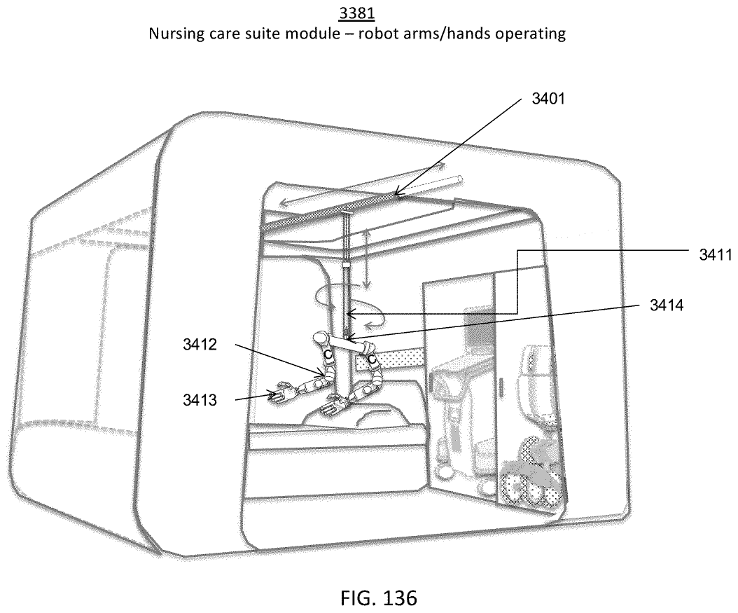

FIG. 136 is a block diagram illustrating a robotic nursing care module 3381 with a telescopic lift or body 3411 with a pair of robotic arms 3412 and a pair of robotic hands 3413 in accordance with the present disclosure. Robot arms 3412 are attached to the shoulder 3414 with a telescopic lift 3411 that moves vertically (up and down) and horizontally (left and right), as a way to move robotic arms 3412 and hands 3413. The telescopic lift 3411 can be moved as a shorter tube or a longer tube or any other rail system for extending the length of the robotic arms and hands. The arm 1402 and shoulder 3414 can move along the rail system 3401 between any positions within the nursing suite 3381. The robotic arms 3412, hands 3413 may move along the rail 3401 and lift system 3411 to access any point within the nursing suite 3381. In this manner, the robotic arms and hands can access, the bed, the cabinets, the medical carts for treatment or the wheel chairs. The robotic arms 3412 and hands 3413 in conjunction with the lift 3411 and rail 3401 may aide to lift a patient to sit a sitting or standing position or may assist placing the patient in a wheel chair or other medical apparatus.

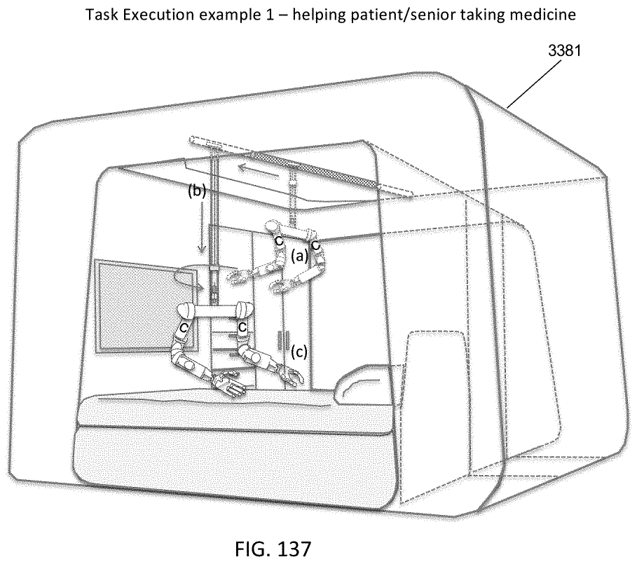

FIG. 137 is a block diagram illustrating a first example of executing a robotic nursing care module with various movements to aid an elderly patient in accordance with the present disclosure. Step (a) may occur at a predetermined time or may be initiated by a patient. Robot arms 3412 and robotic hands 3413 take the medicine or other test equipment from the designated standardized location (e.g. storage location 3402). During step (b) robot arms 3412, hands 3413, and shoulders 3414 moves to the bed via rail system 3401 and to the lower level and may turn to face the patient in the bed. At step (c) robot arms 3412 and hands 3413 perform the programed/required minimanipulation of giving medicine to a patient. Because the patient may be moving and is not standardized, 3D real time adjustment based on patient, standard/non standard objects position, orientation may be utilized to ensure successful a result. In this manner, the real time 3D visual system allows for adjustments to the otherwise standardized minimanipulations.

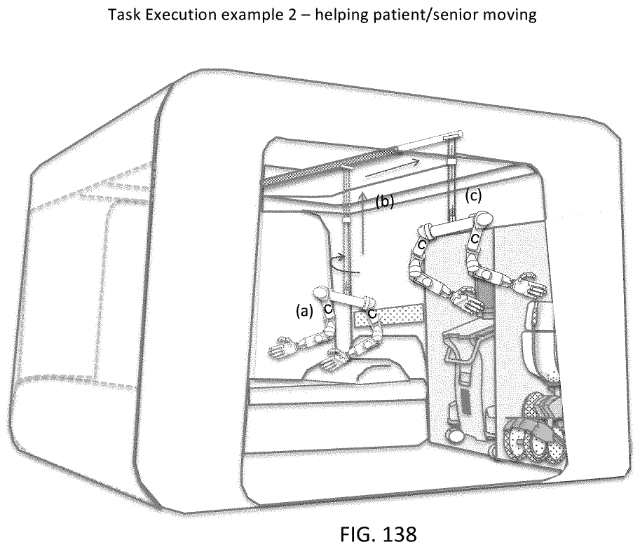

FIG. 138 is a block diagram illustrating a second example of executing a robotic nursing care module with the loading and unloading a wheel chair in accordance with the present disclosure. In position, (a) robot arms 3412 and hands 3413 perform minimanipulations of moving and lifting the senior/patient from a standard object, such as the wheel chair, and placing them on another standard object, such as laying them on the bed, with 3D real time adjustment based on patient, standard/non standard objects position, orientation to ensure successful result. During step (b) the robot arms/hands/shoulder may turn and move the wheelchair back to the storage cabinet after the patient has been removed. Additionally and/or alternatively, if there is more then one set of arms/hands, step (b) may be performed by one set, while step (a) is being completed. Cabinet. During step (c) the robot arms/hands open the cabinet door (standard object), push the wheelchair back in and close the door.

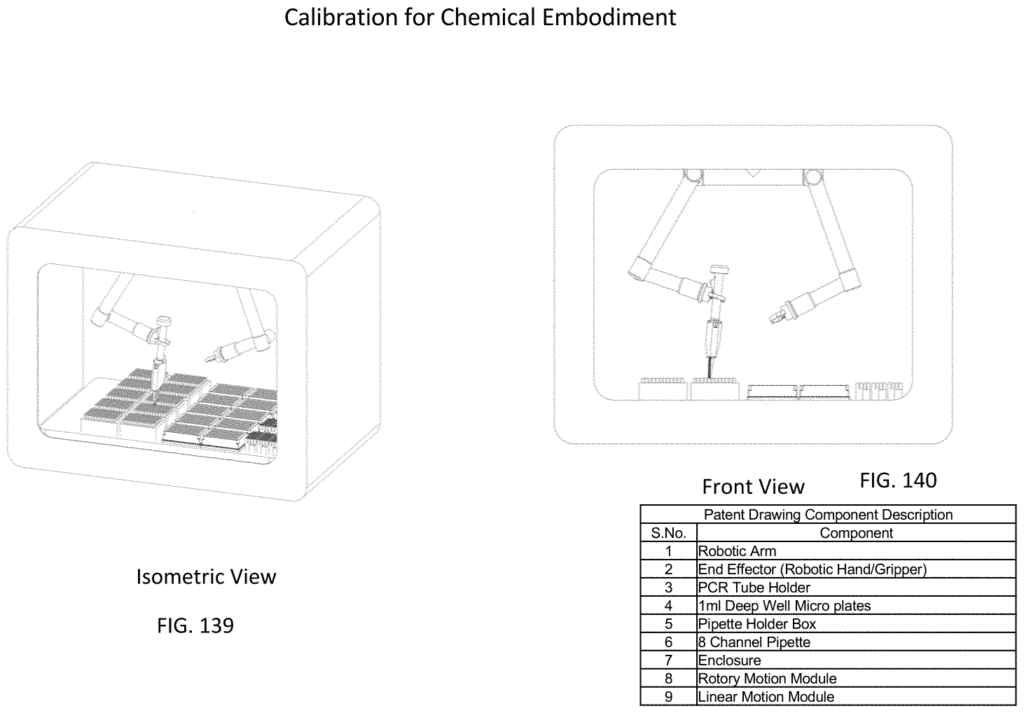

FIG. 139 is a block diagram illustrating one embodiment of an isometric view in calibrating and operating a chemical embodiment with the robot with one or more robot arms coupled to one or more robotic end effectors in accordance with the present disclosure. The robot with one or more robotic arms and the one or more robotic end effectors operate to calibrate in the chemical environment and executes one or more minimanipulations for operating to carry chemical components in the chemical environment.

FIG. 140 is a block diagram illustrating one embodiment of a front view in calibrating and operating a chemical embodiment with the robot with one or more robot arms coupled to one or more robotic end effectors.

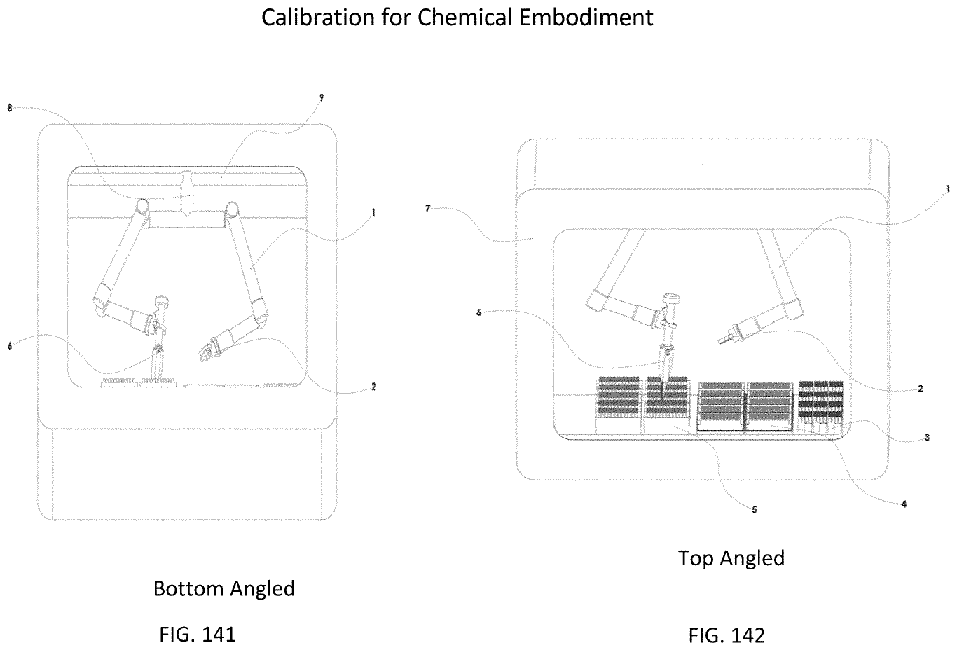

FIG. 141 is a block diagram illustrating one embodiment of a bottom angled view in calibrating and operating a chemical embodiment with the robot with one or more robot arms coupled to one or more robotic end effectors.

FIG. 142 is a block diagram illustrating one embodiment of a top angled view in calibrating and operating a chemical embodiment with the robot with one or more robot arms coupled to one or more robotic end effectors.

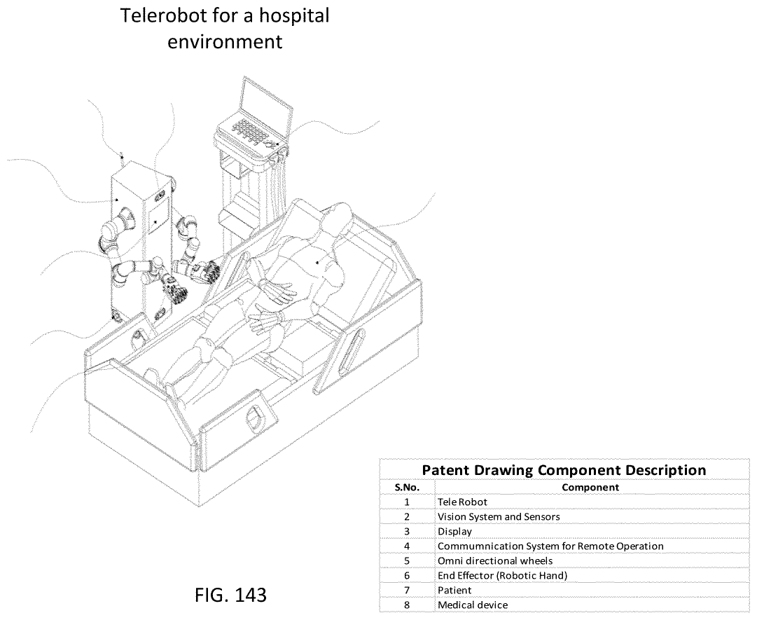

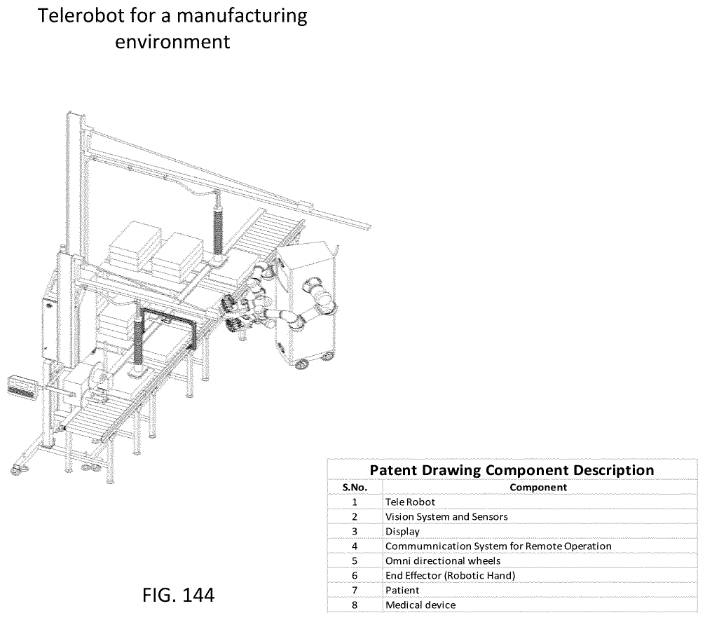

FIG. 143 is a block diagram illustrating a telerobotic for a hospital environment with operating one or more robot arms coupled to one or more robotic end effectors for distance (or remote) automation. Telerobotics provides a remote or distance length automation for food preparation, healthcare, manufacturing, surveillance, etc., where an operator sends an action primitive (AP), whether a micro minimanipulation or a maco minimanipulation telerobotics to carry out the specific action primitive at a remote site, such as picking a book. The operator operates, controls, or navigates the robot through a sequence of parameterized commands. FIG. 144 is a block diagram illustrating a telerobotic for a manufacturing environment with operating one or more robot arms coupled to one or more robotic end effectors for distance (or remote) automation.

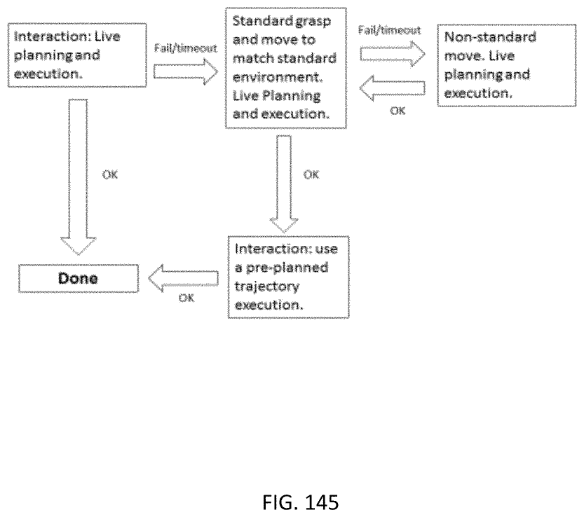

FIG. 145 depicts one embodiment of the process in the object interactions in an unstructured environment. In order to move objects that are not in the direct standard environment, they need to be grasped using a standard grasp (a fingers joint space trajectory that has been tested before) and moved (using live Motion planning). If they cannot be grasped (because for example the handle is blocked), a non-standard move (which can include pushing the objects in some way) is planned live and executed, then another standard grasp and move attempt is made. This procedure will be repeated until an object is in the expected relation to the robot, then for all other objects.

An example for this in the kitchen context is grasping and moving ingredients and tools from the storage area (cluttered, unpredictable, changes often) to the worktop surface into a defined Poses, then moving the robot to the defined configuration, then executing a trajectory that grasps and mixes the ingredients using the tools.

With this method, optimal Cartesian and Motion Plans for standard environments are generated off-line in a dedicated and calculation resource intense way and then transferred to be used by the robot. The data modeling is implemented either by retaining the regular FAP structure and using plan caching, or by replacing some Cartesian trajectories in the FAPs by pre-planned joint space trajectories, including joint space trajectories to connect the trajectories for individual APSBs inside the APs to even replace some parts of live motion planning during the manipulations in the standard environment. In the latter case, there are two sets of FAPs: One set that has “source” Cartesian trajectories suitable for planning, and one with optimized joint space trajectories.

Tolerances for the differences between real direct environment and direct environment of the saved optimised trajectory, which can be determined using experimental methods, are saved per trajectory or per FAPSB.

Using pre-planned manipulations can be extended to include positioning the robot, especially along linear or axes, to be able to execute pre-planned manipulations on a variety of positions. Another application is placing a humanoid robot in a defined relation to other objects (for example a window in a residential house) and then starting a pre-planned manipulation trajectory (for example cleaning the window).

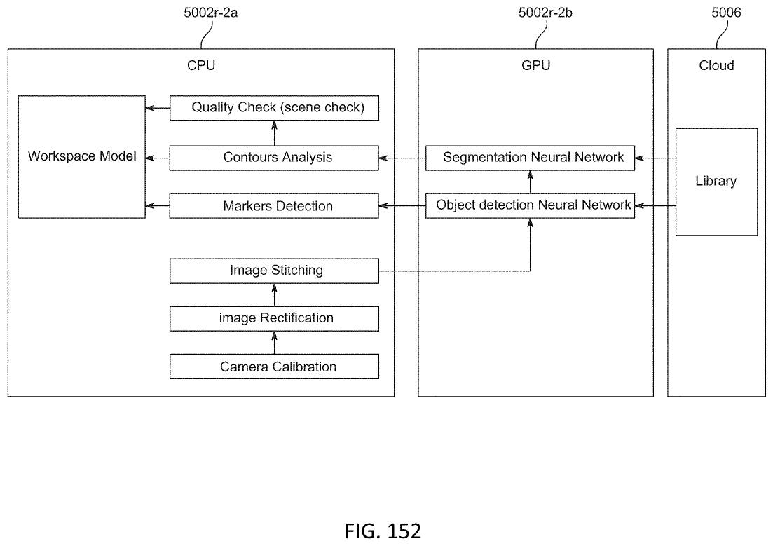

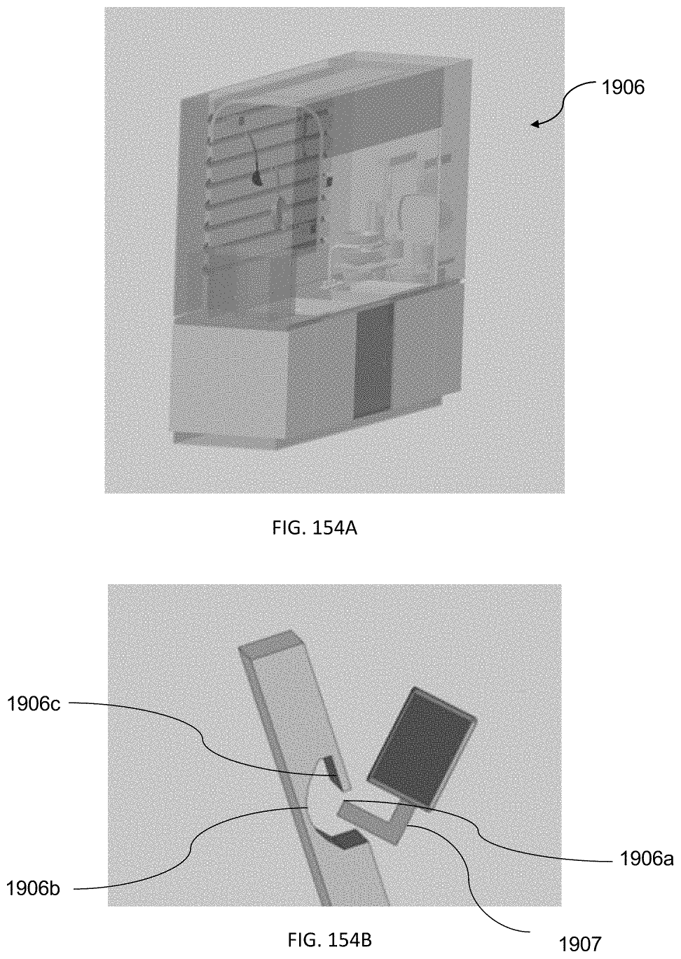

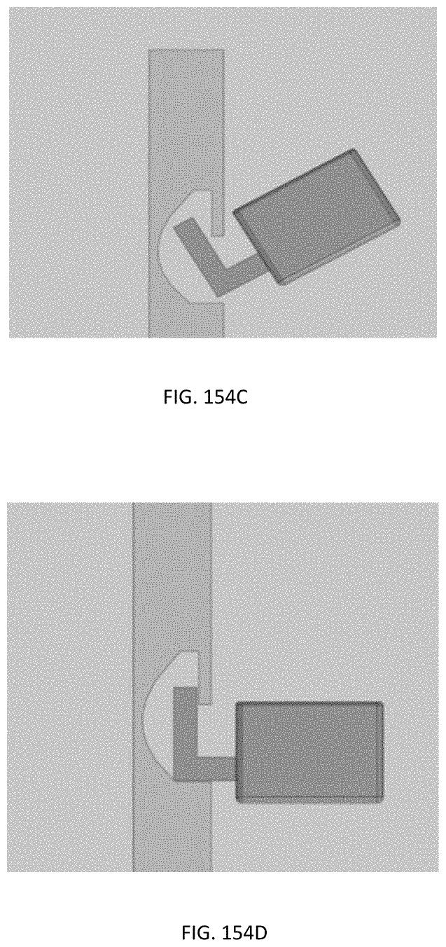

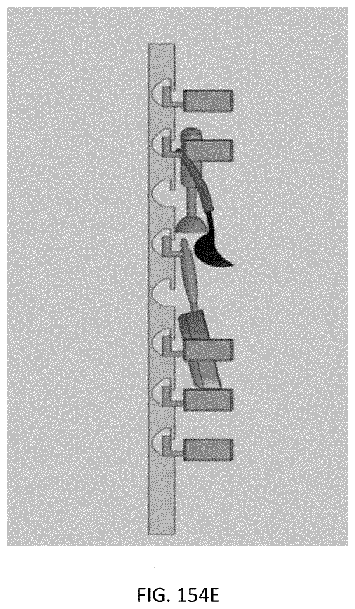

The time management scheme that utilizes proposed applications is described herein. The time-course of planning and execution shown in FIG. 152 represent one preferable scenario when all planning times are less than execution time of the previous APSB. However, this might not be the case when the complexity of the inverse kinetics (IK) problem increases as happens in complex or changing environment. This happens because the number of constraints increases when checking if Cartesian trajectory is executable for more complex environment. As a result the waiting time between the consecutive APSBs becomes non-zero as shown in FIG. 154. In one embodiment, the time management scheme minimizes the sum of these waiting times.

Furthermore, we propose that time management scheme must not only reduce the average sum of waiting times between the executions of movements but also reduce the variability of total waiting time. Specifically, this is very important for cooking processes where the recipes set up the required timing for the operations. Thus, we introduce the cost function which is given by the probability of cooking failure, namely P (τ>τ_{failure}), where τ is the total time of operation execution. Given the probability distribution p(τ) is determined by its average <τ> and the variance σ_{τ}² and neglecting higher order moments

$$P ( τ > {τ}_{failure} ) = {\int }_{{τ}_{failure}}^{∞} p ( τ ) d τ = f ( \frac{\text{<} τ \text{>} - {τ}_{failure}}{{σ}_{τ}} ) ,$$

some monotonic increasing function, (which is for example just the error function ƒ(x)=erf(x) if the higher order moments indeed vanish and p(τ) has normal distribution). Therefore for the time management scheme it is beneficial to reduce both the average time and its variance, when the average is below the failure time. Since the total time is the sum of consequential and independently obtained waiting and execution times, the total average and variance are the sums of individual averages and variances. Minimizing the time average and variance at each individual scheme improves the performance by reducing the probability of cooking failure.

To reduce the uncertainty and thus the variance of the planning times (and therefore the variance in the waiting times) we propose to use the data sets of pre-planned and stored sequences that perform typical FAPs. These sequences are optimized beforehand with heavy computational power for the best time performance and any other relevant criteria. Essentially, their uncertainty is reduced to zero and thus they have zero contribution to the total time variance. So if the time management scheme finds a solution that allows the system to come to a pre-defined state from where the sequence of actions to reach the target state is known and does so before the cooking failure time, the probability of cooking failure is reduced to zero since it has zero estimated time variance. In general, if the pre-defined sequence is just a part of a total AP it still does not contribute to the total time variance and has the beneficial effect on uncertainty of the total execution time.

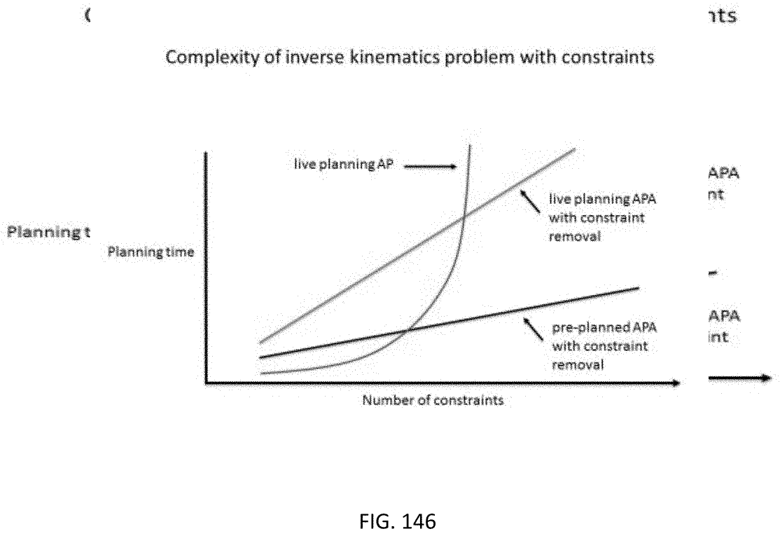

To reduce the complexity and thus the average of the planning times (and therefore the average of the waiting times) we propose to use the data sets of pre-planned and stored configurations for which the number of constraints is minimal. As shown in FIG. 146 that illustrated complexity of inverse kinematics with constraints, if the complexity of inverse kinematics algorithm and thus the average time to find an executable solution increases faster than linear with the number of constraints (which is the case for all algorithms up to date) than we propose to use FAP alternatives (FAPA) obtained using pre-planned Cartesian trajectories or joint trajectories and object interactions that result in constraint removal. If Cartesian trajectory of the found sequence of solutions of IK problem cannot be executed due to a number of constraints the scheme implements simultaneous attempt to find FAPSB which will result in the removal of these constraints one-by one or several at a time. Performing a sequence of FAPSBs for consecutive removal of constraints will lead to linear dependency of the total waiting time on the number of constraints as shown in Illustration 8, therefore providing the lower upper boundary for the estimated waiting time while performing AP. To reduce the slope of that linear curve we propose to use a set of pre-planned FAPSBs to retract the robot arm to one the pre-set states and another set of pre-planned FAPSBs to remove the objects from the direct environment which may block the path and thus provide the constraints for Cartesian trajectory solutions of IK problem.

The logic of this scheme as follows, once the timeout to find a solution is reached (typically set by the execution time of previous FAPSB) and executable trajectory is not found we perform a transitional FAPSB from the incomplete FAPA which does not lead to the target state but rather leads to the new IK problem with reduced complexity. In effect we trade the unknown waiting time with long tail distribution and high average into a fixed time spent on the additional FAPSB and unknown waiting time for the new IK problem with lower average.

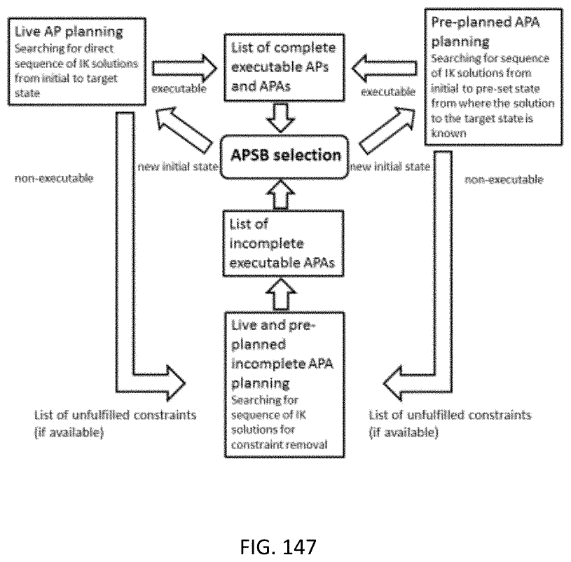

The time course of the decisions made in this scheme is shown in FIG. 147, which shows information flow and generation of incomplete FAPAs. Before the timeout is reached we accumulate a set of complete FAPA and incomplete FAPA, when the timeout is reached we choose the FAPSB from the appropriate APA for execution according to the selection criteria described in the previous sections. If no complete APA is found we choose FAPSB from the set of incomplete FAPAs to avoid large waiting times. The choice of FAPSB from the incomplete FAPA is driven by the list of unfulfilled constraints for the non-executable solutions of IK problem. Namely we preferentially remove the constraints that are most often unsatisfied and prevent solutions of IK problem from execution. The example for this scenario would be the situation when a certain container blocks the path for the robotic arm to perform an action behind it, thus if no solution is found before the timeout we do not wait for the solution to emerge and instead we grab and remove that container from direct environment to a pre-set location outside of it, even if we did not obtain the complete FAPA to finish the FAP. In the case when the list of unsatisfied constraints is unavailable we reduce the number of constraints in a pre-planned manner where we remove the maximum number of constraints at a time. The example for such a pre-FAPA can be relocation of the object to a dedicated area with no other external objects or the retraction of the robotic arm to a standard initial position.

Between the internal and external constraints, the internal constraints are due to the limitations of the robotic arm movements and their role is increased when the joints are in complex positions. Thus the typical constraint removal APSB is the retraction of the robotic arm to one the pre-set joint configurations. The external constraints are due to the objects located in the direct environment. The typical constraint removal APSB is the relocation of the object to one of the pre-set locations. The separation of internal and external constraints is used for the selection of APA from the executable complete and incomplete sets.

To combine the complexity reduction with the uncertainty reduction to decrease both the average and the variance of the total execution time, the following structure of the pre-planned and stored data sets is proposed. The sequences of the IK solutions are stored for the list of manipulations with each type of objects that are executable in the dedicated area. In this area we have no external objects and the robotic arm is in one of the pre-defined standard positions. This ensures the minimal number of constraints. So if the direct solution for FAP is not readily obtained we find and use the solution for FAPA which leads to relocation of the object under consideration to a dedicated area, where the manipulation is performed. This result in a massive constraint removal and allows for the usage of pre-computed sequences that minimizes the uncertainty of the execution times. After the manipulation is performed in the dedicated area the object is returned to the working area to complete the FAP.

In some embodiments, time management system that minimizes the probability of failure to meet the temporal deadline requirements by minimizing the average and the variance of waiting times, comprising of pre-defined list of states and corresponding list of operations, pre-computed and stored set of optimized sequences of IK solutions to perform the operations in the pre-defined state, parallel search and generation of AP and APAs (Cartesian trajectories or sequences of IK solutions) towards the target state and the set of the pre-defined states, APSB selection among the executable APAs or AP, based on the performance metrics for the corresponding APA.

In some embodiments, the average and the variance of waiting times may be minimized with the use of pre-defined and pre-calculated states and solutions, which essentially produce zero contribution to the total average and variance when performed in a sequence of actions, from initial state to pre-defined state where the stored sequence is executed and then back to target state.

In some embodiments, the choice of the pre-defined states with minimal number of constraints, the empirically obtained list may include, but not limited to,
a. Pre-defined state: the object is held by the robot in the dedicated area in a standardized position. These states are used when it is not possible to execute the action at the location of the object due to collisions and lack of space and thus relocation to a dedicated space is performed first;
b. Pre-defined state: the robotic arms (and their joints) are at the standard initial configuration. These states are used when the current joint configurations have complex structure and prevents execution due to internal collisions of the robotic arms, so the retraction of the robotic arms is done before new attempt to perform an action; and
c. Pre-defined state: the external object is held by the robot in the dedicated area. These states are used when the external object blocks the path and causes a collision on a found non-executable trajectory, the grasping and the relocation of the object to the storage area is performed before returning to the main sequence.

[1] In some embodiments, the APSB selection scheme performs the following sequence of choices:
d. If at a timeout one or several executable AP or APAs are found make a selection according to the performance metric based on, but not limited to total time of execution, energy consumption, aesthetics and the like; and
e. If at a timeout non-executable solution is found, make the selection among the incomplete APAs which lead from current state to one of the pre-defined states even when the complete sequence to the target state is not known.; and
f. The APSB selection among the sets of incomplete APA is done according to the performance metric plus the number of the constraints removed by the incomplete APA. The preference is given to the incomplete APA which removes the maximum number of constraints.

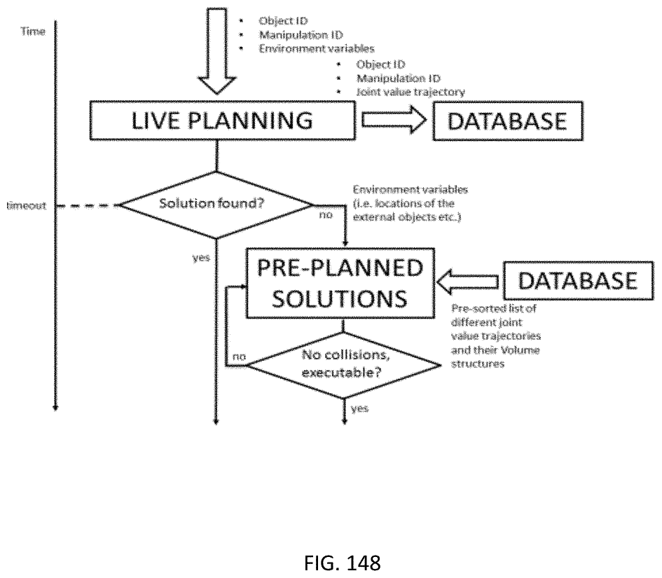

FIG. 148 is a block diagram illustrating write-in and read-out scheme for a database of pre-planned solutions. The database of pre-planned solutions is created for the library of objects and corresponding manipulations with these objects. Numerous solutions of joint value trajectories are stored for each object and manipulation combination. These solutions differ in initial configuration of the robotic arms and the object. These datasets can be pre-calculated by systematically varying and sampling Cartesian coordinates of the initial location and configuration of the robotic arm and the object. Such database can be updated and expanded by writing in the joint value trajectories for the successful live planning operation. If the life planning procedure failed to produce a solution before the timeout, the scheme attempts to find a pre-stored solution that satisfies no collision conditions with current direct environment by comparing the volume of the pre-stored joint value trajectory with excluded volume due to the external objects in the direct environment. The database is structured in such a way that the data list of pre-stored solutions is sorted according to the performance metric, so that the most desirable solutions were attempted first.

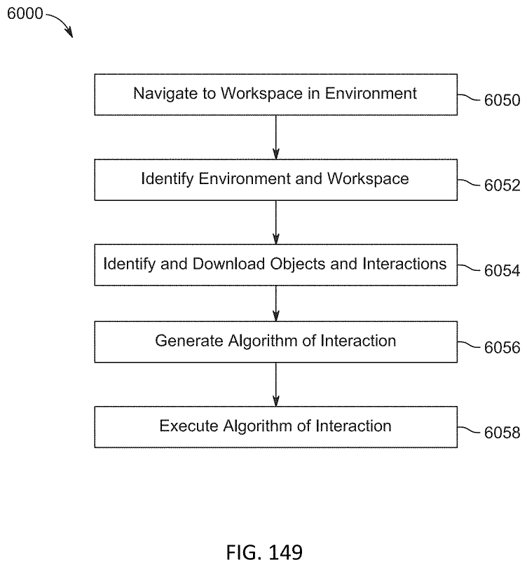

FIG. 149 is a flow chart 6000 illustrating a process for executing an interaction using the robotic assistant 5002r, according to an exemplary embodiment. In some embodiments, Typical application of a Robotic assistant system may include, for example, three steps: Get to workspace (kitchen, bathroom, warehouse, etc.), scan the workspace (detect objects and their attributes) and change the workspace (manipulate objects) according to the recipe.

As shown, at step 6052, the robotic assistant 5002r navigates to a desired or target environment or workspace in which a recipe is to be performed. In the example embodiment described with reference to FIG. 165, the robotic assistant 5002r navigates to a robotic kitchen type workspace 5002w within a robotic home type environment 5002. For example, the robotic home environment 5002 can include multiple rooms, such as a bathroom, living room and bedrooms, and thus, at step 6050, the robotic assistant 5002r can navigate from one of those rooms to the kitchen in order to perform a recipe. In the example embodiment described with reference to FIG. 149, the robotic assistant 5002r is used to execute a recipe to cook a desired dish (e.g., chicken pot pie).

Navigating to the target environment 5002 and workspace 5002w can be triggered by a command received by the robotic assistant locally (e.g., via a touchscreen or audio command), received remotely (e.g., from a client system, third party system, etc.), or received from an internal processor of the robotic assistant that identifies the need to perform a recipe (e.g., according a predetermined schedule). In response to such a trigger, the robotic assistant 5002r moves and/or positions itself at an optimal area within the environment 5002. Such an optimal area can be a predetermined or preconfigured position (e.g., position 0, described in further detail below) that is a default starting point for the robotic assistant. Using a default position enables the robotic assistant 5002r to have a starting point of reference, which can provide more accurate execution of commands.

As described above, the robotic assistant 5002r can be a standalone and independently movable structure (e.g., a body on wheels) or a structure that is movably attached to the environment or workspace (e.g., robotic parts attached to a multi-rail and actuator system). In either structural scenario, the robotic assistant 5002r can navigate to the desired or target environment. In some embodiments, the robotic assistant 5002 includes a navigation module that can be used to navigate to the desired position in the environment 5002 and/or workspace 5002w.

In some embodiments, the navigation module is made up of one or more software and hardware components of the robotic assistant 5002r. For example, the navigation module that can be used to navigate to a position in the environment 5002 or workspace 5002w employs robotic mapping and navigation algorithms, including simultaneous localization and mapping (SLAM) and scene recognition (or classification, categorization) algorithms, among others known to those of skill in the art, that are designed to, among other things, perform or assist with robotic mapping and navigation. At step 6050, for instance, the robotic assistant 5002r navigates to the workspace 5002w in the environment 5002 by executing a SLAM algorithm or the like to generate or approximate a map of the environment 5002, and localize itself (e.g., its position) or plan its position within that map. Moreover, using the SLAM algorithm, the navigation module enables the robotic assistant 5002r to identify its position with respect or relative to distinctive visual features within the environment 5002 or workspace 5002w, and plan its movement relative to those visual features within the map. Still with reference to step 6050, the robotic assistant 5002r can also employ scene recognition algorithms in addition to or in combination with the navigation and localization algorithms, to identify and/or understand the scenes or views within the environment 5002, and/or to confirm that the robotic assistant 502r achieved or reached its desired position, by analyzing the detected images of the environment.

In some embodiments, the mapping, localization and scene recognition performed by the navigation module of the robotic assistant can be trained, executed and re-trained using neural networks (e.g., convolutional neural networks). Training of such neural networks can be performed using exemplary or model workspaces or environments corresponding to the workspace 5002w and the environment 5000.

It should be understood that the navigation module of the robotic assistant 5002r can include and/or employ one or more of the sensors 5002r-4 of the robotic assistant 5002r, or sensors of the environment 5002 and/or the workspace 5002w, to allow the robotic assistant 5002r to navigate to the desired or target position. That is, for example, the navigation module can use a position sensor and/or a camera, for example, to identify the position of the robotic assistant 5002r, and can also use a laser and/or camera to capture images of the “scenes” of the environment to perform scene recognition. Using this captured or sensed data, the navigation module of the robotic assistant 5002r can thus execute the requisite algorithms (e.g., SLAM, scene recognition) used to navigate the robotic assistant 5002r to the target location in the workspace 5002w within the environment 5002.

At step 6052, the robotic assistant 5002r identifies the specific instance and/or type of the workspace 5002w and/or environment 5002, in which the robotic assistant navigates to at step 6050 to execute a recipe. It should be understood that the identification of step 6052 can occur prior to, simultaneously with, or after the navigation of step 6050. For instance, the robotic assistant 5002r can identify the instance or type of the workspace 5002w and/or environment 5002 using information received or retrieved in order to trigger the navigation of step 6050. Such information, as discussed above, can include a request received from a client, third party system, or the like. Such information can therefore identify the workspace and environment with which a request to execute the recipe is associated. For example, the request can identify that the workspace 5002w is a RoboKitchen model 1000. ON the other hand, during or after the navigation of step 6050, the robotic assistant can identify that the environment and workspace through which it is navigating is a RoboKitchen (model 1000), by identifying distinctive features in the images obtained during the navigation. As described below, tis information can be used to more effectively and/or efficiently identify the objects therein with which the robotic assistant can interact.

At step 6054, the robotic assistant 5002r identifies the objects in the environment 5002 and/or workspace 5002w and thus with which the robotic assistant 5002r can communicate. Identifying of the objects of step 6054 can be performed either (1) based on the instance or type of environment and workspace identified at step 6052, and/or (2) based on a scan of the workspace 5002w. In some embodiments, identifying the objects at step 6054 is performed using, among other things, using a vision subsystem of the robotic assistant 5002r, such as a general-purpose vision subsystem (described in further detail below). As described in further detail below, the general-purpose vision subsystem can include or use one or more of the components of the robotic assistant 5002r illustrated in FIG. 163, and/or other of the systems or components illustrated in the ecosystem 5000, such as cameras and other sensors, memories, and processors. It should be understood that, in some embodiments, the object identification of step 6054 is performed based on the scan performed by the general-purpose vision subsystem, which can leverage a library of known objects to more accurately and/or efficiently identify objects.

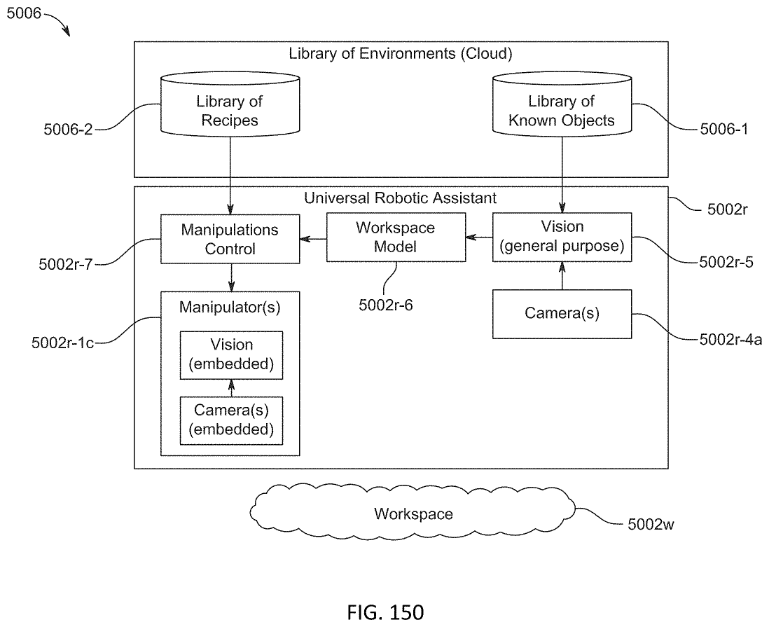

FIG. 150 illustrates aspects of the cloud computing system 5006 and of the robotic assistant 5002r, and the components and interactions there between that are used to, among other things, identify objects at step 6054. As shown, the cloud computing system 5006 can store a library of environments (and/or workspaces), including for example a library definition of environment 5002. The library definition of the environment 5002 (and any other of the environments defined in the library of environments) can include any data known to those of skill in the art that describes and/or is otherwise associated with or to the environment 5002. For example, in connection with each environment definition, including the definition of the environment 5002, the cloud computing system 5006 stores a library of known objects (“object library”) 5006-1 and a library of recipes (“recipe library”) 5006-2. The library of known objects 5006-1 includes data definitions of objects that are standard to or typically known to be in the environment 5002. The recipe library includes data definitions of recipes that can be performed or executed in the environment 5002.

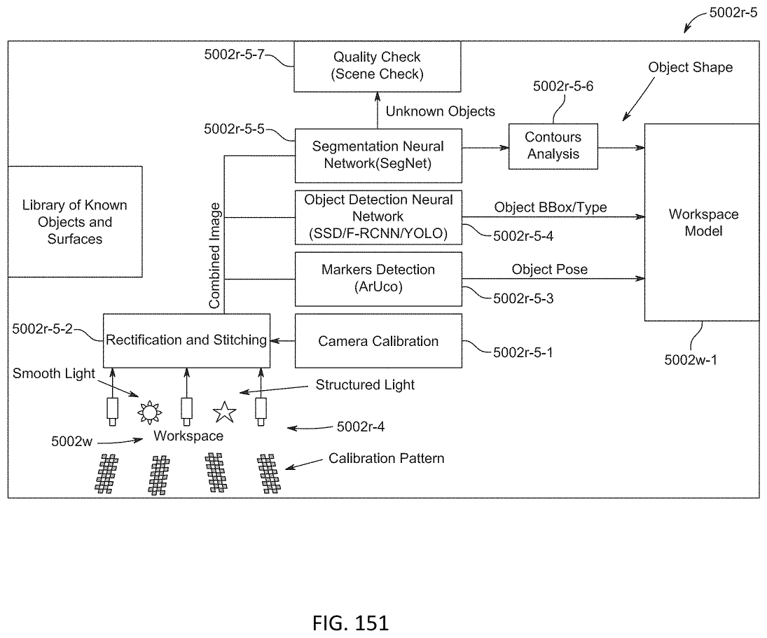

Still with reference to FIG. 150, as illustrated, exemplary aspects of the robotic assistant 5002r can include at least one camera 5002r-4a (and/or other sensors), a general-purpose vision subsystem 5002r-5, a workspace model 5002w-1, a manipulations control module 5002r-7, and at least one manipulator (e.g., end effector) 5002r-1c. The general-purpose vision subsystem 5002r-5 (which is described if further detail below) is a subsystem of the robotic assistant 5002r made up of hardware and/or software and is configured to, among other things, visualize, image and/or detect objects in a workspace or environment. The workplace model 5002w-1 is a data definition of the workspace 5002w, which can be created and updated in real-time by the robotic assistant 5002w, in order to be readily aware of and/or understand the parts and processes of the of the workspace, for instance, for quality control. For instance, the data definition of the workspace 5002w can include a compilation of the data definitions of the objects identified to be present in the environment 5002. The manipulations control module 5002r-7 can be a combination of hardware and/or software configured to identify recipes to execute and to generate algorithms of interaction that define the manner in which the robotic assistant 5002r is to be commanded in order to accurately and successfully execute the recipe. For instance, the manipulations control module 5002r-7 can identify which interactions can or should be performed in order to perform each command of the recipe as efficiently and effectively as possible. The manipulator 5002r1-c can be a part of the robotic assistant 5002r or its anatomy 5002r-1, such an end effector 5002r1-c, which can be used to manipulate and/or interact with an object in the environment 5002. The manipulator 5002r-1c can include a corresponding and/or embedded vision subsystem 5002r-1c-A and/or a camera (or other sensor) 5002r-1c-B. The workspace 5002w is also illustrated in FIG. 151, which is the workspace in or with which the robotic assistant 5002r is to execute the recipe.

Still with reference to FIG. 150 the objects corresponding to the environment 5002 and/or the workspace 5002w are identified based on either the instance/type of the environment 5002 and/or workspace 5002w, and/or by scanning the workspace 5002w to detect the objects therein. An environment and/or workspace can be made up of or include known objects, which are those objects that are always or typically found in the environment 5002w or workspace 5002. For instance, in a kitchen type environment or workspace, a knife can be a “known” object, since a knife is typically found in a kitchen, while a roll of string, if detected in the kitchen, would be deemed to be an “unknown” object, since it is typically not found in a kitchen. Thus, in some embodiments, at step 6054, the robotic assistant 6054 can identify the objects that are known in the environment 5002 and/or workspace 5002w.

Moreover, at step 6054, objects can be identified using the general-purpose vision subsystem 5002r-5 of the robotic assistant 5002r, which is used to scan the environment 5002 and/or workspace 5002w and identify the objects that are actually (rather than expectedly) present in therein. The objects identified by the general-purpose vision subsystem 5002r-5 can be used to supplement and/or further narrow down the list of “known” objects identified as described above based on the specific instance or type of environment and/or workspace identified at step 6052. That is, the objects recognized by the scan of the general-purpose vision subsystem 5002r-5 can be used to cut down the list of known objects by eliminating therefrom objects that, while known and/or expected to be present in the environment 5002 and/or workspace 5002w, are actually not found therein at the time of the scan. Alternatively, the list of known objects can be supplemented by adding thereto any objects that are identified by the scan of the general-purpose vision subsystem 5002r-5. Such objects can be objects that were not expected to be found in the environment 5002 and/or workspace 5002w, but were indeed identified during the scan (e.g., by being manually inserted or introduced into the environment 5002 and/or workspace 5002w). By identifying the identification of objects using these two techniques, an optimal list of objects with which the robotic assistant 5002r is to interact is generated. Moreover, by referencing a pre-generated list of known objects, errors (e.g., omitted or misidentified objects) due to incomplete or less-than-optimal imaging by the general-purpose vision subsystem 5002r-5 can be avoided or reduced.

As shown in FIG. 151, the general-purpose vision subsystem 5002r-5 includes or can use a camera 5002r-4a (or multiple cameras and/or other sensors) to capture images and thereby visualize the environment 5002 and/or workspace 5002w. The general-purpose vision subsystem 5002r-5 can identify objects based on the obtained images, and thereby determine that those objects are indeed present in the environment 5002 and/or workspace 5002w. The general-purpose vision subsystem 5002r-5 is now described in further detail.

FIG. 152 illustrates an architecture of a general-purpose vision subsystem 5002r-5, according to an exemplary embodiment. As shown, the general-purpose vision subsystem 5002r-5 is made up of modules and components (e.g., cameras) configured to provide imaging, object detection and object analysis, for the purpose of identifying objects within the environment 5002 and/or workspace 5002w. The modules and systems of the general-purpose vision subsystem 5002r-5 can leverage the library of known objects (and surfaces) stored in the cloud computing system 5006 to more accurately or efficiently identify objects. Information about the identified objects can be stored in the workspace model 5002w-1, which as described above is a data definition of the workspace 5002.

Still with reference to FIG. 151, the modules of or corresponding to the general-purpose vision subsystem 5002r-5 can include: a camera calibration module 5002r-5-1, rectification and stitching module 5002r-5-2, a markers detection module 5002r-5-3, an object detection module 5002r-5-4, a segmentation module 5002r-5-5, a contours analysis module 5002r-5-6, and a quality check module 5002r-5-7. These modules can consist of code, logic and/or the like stored in one or more memories 5002r-3 and executed by one or more memories 5002r-2 of the robotic assistant 5002r. While each module is configured for a specific purpose, the modules are designed to detect objects and/or analyze objects in order to provide information (e.g., characteristics) about those objects. The object detection and/or analysis of these modules is performed using the illustrated cameras 5002r-4 to image the illustrated workspace 5002w.

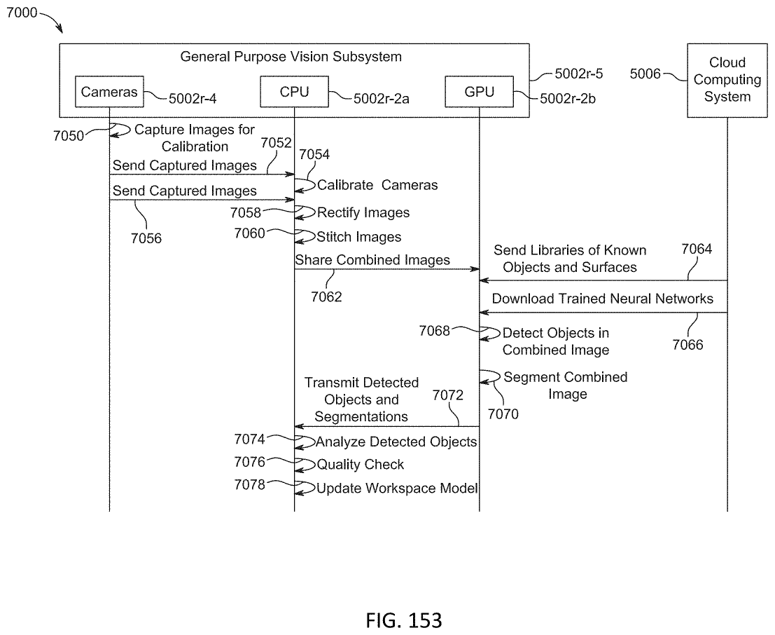

In some embodiments, the cameras 5002r-4 illustrated in FIG. 153 can be deemed to correspond (exclusively or non-exclusively) to a camera system of the general-purpose vision subsystem 5002r-5. It should be understood that while FIG. 153 only illustrates three cameras, the general-purpose subsystem 5002r-5 and/or the camera system can include or be associated with any number of cameras. In some embodiments, the number (and other characteristics) of the cameras can be based on the size and/or structure of the workspace. For example, a three meter by one meter cooking surface can require at least three cameras mounted 1.2 meters high above the top-facing surface of the workspace 5002w. Thus, the cameras 5002r-4 can be cameras that are embedded in the robotic assistant 5002r and/or cameras that are logically connected thereto (e.g., cameras corresponding to the environment 5002 and/or the workspace 5002w).

The camera system can also be said to include the illustrated structured light and smooth light, which can be built or embedded in the cameras 5002r-4 or separate therefrom. It should be understood that the lights can be embedded in or separate from (e.g., logically connected to) the robotic assistant 5002r. Moreover, the camera system can also be said to include the illustrated camera calibration module 5002r-5-1 and the rectification and stitching module 5002r-5-2.

FIG. 154A illustrates an architecture for identifying objects using the general-purpose vision subsystem 5002r-5, according to an exemplary embodiment. As shown in FIG. 154A, a CPU such as processor 5002r-2a of the robotic assistant 5002r handles certain functions of the object identification of step 6054 of FIG. 152, including camera calibration, image rectification, image stitching, marker detection, contour analysis quality (or scene) check, and management of the workspace model. A graphics processing unit (GPU) such as processor 5002r-2b of the robotic assistant 5002r handles certain functions of the object identification of step 6054 of FIG. 152, including object detection and segmentation. And, the cloud computing system 5006, including its own components (e.g., processors, memories) provide storage, management and access to the library of known objects.

FIG. 153 illustrates a sequence diagram 7000 of a process for identifying objects in an environment or workspace, according to an exemplary embodiment. The exemplary process 7000 illustrated in FIG. 153 is described in conjunction with features and aspects of other figures described herein, including FIG. 152 which illustrates an exemplary general-purpose vision subsystem. As shown, the process includes functionality performed by the general-purpose vision subsystem 5002r-5 of the robotic assistant 5002r, and the cloud computing system 5006. The general-purpose vision subsystem 5002r-5 includes and/or is associated with cameras 5002r-4, CPU 5002r-2a, and GPU 5002r-2b. As discussed herein, the cameras can include cameras that exclusively correspond to the robotic assistant 5002r (e.g., cameras embedded in the robot anatomy 5002r-1). It should be understood that the general-purpose vision subsystem 5002r-5 can include and/or be associated with other devices, components and/or subsystems not illustrated in FIG. 168B.

At step 7050, the cameras 5002r-4 are used to capture images of the workspace 5002w for calibration. Prior to capturing the images to be used for camera calibration, a checkerboard or chessboard pattern (or the like, as known to those of skill in the art) is disposed or provided on predefined positions of the workspace 5002w. The pattern can be formed on patterned markers that are outfitted on the workspace 5002w (e.g., top surface thereof). Moreover, in some embodiments such as the one illustrated in FIG. 153 in which the camera system of the general-purpose vision subsystem 5002r-5 includes two or more cameras, the cameras 5002r-4 are arranged for imaging such that the field of view of neighboring (e.g., adjacent) cameras overlap, thereby allowing at least a portion of the pattern to be visible by two cameras. Once the cameras 5002r-4 and 5002w have been configured for calibration, the calibration images are obtained at step 7050. At step 7052, the captured calibration images are transmitted from and/or made available by the cameras to the CPU 5002r-2a. It should be understood that the image capturing performed by the cameras 5002r-4 at step 7050, the transmission of the images to the CPU 5002r-2a at step 7052, and the calibration of cameras 7054 by the CPU 5002r-2a can be performed in sequential steps, or in real time, such that the calibration of step 7054 occurs “live” as the cameras are capturing the images at step 7050.

In turn, at step 7054, calibration of the cameras is performed to provide more accurate imaging such that optimal and/or perfect execution of commands of a recipe can be performed. That is, camera calibration enables more accurate conversion of image coordinates obtained from images captured by the cameras 5002r-4 into real world coordinates of or in the workspace 5002w. In some embodiments, the camera calibration module 5002r-5-2 of the general-purpose vision subsystem 5002r-5 is used calibrate the cameras 5002r-4. As illustrated, the camera calibration module 5002r-5-2 can be driven by the CPU 5002r-2a.

The cameras 5002r-4, in some embodiments, are calibrated as follows. The CPU 5002r-2a detects the pattern (e.g., checkerboard) in the images of the workspace 5002w captured at step 7050. Moreover, the CPU 5002r-2a locates the internal corners in the detected pattern in of the captured images. The internal corners are the corners where four squares of the checkerboard meet and that do not form part of the outside border of the checkerboard pattern disposed on the workspace 5002w. For each of the identified internal corners, the general-purpose vision subsystem 5002r-5 identifies the corresponding pixel coordinates. In some embodiments, the pixel coordinates refer to the coordinate on the captured images at which the pixel corresponding to each of the internal corners is located. In other words, the pixel coordinates indicate where each internal corner of the checkerboard pattern is located in the images captured by the cameras 500r-4, as measured in an array of pixel.

Still with reference to the calibration of step 7054, real world coordinates are assigned to each of the identified pixel coordinates of the internal corners of the checkerboard pattern of. In some embodiments, the respective real-world coordinates can be received from another system (e.g., library of environments stored in the cloud computing system 5006) and/or can be input to the robotic apparatus 5002r and/or the general-purpose vision subsystem 5002r-5. For example, the respective real-world coordinates can be input by a system administrator or support engineer. The real-world coordinates indicate the real-world position in space of the internal corners of the checkerboard pattern of the markers on the workspace 5002w.

Using the calculated pixel coordinates and real-world coordinates for each internal corner of the checkerboard pattern, the general-purpose vision subsystem 5002r-5 can generate and/or calculate a projection matrix for each of the cameras 5002r-4. The projection matrix thus enables the general-purpose vision subsystem 5002r-5 to convert pixel coordinates into real world coordinates. Thus, the pixel coordinate position and other characteristics of objects, as viewed in the images captured by the cameras 5002r-4, can be translated into real world coordinates in order to identify where in the real world (as opposed to where in the captured image) the objects are positioned.

As described herein, the robotic assistant 5002r can be a standalone and independently movable system or can be a system that is fixed to the workspace 5002w and/or other portion of the environment 5002. In some embodiments, parts of the robotic assistant 5002r can be freely movable while other parts are fixed to (and/or be part of) portions of the workspace 5002w. Nevertheless, in some embodiments in which the camera system of the general-purpose vision subsystem 5002r-5 is fixed, the calibration of the cameras 5002r-4 is performed only once and later reused based on that same calibration. Otherwise, if the robotic assistant 5002r and/or its cameras 5002r-4 are movable, camera calibration is repeated each time that the robotic assistant 5002r and/or any of its cameras 5002r-4 change position.

It should be understood that the checkerboard pattern (or the like) used for camera calibration can be removed from the workspace 5002w once the cameras have been calibrated and/or use of the pattern is no longer needed. Although, in some cases, it may be desirable to remove the checkerboard pattern as soon as the initial camera calibration is performed, in other cases it may be optimal to preserve the checkerboard markers on the workspace 5002w such that subsequent camera calibrations can more readily be performed.

With the cameras 5002r-4 calibrated, the general-purpose vision subsystem 5002r-5 can begin identifying objects with more accuracy. To this end, at step 7056, the cameras 5002r-4 capture images of the workspace 5002w (and/or environment 5002) and transmit those captured images to the CPU 5002r-2a. The images can be still images, and/or video made up of a sequence of continuous images. Although the sequence diagram 7000 of FIG. 168B only illustrates single transmission of captured image data at step 7056, it should be understood that images can be sequentially and/or continually captured and transmitted to the CPU 5002r-2a for further processing (e.g., in accordance with steps 7058 to 7078).

At step 7058, the captured images received at step 7056 are rectified by the rectification and stitching module 5002r-5-2 using the CPU 5002r-2a. In some example embodiments, rectification of the images captured by each of the cameras 5002r-4 includes removing distortion in the images, compensating each camera's angle, and other rectification techniques known to those of skill in the art. In turn, at step 7060, the rectified images captured from each of the cameras 5002r-4 are stitched together by the rectification and stitching module 5002r-5-2 to generate a combined captured image of the workspace 5002w (e.g., the entire workspace 5002w). The X and Y axes of the combined captured image are then aligned with the real-world X and Y axes of the workspace 5002w. Thus, pixel coordinates (x,y) on the combined image of the workspace 5002w can be transferred or translated into corresponding (x,y) real world coordinates. In some embodiments, such a translation of pixel coordinates to real world coordinates can include performing calculations using a scale or scaling factor calculated by the calibration module 5002r-5-2 during the camera calibration process.

In turn, at step 7062, the combined (e.g., stitched) image generated by the rectification and stitching module 5002r-5-2 is shared (e.g., transmitted, made available) with other modules, including the object detection module 5002r-5-4, to identify the presence of objects in the workspace 5002w and/or environment 5002 by detecting objects within the captured image. Moreover, at step 7064, the cloud computing system 5006 transmits libraries of known objects and surfaces stored therein to the general-purpose vision subsystem 5002r-5, and in particular to the GPU 5002r-2b. As discussed above, the libraries of known objects and surfaces that is transmitted to the general-purpose vision subsystem 5002r-5 can be specific to the instance or type of the environment 5002 and/or the workspace 5002w, such that only data definitions of objects known or expected to be identified are sent. Transmission of these libraries can be initiated by the cloud computing system 5006 (e.g., pushed), or can be sent in response to a request from the GPU 5002r-2b and/or the general-purpose vision subsystem 5002r-5. It should be understood that transmission of the libraries of known objects can be performed in one or multiple transmissions, each or all of which can occur immediately prior to or at any point before the object detection of step 7068 is initiated.

At step 7066, the GPU 5002r-2b of the general-purpose vision subsystem 5002r-5 of the robotic apparatus 5002r downloads trained neural networks or similar mathematical models (and weights) corresponding to the known objects and surfaces associated with step 7064. These neural networks are used by the general-purpose vision subsystem 5002r-5 to detect or identify objects. As shown in FIG. 185, such models can include a neural network such as convolutional neural networks (CNN), faster convolutional neural networks (F-CNN), you only look once (YOLO) neural networks, and single-shot detector (SSD) neural networks, for object detection and a neural network for image segmentation (e.g., SegNet). To maximize the accuracy and efficiency of the neural networks and their application to detect objects and perform image segmentation, the downloaded neural networks are specifically configured for the workspace 5002w (and/or environment 5002) by being trained only for the known objects and surfaces of the workspace 5002w (and/or environment 5002). Thereby, the neural networks need not account for objects or surfaces that are not known to the workspace 5002w (and/or environment 5002). That is, targeted or particularized neural networks—e.g., ones trained only for the known objects in the workspace and/or environment—can provide faster and less complex object identification processing by avoiding the burdens of considering and dismissing objects that are not known (and therefore less likely) to be present in the environment 5002 and/or the workspace 5002w. It should be understood that the neural networks (and/or other models) can be trained and obtained from the cloud computing system 5006 (as shown in FIG. 168B), or from another component of the ecosystem 5000. Alternatively, although not illustrated in FIG. 168B, the neural networks (and/or other models) can be trained and maintained by the robotic assistant 5002r itself.

In turn, at step 7068, the object detection module 5002r-5-4 uses the GPU 5002r-2b to detect objects in the combined image (and therefore implicitly in the real-world workspace 5002w and/or environment 5002) based on or using the received and trained object detection neural networks (e.g., CNN, F-CNN, YOLO, SSD). In some embodiments, object detection includes recognizing, in the combined image, the presence and/or position of objects that match objects included in the libraries of known objects received at step 7064.

Moreover, at step 7070, the segmentation module 5002r-5-5 uses the GPU 5002r-2b segments portions of the combined image and assign an estimated type or category to that segment based on or using the trained neural network such as SegNet received at step 7066. It should be understood that, at step 7070, the combined image of the workspace 5002w is segmented into pixels, though segmentation can be performed using a unit of measurement other than a pixel as known to those of skill in the art. Still with reference to step 7070, each of the segments of the combined image is analyzed by the trained neural network in order to be classified, by determining and/or approximating a type or category to which the contents of each pixel correspond. For example, the contents or characteristics of the data of a pixel can be analyzed to determine if they resemble a known object (e.g., category: “knife”). In some embodiments, pixels that cannot be categorized as corresponding to a known object can be categorized as a “surface,” if the pixel most closely resembles a surface of the workspace, and/or as “unknown,” if the contents of the pixel cannot be accurately classified. It should be understood that the detection and segmentation of steps 7068 and 7070 can be performed simultaneously or sequentially (in any order deemed optimal).

In turn, at step 7072, the results of the object detection of step 7068 and the segmentation results (and corresponding classifications) of step 7070 are transmitted by the GPU 5002r-2b to the CPU 5002r-2a. Based on these, at step 7074, the object analysis is performed by the marker detection module 5002r-5-3 and the contour analysis module 5002r-5-6, using the CPU 5002r-2a, to, among other things, identify markers (described in further detail below) on the detected objects, and calculate (or estimate) the shape and pose of each of the objects.

That is, at step 7074, the marker detection module 5002r-5-3 determines whether the detected objects include or are provided with markers, such as ArUco or checkerboard/chessboard pattern markers. Traditionally, standard objects are provided with markers. As known to those of skill in the art, such markers can be used to more easily determine the pose (e.g., position) of the object and manipulate it using the end effectors of the robotic assistant 5002r. Nonetheless, non-standard objects, when not equipped with markers can be analyzed to determine their pose in the workspace 5002w using neural networks and/or models trained on that type of non-standard object, which allows the general-purpose vision subsystem 5002r-5 to estimate, among other things, the orientation and/or position of the object. Such neural networks and models can be downloaded and/or otherwise obtained from other systems such as the cloud computing system 5006, as described above in detail. In some embodiments, analysis of the pose of objects, particularly non-standard objects, can be aided by the use of structured lighting. That is, neural networks or models can be trained using structured lighting matching that of the environment 5002 and/or workspace 5002w. The structured lighting highlights aspects or portions of the objects, thereby allowing the module 5002r-5-3 to calculate the object's position (and shape, which is described below) to provide more optimal orientation and positioning of the object for manipulations thereon. Still with reference to stop 7074, analysis of the detected objects can also include determining the shape of the objects, for instance, using the contours analysis module 5002r-5-6 of the general-purpose vision subsystem 5002r-5. In some embodiments, contour analysis includes identifying the exterior outlines or boundaries of the shape of detected objects in the combined image, which can be executed using a variety of contour analysis techniques and algorithms known to those of skill in the art. At step 7076, a quality check process is performed by the quality check module 5002r-5-7 using the CPU 5002r-2a, to further process segments of the image that were classified as unknown. This further processing by the quality check process serves as a fall back mechanism to provide last minute classification of “unknown” segments.

At step 7078, the results of the analysis of step 7074 and the quality check of step 7076 are used to update and/or generate the workspace model 5002w-1 corresponding to the model 5002w. In other words, data identifying the objects, and their shape, position, segment types, and other calculated or determined characteristics thereof are stored in association with the workspace model 5002w-1.

Moreover, with reference to step 6054, the process of identifying objects and downloading or otherwise obtaining information associated with each of the objects into the workspace model 5002w-1 can also include downloading or obtaining interaction data corresponding to each of the objects. That is, as described above in connection with FIG. 168B, object detection includes identifying objects present in the environment 5002 and/or the workspace 5002w. In addition, characteristics such as marker information, shape and pose associated with each object is determined or calculated for the identified objects. The detected presence and characteristics of these objects is stored in association with the workspace model 5002w-1. Moreover, the robotic assistant 5002r can also store, in the workspace model 5002w-1, in association with each of the detected objects, object information downloaded or received from the cloud computing system 5006. Such information can include data that was not calculated or determined by the general-purpose vision subsystem 5002r-5 of the robotic assistant 5002r. For instance, this data can include weight, material, and other similar characteristics that form part of the template or data definition of the objects. Other information that is downloaded to the workspace model in connection with each object are data definitions of interactions that can be performed, by the robotic assistant 5002r in the context of the workspace 5002w and/or environment 5002, on or with each of the detected objects. For instance, in the case of a blender type object, the object definition of the blender can include data definitions of interactions such as “turn on blender,” “turn off blender,” “increase power of blender,” and other interactions that can be performed on or using the blender.

For example, a recipe to be performed in a kitchen can be to achieve a goal or objective such as cooking a turkey in an oven. Such a recipe can include or be made up of steps for marinating the turkey, moving the turkey to the refrigerator to marinate, moving the turkey to the oven, removing the turkey from the oven, etc. These steps that make up a recipe are made up of a list or set of specifically tailored (e.g., ordered) interactions (also referred to interchangeably as “manipulations”), which can be referred to as an algorithm of interactions. These interactions can include, for example: pressing a button to turn the oven on, turning a knob to increase the temperature of the oven to a desired temperature, opening the oven door, grasping the pan on which the turkey is placed and moving it into the oven, and closing the oven door. Each of these interactions is defined by a list or set of commands (or instructions) that are readable and executable by the robotic assistant 5002r. For instance, an interaction for turning on the oven can include or be made up of the following list of ordered commands or instructions:

Move finger of robotic end effector to real world position (xl, yl), where (xl, yl) are coordinates of a position immediately in front of the oven's “ON” button;

Advance finger of robotic end effector toward the “ON” button until X amount of opposite force is sensed by a pressure sensor of the end effector; and

Retract finger of robotic end effector the same distance as in the preceding command.

As discussed in further detail below, the commands can be associated with specific times at which they are to be executed and/or can simply be ordered to indicate the sequence in which they are to be executed, relative to other commands and/or other interactions (and their respective timings). The generation of an algorithm mf interaction, and the execution thereof, is described in further detail below with reference to steps 6056 and 6058 of FIG. 165. Nonetheless, for clarity, interactions by the robotic assistant 5002r are now described.

As described herein, the robotic assistant 5002r can be deployed to execute recipes in order to achieve desired goals or objectives, such as cooking a dish, washing clothes, cleaning a room, placing a box on a shelf, and the like). To execute recipes, the robotic assistant 5002r performs sequences of interactions (also referred to as “manipulations”) using, among other things, its end effectors 5002r-1c and 5002r-1n. In some embodiments, interactions can be classified based on the type of object that is being interacted with (e.g., static object, dynamic object). Moreover, interactions can be classified as grasping interactions and non-grasping interactions.

Non-exhaustive examples of types of grasping interactions include (1) grasping for operating, (2) grasping for manipulating, and (3) grasping for moving. Grasping for operating refers to interactions between one or more of the end effectors of the robotic assistant 5002r and objects in the workspace 5002w (or environment 5002) in which the objective is to perform a function to or on the object. Such functions can include, for example, grasping the object in order to press a button on the object (e.g., ON/OFF power button on a handheld blender, mode/speed button on a handheld blender). Grasping for manipulating refers to interactions between one or more of the end effectors of the robotic assistant 5002r and objects in the workspace 5002w (or environment 5002) in which the objective is to perform a manipulation on or to the object. Such manipulations can include, for example: compressing an object or part thereof; applying axial tension on an X,Y or an X,Y,Z axis; compressing and applying tension; and/or rotating an object. Grasping for moving refers to interactions between one or more of the end effectors of the robotic assistant 5002r and objects in the workspace 5002w (or environment 5002) in which the objective is to change the position of the object. That is, grasping for moving type interactions are intended to move an object from point A to point B (and other points, if needed or desired), or change its direction or velocity.

On the other hand, non-exhaustive examples of types of non-grasping interactions include (1) operating without grasping; (2) manipulating without grasping; and (3) moving without grasping. Operating an object without grasping refers to interactions between one or more of the end effectors of the robotic assistant 5002r and objects in the workspace 5002w (or environment 5002) in which the objective is to perform a function without having to grasp the object. Such functions can include, for example, pressing a button to operate an oven. Manipulating an object without grasping refers to interactions between one or more of the end effectors of the robotic assistant 5002r and objects in the workspace 5002w (or environment 5002) in which the objective is to perform a manipulation without the need to grasp the object. Such functions can include, for example, holding an object back or away from a position or location using the palm of the robotic hand. Moving an object without grasping refers to interactions between one or more of the end effectors of the robotic assistant 5002r and objects in the workspace 5002w (or environment 5002) in which the objective is to move an object from point A to point B (and other points, if needed or desired), or change its direction or velocity, without having to grasp the object. Such non-grasping movement can be performed, for example, using the palm or backside of the robotic hand.

While interactions with dynamic objects can also be classified into grasping and non-grasping interactions, n some embodiments, interactions with dynamic objects (as opposed to static objects) can be approached differently by the robotic assistant 5002r, as compared with interactions with static objects. For example, when performing interactions with dynamic objects, the robotic assistant additionally: (1) estimates each object's motion characteristics, such as direction and velocity; (2) calculates each objects expected position at each time instance or moment of an interaction; and (3) preliminarily positions its parts or components (e.g., end effectors, kinematic chains) according to the calculated expected position of each object. Thus, in some embodiments, interactions with dynamic objects can be more complex than interactions with static objects, because, among other reasons, they require synchronization with the dynamically changing position (and other characteristics, such as orientation and state) of the dynamic objects.

Moreover, interactions between end effectors of the robotic assistant 5002r and objects can also or alternatively be classified based on whether the object is a standard or non-standard object. As discussed above in further detail, standard objects are those objects that do not typically have changing characteristics (e.g., size, material, format, texture, etc.) and/or are typically not modifiable. Non-exhaustive, illustrative examples of standard objects include plates, cups, knives, lamps, bottles, and the like. Non-standard objects are those objects that are deemed to be “unknown” (e.g., unrecognized by the robotic assistant 5002r), and/or are typically modifiable, adjustable, or otherwise require identification and detection of their characteristics (e.g., size, material, format, texture, etc.). Non-exhaustive, illustrative examples of non-standard objects include fruits, vegetables, plants, and the like.

FIGS. 154A-154E in one exemplary embodiment of the present disclosure, illustrates a wall locking mechanism 1906 for the one or more objects. The wall locking mechanism 1906 includes an opening 1906a for receiving the one or more objects. The opening 1906a extends into a socket 1906b, which configured to retain a portion of a wall mount bracket 1907 fixed to the one or more objects. Further, a stopper 1906c is provided to the opening 1906a, which extends parallel to the surface of the wall and is configured to lock the portion of the wall mount bracket 1907 into the socket 1906b.

In an embodiment, for storing the one or more objects the robotic system is adapted approach the wall locking mechanism 1906 and orient the one or more objects at a predetermined angle for inserting the wall mount bracket 1907 of the one or more objects. At this stage, the robotic system tilts the one or more objects suitably, to lock the wall mount bracket 1907 into the opening 1906a.

In an embodiment, the opening 1906a, the socket 1906b and the stopper 1906c may be configured corresponding to the configuration of the wall mount bracket 1907 provisioned to the one or more brackets.

In an embodiment, the wall locking mechanism 1906 may be configured to directly receive and store the one or more objects. In an embodiment, a magnet may be provided in the socket 1906b, for providing extra locking force to the one or more objects. In an embodiment, the magnet may be provided to the wall mount bracket 1907 or may be directly mounted to the one or more objects for fixing onto the wall locking mechanism 1906. In an embodiment, wall mount mechanism is defined in at least one of a kitchen environment, a structured environment or an un-structured environment.

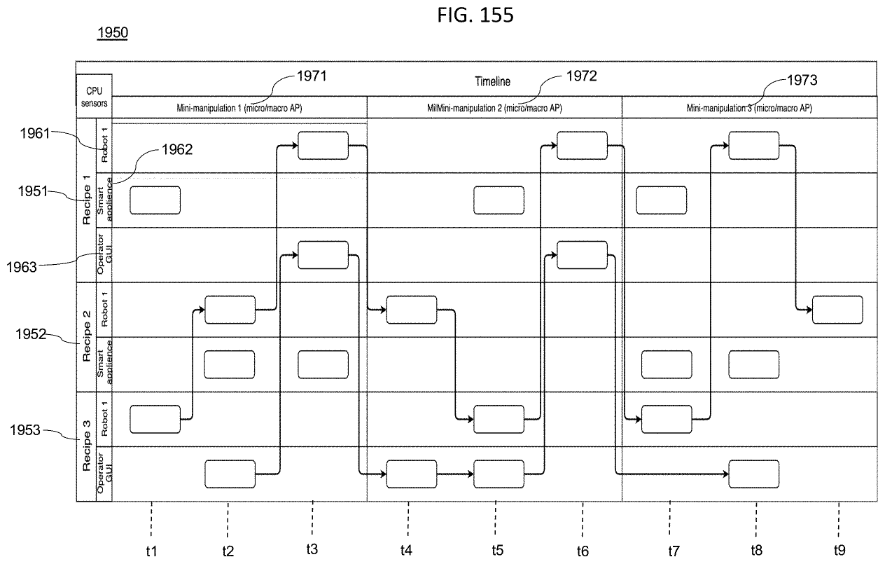

FIG. 155 is a block diagram illustrating one example of a flow diagram 1950 showing a robotic kitchen preparing multiple recipes at the same time (or parallel cooking) with the execution of the minimanipulations with a first robot (robot 1), a smart appliance, and an operator graphical user interface (GUI). The operator graphical user interface (GUI) can be used to send a voice command or a graphic command to an operator. The robotic kitchen receives three recipes from customer orders, a first recipe 1951, a second recipe 1952, and a third recipe 1953. For simplicity and illustrations, the robotic kitchen in this example has a first robot 1961, a smart appliance 1962, and an operator GUI 1963. A computer processor at the robotic kitchen has to manage the different recipes through the execution of a plurality of minimanipulations by the first robot 1961, the smart appliance 1962, and the operator GUI 1963 to avoid potential collusions between the execution of minimanipulations carried out by and between the first robot 1961, the smart appliance 1962, or the operator GUI 1963. In this example, three minimanipulations 1971, 1972, 1973 are executed across a time line. Each of the three minimanipulations 1971, 1972, 1973 can be either a micro AP or a macro AP. At time t1, the first smart appliance executes the first minimanipulation 1971 as part of the first recipe 1951 and the first robot 1961 executes the first minimanipulation 1971 as part of the third recipe 1953. At time t2, the first robot 1961 executes the first minimanipulation 1971 as part of the second recipe 1952, the smart appliance 1962 executes the first minimanipulation 1971 as part of second recipe 1952, and the operator GUI 1963 executes the first minimanipulation 1971 as part of the third recipe 1953. At time t3, the first robot 1961 executes the first minimanipulation 1971 as part of the first recipe 1951, the operator GUI 1963 executes the first minimanipulation 1971 as part of first recipe 1951, and the smart appliance 1963 executes the first minimanipulation 1971 as part of the second recipe 1952.

At time t4, the first robot 1961 executes the second minimanipulation 1972 as part of the second recipe 1952, and the operator GUI 1963 executes the second minimanipulation 1972 as part of third recipe 1953. At time t5, the smart appliance 1962 executes the second minimanipulation 1972 as part of the first recipe 1951, the first robot 1961 executes the second minimanipulation 1972 as part of the third recipe 1953, and the operator GUI 1963 executes the second minimanipulation 1972 as part of third recipe 1953. At time t6, the first robot 1961 executes the second minimanipulation 1972 as part of the first recipe 1951, and the operator GUI 1963 executes the second minimanipulation 1972 as part of first recipe 1951.

At time t7, the smart appliance 1962 executes the third minimanipulation 1973 as part of the first recipe 1951, the smart appliance 1962 executes the third minimanipulation 1973 as part of the second recipe 1952, and the first robot 1961 executes the third minimanipulation 1973 as part of the third recipe 1953. At time t8, the first robot 1961 executes executes the third minimanipulation 1973 as part of the first recipe 1951, the smart appliance 1962 executes the third minimanipulation 1973 as part of the second recipe 1952, and the operator GUI 1963 executes the third minimanipulation 1973 as part of the third recipe 1953. At time t9, the first robot 1961 executes executes the third minimanipulation 1973 as part of the second recipe 1952.

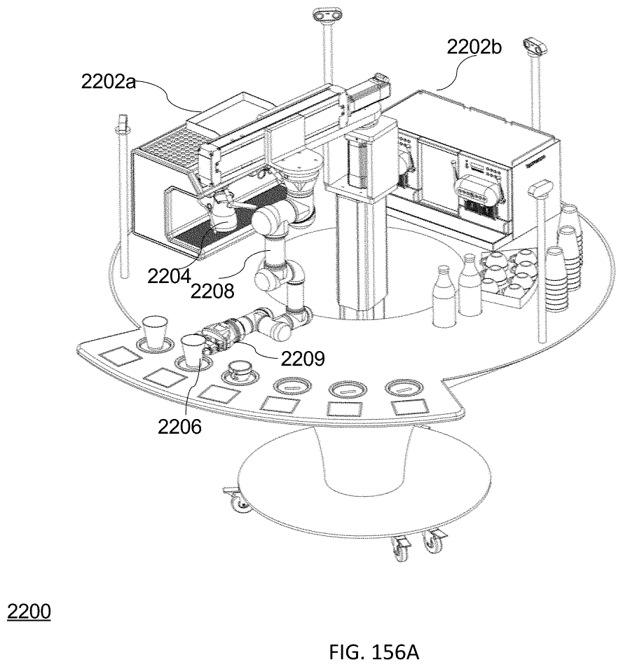

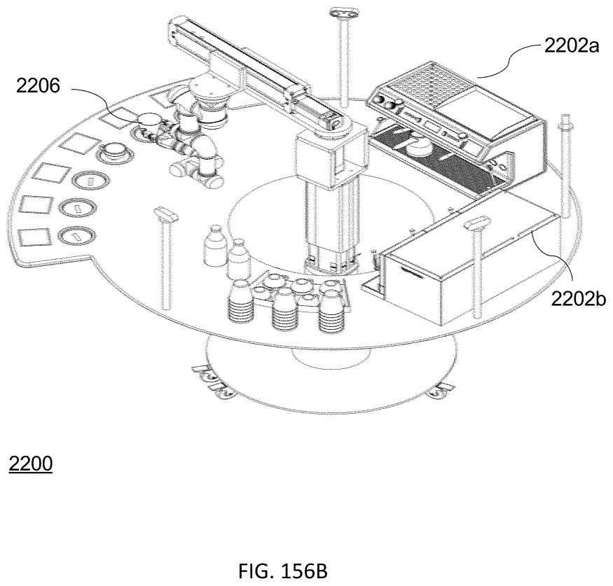

FIG. 156A is a block diagram illustrating an isometric front view of a robo café 2200 (or café barista) for a robot to serve a variety of drinks to customers; and FIG. 156B is a block diagram illustrating an isometric back view of a robotic café for a robot to serve a variety of drinks to customers. Drinks may include, but not limited, to latte, cappuciono, caffe mocha, espresso. The robo café (or robotic café) 2200 comprises one or more robotic arms 2208 and one or more robotic end effectors 2209 that executes one or more minimanipulations to prepare a coffee order in response to an order request from a customer, which a processor in the robo café 2200 may receive the order from an electronic device from the customer. The executed one or more minimanipulations may be part of a minimanipulation library for preparing a variety of coffees. The one or more robotic arms 2208 and one or more robotic end effectors 2209 in the robo café 2200 executes one or more minimanipulations to operate the one or more coffee machines 2202a, 2202b, and the one or more cups or pitchers 2204, to prepare the requested coffee from the electronic order of the customer. When the one or more robotic arms 2208 and one or more robotic end effectors 2209 has completed executing the one or more minimanipulations to finish preparing the requested order, the one or more robotic arms 2208 and one or more robotic end effectors 2209 places the coffee cup at a designated location 2206 corresponding to the location of the requested customer.

The robo café 2200 serves as one illustration in the application of the present disclosure. Other types of food module can be customized for the robot to access a minimanipulation library or minimanipulation libraries where the one or more robotic arms and one or more robotic end effectors provides some food offerings, like smoothies, boba (or tapioca or pearl) drinks, etc.

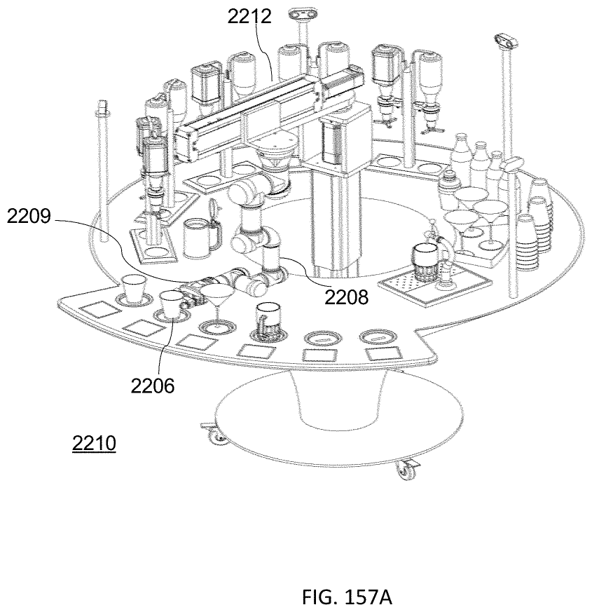

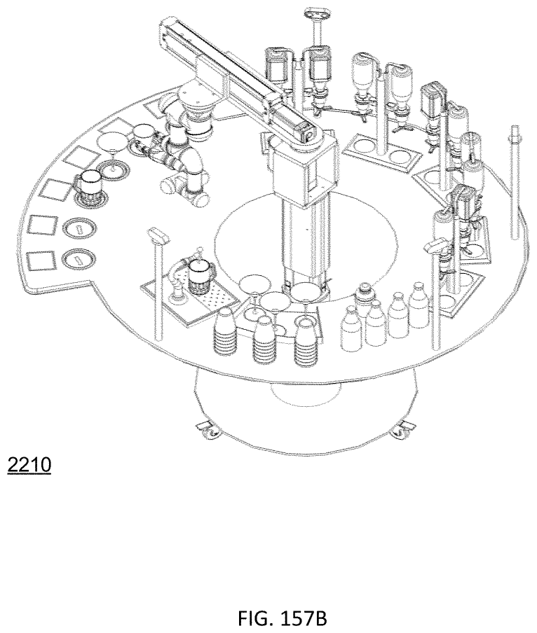

FIG. 157A is a block diagram illustrating an isometric front view of a robotic bar (barista alcohol or robo bar) for a robot to serve a variety of drinks to customers in accordance with the present disclosure; and FIG. 157B is a block diagram illustrating an isometric back view of a robotic café for a robot to serve a variety of drinks to customers. Drinks may include, but not limited, vodka, gin, baijiu, shōchū, soju, tequila, rum, whisky, brandy, black Russian, daiquiri, gin and tonic, long island iced lea, mai tai, Manhattan, margarita, martini, tequila sunrise, are example of drinks. Mixed drinks can also include non-alcoholic drinks. The robo bar (or robotic bar) 2210 comprises one or more robotic arms 2208 and one or more robotic end effectors 2209 that executes one or more minimanipulations to prepare an alcoholic or non-alcoholic drink order in response to an order request from a customer, which a computer processor in the robo bar 2210 may receive the order from an electronic device from the customer. The executed one or more minimanipulations may be part of a minimanipulation library for preparing a variety of alcoholic or non-alcoholic drinks. The one or more robotic arms 2208 and one or more robotic end effectors 2209 in the robo bar 2210 executes one or more minimanipulations to operate the one or more drink station 2212, to prepare the requested drink from the electronic order of the customer. When the one or more robotic arms 2208 and one or more robotic end effectors 2209 has completed executing the one or more minimanipulations to finish preparing the requested order, the one or more robotic arms 2208 and one or more robotic end effectors 2209 places the drink at a designated location 2216 corresponding to the location of the requested customer.

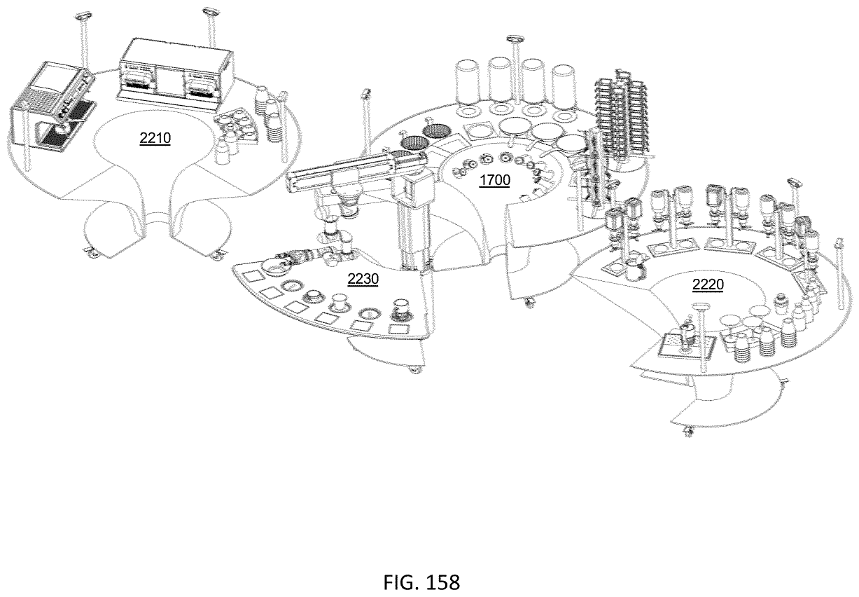

FIG. 158 is a block diagram illustrating a mobile, multi-use robot module (or a multi-use robot module assembly) 2230 for fitting with either the cooking station 1700, the coffee station 2210, or the drink station 2220. Generally, the multi-use robot module (or a cooking station) 2030 can operate and fitted with any worktop, such as a cooing worktop, a coffee worktop, a drink worktop, or other types of worktops, where each worktop can have a different environment, such as in a cooking worktop with a different sets of cookware and utensils. The cooking station includes a workstop and a station frame. The worktop has a first plurality of standardized placements for the placement of a first plurality of objects, each placement being used to place an environmental object. A plurality of the standardized placements can be unique to the environment in which the multi-use robot module operates in, such as for example a breakfast environment, a coffee shop environment, an alcoholic bar environment, a smoothie environment, a tapioca environment. Each environment may have a set of standardized placements in order to prepare food dishes or drinks for that particular environment. For example, for a ramen (or ramen noodle) environment, there may be standardized placements for one or more placements of bowls, one or more placements to boil ramen noodles, and one or more placements to cook ramen soups. Examples of environment objects include a frying basket, a wok, a soup pot, a cooking grill, an oven, a coffee machine, alcohols, bottles, cups. The cooking station has an interface area with a robotic kitchen module. In one embodiment, the interface area of the cooking station has a contoured open slot, which the robotic kitchen module can be pushed into the contoured open slot in a fixed position. Effectively, the robotic kitchen module is attached to the cooking station so the one or more robotic arms and one or more robotic end effector in the robotic kitchen module assembly can operate the cooking station to prepare food dishes or drinks for customers. The multi-use robot module 2230 can be moved to connect with the cooking station 1700 to prepare a variety of food dishes based in which the multi-use robot module 2230 accesses and executes a minimanipulation library containing or more more minimanipulations for preparing food dishes. The multi-use robot module 2230 can be moved to connect with the coffee station 2210 to prepare a variety of coffee drinks based in which the multi-use robot module 2230 accesses and executes a minimanipulation library containing or more more minimanipulations for preparing a variety of coffee drinks. The multi-use robot module 2230 can be moved to connect with the drink station 2220 to prepare a variety of alcoholic or non-alcoholic drinks based in which the multi-use robot module 2230 accesses and executes a minimanipulation library containing or more more minimanipulations for preparing a variety of alcoholic or non-alcoholic drinks. A robotic system comprising a cooking station with a first worktop and a station frame, the worktop is placed on station frame, the worktop including a first plurality of standardized placements and a first plurality of objects, each placement being used to place an environmental object, the cooking station having an interface area; and a robotic kitchen module having one or more robotic arms and one or more robotic end effector, the robotic kitchen module having a first contour, the robotic kitchen module being attached to the interface area of the cooking station.

A system for mass production of a robotic kitchen module comprising a kitchen module frame for housing a robotic apparatus in an instrumented environment, the robotic apparatus having one or more robotic arms and one or more effectors, the one or more robotic arms including a share joint, the kitchen module having a set of robotic operable parameters for calibration verifications to an initial state for operation by the robotic apparatus; and one or more calibration actuators coupled to a respective one of the one or more robotic arms, each calibration actuator corresponding to an axis on x-y-z axes, each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations. The detector comprises at least one probe. The kitchen module frame has a physical representation and a virtual representation, the virtual representation of the kitchen module frame being fully synchronized with the physical representation of the kitchen module frame.

A robotic multi-function platform comprising an instrumental environment having an operation area and a storage space, the storage area having one or more actuators, one or more rails, a plurality of locations, and one or more placements; one or more weighting sensors, one or more camera sensors, and one or more lights a processor executed to operate receiving a command to locate an identified object, the processor identifying the object location of the object in the storage area, the processor activating the one or more actuators to move the object from the storage area to the operation area of the instrumented environment. The storage space comprises a refrigerated area, the refrigerated area including one or more sensors and one or more actuators, and one or more automated doors with one or more actuators. The instrumented environment comprises one or more electronic hooks to change the orientation of the object.

A multi-functional robotic platform comprising one or more robotic apparatus; one or more end effectors; one or more operation zones; one or more sensors; one or more safety guards; a minimanipulation library comprising one or more minimanipulations; a task management and distribution module receiving an operation mode, the operation mode including a robot mode, a collaborative mode and a user mode, wherein in the collaborative mode, the task management and distribution module distributing one or more minimanipulations to a first operation zone for a robot and a second operation zone for the user; and an instrumented environment with one or more operational objects adopted for human and one or more robotic apparatuses interactions.

A method of structuring the execution of a robot movement or environment interaction sequence, defined by a pre-determined and -verified set of action primitives with well-defined starting and ending boundary configurations and execution steps, well defined through parameters, and executed in a sequence comprising (a) sensing and determining the robot configuration in the world using robot-internal and -external sensory systems, (b) using additional sensory systems to image the environment, identify objects therein, locating and mapping them accordingly, (c) developing a set of transformation parameters captured in one or more transformation matrices thereafter applied to the robot system as part of an adaptation step to compensate for any deviations between the physical system configuration and the pre-defined configuration defined for the starting point of a particular command sequence, (d) aligning the robotic system into one of multiple known possible set of starting configurations best-matched to the first of multiple sequential action primitives, (e) executing the pre-defined sequence of action primitives by way of a series of linked execution steps, each of the steps constrained to start and end at each respective step's pre-defined starting and exit configuration, whereby each step sequences into a succeeding step, only after satisfying a set of pre-defined success criteria for each of the respective steps, (g) completing the pre-determined set of steps within one or more AP required for the execution of a specific command sequence, (h) performing the steps of sensing the robot and environment and associated steps of imaging, identification and mapping, with a subsequent adaptation process involving the computation and application of a set of configuration transformation parameters to the robot system, ideally only at the beginning and end of the entire command sequence, and (i) storing all parameters associated with each of the aforementioned steps in a readily accessible database or repository. The execution sequence and associated boundary configurations of each action primitive are described by parameters that can be defined by an outside process involving simulation of the process in a virtual world developed on a computerized model, allowing for the extraction of all needed configuration parameters based on the idealized representation of the robotic system, its environment and the command sequence steps, or using a teach playback method by which the robot can be moved, either manually or through a teach-pendant interface by a human operator, allowing for the encoding and storage of all the individual steps and their associated configuration parameters, or manual encoding by having the human define all the respective movement and interaction steps using joint- and/or cartesian positions and configurations with associated time-stamps, and thereby build execution steps through a set of user-defined action primitives along a user-defined time-scale, which are then manually combined into a specific set of command sequences, or capturing the sequences and their associated parameters by monitoring a professional practitioner carrying out the desired movements and interactions and converting these into machine-readable and -executable command sequences. the parameters captured and stored for future use, include, but are not limited to parameters that describe allowable poses or configurations of the robotic system handling or grasping any particular tool needed in the execution of a particular process step within a particular command sequence, and Individual process steps broken down into macro APs, whereby a sequence of macro-APs constitutes a particular single process step within the entire command sequence, and further structuring each macro-AP into a sequence of smaller micro-APs or process-steps, whereby a sequence of micro-APs constitutes a single macro-AP, and the starting and exit configurations of each macro- and micro-AP that the robotic system and its associated tools have to pass through between each AP, before being allowed to proceed to the next macro- and micro-AP within a given sequence, and the associated success criteria needing to be satisfied before starting and concluding each macro- and micro-AP within each sequence, based on sensory data from the robotic system, the environment and any significant process variables. The experimental verification and validation ensure a guaranteed performance specification, ensuring the final sequence parameters can be stored within an MML process database. A possible set of starting configurations for each command sequence has been identified and stored in on-board system memory, allowing the system to select the closest best-match configuration based on a comparison of robot-internal and external environmental sensory data. Reconfiguring a robotic system from a current configuration, to a new and different configuration pre-defined as the starting configuration for one or more steps within a cooking sequence, with each cooking step describes a sequentially-executed set of APs, the steps of said adaptation process consisting of a reconfiguration process which includes sensing and determining the robot configuration in the world using robot-internal and -external sensory systems, using additional sensory systems to image the environment, identify objects therein, locating and mapping them accordingly, developing a set of transformation parameters captured in one or more transformation vectors and/or matrices thereafter applied to the robot system as part of an adaptation step to compensate for any deviations between the physical system configuration and the pre-defined configuration defined for the starting point of a particular step within a given command sequence, aligning the robotic system into one of multiple known possible set of starting configurations best-matched to the first of multiple sequential action primitives, and returning control to the central control system for execution of any follow-on robotic movement steps described by a sequence of APs within a particular recipe execution process. The defined adaptation process for the robotic systems is performed at one or more of the following situations at the beginning of the entire command sequence as defined by the first AP and its associated robotic system starting configuration parameters within a particular recipe execution sequence, or at the conclusion of a cooking sequence as defined by the last AP and its associated robotic system starting configuration parameters within a particular recipe execution sequence, at the beginning or conclusion of any particular AP, with its associated starting and exiting robot system configuration parameters, so defined as a critical AP within the recipe execution process so to ensure eventual successful recipe execution, at any step interval within a particular recipe execution sequence, with the step interval determined a-priori by the operator or the robot system controller, or at the conclusion of any particular AP step within a robotic cooking sequence, with its associated exiting robot system configuration parameters, whereby a numerically determined execution-error metric based on deviations from pre-defined success criteria and their associated parameters, exceeds a threshold defined for each AP step. The adaptation process is not allow to occur at every time-step within the controller execution loop of the AP execution sequence, nor at a rate that results in a computational delay or stack-up of execution time that exceeds the time-interval defined by the fixed time difference two succeeding time-steps of the robotic controller execution loop, thereby compromising the overall execution time while also jeopardizing the successful completion of the overall robotic cooking sequence.

A robotic kitchen system comprises a master robotic module assembly having a processor, one or more robotic arms, and one or more robotic end effectors; one or more slave robotic module assemblies, each robotic module assembly having one or more robotic arms and one or more robotic end effectors, the master robotic module assembly being positioned at one end that is adjacent to the one or more slave robotic module assemblies, wherein the master robotic module assembly receiving an order electronically to prepare one or more food dishes, the master robotic module assembly selecting a mode to operate for providing instructions and collaborating with the slave robotic module assemblies. The mode comprises a plurality of modes having a first mode and a second mode, during the first mode, the master robotic module assembly and the one or more slave robotic module assemblies preparing a plurality of dishes from the order, during a second mode, the master robotic module assembly and the one or more slave robotic module assemblies operate collectively to prepare different components of a same dish from the order, the different components of the same dish comprises an entrée, a side dish, and dessert. Depending on the selected mode, either as the first mode or the second mode, the processor at the master robotic assembly sends instructions to the processors at the one or more slave robotic assemblies for the master robotic assembly and the one or more slave robotic assembly to execute a plurality of coordinated and respective minimanipulations to prepare either a plurality of dishes, or a different components of a dish. The master robotic module assembly receives a plurality of orders and distributes the plurality of orders among the master robotic module assembly and the one or more slave robotic module assemblies in preparing a plurality of orders, one or more robotic arms and the one or more robotic end effectors of the master robotic module assembly preparing one or more distributed orders, and one or more robotic arms and the one or more robotic end effectors at each slave robotic module assembly in the one or more slave robotic module assemblies preparing the one or more distributed orders received from the master robotic module assembly. The master robotic module assembly receives a plurality of orders within a time duration, if the plurality of orders involving a same food dish, the master robotic module assembly allocates a larger portion to prepare the same food dish that is proportional to the number of orders for the same dish, the master robotic module assembly then distributing the plurality of orders among the master robotic module assembly and the one or more slave robotic module assemblies, one or more robotic arms and the one or more robotic end effectors of the master robotic module assembly or one or more robotic arms and the one or more robotic end effectors of the one or more slave robotic module assemblies preparing the same food dish in a larger portion proportional to the number of orders for the same food dish. The master robotic module assembly and the one or more slave robotic module assemblies prepares the plurality of dishes from the order for one customer. The master robotic module assembly and the one or more slave robotic module assemblies operate collectively to prepare different components of a same dish from the order for one customer.

A robotic system comprises a cooking station with a first worktop and a station frame, the worktop is placed on station frame, the worktop including a first plurality of standardized placements and a first plurality of objects, each placement being used to place an environmental object, the cooking station having an interface area; and a robotic kitchen module having one or more robotic arms and one or more robotic end effector, the robotic kitchen module having a first contour, the robotic kitchen module being attached to the interface area of the cooking station. The first worktop of the cooking station is changed to a second worktop, the second worktop including a second plurality of standardized placements. The first plurality of objects is changed to a second plurality of objects for use in the first worktop of the cooking station. The robotic kitchen module is a mobile module that can be detached from the interface area of the cooking station, the interface area providing space for a human to operate the cooking station instead of operated by the robotic kitchen module. The workstop comprises a food dish worktop, a coffee worktop, boiling, frying, and others. The plurality objects comprises coffee machines, bottles, ingredient carousel and others. A macro active primitive (AP) structure or a micro active primitive (AP) structure is selected to minimize the number of degree of freedom for the one or more robotic arms and the one or more robotic end effectors to operate in the environment of the cooking station. One or more entry/exit joint state configurations for operating one or more minimanipulations, micro action primitive, or macro primitive.

FIG. 159 is a block diagram illustrating an example of a computer device, as shown in 960, on which computer-executable instructions to perform the methodologies discussed herein may be installed and run. As alluded to above, the various computer-based devices discussed in connection with the present disclosure may share similar attributes. Each of the computer devices is capable of executing a set of instructions to cause the computer device to perform any one or more of the methodologies discussed herein. The computer devices may represent any or all of the server, or any network intermediary devices. Further, while only a single machine is illustrated, the term “machine” shall also be taken to include any collection of machines that individually or jointly execute a set (or multiple sets) of instructions to perform any one or more of the methodologies discussed herein. The example computer system 960 includes a processor 962 (e.g., a central processing unit (CPU), a graphics processing unit (GPU), or both), a main memory 964 and a static memory 966, which communicate with each other via a bus 968. The computer system 960 may further include a video display unit 970 (e.g., a liquid crystal display (LCD)). The computer system 960 also includes an alphanumeric input device 972 (e.g., a keyboard), a cursor control device 974 (e.g., a mouse), a disk drive unit 976, a signal generation device 978 (e.g., a speaker), and a network interface device 980.

The disk drive unit 976 includes a machine-readable medium 980 on which is stored one or more sets of instructions (e.g., software 982) embodying any one or more of the methodologies or functions described herein. The software 982 may also reside, completely or at least partially, within the main memory 980 and/or within the processor 962 during execution thereof the computer system 960, the main memory 964, and the instruction-storing portions of processor 982 constituting machine-readable media. The software 982 may further be transmitted or received over a network 984 via the network interface device 986.

While the machine-readable medium 980 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any tangible medium that is capable of storing a set of instructions for execution by the machine and that cause the machine to perform any one or more of the methodologies of the present disclosure. The term “machine-readable medium” shall accordingly be taken to include, but not be limited to, solid-state memories, and optical and magnetic media.

Some portions of the above are presented in terms of algorithms and symbolic representations of operations on data bits within a computer memory. These algorithmic descriptions and representations are the means used by those skilled in the data processing arts to convey most effectively the substance of their work to others skilled in the art. An algorithm is generally perceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), erasable programmable ROMs (EPROMs), electrically erasable and programmable ROMs (EEPROMs), magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

An electronic device according to various embodiments of the disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HIMDs)), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In other embodiments, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automated teller machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of the disclosure may not be limited to the above-described devices, and may provide functions of a plurality of devices like smartphones which have measurement function of personal biometric information (e.g., heart rate or blood glucose). In the disclosure, the term “user” may refer to a person who uses an electronic device or may refer to a device (e.g., an artificial intelligence electronic device) that uses the electronic device.

Moreover, terms such as “request”, “client request”, “requested object”, or “object” may be used interchangeably to mean action(s), object(s), and/or information requested by a client from a network device, such as an intermediary or a server. In addition, the terms “response” or “server response” may be used interchangeably to mean corresponding action(s), object(s) and/or information returned from the network device. Furthermore, the terms “communication” and “client communication” may be used interchangeably to mean the overall process of a client making a request and the network device responding to the request.

In respect of any of the above system, device or apparatus aspects, there may further be provided method aspects comprising steps to carry out the functionality of the system. Additionally or alternatively, optional features may be found based on any one or more of the features described herein with respect to other aspects.

The present disclosure has been described in particular detail with respect to possible embodiments. Those skilled in the art will appreciate that the disclosure may be practiced in other embodiments. The particular naming of the components, capitalization of terms, the attributes, data structures, or any other programming or structural aspect is not mandatory or significant, and the mechanisms that implement the disclosure or its features may have different names, formats, or protocols. The system may be implemented via a combination of hardware and software, as described, or entirely in hardware elements, or entirely in software elements. The particular division of functionality between the various system components described herein is merely exemplary and not mandatory; functions performed by a single system component may instead be performed by multiple components, and functions performed by multiple components may instead be performed by a single component.

In various embodiments, the present disclosure can be implemented as a system or a method for performing the above-described techniques, either singly or in any combination. The combination of any specific features described herein is also provided, even if that combination is not explicitly described. In another embodiment, the present disclosure can be implemented as a computer program product comprising a computer-readable storage medium and computer program code, encoded on the medium, for causing a processor in a computing device or other electronic device to perform the above-described techniques.

As used herein, any reference to “one embodiment” or to “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The algorithms and displays presented herein are not inherently related to any particular computer, virtualized system, or other apparatus. Various general-purpose systems may also be used with programs, in accordance with the teachings herein, or the systems may prove convenient to construct more specialized apparatus needed to perform the required method steps. The required structure for a variety of these systems will be apparent from the description provided herein. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

In various embodiments, the present disclosure can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the disclosure include a mobile phone, personal digital assistant, smartphone, kiosk, desktop computer, laptop computer, consumer electronic device, television, set-top box, or the like. An electronic device for implementing the present disclosure may use an operating system such as, for example, iOS available from Apple Inc. of Cupertino, Calif., Android available from Google Inc. of Mountain View, Calif., Microsoft Windows 10 available from Microsoft Corporation of Redmond, Wash., or any other operating system that is adapted for use on the device. In some embodiments, the electronic device for implementing the present disclosure includes functionality for communication over one or more networks, including for example a cellular telephone network, wireless network, and/or computer network such as the Internet.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one as or more than one. The term “plurality,” as used herein, is defined as two or as more than two. The term “another,” as used herein, is defined as at least a second or more.

An ordinary artisan should require no additional explanation in developing the methods and systems described herein but may find some possibly helpful guidance in the preparation of these methods and systems by examining standardized reference works in the relevant art.

In addition to the above disclosure on the robotic kitchen for use in residential, commercial or industrial applications, the design of the robotic kitchen in the present disclosure can also be modified as a toy for kids, as toy robotic kitchen. In one embodiment, the toy robotic kitchen can be made of plastics with different pieces for assembly by kids, similar to LEGO pieces. In another embodiment, the toy robotic kitchen can be equipped with one or more batteries for which the toy robotic kitchen has some parts that are mechanical pieces to be put together, and some other parts which can be moveable upon activating a power switch by batteries, such as to move the robotic arm and hands. In a further embodiment, the toy robotic kitchen can be an educational toy which the toy robotic kitchen has an interactive function with kids to teach the kids as to how to make food dishes.

While the disclosure has been described with respect to a limited number of embodiments, those skilled in the art, having benefit of the above description, will appreciate that other embodiments may be devised which do not depart from the scope of the present disclosure as described herein. It should be noted that the language used in the specification has been principally selected for readability and instructional purposes, and may not have been selected to delineate or circumscribe the inventive subject matter. The terms used should not be construed to limit the disclosure to the specific embodiments disclosed in the specification and the claims, but the terms should be construed to include all methods and systems that operate under the claims set forth herein below. Accordingly, the disclosure is not limited by the disclosure, but instead its scope is to be determined entirely by the following claims.

What is claimed is:

1. A system for mass production of a robotic kitchen module, comprising:
a kitchen module frame for housing a robotic apparatus in an instrumented environment, the robotic apparatus having one or more robotic arms and one or more effectors, the one or more robotic arms including a share joint, the kitchen module having a set of robotic operable parameters for calibration verifications to an initial state for operation by the robotic apparatus; and
one or more calibration actuators coupled to a respective one of the one or more robotic arms, each calibration actuator corresponding to an axis on x-y-z axes, each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and
a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations.

2. The system of claim 1, wherein the detector comprises at least one probe.

3. The system of claim 2, wherein the kitchen module frame having a physical representation and a virtual representation, the virtual representation of the kitchen module frame being fully synchronized with the physical representation of the kitchen module frame.

4. A method of reconfiguring a robotic system from a current configuration, to a new and different configuration pre-defined as the starting configuration for one or more steps within a cooking sequence, with each cooking step being described by a sequentially-executed set of APs, the steps of said adaptation process consisting of a reconfiguration process, comprising:
a. sensing and determining the robot configuration in the world using robot-internal and -external sensory systems;
b. using additional sensory systems to image the environment, identify objects therein, locating and mapping them accordingly;
c. developing a set of transformation parameters captured in one or more transformation vectors and/or matrices thereafter applied to the robot system as part of an adaptation step to compensate for any deviations between the physical system configuration and the pre-defined configuration defined for the starting point of a particular step within a given command sequence;
d. aligning the robotic system into one of multiple known possible set of starting configurations best-matched to the first of multiple sequential action primitives; and
e. returning control to the central control system for execution of any follow-on robotic movement steps described by a sequence of APs within a particular recipe execution process.

5. A robotic kitchen system, comprising:
a master robotic module assembly having a processor, one or more robotic arms, and one or more robotic end effectors;
one or more slave robotic module assemblies, each robotic module assembly having one or more robotic arms and one or more robotic end effectors, the master robotic module assembly being positioned at one end that is adjacent to the one or more slave robotic module assemblies,
wherein the master robotic module assembly receiving an order electronically to prepare one or more food dishes, the master robotic module assembly selecting a mode to operate for providing instructions and collaborating with the slave robotic module assemblies.

6. The robotic kitchen system of claim 5, wherein the mode comprises a plurality of modes having a first mode and a second mode, during the first mode, the master robotic module assembly and the one or more slave robotic module assemblies preparing a plurality of dishes from the order, during a second mode, the master robotic module assembly and the one or more slave robotic module assemblies operate collectively to prepare different components of a same dish from the order, the different components of the same dish comprises an entrée, a side dish, and dessert.

7. The robotic kitchen system of claim 6, depending on the selected mode, either as the first mode or the second mode, the processor at the master robotic assembly sends instructions to the processors at the one or more slave robotic assemblies for the master robotic assembly and the one or more slave robotic assembly to execute a plurality of coordinated and respective minimanipulations to prepare either a plurality of dishes, or a different components of a dish.

8. The robotic kitchen system of claim 6, wherein the master robotic module assembly receives a plurality of orders and distributes the plurality of orders among the master robotic module assembly and the one or more slave robotic module assemblies in preparing a plurality of orders, one or more robotic arms and the one or more robotic end effectors of the master robotic module assembly preparing one or more distributed orders, and one or more robotic arms and the one or more robotic end effectors at each slave robotic module assembly in the one or more slave robotic module assemblies preparing the one or more distributed orders received from the master robotic module assembly.

9. The robotic kitchen system of claim 6, wherein the master robotic module assembly receives a plurality of orders within a time duration, if the plurality of orders involving a same food dish, the master robotic module assembly allocates a larger portion to prepare the same food dish that is proportional to the number of orders for the same dish, the master robotic module assembly then distributing the plurality of orders among the master robotic module assembly and the one or more slave robotic module assemblies, one or more robotic arms and the one or more robotic end effectors of the master robotic module assembly or one or more robotic arms and the one or more robotic end effectors of the one or more slave robotic module assemblies preparing the same food dish in a larger portion proportional to the number of orders for the same food dish.

10. The robotic kitchen system of claim 6, wherein the master robotic module assembly and the one or more slave robotic module assemblies preparing the plurality of dishes from the order for one customer.

11. The robotic kitchen system of claim 5, wherein the master robotic module assembly and the one or more slave robotic module assemblies operate collectively to prepare different components of a same dish from the order for one customer.

12. A robotic system, comprising:
a cooking station with a first worktop and a station frame, the worktop is placed on station frame, the worktop including a first plurality of standardized placements and a first plurality of objects, each placement being used to place an environmental object, the cooking station having an interface area; and
a robotic kitchen module having one or more robotic arms and one or more robotic end effector, the robotic kitchen module having a first contour, the robotic kitchen module being attached to the interface area of the cooking station.

13. The robotic system of claim 12, wherein the first worktop of the cooking station is changed to a second worktop, the second worktop including a second plurality of standardized placements.

14. The robotic system of claim 12, wherein the first plurality of objects is changed to a second plurality of objects for use in the first worktop of the cooking station.

15. The robotic system of claim 12, wherein the robotic kitchen module is a mobile module that can be detached from the interface area of the cooking station, the interface area providing space for a human to operate the cooking station instead of operated by the robotic kitchen module.
